(19) United States
(12) Patent Application Publication
(10) Pub. No.: US 2025/0222450 A1
(43) Pub. Date: Jul. 10, 2025

(54) PREPARATION OF ARRAY SURFACES FOR SINGLE-ANALYTE PROCESSES

(71) Applicant: Nautilus Subsidiary, Inc., Seattle, WA (US)

(72) Inventors: Christina E. INMAN, Seattle, WA (US); Krista COSERT, Seattle, WA (US); Pierre INDERMUHLE, Berkeley, CA (US); Ali Najafi SOHI, Seattle, WA (US); Shubhodeep PAUL, Seattle, WA (US); Maria Mercedes Hernandez DE GARATE, Seattle, WA (US); Seok Ki CHOI, Seattle, WA (US); Rukshan PERERA, Seattle, WA (US)

(21) Appl. No.: 19/084,643

(22) Filed: Mar. 19, 2025

Related U.S. Application Data
(63) Continuation of application No. PCT/US2023/075418, filed on Sep. 28, 2023.
(60) Provisional application No. 63/377,601, filed on Sep. 29, 2022.
(60) Provisional application No. 63/387,322, filed on Dec. 14, 2022.

(51) Int. Cl. B01L 3/00; G01N 15/1434

(52) U.S. Cl. CPC B01L 3/502715; G01N 15/1436; B01L 2300/0819; B01L 2300/0877; B01L 2300/161

(57) ABSTRACT

Compositions and methods are provided for forming single-analyte arrays with enhanced characteristics for inhibiting orthogonal binding of molecules to the array. Arrays are modified to contain covalently incorporated passivating moieties at array addresses where orthogonal binding may occur. The compositions and methods may facilitate detection of an increased quantity of array features at single-analyte resolution.

### CROSS REFERENCE TO RELATED APPLICATIONS

This application is a bypass continuation claiming priority to International Patent Application Serial No. PCT/US23/75418, filed Sep. 28, 2023, which claims priority to U.S. Provisional Patent Application Ser. No. 63/377,601, filed Sep. 29, 2022, and to U.S. Provisional Patent Application Ser. No. 63/387,322, filed Dec. 14, 2022, all of which are hereby incorporated by reference in their entireties.

### BACKGROUND

Array-based single-molecule assays provide the ability to distinguish individual array features at single-molecule resolution. Single-molecule resolution may be obtained when detectable signals from an array feature are both observable and distinguishable from detectable signals originating from other array features. Accordingly, achieving single-molecule resolution during detection of single-molecule arrays is a function of both the detection method utilized to interrogate an array and the composition and structure of the array itself.

Orthogonal binding phenomena can interfere with or altogether eliminate detection of array features at single-molecule resolution. In the context of single-molecule arrays, orthogonal binding may refer to the unintended or unexpected binding of any assay component to the array at an array address that is not configured to bind the assay component. Orthogonal binding phenomena may lead to the binding of detectable moieties to the array at locations that interfere with the detection of array features at single-molecule resolution.

### SUMMARY

In an aspect, provided herein is a composition, comprising: a) a solid support, in which the solid support comprises: i) a plurality of sites, in which each site is coupled to one and only one analyte, and ii) one or more interstitial regions, in which each site of the plurality of sites is spatially separated from other sites of the plurality of sites by an interstitial region of the one or more interstitial regions, b) a first plurality of molecules, in which the first plurality of molecules is coupled to the one or more interstitial regions, and in which each molecule of the first plurality of molecules comprises a moiety that is configured to inhibit binding of an assay agent, c) a plurality of defects occurring in a random spatial distribution on the one or more interstitial regions, and in which each defect of the plurality of defects comprises a moiety that is configured to bind the assay agent, d) a second plurality of molecules bound to the plurality of defects, and e) a plurality of assay agents coupled to the solid support, in which less than 10% of the plurality of assay agents are coupled to the one or more interstitial regions of the solid support.

In another aspect, provided herein is a composition, comprising: a) a solid support, in which the solid support comprises: i) a plurality of sites, in which each site is coupled to one and only one analyte, and ii) one or more interstitial regions, in which each site of the plurality of sites is spatially separated from other sites of the plurality of sites by an interstitial region of the one or more interstitial regions, b) a first plurality of molecules, in which the first plurality of molecules is coupled to the one or more interstitial regions, and in which each molecule of the first plurality of molecules comprises a first moiety that is configured to inhibit binding of a detection agent, c) a second plurality of molecules occurring in a random spatial distribution on the one or more interstitial regions, in which each molecule of the second plurality of molecules comprises a dissimilar chemical structure to each molecule of the first plurality of molecules, and in which each molecule of the second plurality of molecules is configured to inhibit binding of the detection agent, d) a plurality of defects, in which each defect is configured to bind the assay agent, in which the plurality of defects comprises a random spatial distribution on the one or more interstitial regions, and in which the plurality of defects comprises a subset of defects comprising no more than 1% of defects of the plurality of defects, in which each defect of the subset of defects is spatially non-resolvable from at least one site of the plurality of sites, and e) a plurality of detection agents coupled to the solid support, in which the plurality of detection agents is coupled to the subset of defects.

In another aspect provided herein is a composition, comprising: a) a solid support, in which the solid support comprises: i) a plurality of sites, in which each site comprises one and only one analyte, and ii) one or more interstitial regions, in which each site of the plurality of sites is spatially separated from other sites of the plurality of sites by an interstitial region of the one or more interstitial regions, b) a passivating layer, in which the passivating layer is coupled to the one or more interstitial regions, in which the passivating layer is configured to inhibit binding of an assay agent, in which the passivating layer comprises a first plurality of passivating molecules and a second plurality of passivating molecules, in which a first passivating molecule of the first plurality of passivating molecules is chemically dissimilar to a second passivating molecule of the second plurality of passivating molecules, and in which the second plurality of passivating molecules occurs in a first random spatial distribution, c) a plurality of defects, in which each defect is configured to bind an assay agent, and in which the plurality of defects occurs in a second random spatial distribution on the one or more interstitial regions, and d) a plurality of assay agents bound to the plurality of defects.

In another aspect, provided herein is a method, comprising: a) providing a solid support comprising an organic layer, in which the organic layer comprises a plurality of defects, in which each defect of the plurality of defects comprises an absence of the organic molecules, in which the organic layer comprises an average defect density, in which the plurality of defects comprises a spatially-random distribution on the solid support, in which a first plurality of organic molecules is coupled to defects of the plurality of defects, and in which the solid support comprises: i) a plurality of sites, and ii) one or more interstitial regions, in which each site of the plurality of sites is spatially separated from other sites of the plurality of sites by an interstitial region of the one or more interstitial regions, and b) coupling a second plurality of organic molecules to the solid support, in which molecules of the second plurality of organic molecules are coupled to defects of the plurality of defects, and in which each molecule of the second plurality of organic molecules comprises a passivating moiety.

In another aspect, provided herein is a method, comprising: a) coupling a first plurality of organic molecules to a solid support to form an organic layer, in which the organic layer comprises a plurality of defects, in which each defect of the plurality of defects comprises an absence of the organic molecules, in which the organic layer comprises an average defect density, in which the plurality of defects comprises a spatially-random distribution on the solid support, and in which the solid support comprises: i) a plurality of sites, and ii) one or more interstitial regions, in which each site of the plurality of sites is spatially separated from other sites of the plurality of sites by an interstitial region of the one or more interstitial regions, and b) coupling a second plurality of organic molecules to the solid support, in which each molecule of the second plurality of organic molecules is coupled to a defect of the plurality of defects, and in which each molecule of the second plurality of organic molecules comprises a passivating moiety.

In another aspect, provided herein is a method, comprising: a) providing an array comprising a solid support, in which the array comprises: i) a plurality of sites, in which a site of the plurality of sites is configured to couple one and only one analyte, ii) one or more interstitial regions, in which each site of the plurality of sites is separated from other sites of the plurality of sites by the one or more interstitial regions, and iii) a surface-bound layer comprising a plurality of organic molecules, in which the surface-bound layer comprises a first plurality of defects and a second plurality of defects, in which the first plurality of defects is chemically distinguishable from the second plurality of defects, b) contacting the array with a second plurality of organic molecules, and c) coupling a first fraction of the second plurality of organic molecules to the first plurality of defects, and coupling a second fraction of the second plurality of organic molecules to the second plurality of defects.

In another aspect, provided herein is a method, comprising: a) providing a solid support surface comprising a plurality of surface-coupled moieties, in which the surface-coupled moieties comprise reactive functional groups, b) contacting the solid support with an aqueous medium comprising a plurality of molecules, in which molecules of the plurality of molecules comprise coupling moieties, in which the aqueous medium further comprises a kosmotropic agent or a clouding agent, in which a coupling moiety of the coupling moieties comprises a complementary reactive functional group, and in which reactive functional groups covalently coupled complementary reactive functional groups, and c) covalently coupling molecules of the plurality of molecules to at least 50% of the plurality of surface-coupled moieties in the presence of the kosmotropic agent or clouding agent.

In another aspect, provided herein is a composition, comprising: a) a solid support, b) a moiety coupled to the solid support, in which the moiety comprises a nucleophilic functional group, and c) an aqueous medium contacted to the solid support, in which the aqueous medium comprises: i) a compound comprising a moiety comprising an N-hydroxysuccinimide (NHS) ester, in which the compound further comprises a polymeric moiety, and ii) a kosmotropic agent or a clouding agent.

In another aspect, provided herein is a method, comprising: a) providing a solid support comprising a surface, in which a patternable material is disposed on the surface, in which the patternable material comprises a well, and in which a portion of the surface of the solid support is exposed in the well, b) contacting the patternable material with an organic polar solvent, in which the organic polar solvent comprises a plurality of surfactant molecules, c) after contacting the patternable material with the organic polar solvent, forming an admixture of the plurality of surfactant molecules and the patternable material, d) coupling a plurality of molecules to the portion of the solid support, in which the plurality of molecules comprises a plurality of reactive functional groups, and e) removing from the solid support at least a fraction of the admixture comprising the patternable material and the plurality of surfactant molecules.

In another aspect, provided herein is a composition, comprising: a) a solid support comprising a surface, b) a patternable material disposed on the surface, in which the patternable material comprises a well, in which the well is at least partially bounded by the patternable material, and in which a bottom of the well comprises an exposed portion of the surface, c) a plurality of molecules, in which the molecules are coupled to the exposed portion of the surface, and in which molecules of the plurality of molecules comprise reactive functional groups, and d) a plurality of protectant moieties, in which the plurality of protectant moieties is dispersed within the patternable material.

In another aspect, provided herein is a method, comprising: a) providing a solid support comprising a surface, in which a patternable material is disposed on the surface, in which the patternable material comprises a well, and in which a portion of the surface of the solid support is exposed in the well, b) forming an admixture of a plurality of chemical sink moieties and the patternable material, c) coupling a plurality of molecules to the portion of the solid support, and d) after coupling the plurality of molecules to the portion of the solid support, forming a perimeter material adjacent to the portion of the solid support, in which the perimeter material is disposed on the surface, in which the perimeter material comprises a molecule of the plurality of molecules coupled to a molecule of the patternable material, and in which the perimeter material further comprises chemical sink moieties of the plurality of chemical sink moieties.

In another aspect, provided herein is a composition, comprising: a) a solid support comprising a surface, and b) a solid-phase admixture disposed on the surface, in which the solid-phase admixture comprises a patternable material and a plurality of chemical sink moieties

In another aspect, provided herein is a composition, comprising: a) a solid support comprising a surface, b) a plurality of molecules coupled to a portion of the surface, and c) a perimeter material disposed on the surface adjacent to the portion of the surface, in which the perimeter material comprises a molecule of the plurality of molecules covalently coupled to a molecule of a patternable material, and in which the perimeter material further comprises a chemical sink moiety.

In another aspect, provided herein is a method, comprising: a) providing a substrate, wherein the substrate comprises a solid support and a layer of a resist material disposed on a surface of the solid support, and wherein the layer of the resist material comprises a plurality of depressions, in which each individual depression of the plurality of depression comprises an exposed region of the surface of the solid support, b) binding a plurality of molecules to each individual exposed region of the surface of the solid support in each individual depression of the plurality of depressions, in which molecules of the plurality of molecules comprise reactive functional groups that are not attached to the surface of the solid support, in which the binding occurs in the presence of a fluidic medium comprising water and a miscible solvent, and c) after binding the plurality of molecules to each individual exposed region of the surface of the solid support, removing the layer of the resist material from the surface of the solid support.

In another aspect, provided herein is an array, comprising: a) a solid support comprising a surface, b) a plurality of discrete regions on the surface of the solid support, wherein each discrete region comprises a plurality of molecules coupled to the surface of the solid support, and c) one or more interstitial regions, in which each individual discrete region of the plurality of discrete regions is separated from each other discrete region by an interstitial region of the one or more interstitial regions, in which the plurality of molecules comprises a plurality of passivating molecules and a plurality of coupling molecules, in which a ratio of a quantity of the plurality of passivating molecules to a quantity of the plurality of coupling molecules is at least 2:1, and in which the one or more interstitial regions comprise a layer disposed on the surface of the solid support, wherein the layer comprises a hydrophobic material.

In another aspect, provided herein is a flow cell, comprising: a) a first solid support, wherein an array, as set forth herein, is disposed on a surface of the first solid support, and b) a second solid support, in which the first solid support is joined to the second solid support to form an enclosed void, in which the array is disposed within the void, and in which a surface of the second solid support within the void comprises a layer of a hydrophobic material.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A depicts a top-down view of a single-analyte array with circular binding sites and a superimposed pixel grid, in accordance with some embodiments. FIGS. 1B, and 1C illustrate simulated pixel data for fluorescent detection under high array-occupancy and low array-occupancy conditions, in accordance with some embodiments.

FIGS. 2A, 2B, 2C, 2D, and 2E show steps of an idealized method for forming a surface layer on a solid support, in accordance with some embodiments.

FIGS. 3A and 3B display steps of a method of forming a surface layer comprising defects on a solid support, in accordance with some embodiments.

FIGS. 4A, 4B, and 4C depict steps of a method of forming a surface layer comprising defects on a solid support, in accordance with some embodiments.

FIG. 5 illustrates a surface layer comprising multiple defects with dissimilar chemical structures, in accordance with some embodiments.

FIGS. 6A and 6B show a method of binding a heterogeneous mixture of molecules to a surface comprising multiple types of defects, in accordance with some embodiments.

FIGS. 7A, 7B, 7C, 7D, and 7E display steps of a method for forming a surface layer, in accordance with some embodiments.

FIGS. 8A, 8B, 8C, and 8D illustrate different configurations of single-analyte arrays, in accordance with some embodiments.

FIGS. 9A, 9B, 9C, 9D, 9E, 9F, and 9G show steps of a method of modifying a surface layer of a single-analyte array utilizing surface defects as coupling points, in accordance with some embodiments.

FIGS. 10A, 10B, 10C, 10D, and 10E depict steps of a method of modifying a surface layer of a single-analyte array utilizing surface defects as coupling points, in accordance with some embodiments.

FIG. 11 illustrates a surface layer comprising labile chemical structures, in accordance with some embodiments.

FIGS. 12A, 12B, 12C, 12D, and 12E show steps of a method for forming and modifying a surface layer, in accordance with some embodiments.

FIGS. 13A, 13B, 13C, 13D, 13E, 13F, 13G, 13H, 13I, 13J, and 13K depict steps of a method for forming single-analyte arrays, in accordance with some embodiments.

FIG. 14A displays reaction pathways during formation of a surface layer in an absence of a kosmotropic agent or clouding agent, in accordance with some embodiments. FIG. 14B displays a configuration of a surface layer formed by the reactions of FIG. 14A, in accordance with some embodiments. FIG. 14C displays reaction pathways during formation of a surface layer in a presence of a kosmotropic agent or clouding agent, in accordance with some embodiments. FIG. 14D displays a configuration of a surface layer formed by the reactions of FIG. 14C, in accordance with some embodiments.

FIGS. 15A and 15B illustrate steps of a method of forming a single-analyte array, in accordance with some embodiments.

FIGS. 16A and 16B illustrate steps of a method of forming a single-analyte array, in accordance with some embodiments. FIGS. 16C and 16D illustrate top-down views of single-analyte array configurations during the steps depicted in FIGS. 16A and 16B, respectively, in accordance with some embodiments.

FIGS. 17A, 17B, 17C, 17D, 17E, and 17F show steps of a method of inhibiting cross-reactivity between a patternable material and surface-coupled moieties, in accordance with some embodiments.

FIGS. 18A, 18B, 18C, and 18D depict steps of a method for incorporating moieties into a perimeter surface layer surrounding an array site, in accordance with some embodiments.

FIG. 19 displays methods for attaching a surface-coupled moiety to a solid support, in accordance with some embodiments.

FIG. 20 illustrates a schematic of a single-analyte array formation process, in accordance with some embodiments.

FIG. 21 shows a method of forming a site of a single-analyte array, in accordance with some embodiments.

FIG. 22 depicts a portion of an array comprising an interstitial region and a binding site, in which a defect of the interstitial region and a defect of the binding site both cause detectable probes to become bound to the array by differing orthogonal binding phenomena, in accordance with some embodiments.

FIGS. 23A, 23B, and 23C display configurations of molecules attached to a solid support that may be useful for inhibiting orthogonal binding phenomena at a binding site, in accordance with some embodiments.

FIGS. 24A, 24B, 24C, 24D, 24E, and 24F show fluorescent microscopy data for multivalent binding reagents orthogonally bound to surfaces with differing surface layers.

### DETAILED DESCRIPTION

Substantial differences exist between the structure and behavior of matter at the nanoscale and the macroscale. Imperfections in a fabricated system, such as a biomolecular array, will inherently occur at the nanoscale, whether due to entropic processes, fabrication irregularities, fabrication variability, reagent impurities, or any of a variety of other sources of natural or engineered variability or error. Such imperfections, when considered from the macroscale, comprise an inherent property of the fabricated system; the net effect of the imperfections becomes averaged into the ensemble average properties of the fabricated system. However, when considered from the nanoscale, such imperfections can exert a substantial influence on the local properties of the fabricated system. In some cases, imperfections in fabricated systems can generate deleterious or otherwise unwanted physical behaviors that affect interrogation of the systems in a nanoscale fashion.

An example of the impact of imperfections on a fabricated system is orthogonal binding phenomena. A surface of a solid support (e.g., glass, silica, silicon, etc.) or other particle is often provided a passivating layer (e.g., polyethylene glycol, dextrans, etc.) that is configured to inhibit the unwanted adhesion of certain molecules to the surface. The passivating layer is typically solvent exposed to prevent molecules solvated or suspended within the solvent from adhering to the surface. If the surface were perfectly fabricated (i.e., a completely homogeneous passivating layer, free of defects), the surface would be expected to prevent unwanted adhesion of whichever molecules the surface was engineered to prevent binding. In non-ideal systems, the presence of localized, often random imperfections can lead to unwanted orthogonal binding of certain molecules that the system was specifically designed to inhibit. Orthogonal binding phenomena can become especially troublesome for single-molecule or single-analyte systems, such as single-molecule biomolecular assays. Such systems often utilize arrays with analytes located at highly localized addresses on the array. Orthogonal binding on or in close proximity to such addresses can affect the quality of data obtained from such arrays during an assay, for example due to false positive or false negative detection events.

Arrays for single-molecule or single-analyte assays are frequently provided in a format that comprises a solid support with a plurality of discretely defined or patterned analyte binding sites (for example, a rectangular or hexagonal grid of binding sites). Each analyte binding site is separated from the other analyte binding sites by interstitial regions that are configured to prevent binding of analytes or other molecules to the interstitial regions. Frequently, the surface chemistry of the analyte binding sites may differ from the surface chemistry of the interstitial regions due to their differing functions in a single-molecule or single-analyte assay. For example, an array that is configured to retain a single nucleic acid at each binding site may comprise binding sites containing a layer of oligonucleotides that are configured to bind the single nucleic acid, while interstitial regions may comprise a PEGylated layer that is configured to prevent binding of nucleic acids and/or other molecules. The oligonucleotides and PEG molecules can be configured for exposure to a solvent containing nucleic acids. In such a system, imperfections in the PEGylated layer (e.g., incorporation of partially-oxidized PEG impurities to the PEGylated layer) can result in orthogonal binding of nucleic acids to interstitial regions, thereby possibly occluding detection of analytes at proper binding sites, or producing false detection events at non-binding sites.

Provided herein are methods for forming arrays for single-molecule or single-analyte processes that have improved inhibition of orthogonal binding phenomena. The methods utilize sequential chemical strategies to form passivating layers on surfaces, then reduce the concentration of surface defects that give rise to orthogonal binding phenomena. The methods may further comprise incorporating moieties into surface layers at surface defects that alter the configuration or conformation of molecules within the surface layer. For example, the incorporation of a polyethylene glycol (PEG) moiety into a surface layer comprising oligonucleotides may alter the binding behavior of the oligonucleotides to complementary nucleic acid sequences. In some cases, the methods comprise the attachment of additional passivating moieties to surface defects to block or remove the defect. Also provided herein are compositions that arise before, during, and after the disclosed array formation methods. The compositions may comprise single-analyte arrays with enhanced resistance to orthogonal binding of molecules during single-analyte assays.

### Definitions

As used herein, the terms “address” or “site” refer synonymously to a location in an array where a particular molecule (e.g. organic molecule, inorganic molecule, passivating moiety, analyte, etc.) is present or is configured to be bound. An address can contain a single molecule, or it can contain a population of several molecules of the same species (i.e. an ensemble of the analytes). Alternatively, an address can include a population of different molecules. Addresses are typically discrete. The discrete addresses can be contiguous, or they can be separated by interstitial spaces. An address may be vacant (e.g., an array site that is configured to bind a molecule but has not bound the molecule). An array useful herein can have, for example, addresses that are separated by less than 100 microns, 10 microns, 1 micron, 100 nm, 10 nm or less. Alternatively or additionally, an array can have addresses that are separated by at least 10 nm, 100 nm, 1 micron, 10 microns, or 100 microns. The addresses can each have an area of less than 1 square millimeter, 500 square microns, 100 square microns, 10 square microns, 1 square micron, 100 square nm or less. An array can include at least about 1×10⁴, 1×10⁵, 1×10⁶, 1×10⁷, 1×10⁸, 1×10⁹, 1×10¹⁰, 1×10¹¹, 1×10¹², or more addresses. A site can have a characteristic dimension (e.g., a diameter, a length, a width, a circumference) of at least about 1 nm, 10 nm, 100 nm, 200 nm, 300 nm, 400 nm, 500 nm, 1 micron, 1.5 microns, 2 microns, 5 microns, or more than 5 microns. Alternatively or additionally, a site can have a characteristic dimension of no more than about 5 microns, 2 microns, 1.5 microns, 1 micron, 500 nm, 400 nm, 300 nm, 200 nm, 100 nm, 10 nm, 1 nm, or less than 1 nm. A site may comprise a surface layer, such as a coupling layer, a passivating layer, or a combination thereof. A site may comprise a coupling layer that contains a molecule, moiety, or a plurality thereof that attaches or is configured to attach an entity (e.g., an anchoring moiety, an analyte) to the site, such as an oligonucleotide, a reactive functional group (e.g., a Click-type reagent), or a member of a receptor-ligand binding pair (e.g., streptavidin-biotin, SpyCatcher-SpyTag, SnoopCatcher-SnoopTag, etc.). A site may comprise a passivating layer that contains a molecule, moiety, or a plurality thereof that does not form or is not configured to form an orthogonal binding interaction with an entity (e.g., an analyte, an anchoring moiety, a blocking reagent, an affinity agent, a detectable probe, a detectable label, etc.). For example, a passivating layer may comprise hydrophobic, hydrophilic, polar, or non-polar molecular chains, depending upon the nature of entity that is not supposed to bind to the passivating layer. A passivating layer may comprise a molecular chain or dendrimeric molecule such as a PEG chain or a dextran molecule. A site may comprise a molecule, moiety, or a plurality thereof that contains a coupling moiety and a passivating moiety. For example, a site may comprise a surface-coupled molecule comprising a PEG chain and an oligonucleotide. A plurality of sites may comprise a regular, uniform, or repeating spatial order or pattern (e.g., a rectangular, hexagonal, or radial grid) such that site locations can be determined relative to the pattern or order.

As used herein, the term “affinity agent” refers to a molecule or other substance that is capable of specifically or reproducibly binding to an analyte (e.g. protein). An affinity agent can be larger than, smaller than or the same size as the analyte. An affinity agent may form a reversible or irreversible bond with an analyte. An affinity agent may bind with an analyte in a covalent or non-covalent manner. Affinity agents may include reactive affinity agents, catalytic affinity agents (e.g., kinases, proteases, etc.) or non-reactive affinity agents (e.g., antibodies or fragments thereof). An affinity agent can be non-reactive and non-catalytic, thereby not permanently altering the chemical structure of an analyte to which it binds. Affinity agents that can be particularly useful for binding to proteins include, but are not limited to, antibodies or functional fragments thereof (e.g., Fab′ fragments, F(ab′)₂ fragments, single-chain variable fragments (scFv), di-scFv, tri-scFv, or microantibodies), affibodies, affilins, affimers, affitins, alphabodies, anticalins, avimers, DARPins, monobodies, nanoCLAMPs, nucleic acid aptamers, protein aptamers, lectins or functional fragments thereof.

As used herein, the term “array” refers to a population of sites that are associated with unique identifiers such that the sites can be distinguished from each other. An array may include an array of analytes, in which each array site contains at least one analyte. A unique identifier can be, for example, a solid support (e.g. particle or bead), address on a solid support, position relative to a fiducial maker, tag, label (e.g. luminophore), or barcode (e.g. nucleic acid barcode) that is associated with a site and that is distinct from other identifiers in the array. Sites can be associated with unique identifiers by attachment, for example, via covalent bonds or non-covalent bonds (e.g. ionic bond, hydrogen bond, van der Waals forces, electrostatics etc.). Unique identifiers can be attached to analytes that are present at array sites. An array can include different analytes that are each attached to different unique identifiers. An array can include different unique identifiers that are attached to the same or similar analytes. An array can include separate solid supports or separate addresses that each bear a different analyte, in which the different analytes can be identified according to the locations of the solid supports or addresses.

As used herein, the terms “attached” or “bound” refer to the state of two things being joined, coupled, fastened, adhered, or connected to each other. Attachment or binding can be covalent or non-covalent. For example, a particle can be attached to a protein by a covalent or non-covalent bond. A covalent bond is characterized by the sharing of pairs of electrons between atoms. A non-covalent bond is a chemical bond that does not involve the sharing of pairs of electrons and can include, for example, hydrogen bonds, ionic bonds, van der Waals forces, hydrophilic interactions, adhesion, adsorption, and hydrophobic interactions.

The term “comprising” is intended herein to be open-ended, including not only the recited elements, but further encompassing any additional elements.

As used herein, the term “each,” when used in reference to a collection of items, is intended to identify an individual item in the collection but does not necessarily refer to every item in the collection. Exceptions can occur if explicit disclosure or context clearly dictates otherwise.

As used herein, the terms “group” and “moiety” are intended to be synonymous when used in reference to the structure of a molecule. The terms refer to a component or part of the molecule. The terms do not necessarily denote the relative size of the component or part compared to the rest of the molecule, unless indicated otherwise.

As used herein, the term “protein” refers to a molecule comprising two or more amino acids joined by a peptide bond. A protein may also be referred to as a polypeptide, oligopeptide or peptide. A protein can be a naturally-occurring molecule, or synthetic molecule. A protein may include one or more non-natural amino acids, modified amino acids, or non-amino acid linkers. A protein may contain D-amino acid enantiomers, L-amino acid enantiomers or both. Amino acids of a protein may be modified naturally or synthetically, such as by post-translational modifications. In some circumstances, different proteins may be distinguished from each other based on different genes from which they are expressed in an organism, different primary sequence length or different primary sequence composition. Proteins expressed from the same gene may nonetheless be different proteoforms, for example, being distinguished based on non-identical length, non-identical amino acid sequence or non-identical post-translational modifications. Different proteins can be distinguished based on one or both of gene of origin and proteoform state.

As used herein, the term “single,” when used in reference to an object such as an analyte, means that the object is individually manipulated or distinguished from other objects. A single analyte can be a single molecule (e.g. single protein), a single complex of two or more molecules (e.g. a multimeric protein having two or more separable subunits, a single protein attached to a structured nucleic acid particle or a single protein attached to an affinity reagent), a single particle, or the like. Reference herein to a “single analyte” in the context of a composition, system or method herein does not necessarily exclude application of the composition, system or method to multiple single analytes that are manipulated or distinguished individually, unless indicated contextually or explicitly to the contrary.

As used herein, the term “single-analyte resolution” refers to the detection of, or ability to detect, an analyte on an individual basis, for example, as distinguished from its nearest neighbor in an array.

As used herein, the term “solid support” refers to a substrate that is insoluble in aqueous liquid. Optionally, the substrate can be rigid. The substrate can be non-porous or porous. The substrate can optionally be capable of taking up a liquid (e.g. due to porosity) but will typically, but not necessarily, be sufficiently rigid that the substrate does not swell substantially when taking up the liquid and does not contract substantially when the liquid is removed by drying. A nonporous solid support is generally impermeable to liquids or gases. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefins, polyimides etc.), nylon, ceramics, resins, Zeonor™, silica or silica-based materials including silicon and modified silicon, carbon, metals, metal oxides, metal carbides, metal nitrides, metal sulfides, inorganic glasses, optical fiber bundles, gels, and polymers. In particular configurations, a solid support may comprise a first solid material disposed upon a second solid material. For example, a solid support may comprise a metal oxide layer disposed upon a silicon or glass material. In particular configurations, a flow cell contains the solid support such that fluids introduced to the flow cell can interact with a surface of the solid support to which one or more components of a binding event (or other reaction) is attached.

As used herein, the term “structured nucleic acid particle” or “SNAP” refers to a single- or multi-chain polynucleotide molecule having a compacted three-dimensional structure. The compacted three-dimensional structure can optionally be characterized in terms of hydrodynamic radius or Stoke's radius of the SNAP relative to a random coil or other non-structured state for a nucleic acid having the same sequence length as the SNAP. The compacted three-dimensional structure can optionally be characterized with regard to tertiary structure. For example, a SNAP can be configured to have an increased number of internal binding interactions between regions of a polynucleotide strand, less distance between the regions, increased number of bends in the strand, and/or more acute bends in the strand, as compared to a nucleic acid molecule of similar length in a random coil or other non-structured state. Alternatively or additionally, the compacted three-dimensional structure can optionally be characterized with regard to tertiary or quaternary structure. For example, a SNAP can be configured to have an increased number of interactions between polynucleotide strands or less distance between the strands, as compared to a nucleic acid molecule of similar length in a random coil or other non-structured state. In some configurations, the secondary structure of a SNAP can be configured to be more dense than a nucleic acid molecule of similar length in a random coil or other non-structured state. A SNAP may contain DNA, RNA, PNA, modified or non-natural nucleic acids, or combinations thereof. A SNAP may include a plurality of oligonucleotides that hybridize to form the SNAP structure. The plurality of oligonucleotides in a SNAP may include oligonucleotides that are attached to other molecules (e.g., probes, analytes such as proteins, reactive moieties, or detectable labels) or are configured to be attached to other molecules (e.g., by functional groups). A SNAP may include engineered or rationally designed structures. Exemplary SNAPs include nucleic acid origami and nucleic acid nanoballs.

As used herein, the term “anchoring moiety” refers to a molecule, particle, or other moiety that serves as an intermediary attaching a protein, peptide or other analyte of interest to a surface (e.g., a solid support or a microbead). An anchoring moiety may be covalently or non-covalently attached to a surface and/or analyte of interest. An anchoring moiety may be a biomolecule, polymer, particle, nanoparticle, or any other entity that is capable of attaching to a surface or analyte of interest. In some cases, an anchoring moiety may be a nucleic acid nanoparticle, such as a structured nucleic acid particle. In some cases, an anchoring moiety may occlude contact between an analyte attached to the anchoring moiety and a surface (e.g., a solid support or array surface).

As used herein, the term “analyte” refers to a molecule, particle, or complex of molecules or particles that is coupled or is to be coupled to an array or a site thereof. An analyte may comprise a target for an analytical method (e.g., sequencing, identification, quantification, etc.) or may comprise a functional element such as a binding ligand or a catalyst. An analyte may comprise a biomolecule, such as a polypeptide, polysaccharide, nucleic acid, lipid, metabolite, enzyme cofactor, pharmaceutical agent, or a combination thereof. An analyte may comprise a non-biological molecule, such as a polymer, metal, metal oxide, ceramic, semiconductor, mineral, or a combination thereof.

As used herein, the term “assay agent,” when used in reference to an array, refers to a molecule, particle, moiety, or medium that is contacted with the array, site of the array, or a surface thereof at some point during the course of a single-analyte assay or process, or a step thereof. An assay agent may facilitate a single-analyte assay or process or a step thereof, such as by forming an interaction with an array or a site thereof, or altering an interaction of a second assay agent with an array or a site thereof (e.g., strengthening and interaction, weakening an interaction, etc.). An assay agent may comprise a molecule, moiety, or particle that forms a covalent interaction at an array site. For example, an assay agent may comprise a reactive chemical species that forms a covalent bond to an analyte at an array site. An assay agent may comprise a molecule, moiety, or particle that forms a non-covalent interaction at an array site. For example, an assay agent may comprise an affinity agent that binds to an analyte at an array site.

As used herein, the term “unbound,” when used in reference to a molecule, particle or moiety that is contacted with a single-analyte array, refers to the molecule, particle, or moiety not being attached or bound at an array site in an initial configuration. An unbound assay agent may include a molecule, particle, or moiety that is solvated, suspended, or otherwise mobile within a fluidic medium at the instant it is contacted with a single-analyte array.

As used herein, the term “defect,” when used in reference to a surface layer (e.g., a passivating layer, a coupling layer) on an array or a surface thereof, refers to an address containing a chemical irregularity with respect to a bulk characteristic or structure of the surface layer. A chemical irregularity with respect to a passivating layer may include absence of a passivating molecule or moiety or a plurality thereof, absence of a coupling molecule or moiety or a plurality thereof, at an address of a surface that comprises the surface layer. A chemical irregularity with respect to a passivating layer may include an increased or decreased concentration of molecules at an address of a surface relative to an average concentration of molecules for a passivating layer. A defect may comprise a void in a passivating layer. For example, a passivating layer on a surface of a solid support may comprise a void (e.g., an absence of a molecule, particle, or moiety) that permits direct contact between an assay agent and the surface of the solid support. A defect may comprise a molecule, particle, or moiety whose chemical structure or characteristics differ from the bulk chemical structure or characteristics of the passivating layer. For example, a passivating layer of polyethylene glycol (PEG) molecules may comprise a defect containing a non-PEGylated molecule. A defect in a passivating layer may contain a molecule, particle, or moiety that facilitates binding of an assay agent to the passivating layer, such as a reactive species, an electrically-charged species, a magnetic species, a polar species, or a combination thereof. A defect may comprise a molecule, particle, or moiety that is covalently bound to a surface containing a passivating layer. A defect may comprise a molecule, particle, or moiety that is non-covalently bound to a surface containing a passivating layer. A defect may comprise a single molecule or moiety, or a complex of molecules or moieties that form an orthogonal binding interaction with an entity (e.g., an analyte, an anchoring moiety, a blocking reagent, an affinity agent, a detectable probe, a detectable label, etc.) contacted with the defect. A defect may be co-located at an address comprising an interstitial region or a site, as set forth herein. A defect may have a length scale that differs significantly from a length scale of an interstitial region or site. A defect may have a characteristic size (e.g., length, width, diameter) of less than about 10 nanometers (nm), 5 nm, 4 nm, 3 nm, 2 nm, 1 nm, 0.5 nm, 0.1 nm, or less than 0.1 nm, while an interstitial region may have a characteristic size (e.g., length, width, diameter, pitch) of at least about 10 nm, 20 nm, 50 nm, 100 nm, 150 nm, 200 nm, 250 nm, 300 nm, 400 nm, 500 nm, 750 nm, 1 micron (μm), 2 μm, 5 μm, 10 μm, or more than 10 μm. A plurality of sites may comprise a random or irregular spatial distribution such that a defect location cannot be predicted based upon a location of any other defect. A molecule, particle, or moiety on an array or a surface thereof can be considered a defect with respect to a binding context to which the array or array surface is exposed. For example, a surface layer that is intended to inhibit binding of an affinity agent may have a defect if an address of the layer binds an affinity agent. A layer, molecule, particle, or moiety of a defect can be hydrophobic, hydrophilic, polar, non-polar, positively-charged, negatively-charged, linear, branched, dendrimeric, or a combination thereof, depending upon a binding context or a chemical property of an assay agent.

As used herein, the terms “passivate” or “passivating,” when used in reference to an array or a surface thereof, refers to inhibition of unwanted or orthogonal binding of an assay agent to the array or the surface thereof. A layer, molecule, particle, or moiety on an array or a surface thereof can be considered passivating with respect to a binding context to which the array or array surface is exposed. For example, a surface comprising a plurality of attached oligonucleotides with uniform nucleotide sequences would be expected to specifically bind oligonucleotide assay agents with complementary sequences to the attached oligonucleotides (i.e., a wanted or intended binding interaction), but would inhibit binding of oligonucleotide assay agents with partially or completely non-complementary nucleotide sequences (i.e., unwanted or unintended binding interactions). Likewise, a surface comprising a layer of positively-charged amine moieties (i.e., a positively charged surface) can be expected to form binding interactions with negatively-charged assay agents, and would be expected to inhibit binding of positively-charged assay agents (i.e., the layer is passivating with respect to positively-charged assay agents). A layer, molecule, particle, or moiety on an array or a surface thereof with passivating properties can be hydrophobic, hydrophilic, polar, non-polar, positively-charged, negatively-charged, linear, branched, dendrimeric, or a combination thereof, depending upon a binding context or a chemical property of an assay agent. Exemplary passivating molecules or moieties can include, but are not limited to, polyethylene glycol molecules (PEG), alkyl moieties, halogenated alkyl moieties, polyvinylpyrrolidines, polyalcohols, oligosaccharide molecules (e.g., dextrans, glucopyranosides, methyl cellulose), polypeptides (e.g., albumins), and oligonucleotides.

As used herein, the term “optically resolvable distance” refers to a distance on an array or a surface thereof at which two separate objects can be optically distinguished with respect to each other. The threshold for an optically resolvable distance can vary based upon a mechanism of detection and/or the physical apparatus used to perform an optical detection as well as a detectable species utilized for detection (e.g., single fluorophores, multiple fluorophores, nanoparticles, intercalated dyes, etc.). For example, when detecting two fluorescent objects on a surface via optical microscopy, an optically resolvable distance may depend upon an excitation wavelength of fluorophores, an emission wavelength of fluorophores, and optical characteristics of an optical microscope utilized to image the objects. An optically resolvable distance may be at least about 1 nanometer (nm), 5 nm, 10 nm, 25 nm, 50 nm, 75 nm, 100 nm, 125 nm, 150 nm, 200 nm, 300 nm, 400 nm, 500 nm, or more than 500 nm. Alternatively or additionally, an optically resolvable distance may be no more than about 500 nm, 400 nm, 300 nm, 200 nm, 150 nm, 125 nm, 100 nm, 75 nm, 50 nm, 25 nm, 10 nm, 5 nm, 1 nm, or less than 1 nm. In some cases, an optically resolvable distance may be determined with respect to a detection method (e.g., a pixel-based sensor). For example, two objects may be considered to be separated by an optically resolvable distance if a sensor-based detection produces two optical signal intensity maxima (corresponding to the two objects) and an optical signal intensity minimum between the two maxima, in which the optical signal intensity minimum has a magnitude that is no more than half of the average signal-to-noise ratio of the two optical signal intensity maxima. As used herein, the term “optically non-resolvable distance” refers to a distance on an array or a surface thereof which is less than an optically resolvable distance, as set forth herein. An optically non-resolvable distance may be a distance at which an optical signal from a first object cannot be distinguished from an optical signal from a second object. For example, a first optical signal from a first object may be optically non-resolvable from a second optical signal from a second object if the first optical signal and the second optical signal are respectively detected by adjacent pixels of a pixel-based sensor.

As used herein, the term “substantially uniform,” when used in reference to a plurality of molecules, refers to the plurality of molecules as containing a vast majority (e.g., at least about 90%, 95%, 96%, 97%, 98%, 99%, 99.5%, 99.9%, 99.99%, 99.999%, or more than 99.999% on a molar or mass basis) of molecules with uniform structural or physical properties. A plurality of molecules may be substantially uniform with respect to a structural property, a physical property, or both a structural and a physical property. For example, a plurality of polyethylene glycol (PEG) molecules containing a molecular weight distribution may be considered substantially uniform with respect to chemical structure (i.e., repeating polymerized ethylene glycol monomers). In another example, a plurality of PEG molecules comprising a mixture of linear and branched molecular chains may be considered substantially uniform with respect to a physical property if all molecules of the mixture are configured to inhibit binding of a particular assay agent, as set forth herein.

As used herein, the term “fluidic medium” refers to a fluid that is configured to be contacted with a single-analyte array, as set forth herein. A fluidic medium may comprise a liquid fluid medium or a gas fluidic medium. A fluidic medium may comprise any of a variety of components, such as a solvent species, pH buffering species, a cationic species, an anionic species, a surfactant species, a denaturing species, or a combination thereof. A solvent species may include water, acetic acid, methanol, ethanol, n-propanol, isopropyl alcohol, n-butanol, formic acid, ammonia, propylene carbonate, nitromethane, dimethyl sulfoxide, acetonitrile, dimethylformamide, acetone, ethyl acetate, tetrahydrofuran, dichloromethane, chloroform, carbon tetrachloride, dimethyl ether, diethyl ether, 1-4, dioxane, toluene, benzene, cyclohexane, hexane, cyclopentane, pentane, or combinations thereof. A fluidic medium may include a buffering species including, but not limited to, MES, Tris, Bis-tris, Bis-tris propane, ADA, ACES, PIPES, MOPSO, MOPS, BES, TES, HEPES, HEPBS, HEPPSO, DIPSO, MOBS, TAPSO, TAPS, TABS, POPSO, TEA, EPPS, Tricine, Gly-Gly, Bicine, AMPD, AMPSO, AMP, CHES, CAPSO, CAPS, PBS, and CABS. A fluidic medium may comprise a cationic species such as Na⁺, K⁺, Ag⁺, Cu⁺, NH₄⁺, Mg²⁺, Ca²⁺, Cu²⁺, Cd²⁺, Zn²⁺, Fe²⁺, Co²⁺, Ni²⁺, Cr²⁺, Mn²⁺, Ge²⁺, Sn²⁺, Al³⁺, Cr³⁺, Fe³⁺, Co³⁺, Ni³⁺, Ti³⁺, Mn³⁺, Si⁴⁺, V⁴⁺, Ti⁴⁺, Mn⁴⁺, Ge⁴⁺, Se⁴⁺, V⁵⁺, Mn⁵⁺, Mn⁶⁺, Se⁶⁺, and combinations thereof. A fluidic medium may comprise an anionic species such as F⁻, Cl⁻, Br⁻, ClO₃⁻, H₂PO₄⁻, HCO₃⁻, HSO₄⁻, OH⁻, I⁻, NO₃⁻, NO₂⁻, MnO₄⁻, SCN⁻, CO₃²⁻, CrO₄²⁻, Cr₂O₇²⁻, HPO₄²⁻, SO₄²⁻, SO₃²⁻, PO₄³⁻, and combinations thereof. A fluidic medium may include a surfactant species, such as a cationic surfactant, an anionic surfactant, a zwitterionic surfactant, or an amphoteric surfactant. A fluidic medium may include a surfactant species including, but not limited to, stearic acid, lauric acid, oleic acid, sodium dodecyl sulfate, sodium dodecyl benzene sulfonate, dodecylamine hydrochloride, hexadecyltrimethylammonium bromide, polyethylene oxide, nonylphenyl ethoxylates, Triton X, pentapropylene glycol monododecyl ether, octapropylene glycol monododecyl ether, pentaethylene glycol monododecyl ether, octaethylene glycol monododecyl ether, lauramide monoethylamine, lauramide diethylamine, octyl glucoside, decyl glucoside, lauryl glucoside, Tween 20, Tween 80, n-dodecyl-β-D-maltoside, nonoxynol 9, glycerol monolaurate, polyethoxylated tallow amine, poloxamer, digitonin, zonyl FSO, 2,5-dimethyl-3-hexyne-2,5-diol, Igepal CA630, Aerosol-OT, triethylamine hydrochloride, cetrimonium bromide, benzethonium chloride, octenidine dihydrochloride, cetylpyridinium chloride, adogen, dimethyldioctadecylammonium chloride, CHAPS, CHAPSO, cocamidopropyl betaine, amidosulfobetaine-16, lauryl-N,N-(dimethylammonio) butyrate, lauryl-N,N-(dimethyl)-glycinebetaine, hexadecyl phosphocholine, lauryldimethylamine N-oxide, lauryl-N,N-(dimethyl)-propanesulfonate, 3-(1-pyridinio)-1-propanesulfonate, 3-(4-tert-butyl-1-pyridinio)-1-propanesulfonate, N-laurylsarcosine, and combinations thereof.

As used herein, the term “patternable” refers to a material possessing an ability to be locally formed from a first morphology into a second morphology. Optionally, a local region can be formed without substantially disrupting material surrounding the formed region. A patternable material may be formed in a localized region by a method such as imprinting, etching, photolysis, thermal decomposition, or combinations thereof. A patternable material can comprise one or more properties selected from the groups of: i) being configured to adhere to a surface of a solid support, ii) retaining a set shape after being formed on a surface of a solid support, iii) being patternable by a lithographic process, and iv) being patternable in a discrete region without substantially altering a morphology of a region adjacent to the discrete region. A patternable material may comprise a resin. Exemplary resins may include, but are not limited to, polyester resins, phenolic resins, alkyl resins, polycarbonate resins, polyamide resins, polyurethane resins, silicone resins, epoxy resins, polyethylene resins, acrylic resins, polystyrene resins, polypropylene resins, acetal resins, amino resins, and combinations thereof. A patternable material may comprise a polymeric material, such as polyethylene, polypropylene, polycarbonate, polyester, polyvinyl chloride, polymethyl methacrylate, polystyrene, polyurethane, and combinations thereof. A patternable may comprise a photoresist material, such as a positive photoresist or a negative photoresist. Exemplary photoresist materials include, but are not limited to, polydimethylsiloxane (PDMS), SU-8, polymethyl glutarimide (PMGI), and polymethyl methacrylate (PMMA).

### Preparation of Solid Supports

Methods of preparing single-analyte arrays, as set forth herein, may comprise one or more steps of preparing a solid support or a surface thereof. Preparation of a solid support may comprise one or more steps of: 1) forming the solid support, 2) forming a surface layer on a surface of the solid support, and 3) patterning a distribution of the surface layer on the surface of the solid support, optionally by a lithographic process. While single-analyte array formation methods are exemplified with respect to certain processes, a person skilled in the art will recognize innumerable variations of the examples set forth herein.

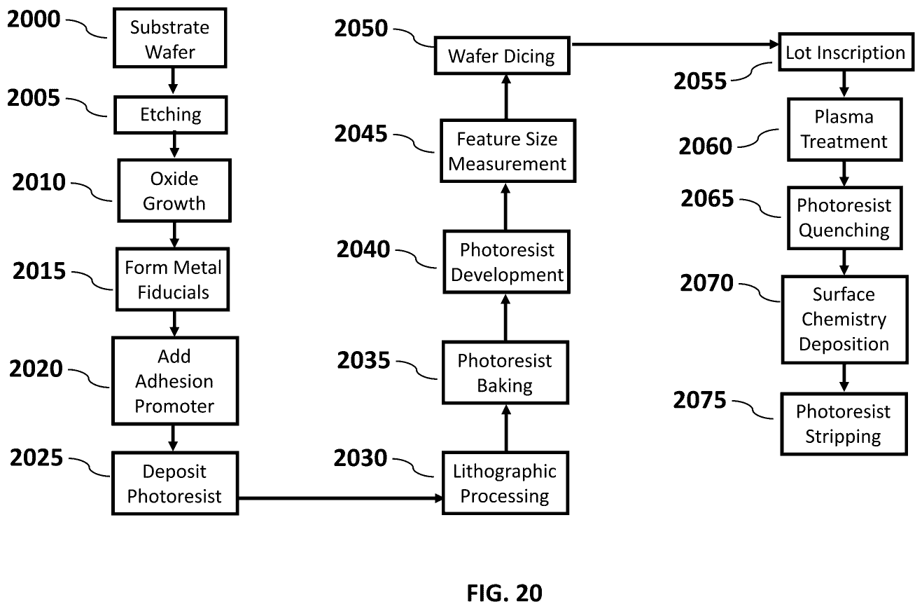

FIG. 20 illustrates a flowchart depicting a method of preparing a solid support. A skilled person will readily recognize innumerable variations to the depicted method. Variations can include the addition of intermediate or ancillary steps, such as rinsing, cleaning, storage, packaging, and transportation of initial, intermediate, or final products. FIG. 20 depicts a substrate preparation method for a substrate such as a wafer of silicon, glass, fused silica, quartz, or mica. A wafer may be provided 2000 as a standard wafer from a foundry. Wafers may be provided 2000 to a substrate preparation process as undoped wafers or doped wafers (e.g., doped with boron, phosphorus, antimony, gallium, arsenic, etc.). Inclusion of dopants may affect subsequent processing steps (e.g., surface chemistry deposition) due to the presence of dopant atoms at a wafer surface as well as migration of dopant atoms during thermal processes (e.g., thermal oxide development).

A substrate preparation method may include an optional etching step 2005. Etching may be performed to form fiducial patterns on a surface of a wafer. Etching may be performed by a wet etching process, or preferably by a dry etching process. Patterning of etched regions may be achieved by applying a mask to a surface of a substrate wafer. An etching process may be continued for a sufficient time to achieve a desired etch depth. An etched feature may have a depth of at least about 1 nanometer (nm), 5 nm, 10 nm, 20 nm, 50 nm, 75 nm, 100 nm, 125 nm, 150 nm, 200 nm, or more than 200 nm in depth. Alternatively or additionally, an etched feature may have a depth of no more than about 200 nm, 150 nm, 125 nm, 100 nm, 75 nm, 50 nm, 20 nm, 10 nm, 5 nm, 1 nm, or less than 1 nm. An etched fiducial feature may be etched until a sufficient depth is achieved to create high optical contrast at the edges of the etched feature. An etched feature may have a lateral dimension (e.g., length, width, diameter, etc.) of at least about 10 nm, 50 nm, 100 nm, 250 nm, 500 nm, 1 micron (μm), 2 μm, 5 μm, 10 μm, 20 μm, 50 μm, 100 μm, 200 μm, 500 μm, or more than 500 μm. Alternatively or additionally, an etched feature may have a lateral dimension of no more than about 500 μm, 200 μm, 100 μm, 50 μm, 20 μm, 10 μm, 5 μm, 2 μm, 1 μm, 500 nm, 250 nm, 100 nm, 50 nm, 10 nm, or less than 10 nm. An optional etching step may occur at other points in a substrate preparation process, although it may be preferable to perform the etching before a lithographic process.

A substrate preparation process may include development of a thermal oxide layer 2010. The chemical composition of a thermal oxide layer will vary depending upon substrate type. For example, a silicon-containing material may be used to form a silicon oxide thermal layer. A thermal oxide layer may be advantageous for improving the optical detection of analytes on a surface of a substrate. Additional details of the advantage of a thermal oxide layer for optical detection can be found in U.S. Provisional Patent App. No. 63/354,169, which is hereby incorporated by reference. A thermal oxide layer may also be provided to tailor surface characteristics such as roughness and flatness. A thermal oxide layer may be provided to facilitate additional surface chemistry on a surface of an array composition. A thermal oxide layer may be developed by thermal treatment of a wafer. A thermal oxide layer may be formed at a temperature of at least about 800° C., 850° C., 900° C., 950° C., 1000° C., 1050° C., 1100° C., 1150° C., 1200° C., 1250° C., 1300° C., 1350° C., 1400° C., 1450° C., 1500° C., or more than 1500° C. Alternatively or additionally, a thermal oxide layer may be formed at a temperature of no more than about 1500° C., 1450° C., 1400° C., 1350° C., 1300° C., 1250° C., 1200° C., 1150° C., 1100° C., 1050° C., 1000° C., 950° C., 900° C., 850° C., 800° C., or less than 800° C. A thermal oxide layer may be formed to an average thickness of at least about 0.1 nm, 1 nm, 10 nm, 100 nm, 200 nm, 300 nm, 400 nm, 500 nm, 550 nm, 600 nm, 650 nm, 700 nm, 750 nm, 800 nm, 850 nm, 900 nm, 950 nm, 1000 nm, 1050 nm, 1100 nm, 1200 nm, 1500 nm, 2000 nm, or more than 2000 nm. Alternatively or additionally, a thermal oxide layer may be formed to an average thickness of no more than about 2000 nm, 1500 nm, 1200 nm, 1100 nm, 1050 nm, 1000 nm, 950 nm, 900 nm, 850 nm, 800 nm, 750 nm, 700 nm, 650 nm, 600 nm, 550 nm, 500 nm, 400 nm, 300 nm, 200 nm, 100 nm, 10 nm, 1 nm, 0.1 nm, or less than 0.1 nm. A thermal oxide layer may have an average surface roughness of no more than about 20 nm, 15 nm, 10 nm, 9 nm, 8 nm, 7 nm, 6 nm, 5 nm, 4 nm, 3 nm, 2 nm, 1 nm, 0.5 nm, 0.1 nm, or less than 0.1 nm. Alternatively or additionally, a thermal oxide layer may have an average surface roughness of at least about 0.1 nm, 0.5 nm, 1 nm, 2 nm, 3 nm, 4 nm, 5 nm, 6 nm, 7 nm, 8 nm, 9 nm, 10 nm, 15 nm, 20 nm, or more than 20 nm. In some cases, substrate wafer dopants may migrate to an exposed surface of a thermal oxide layer. The presence of dopants at an exposed surface of a thermal oxide layer may affect attachment of molecules to the exposed surface, for example by increasing or decreasing a reactivity of the exposed surface. Accordingly, wafer composition and thermal oxide layer properties and development may affect surface concentration and or deposition kinetics of attachment of surface-coupled molecules or moieties, as set forth herein. After thermal oxide development, thermally-treated wafers may be stored in a controlled atmosphere, such as an inert atmosphere (e.g., argon, nitrogen, helium), an oxidizing atmosphere (e.g., oxygen, carbon dioxide, water), or a reducing atmosphere (e.g., hydrogen). A thermally-treated wafer may be stored in a controlled humidity environment. Length of storage and storage atmosphere may be chosen to control an extent of functionalization of an exposed surface (e.g., hydroxylation of the surface oxide layer).

Continuing with FIG. 20, after development of a thermal oxide layer, an optional metal or metal oxide layer may be deposited 2015 on a surface of a substrate wafer. An optional metal or metal oxide layer may be deposited uniformly to a surface (e.g., a reflective coating). An optional metal or metal oxide layer may be deposited by PVD (evaporation, sputtering, optionally under an oxidizing atmosphere), atomic layer deposition (ALD), or molecular layer deposition (MLD). A metal or metal oxide layer may then be patterned (e.g., masking and physical vapor deposition), for example to form reflective fiducial patterns.

Prior to deposition of a photoresist on a surface of a substrate wafer, an adhesion promoter may be applied 2020 to the surface of the substrate wafer. An adhesion promoter may be a layer or coating of a material that improves adhesion of a photoresist to a surface. In some cases, an adhesion promoter may inhibit orthogonal binding phenomena on a surface of a single-analyte array. An adhesion promoter may be a hydrophobic material (e.g., HMDS, TI Prime, AP9000C, etc.) when used with a hydrophobic photoresist. An adhesion promoter may be applied to a surface comprising a thermal oxide layer, as set forth herein. An adhesion promoter may be applied by a method such as chemical vapor deposition or spin-coating. An adhesion promoter may be applied to a thickness of at least about 0.1 nm, 0.2 nm, 0.3 nm, 0.4 nm, 0.5 nm, 0.6 nm, 0.7 nm, 0.8 nm, 0.9 nm, 1 nm, 1.5 nm, 2 nm, 3 nm, 4 nm, 5 nm, or more than 5 nm. Alternatively or additionally, an adhesion promoter may be applied to a thickness of no more than about 5 nm, 4 nm, 3 nm, 2 nm, 1.5 nm, 1 nm, 0.9 nm, 0.8 nm, 0.7 nm, 0.6 nm, 0.5 nm, 0.4 nm, 0.3 nm, 0.2 nm, 0.1 nm, or less than 0.1 nm. In some cases, a liftoff layer (LOL) or bottom anti-reflective coating (BARC) material may be deposited on an adhesion promoter layer. For certain lithography processes (e.g., nanoimprint lithography), a resin material may be deposited on an adhesion promoter layer.

After deposition of an adhesion promoter, a resist material (e.g., a photoresist, a nanoimprint resist) may be deposited 2025 on a substrate wafer, preferably forming a layer on the adhesion promoter. The resist material may be deposited by spin coating. A photoresist material may be a positive photoresist, a negative photoresist, an e-beam resist, or a chemically-amplified photoresist, depending upon a lithographic process to be performed. A resist material may be deposited to a thickness of at least about 10 nm, 25 nm, 50 nm, 100 nm, 125 nm, 150 nm, 160 nm, 170 nm, 180 nm, 190 nm, 200 nm, 210 nm, 220 nm, 230 nm, 240 nm, 250 nm, 300 nm, 400 nm, 500 nm, or more than 500 nm. Alternatively or additionally, a resist material may be deposited to a thickness of no more than about 500 nm, 400 nm, 300 nm, 250 nm, 240 nm, 230 nm, 220 nm, 210 nm, 200 nm, 190 nm, 180 nm, 170 nm, 160 nm, 150 nm, 125 nm, 100 nm, 50 nm, 25 nm, 10 nm, or less than 10 nm.

Continuing with FIG. 20, after forming a resist layer on a surface of a substrate wafer, the wafer can undergo a lithography process 2030. In some cases, a photolithography or electron-beam (e-beam) process may be utilized to develop a pattern on a surface, such as a patterned plurality of sites, as set forth herein. A photolithography or immersion lithography process may utilize a reticle or other type of mask to selectively expose regions of the surface to energy input that chemically or physically prepares volumes of the resist material at the regions for selective removal. A mask may be contacted to a photoresist or may be separated by a gap during a lithography process. Alternatively, a resist layer may be patterned by a maskless process, such as e-beam lithography. Radiation may be applied for sufficient time to completely remove resist material down to a surface of a solid support (i.e., removing an adhesion promoter layer) or to a surface-adjacent layer (adhesion promoter, LOL BARC, etc.). In some cases, light for irradiation may be selected based upon a choice of photoresist. Common processes utilize ultraviolet light with 193 nm or 248 nm wavelengths. A resist material may also be patterned by a nanoimprint lithography process. A stamp may be provided with a desired feature size, shape, and pitch. The stamp is used to form an impression that displaces resist material, thereby forming a plurality of wells in the resist material with desired feature size, shape and pitch. Subsequent processing of substrates patterned by nanoimprint lithography will differ in certain respects from photoresist processing, but many processes (including characterization, dicing, and surface chemistry deposition) will be performed on such substrates. After stamping, subsequent processes such as plasma treatment or reactive ion etching may be performed to improve the shape, feature size (e.g., depth, diameter) and/or pitch of imprinted features.

Before or after lithography, a substrate wafer comprising a resist material may undergo an optional baking process 2035. For photolithography, a substrate wafer comprising a patterned resist material may undergo a soft baking process if baking is performed before patterning the photoresist. Soft baking may facilitate desorption of adsorbed gas species (e.g., oxygen, nitrogen) and improve photoresist adhesion. Soft baking may be performed at a temperature such as at least about 80° C., 90° C., 100° C., 110° C., 120° C., 130° C., 140° C., 150° C., or more than 150° C. Alternatively or additionally, soft baking may be performed at a temperature such as no more than about 150° C., 140° C., 130° C., 120° C., 110° C., 100° C., 90° C., 80° C., or less than 80° C. In other cases, a substrate wafer comprising a patterned resist material may undergo a hard baking process if baking is performed after patterning the photoresist. Hard baking may chemically modify a photoresist in preparation for a photolithography process and/or mechanically relax stresses in a deposited photoresist to promote more uniform photoresist development. Hard baking may occur before or after development of a photoresist material. Hard baking may be performed at a temperature such as at least about 80° C., 90° C., 100° C., 110° C., 120° C., 130° C., 140° C., 150° C., or more than 150° C. Alternatively or additionally, hard baking may be performed at a temperature such as no more than about 150° C., 140° C., 130° C., 120° C., 110° C., 100° C., 90° C., 80° C., or less than 80° C. In some cases, it may be preferable to utilize a lower soft baking or hard baking temperature to prevent chemical modifications to the photoresist that increase reactivity of the photoresist toward other chemical components set forth herein (e.g., surface-coupled molecules such as aminosilanes).

After lithography, a photoresist may undergo a development process 2040. Photoresist development may comprise contacting a photoresist material with a development solvent. Choice of solvent will depend upon the type of photoresist (e.g., positive, negative, e-beam resist) and the specific chemical structure of the light exposed photoresist. Exemplary solvent may include sodium hydroxide, potassium hydroxide, tetramethyl ammonium hydroxide for positive photoresists, or an organic solvent (e.g., an alcohol) for a negative photoresist. Development may be performed for a sufficient amount of time to ensure complete reaction of light-exposed or e-beam exposed resist material in the presence of the solvent. A development process 2040 may cause removal of surface-adjacent compounds due to the corrosivity of the development solution. Accordingly, patterned features may be substantially stripped of an adhesion promoter or other organic layer at regions of patterning.

After development, a substrate wafer may optionally be characterized 2045 one or more times to confirm patterning and surface characteristics. Characterization may include optical measurements (e.g., optical microscopy, electron microscopy), or other measurements such as atomic force microscopy to measure characteristics such as average feature size, pitch, and feature shape. Depending upon a stage of processing, a substrate wafer may undergo a measurement such as surface profilometry, surface ellipsometry, or contact angle measurement. Before or after characterization 2045, a substrate wafer may be diced 2050 into smaller chips. Dicing may be accomplished by a method such as saw cutting or preferably laser cutting. A dicing methods may create particulates that require rinsing or cleaning from a surface of the diced substrate wafer. Before or after a dicing process 2050, each diced wafer may receive an inscription or other marking 2055 that pertains to lot number or any other identifying information.

Prior to deposition of additional surface chemistry at patterned features, a substrate wafer or chip may undergo a plasma treatment 2060. Plasma treatment may be performed in an oven by a suitable plasma source, such as Zorrix™, ethanol/water, or oxygen plasma. Differing plasma configurations may be useful, such as direct plasma, reactive ion etching, or downstream plasma processing. Plasma treatment 2060 may be optimized depending upon feature size, photoresist chemistry, and intended surface chemistry. Plasma treatment 2060 variables include exposure time, oven pressure, plasma chemistry, plasma power, plasma configuration (e.g., barrel or parallel plate), wafer orientation (e.g., normal, angled, or faced to plasma), plate proximity, wall proximity, and substrate holder position. A plasma treatment process may proceed for a time such as at least about 30 seconds (s), 1 minute (min), 2 mins, 3 mins, 4 mins, 5 mins, 10 mins, 15 mins, or more than 15 mins. Alternatively or additionally, a plasma treatment process may proceed for a time such as no more than about 15 mins, 10 mins, 5 mins, 4 mins, 3 mins, 2 mins, 1 min, 30 s, or less than 30 s. A plasma treatment may be performed for a sufficient time to increase feature size or alter the morphology of patterned features. For example, some lithography processes may produce wells with non-uniform sidewall profiles (e.g., wider at top, narrower near wafer surface), in which plasma treatment can create a more uniform sidewall profile or increase the overall feature size. In some cases, plasma treatment may increase reactivity of a photoresist material. Increased reactivity of a photoresist material may increase a likelihood of forming adducts with other reactive molecules or moieties by methods set forth herein. Accordingly, plasma treatment time may be minimized to reduce reactivity of the photoresist material. In some cases, a plasma treatment step may be omitted to minimize cross-reactivity of a photoresist material during subsequent processing and/or surface chemistry deposition.

An oven used for plasma treatment of a wafer or chip may have a set internal temperature of at least about 35° C., 40° C., 45° C., 50° C., 55° C., 60° C., 65° C., 70° C., 75° C., 80° C., 85° C., 90° C., 95° C., 100° C., or more than 100° C. Alternatively or additionally, an oven used for plasma treatment of a wafer or chip may have a set internal temperature of no more than about 100° C., 95° C., 90° C., 85° C., 80° C., 75° C., 70° C., 65° C., 60° C., 55° C., 50° C., 45° C., 40° C., 35° C., or less than 35° C. In some cases, it may be preferable to utilize a lower oven temperature during plasma treatment to prevent chemical modifications to the photoresist that increase reactivity of the photoresist toward other chemical components set forth herein (e.g., surface-coupled molecules such as aminosilanes). A wafer or chip may be equilibrated in an oven before a plasma treatment process. In some cases, the equilibration time may be sufficient to equilibrate the wafer or chip to the oven temperature. In other cases, the equilibration time may be insufficient to equilibrate the wafer or chip to the oven temperature. A wafer or chip may be provided an equilibration time in a plasma treatment oven of at least about 1 minute (min), 2 mins, 3 mins, 4 mins, 5 mins, 10 mins, 15 mins, 20 mins, 30 mins, or more than 30 mins. Alternatively or additionally, a wafer or chip may be provided an equilibration time in a plasma treatment oven of no more than about 30 mins, 20 mins, 15 mins, 10 mins, 5 mins, 4 mins, 3 mins, 2 mins, 1 min, or less than 1 min. In some cases, it may be preferable to reduce an equilibration time before plasma treatment to prevent chemical modifications to the photoresist that increase reactivity of the photoresist toward other chemical components set forth herein (e.g., surface-coupled molecules such as aminosilanes).

Location and/or orientation of a wafer or chip in a plasma treatment oven may affect the outcome of a plasma treatment process. In some cases, a wafer or chip may be placed on a ground electrode of a plasma generation device. In other cases, a wafer or chip may be placed on a shelf or retaining device between the ground electrode and active electrode of the plasma generation device. In some cases, it may be preferable to reduce an equilibration time before plasma treatment to prevent chemical modifications to the photoresist that increase reactivity of the photoresist toward other chemical components set forth herein (e.g., surface-coupled molecules such as aminosilanes).

Prior to deposition of additional surface chemistry at patterned features, and optionally after plasma treatment. a photoresist material may be quenched 2065. A quenching process 2065 may be provided to reduce reactivity of a photoresist material with one or more chemicals or chemical components used during the surface chemistry treatment of the substrates. The reaction of PR with these one or more chemicals or chemical components may create insoluble components that are difficult to remove during the subsequent PR stripping step. In some cases, a quenching material may be added to a surface of a developed photoresist material. In other cases, a quenching material may be dispersed into a photoresist material, e.g., by solvation or other chemical mobilization. A quenching material, such as HMDS or an organosilane, may be deposited by a chemical vapor deposition (CVD) process. A quenching material, such as an amine or an organosilane, may be deposited by a non-CVD process, such as chemical liquid deposition. Other methods set forth herein may inhibit photoresist reactivity, such as the dispersion of cationic surfactants into photoresist materials.

After a lithographic process, a surface layer may be deposited 2070 in features formed by the lithographic process. Surface layer methods may include the covalent attachment of molecules (e.g., organosilanes, organophosphonates, organophosphates) to exposed wafer surfaces at the bottom of patterned features. Deposition 2070 of surface layers may be done by chemical vapor deposition or chemical liquid deposition, depending upon the type of molecules or moieties to be attached. Methods for forming surface layers in patterned features are set forth herein. Due to the presence of resist material on a substrate wafer, a surface layer may be deposited on any exposed surfaces of the resist material. If the resist material is cross-reactive with the deposited surface layer, quenching may be necessary to prevent cross-reactivity in the presence of a stripping solution. After depositing a surface layer at patterned features, resist material may be stripped 2075 by a method set forth herein. Stripping 2075 typically occurs in the presence of an organic solvent that is configured to mobilize resist material, thereby separating it from the wafer surface. Sonication (which may be varied by frequency range and/or power), mechanical agitation, temperature (e.g., increased temperature), or combinations thereof may be utilized to facilitate the stripping process and to facilitate removal of insoluble side compounds that may have been created by the reaction of a photoresist material with chemicals or chemical components used to deposit a surface chemistry. A stripping process 2075 may include sonication and/or a quiescent immersion in a stripping solution. In some cases, quiescent immersion of a wafer or chip in a stripping solution may occur before or after a sonication process. After stripping 2075, a layer of adhesion promoter (e.g., HMDS) may remain on the surface. In some cases, the adhesion promoter may be removed by a subsequent stripping process and the surface may be functionalized with a surface chemistry that differs from the surface chemistry of the patterned array sites. In other cases, the adhesion promoter may be retained as a suitable interstitial surface chemistry for preventing orthogonal binding, as set forth herein. Stripping solutions for removing resist materials are well known in the art. In some cases, it may be preferable to utilize a stripping solution comprising a surfactant species during a stripping process 2075. A surfactant may facilitate complete removal of resist materials from array surfaces, as well as facilitate loosening and/or dissociation of adducts formed due to cross-reactivity of resist material with surface-coupled molecules. In some cases, a stripping solution may comprise a non-ionic surfactant, a cationic surfactant, an anionic surfactant, a zwitterionic surfactant, an amphoteric surfactant, or a combination thereof. A stripping process 2075, or a subprocess thereof (e.g., sonication, quiescent immersion) may occur for at least about 1 minute (min), 5 mins, 10 mins, 15 mins, 20 mins, 30 mins, 60 mins, or more than 60 mins. Alternatively or additionally, a stripping process 2075, or a subprocess thereof (e.g., sonication, quiescent immersion) may occur for no more than about 60 mins, 30 mins, 20 mins, 15 mins, 10 mins, 5 mins, 1 mins, or less than 1 min.

A protective surface coating may be applied to a solid support composition during a processing method. Exemplary coatings can include a sucrose coating, a wax coating, or a commercial product such as PLAINCOAT surface protectant. A protective surface coating may prevent damage to surface layers during certain processing steps (e.g., dicing, drilling) or simplify removal of particulates generated during such processes. A protective surface coating may be applied at any conceivable step before the protective coating is needed, such as after resist material deposition, after resist material patterning, or before or after resist material development.

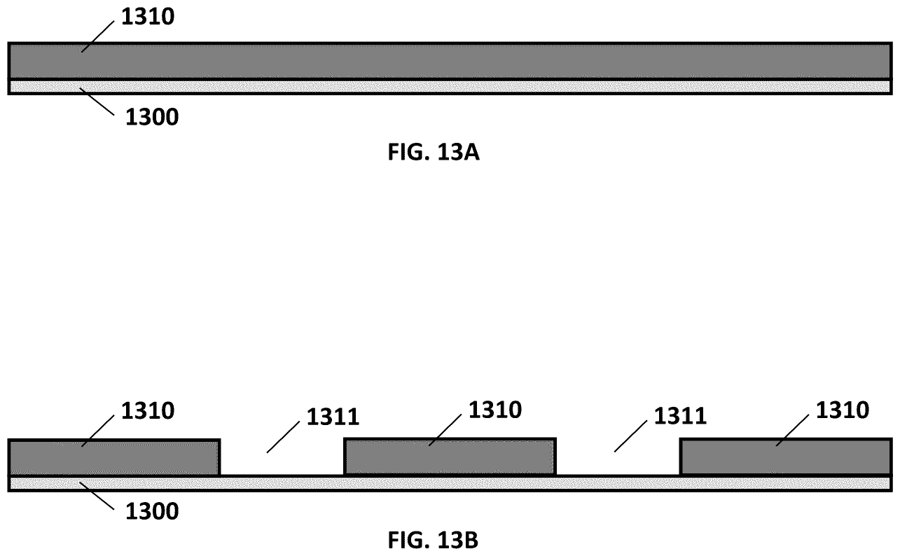

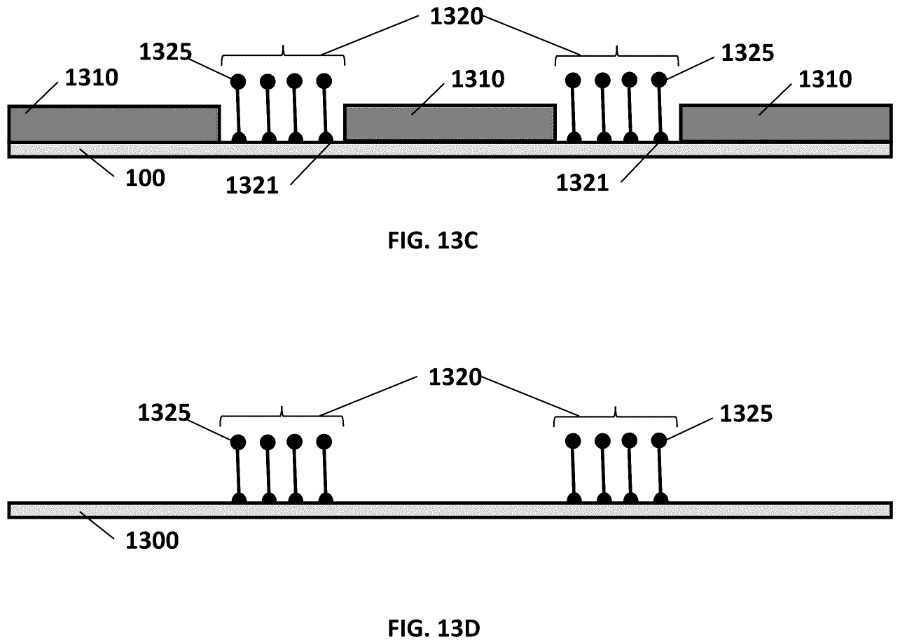

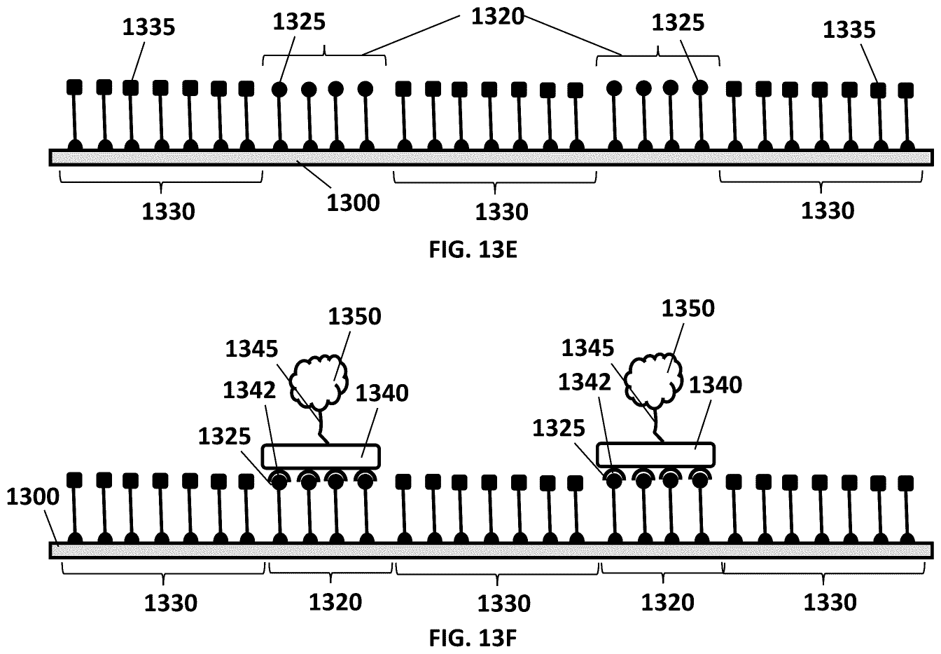

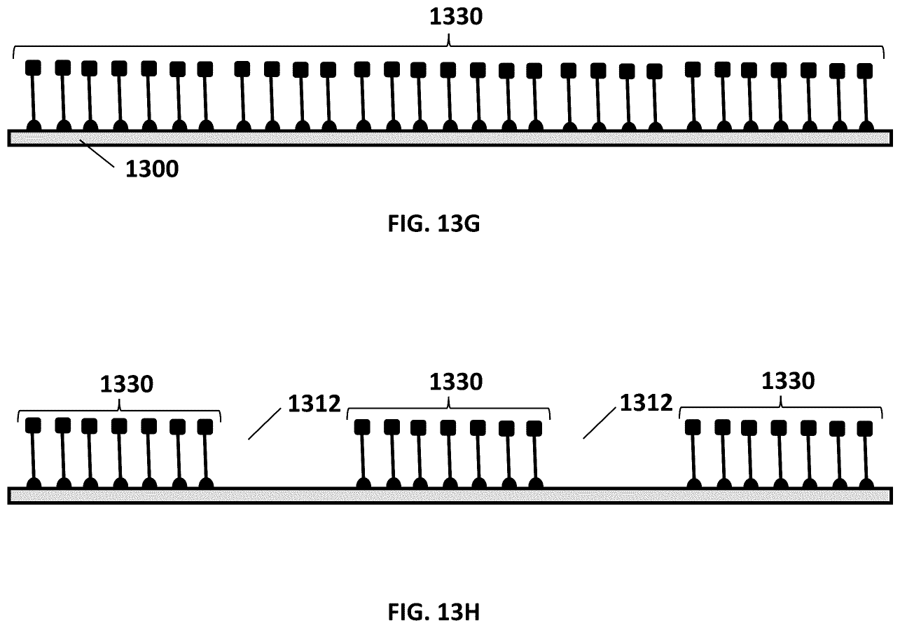

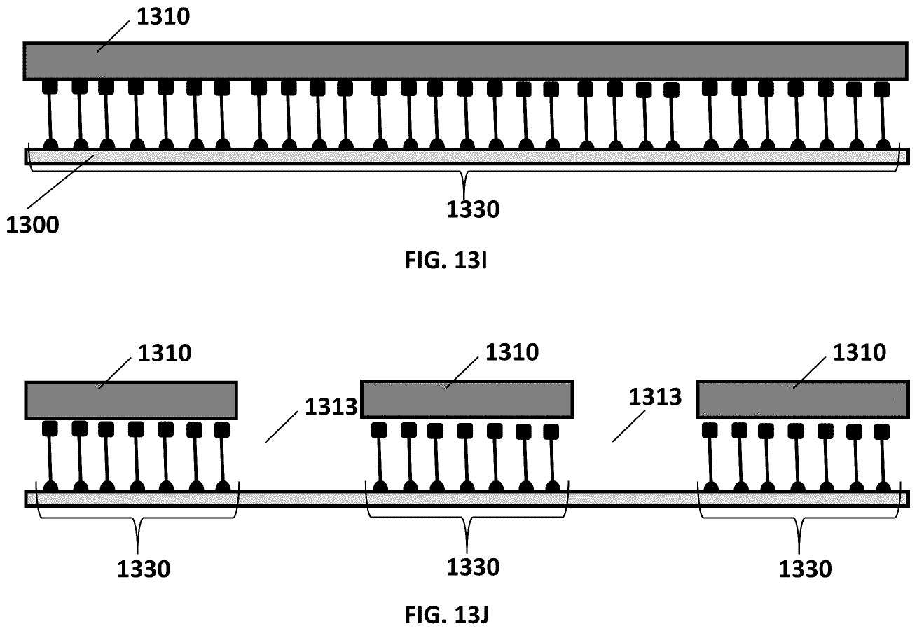

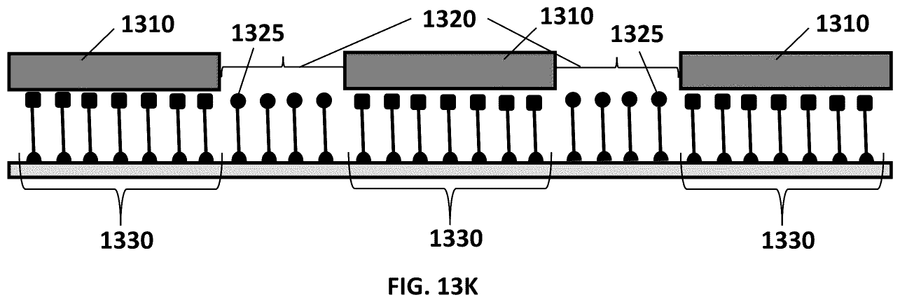

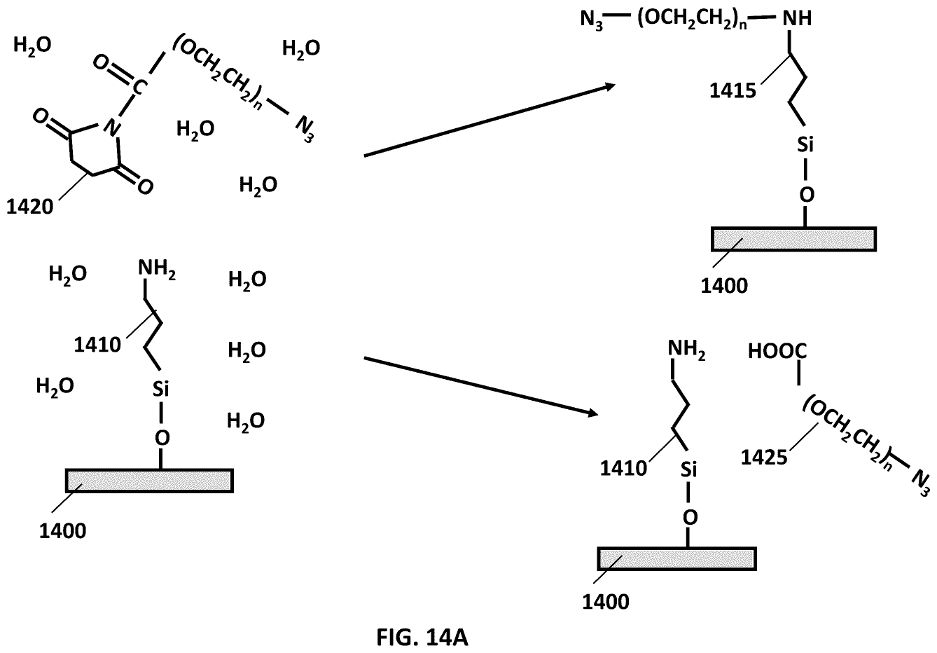

FIGS. 13A-13K illustrate compositions that exist during various stages of exemplary methods of preparing from a solid support a single-analyte array comprising a plurality of analyte binding sites. FIGS. 13A-13F depict single-analyte array compositions that are formed by a first exemplary process utilizing a patternable material. FIG. 13A depicts a solid support 1300 (e.g., silicon, silica, fused silica, glass, quartz, sapphire, etc.) with a patternable material 1310 (e.g., a photoresist, a resin, etc.) disposed upon an upward-facing surface of the solid support. FIG. 13B depicts the solid support 1300 and patternable material 1310 after a lithographic process, in which regions of patternable material 1310 have been removed to form a series of wells 1311. Each well 1311 comprises a bottom containing at least a partially-exposed portion of the upward-facing surface of the solid support, and a sidewall that is bounded, at least in part, by the patternable material 1310. FIG. 13C depicts a composition of the solid support, in which a plurality of molecules 1320 have been coupled to exposed portions of the solid support at the bottoms of wells 1311. Molecules of the plurality of molecules may comprise a surface-coupling moiety 1321 that couples the molecules to the solid support 1300 (e.g., a silane moiety that couples to a silicon-containing solid support, a phosphonate moiety that couples to a metal oxide solid support). Molecules of the plurality of molecules may further comprise an additional moiety 1325 (e.g., a passivating moiety, a reactive functional group). FIG. 13D depicts a configuration of the solid support 1300 after the patternable material 1310 has been separated from the surface of the solid support 1300. In one particular configuration of FIG. 13D, the isolated regions containing the plurality of molecules 1320 may comprise analyte binding sites. In another particular configuration of FIG. 13D, the regions containing the plurality of molecules 1320 may comprise interstitial regions that surround analyte binding sites. FIG. 13E depicts the solid support after deposition of a second plurality of molecules 1330. The second plurality of molecules may occupy portions of the surface of the solid support that do not contain coupled molecules of the plurality of molecules 1320. For example, if a plurality of molecules 1320 is deposited at analyte binding sites, a second plurality of molecules 1330 may be deposited at other regions of the surface to form a non-binding interstitial region that separates analyte binding sites. Molecules of the second plurality of molecules 1330 may comprise additional moieties 1335 that differ from the additional moieties 1325 of the plurality of molecules 1320. FIG. 13F illustrates an embodiment of a prepared single-analyte array, in which analytes 1350 have been deposited at analyte binding sites. Each analyte 1350 is coupled to an anchoring moiety 1340 by a linking moiety 1345 that is coupled to both the analyte 1350 and the anchoring moiety 1340. Each anchoring moiety comprises one or more site-coupling moieties 1342 that form binding interactions with additional moieties 1325 of the plurality of molecules 1320, thereby coupling the analytes 1350 at analyte binding sites of the array.

FIGS. 13G-13H illustrate forming a single-analyte array comprising a plurality of analyte binding sites by a direct patterning process. FIG. 13G depicts a solid support 1300 comprising a surface with a substantially uniform surface layer (e.g., with respect to composition, with respect to surface density, etc.) comprising a second plurality of molecules 1330. FIG. 13H depicts the solid support 1300 after a direct patterning process (e.g., direct UV patterning) has been performed. Well-like structures 1312 have been formed in the substantially uniform surface layer comprising the second plurality of molecules by the removal of molecules of the second plurality of molecules 1330. The well-like structures 1312 comprise at least partially-exposed portions of the surface of the solid support 1300 and are at least partially-bounded by molecules of the second plurality of molecules 1330. Subsequently, a plurality of molecules 1320 may be deposited on the exposed regions of the solid support 1300 in the well-like structures, thereby forming an array composition like the composition of FIG. 13E.

FIGS. 13I-13K depict forming a single-analyte array comprising a plurality of binding sites by an alternative process. FIG. 13I depicts a solid support 1300 comprising a surface with a substantially uniform surface layer (e.g., with respect to composition, with respect to surface density, etc.) comprising a second plurality of molecules 1330. A patternable material 1310 (e.g., a photoresist material) is disposed over the substantially uniform layer comprising the second plurality of molecules 1330. FIG. 13J depicts a composition after a patterning process (e.g., photolithography, direct UV patterning) has removed patternable material 1310 and molecules of the second plurality of molecules 1330, thereby forming well-like structures 1313. The well-like structures comprise a bottom containing at least partially-exposed portions of the surface of the solid support, and are at least partially-bounded by molecules of the second plurality of molecules 1330 and patternable material 1310. FIG. 13K depicts an array composition after a plurality of molecules 1320 comprising additional moieties 1325 have been deposited on exposed portions of the surface of the solid support 1300. A subsequent separation process to separate the patternable material 1310 from the solid support 1300 may be performed, thereby providing an array composition such as the one depicted in FIG. 13E.

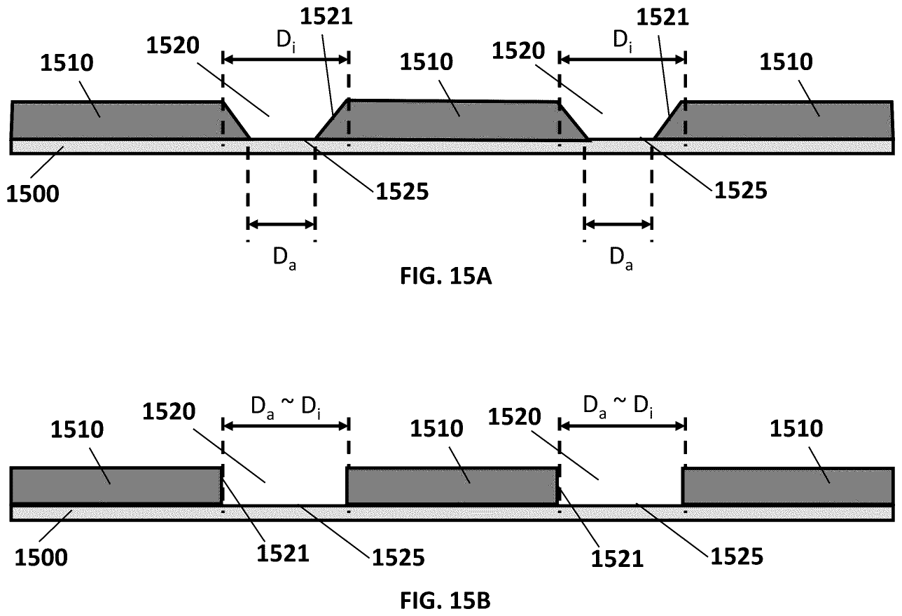

A method of preparing a solid support may comprise a step or a series of steps that produce wells or well-like structures. The wells or well-like structures may be transient features during preparation of a solid support. For example, wells may be formed in a layer of patternable material disposed on a surface of a solid support by a lithographic process. Subsequently, one or more steps of a solid support preparation process may comprise depositing molecules or materials in a well or well-like structure. A well or well-like structure may be defined by surfaces that bound the well or well-like structure. In some cases, a bottom surface of a well or well-like structure may comprise a surface of a solid support. A bottom surface may be substantially flat or planar. In other cases, a bottom surface may comprise a curved surface (e.g., a convex or concave surface). A well or well-like structure may be further defined by a sidewall that bounds the depth of the well or well-like structure. In some cases, a sidewall may be substantially orthogonal with respect to a surface of a solid support. In other cases, a sidewall may be non-orthogonal in whole or in part with respect to a surface of a solid support. FIG. 15A depicts a cross-sectional view of a solid support 1500 with a patternable material 1510 that has been patterned to form a plurality of wells 1520. Each well 1520 has a bottom surface 1525 comprising an exposed portion of solid support 1500, and a sidewall 1521 that bounds the depth of the well 1520. The sidewall 1521 is non-orthogonal to the substantially planar surface of the solid support such that a characteristic dimension Dᵢ (e.g., a diameter, width, etc.) of a well 1520 near the upper surface of the patternable material 1510 is larger than a characteristic dimension Dₐ of the well 1520 at the interface between the patternable material 1510 and the solid support 1500.

A method of preparing a solid support may comprise altering a conformation or morphology of a well or well-like structure formed on the solid support. Altering a conformation or morphology of a well may comprise a step selected from the group consisting of: i) removing patternable material adjacent to a side of the well, ii) removing patternable material adjacent to a portion of the solid support that is exposed (e.g., a bottom surface of a well), iii) altering a morphology of the side of the well, iv) removing material from the portion of solid support that is exposed in the well; v) increasing a volume occupied by patternable material adjacent to the side of the well, vi) decreasing the volume occupied by patternable material adjacent to the side of the well, and vii) combinations thereof. Altering a conformation or morphology of a well or well-like structure may comprise increasing or decreasing a characteristic dimension (e.g., diameter, width, depth, circumference) of the well or well-like structure. Altering a morphology of a well or well-like structure may comprise forming a more uniform sidewall, for example as determined by a ratio of characteristic dimensions (e.g., maximum diameter/minimum diameter, maximum diameter/average diameter. For example, a more uniform sidewall may be produced if a ratio of characteristic dimensions becomes closer to a value of 1. An array formation process may include one or more steps that alter a morphology of a well or well-like structure. An array formation process may include an etching step (e.g., dry etching, wet etching) that removes material from a well or well-like structure to form a more uniform sidewall morphology. An array formation process may include contacting a well or well-like structure with a fluidic medium that alters a morphology of a sidewall of a well or well-like structure. FIG. 15B depicts the composition of FIG. 15A after a process that has altered the morphology of sidewalls 1521 of the wells 1520. The characteristic dimension Dₐ has been increased to substantially the same magnitude as characteristic dimension Dᵢ, thereby producing a larger exposed portion of the solid support 1500 at the bottom surface 1525 of the well 1520. Accordingly, the wells 1520 have sidewalls 1521 that are substantially orthogonal to the surface of the solid support 1500.

A method of preparing a solid support may comprise a step of separating a patternable material from a surface of a solid support. In some cases, separating a patternable material from a surface of a solid support may occur in the presence of a dissolution medium. A dissolution medium may comprise a photoresist developer (e.g., tetramethylammonium hydroxide, sodium carbonate, potassium carbonate, etc.). Numerous commercial photoresist developers are available and many are particular to a specific photoresist or class of photoresists. A dissolution medium may comprise an organic and/or aqueous solvent. A dissolution medium may be configured to inhibit dissociation of surface-coupled moieties or molecules from a surface of a solid support. In some cases, separating a patternable material from a surface of a solid support may comprise etching or a plasma treatment. Separating a patternable material from a surface of a solid support may comprise one or more steps of: a) contacting a patternable material with a dissolution medium, b) dissociating at least a portion of the patternable material from the surface of the solid support, and c) removing the dissolution medium and the portion of the patternable material from the solid support. A patternable material may be separated from a surface of a solid support at any conceivable step of an array formation process, including before or after any step following a lithographic process.

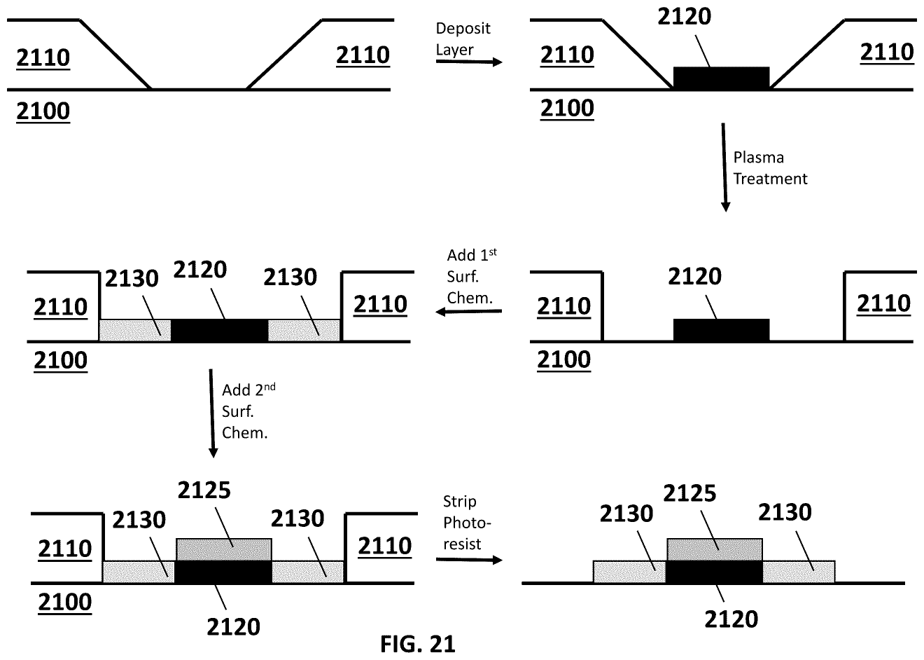

FIG. 21 depicts a method of forming patterned array sites with two differing surface chemistries in a concentric pattern. The upper left schematic depicts a cross-section of a solid support 2100 with a patterned resist material 2110. A well-like structure with a non-uniform feature dimension (e.g., radius, width) has been patterned in the resist material 2110. The cross-sectional area of the feature narrows as the bottom of the well is approached (e.g. the well-like structure can have a conical or tapering cross-section), as may occur in some resist materials. In a subsequent processing step, a metal oxide layer 2120 (e.g., zirconium oxide, titanium oxide) is deposited on an exposed surface of the solid support 2100 at the bottom of the patterned feature. After the metal oxide layer 2120 is deposited, the photoresist material 2110 may be reformed (e.g., by plasma treatment, by solvent treatment, etc.) to produce a more uniform feature size. Exposed regions of surface of the solid support 2100 are exposed in a concentric fashion around the metal oxide layer 2120. Serially or simultaneously, orthogonal surface chemistries may be deposited on surfaces at the bottom of the patterned features. For example, a first surface-coupled layer 2130 (e.g., organosilanes) may be attached to exposed regions of the solid support 2100, then a second surface-coupled layer 2125 (e.g., organophosphonates) may be attached to an exposed surface of the metal oxide layer 2120. Subsequently, resist material 2110 may be stripped, providing an array site with a central region comprising the second surface-coupled layer 2125 and a concentric region surrounding the second surface-coupled layer 2125 that comprises the first surface-coupled layer 2130.

### Orthogonal Binding Phenomena

Orthogonal binding phenomena, in the context of single-analyte arrays, can include any unwanted, unexpected, or contrary-to-design binding interactions that occur between an array surface or array feature and an unbound moiety that may become contacted with the array surface or array feature. Orthogonal binding phenomena may be qualitatively characterized as a binding interaction that occurs in a system that has been engineered to prevent such a binding interaction (e.g., a hydrophilic molecule binding to a putatively hydrophobic surface). Orthogonal binding phenomena may be quantitatively characterized as measurable binding interactions occurring between an array surface or array feature (e.g., an interstitial region, an analyte binding site) and an unbound moiety that may become contacted with the array surface or feature, in which the measurable binding interactions occur at a rate and/or to an extent that exceeds a predicted rate and/or extent, such as a thermodynamic or kinetic prediction (e.g., a dissociation constant, a binding on-rate, a binding off-rate, etc.). For example, if an unbound moiety is characterized to bind to a surface-coupled passivating moiety (e.g., polyethylene glycol) with a kilomolar dissociation constant (a very weak binding interaction), then observing a millimolar binding dissociation constant between the unbound moiety and an array surface that is provided with a uniform layer of the surface-coupled passivating moiety would indicate a orthogonal binding phenomena (i.e., binding due to a mechanism other than the specific binding of the unbound moiety to the surface-coupling passivating moiety). Orthogonal binding phenomena may be characterized based upon a stochastic measure, such as spatial and/or temporal variations in unwanted, unexpected, or contrary-to-design binding phenomena.

Orthogonal binding phenomena of molecules, particles, or other moieties to arrays of single analytes or single molecules may impact a single-analyte process (e.g., a single-analyte assay) for example, by one or more of: 1) inhibiting completion of a process step for a single-analyte or a plurality of single analytes, 2) inhibiting detection of a single-analyte or a plurality of single analytes, and 3) facilitating aggregation of additional molecules, particles, or moieties at an array address, thereby causing inhibition of a process step, inhibiting detection of a single-analyte, or otherwise a single-analyte process. For example, orthogonal binding of an affinity agent (e.g., an antibody) or other reagent (e.g., a surfactant, a polypeptide, a polymer, etc.) to an address adjacent to a single polypeptide on a single-molecule polypeptide array may sterically occlude other affinity agents from properly binding to the polypeptide. In another example, orthogonal binding of a fluorescently-labeled affinity agent (e.g., a fluorescently-labeled antibody) at an address adjacent to a single polypeptide on a single-molecule polypeptide array may cause a false positive optical signal to be detected at the address corresponding to the single polypeptide if optical resolution is insufficient to distinguish the address of the orthogonally bound affinity agent from the address of the single polypeptide.

The presence, type or degree of orthogonal binding phenomenon is typically contextual, for example, relating to the conditions in which a binding interaction occurs. Consider, for example, a surface that is engineered to comprise a material that prevents binding of an assay reagent to the surface but also contains an unwanted impurity or a vacancy that can form a binding interaction with the assay reagent. Independent of any predictability or specificity that may be ascribed to the binding interaction between the impurity and the assay reagent, it is unwanted and unintended. Accordingly, “non-orthogonal” and “orthogonal” binding interactions can be discerned in the context of the intended use of the system within which they occur. In the context of a molecular array, such as a single-analyte array, the molecular array may be engineered to specifically retain chosen moieties at particular sites and inhibit binding of particular moieties at other sites or regions. In such a context, orthogonal binding interactions may include binding of moieties other than the chosen moieties at the particular sites, as well as binding of particular moieties at the other sites or regions.

In some configurations of a method or apparatus set forth herein, an assay reagent may recognize or bind an analyte that is a target analyte for the assay reagent. Nevertheless, the assay reagent may orthogonally bind to non-target materials or substances, such as non-target materials or substances present in an array that also includes the target analyte (e.g., anchoring moieties). Accordingly, orthogonal binding phenomena may be defined in certain cases as “analyte orthogonal binding interaction” or “non-analyte orthogonal binding interactions.” An analyte orthogonal binding interaction may refer to a binding interaction between a moiety and a non-analyte component of a single-analyte system, in which the moiety is expected or intended to form a binding interaction with an analyte of a single-analyte system. For example, an analyte orthogonal binding interaction may comprise an affinity agent becoming bound to an interstitial region of a single-analyte array. A non-analyte binding interaction may refer to a binding interaction between a moiety and a component of a single-analyte system (including an analyte), in which the moiety is not expected or intended to form a binding interaction with the component of a single-analyte system. For example, a blocking moiety (e.g., albumin, dextran, etc.) that is configured to remain unbound in solution may become bound to a surface-coupled molecule adjacent an analyte on a single-analyte array, thereby sterically impeding access to the analyte.

With respect to the detection of signals (e.g., optical signals) from single-analyte or single-molecule arrays, orthogonal binding phenomena can impact the detection of signals, including at conditions of high occupancy or low occupancy of an array. High occupancy of an array, when used in reference to detection of signals emitted from the array, may refer to obtaining or expecting to obtain signals from a majority fraction (e.g., greater than 50%, 90%, 95%, 99%, 99.9%, etc.) of analyte-binding sites of the array. Low occupancy of an array, when used in reference to detection of signals emitted from the array, may refer to obtaining or expecting to obtain signals from a minority fraction (e.g., less than 50%, 10%, 5%, 1%, 0.1%, etc.) of analyte-binding sites of the array. High occupancy may be determined based upon signals emitted from analytes or moieties attached thereto (e.g., anchoring moieties, tag moieties), or from detectable probes that are configured to bind to analytes on a single-analyte array.

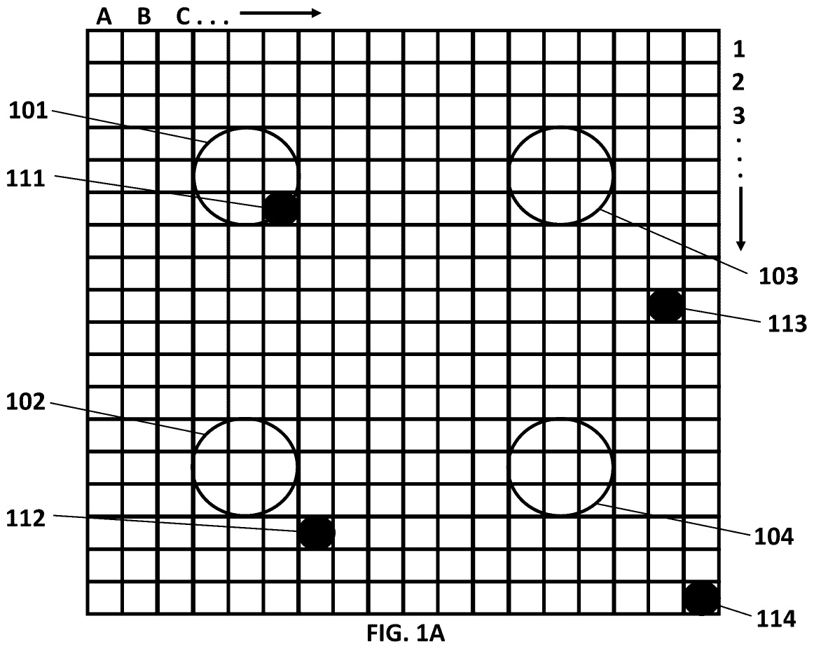

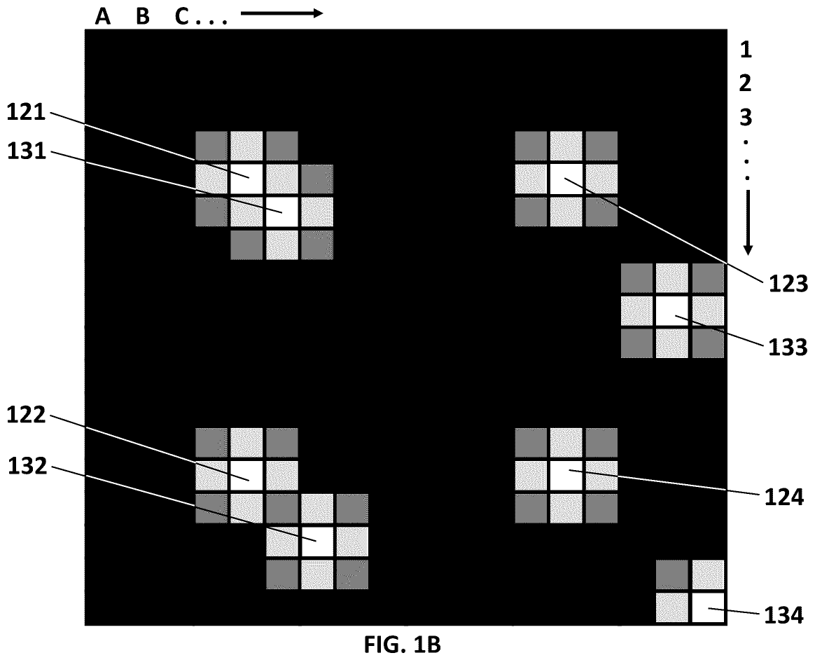

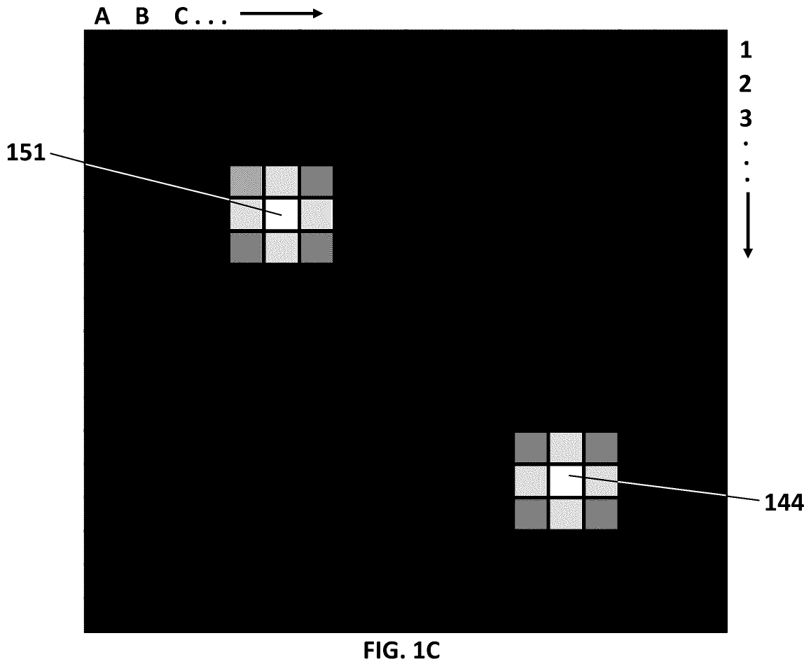

FIGS. 1A-1C, depict possible impacts of orthogonal binding phenomena on optical detection of an array of single analytes. FIG. 1A depicts a region of an array containing four circular analyte binding sites (101, 102, 103, 104). Each analyte binding site has a diameter of 150 nanometers (nm), and analyte binding sites are spaced at a 500 nm pitch center-to-center. Overlayed on the depicted array of FIG. 1A is a grid of 50 nm×50 nm, with each grid square corresponding to a fixed region of the array that is detected by a pixel-based optical sensor. Each grid square may be assigned a coordinate position (e.g., A, B, C, etc. in the horizontal direction, 1, 2, 3, etc. in the vertical direction. Accordingly, the center of analyte binding site 101 is located at grid space E5, as an example. Also depicted in FIG. 1A are four addresses (111 at F6, 112 at G16, 113 at Q9, 114 at R18) where orthogonal binding of moieties can occur (e.g., due to a surface defect) in interstitial regions of the array adjacent to analyte binding sites.

FIG. 1B depicts a simulated pixel-based image of the array of FIG. 1A when detected in a high occupancy condition. For example, an array of single analytes (e.g., single polypeptides, single nucleic acids) may be detected after array formation to detect presence or absence of a single analyte at each analyte binding site of the array, in which a majority of array sites are expected to be occupied by a single analyte. In another example, a fluorescent detection agent may be utilized before a single-analyte assay to detect precise addresses on a single-analyte array where analyte binding sites are located relative to an absolute position. In the simulated image of FIG. 1B, the four analyte binding sites (101, 102, 103, 104 of FIG. 1A) are emitting a detectable signal that is captured on sets of pixels, with intensity maxima at addresses 121, 122, 123, and 124, respectively. The orthogonal binding addresses (111, 112, 113, and 114 of FIG. 1A) are also occupied by signal-producing moieties, as captured in sets of pixels with intensity maxima at addresses 131, 132, 133, and 134, respectively. Notably, the signals associated with analyte binding site 101 and orthogonal binding site 111 are sufficiently overlapped that it may be difficult to distinguish or spatially-resolve the precise location of analyte binding site 101. Signals associated with analyte binding site 102 and orthogonal binding site 112 are partially-overlapped, but may be sufficiently separated to distinguish the true centerpoint of analyte binding site 112. Analyte binding sites 103 and 104 are sufficiently separated from orthogonal binding sites 113 and 114, respectively, to not inhibit high-confidence detection and/or location of the analyte binding sites. In the high-occupancy condition, a regular pattern of locations for array features may provide increased confidence in expected locations of analyte binding sites, thereby facilitating distinction of true signals from signals arising from orthogonal binding phenomena.

FIG. 1C depicts a simulated pixel-based image of the array of FIG. 1A when detected in a low occupancy condition. For example, an array of single analytes may be detected by an affinity agent that is configured to only bind a fraction of the single analytes (e.g., polypeptides containing a certain trimer amino acid epitope). In the low-occupancy condition, only signals at addresses 151 and 144 can be distinguished. If addresses for analyte binding sites have been determined (e.g., by a detection method as shown in FIG. 1B), it may be possible to determine that the signal at address 144 correspond to a true detection at analyte binding site 104. The proximity of the signal at address 151 to the location of analyte binding site 101 may make interpretation of the signal difficult. Notably, there is a faint signal centered at address 141 that may comprise a true signal from analyte binding site 101 that is overwhelmed by the signal of a retentate at address 151, or may comprise cross-talk of signal from the retentate 151. Accordingly, an image analysis algorithm may not be capable of properly classifying the signal at address 151 due to the ambiguity of signal information.

Without wishing to be bound by theory, orthogonal binding phenomena may arise in array-based systems due to one or more of: 1) surface structure and/or properties, 2) unbound moiety structure and/or properties, and 3) an environment mediating a binding interaction between a surface structure and an unbound moiety. At the nanoscale, binding interactions between array surface structures and unbound moiety in contact with the surface structures may contain some degree of stochasticity due to sources of variability, including natural variability (e.g., entropy), engineering variability (e.g., choice of manufacturing method, measurement error), and unintended variability (e.g., user error, equipment malfunction). Table I highlights a non-comprehensive list of factors in a single-analyte array system that may give rise to orthogonal binding phenomena. The skilled person will readily recognize that orthogonal binding phenomena can arise due to an individual factor listed in Table I or a combination of two or more of the factors listed in Table I. For example, an unbound moiety may have a binding specificity for a surface structure inhomogeneity (e.g., an impurity of a surface-coupled passivating moiety), thereby causing a binding interaction between the unbound moiety and the surface structure inhomogeneity. In another example, a change in solvent composition or ionic strength may alter the binding specificity or binding affinity of an unbound moiety, thereby inducing binding of the unbound moiety to an array surface. Accordingly, orthogonal binding phenomena can occur in the presence of an ideal array component (e.g., an ideal array surface or feature, an ideal unbound moiety, an ideal binding environment) if another array component deviates from an ideal form (i.e., containing a local or global irregularity that induces an orthogonal binding phenomenon).

In the context of a single-analyte array surface, orthogonal binding phenomena may comprise a global phenomenon or a local phenomenon. A global orthogonal binding phenomenon may comprise any orthogonal binding interaction that occurs with a substantially uniform distribution (e.g., spatially or temporally) over an array surface or a defined region of an array surface. For example, a change in the ionic strength of a fluidic medium comprising a plurality of unbound moieties that is contacted with an array surface may induce orthogonal binding of the unbound moieties to the array surface. In some cases, a global orthogonal binding phenomenon may be observed by a detection method (e.g., optical detection) as a substantially uniform signal (e.g., temporally and/or spatially) detected from an array surface or a defined region thereof. A local orthogonal binding phenomenon may comprise any orthogonal binding interaction that is spatially resolvable on an array surface, and optionally temporally resolvable on the array surface. For example, a fluidic medium comprising a plurality of unbound moieties may be contacted with an array surface comprising a plurality of isolated surface defects, thereby inducing the formation of orthogonal binding interactions with each binding interaction comprising a retentate bound to a single surface defect. In some cases, more than one orthogonal binding phenomenon may occur simultaneously or sequentially. Two or more simultaneous or sequential orthogonal binding phenomena may include two or more global orthogonal binding phenomena, two or more local orthogonal binding phenomena, or at least one global orthogonal binding phenomenon and at least one local orthogonal binding phenomenon.

TABLE I
Factors Contributing to Non-Specific Binding Phenomena

| Array Surface | Unbound Moiety | Binding Environment |
|---|---|---|
| Solid support composition | Moiety structure | Solvent composition |
| Solid support inhomogeneities | Moiety structural errors | Solvent impurities |
| Solid support degradation | Moiety structural conformation | Ionic strength |
| Solid support damage | Moiety structural damage | pH |
| Solid support reactivity | Moiety structural degradation | Temperature |
| Surface structure | Moiety agglomeration | Pressure |
| Surface structure vacancies | Moiety binding affinity | Fluid velocity |
| Surface structure impurities | Moiety binding specificity | Fluid velocity gradients |
| Surface structure degradation | Moiety dimensions | Electric field magnitude |
| Surface structure damage | Moiety diffusivity | Electric field gradients |
| Surface electrical charge | Moiety solubility | Magnetic field strength |
| Surface electrical charge variability | Moiety surface electrical charge | Magnetic field gradients |
| Surface reactivity | Moiety electrical charge variability | Fluid phase |
| | Moiety chemical reactivity | Fluid phase interfaces |
| | | Surface tension |

When an unbound moiety is contacted with an array or a surface thereof, orthogonal binding between the unbound moiety and the array of the surface thereof may occur by any conceivable mechanism. An orthogonal binding phenomenon may include a non-covalent interaction, such as an electrostatic interaction, a magnetic interaction, a van der Waals interaction, a hydrogen bonding interaction, a nucleic acid hybridization interaction, or a receptor-ligand binding interaction. In some cases, an orthogonal binding interaction may comprise a charge-bridging interaction, such as an interaction between an unbound moiety and an array surface that is mediated by a cationic or anionic species. An orthogonal binding phenomenon may include a covalent interaction, such as the formation of a covalent bond or a coordination bond. An orthogonal binding phenomenon may comprise a formation of a covalent interaction between a reactive group of an unbound moiety and a complementary reactive group of an array or an array surface. An orthogonal binding phenomenon may comprise an agglomeration phenomenon. For example, orthogonal binding of a first unbound moiety to an array surface may subsequently facilitate orthogonal binding of a second unbound moiety to the same region of the array surface.

Orthogonal binding phenomena may affect an array-based assay or process in one or more ways, including: 1) producing signals that cause false positive detections at an array site; 2) inhibiting true signals (i.e., signals emitted by a single-analyte or a moiety attached thereto) from an array site, thereby causing a false negative detection; 3) producing a background or baseline signal that reduces or eliminates the signal-to-noise ratio (SNR) of true signals; 4) inhibiting an array process or a step thereof, and 5) facilitating unwanted or extraneous side-processes during an array-based process or method. In some cases, orthogonal binding of unbound moieties to an array or a surface thereof may produce no detectable signals. For example, a large unbound moiety may become bound adjacent to an array site containing a polypeptide such that affinity agents contacted with the array are sterically occluded from binding to the polypeptide at the array site.

Orthogonal binding phenomena can occur at any step of an array-based assay or process. Orthogonal binding of unbound moieties to an array or a surface thereof may occur with a spatially-random distribution on the array or the surface thereof. Orthogonal binding of unbound moieties to an array or a surface thereof may occur with a temporally-random distribution on the array or the surface thereof. In some cases, a differing spatial distribution of orthogonally bound moieties on an array or a surface thereof may be produced by a repeated process. For example, in an array-based method comprising a cyclical sequence of: 1) contacting the array with a plurality of detectable unbound moieties, 2) detecting spatial addresses of detectable signals on the array, and 3) rinsing any moieties bound to the array, each cycle may produce a unique spatial distribution of unbound moieties that have become orthogonally bound to the array, as determined by the location of detectable signals on the array. In some cases, the spatial and/or temporal distribution of orthogonally bound moieties on an array or a surface thereof may be described by a stochastic or probabilistic relationship.

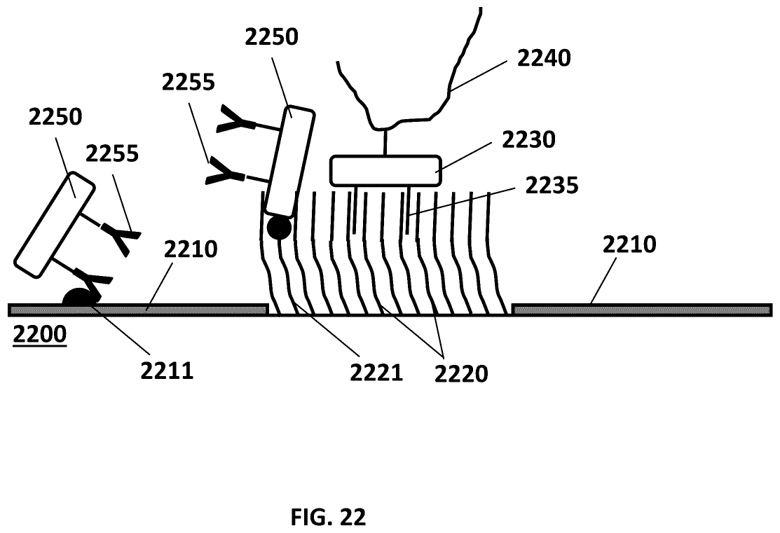

Orthogonal binding phenomena on array compositions set forth herein may arise due to more than one source of orthogonal binding. Array compositions may have multiple types of surface chemistries (e.g., interstitial surfaces vs. binding site surfaces) that are characterized by differing types of orthogonal binding phenomena, or contain differing types of surface defects. Multiple mechanisms of orthogonal binding phenomena may arise when arrays are contacted with complex assay reagents (e.g., reagents containing macromolecules or nanoparticles, reagents with anisotropic surface electrical charge density, etc.), for example polypeptides or detectable probes containing a plurality of affinity agents and/or detectable labels coupled to a nanoparticle. FIG. 22 illustrates an array composition that has formed orthogonal binding interactions with assay reagents by more than one type of orthogonal binding phenomenon. The array composition comprises a solid support 2200 containing interstitial regions comprising a first surface layer 2210 (e.g., a hydrophobic material, passivating moieties, etc.) and an array site comprising a second surface layer (e.g., coupling moieties 2220). An interstitial region comprises a first defect 2211 (e.g., a residual particle or molecule of a patternable material from a lithographic process) and the array site comprises a second defect 2221 (e.g., a surface-coupled molecule with a reactive functional group), in which the first defect 2211 and the second defect 2221 differ structurally, chemically, or physically. An anchoring moiety 2230 (e.g., a nanoparticle, a nucleic acid nanoparticle) comprising a plurality of complementary coupling moieties 2235 is bound to the array site by coupling of the complementary coupling moieties 2235 to the coupling moieties 2220 of the second surface layer. A single analyte (e.g., a polypeptide) is attached to the anchoring moiety. During an array-based process, the array composition may be contacted by assay reagents that can form orthogonal binding interactions with components of the array composition. FIG. 22 depicts multivalent binding reagents comprising a plurality of affinity reagents 2255 (e.g., antibodies, antibody fragments, aptamers, etc.) that are coupled together by a retaining group 2250 (e.g., a nanoparticle, a nucleic acid nanoparticle). Because the first defect 2211 and the second defect 2221 differ, the multivalent binding reagents may interact differently with each type of defect. The multivalent binding reagents may become bound at the first defect 2211 or the second defect 2221 by differing components or portions of the multivalent binding reagent (as shown in FIG. 22), or may become bound at the first defect 2211 or the second defect 2221 by differing types of binding interactions between the binding reagent and the array composition.

Accordingly, the skilled person will readily envisage methods that combine two or more methods set forth herein to prepare, modify, or utilize arrays, thereby inhibiting two or more sources of orthogonal binding phenomena.

### Forming Surface Layers on Solid Supports

A method of forming a single-analyte array, as set forth herein, may comprise one or more steps of forming a surface layer on a surface of a solid support. In some cases, a surface layer may be formed on a surface of a solid support before a lithographic process (e.g., deposition of a photoresist prior to a photolithographic process, deposition of an imprint resin prior to a nanoimprint lithography process, etc.). In other cases, a surface layer may be formed on a portion of a surface of a solid support to provide a chemical property to the portion of the surface. For example, surface layers may be formed at analyte binding sites of an array to provide coupling chemistries for the attachment of analytes to the binding site. In another example, surface layers may be formed at interstitial regions of an array to inhibit orthogonal binding of moieties to the interstitial regions.

A surface layer may be adhered to a surface of a solid support. In some cases, a surface layer or constituent moieties thereof may be adhered to a surface of a solid support by one or more non-covalent binding interactions, such as electrostatic interactions, Van der Waals interactions, magnetic interactions, hydrogen bonding, gravitational settling, hydrophobic interactions, hydrophilic interactions, or combinations thereof. In other cases, a surface layer or constituent moieties thereof may be adhered to a surface of a solid support by one or more covalent binding interactions, including coordination binding. A surface layer comprising a plurality of moieties may comprise a disordered layer if orientations of moieties of the plurality of moieties are non-uniform or random. For example, a polymeric surface layer disposed on a surface of a solid support may be disordered due to presence of polymer molecules that are adhered to the surface, polymer molecules that are adhered to the surface and other polymer molecules, and polymer molecules that are adhered to other polymer molecules but not directly adhered to the surface. A surface layer comprising a plurality of moieties may be ordered if orientations of substantially all moieties of the plurality of moieties are uniform or non-random. For example, an ordered surface layer may comprise a plurality of moieties, in which each moiety comprises a first terminal group and a second terminal group, in which the first terminal group is attached to a surface of a solid support, and in which the second terminal group is not attached to the surface of the solid support. In some cases, a surface layer may comprise a self-assembled monolayer.

A method of preparing an array may comprise a step of coupling a plurality of molecules to a surface of a solid support. A plurality of molecules that is to be coupled to a surface of a solid support may comprise surface-reactive functional groups that are configured to form covalent bonds with a surface (e.g., coordination bonds). Useful covalent coupling chemistries for attaching molecules to a surface may include contacting organosilane molecules (e.g., APTMS, APTES, GOPS, etc.) with a silicon-containing solid support (e.g., silicon, glass, fused silica, quartz, etc.), or contacting organophosphonate or organophosphate molecules with a metal oxide solid support (e.g., zirconium oxide, titanium oxide, etc.). Additional useful coupling chemistries are detailed in U.S. Pat. No. 11,203,612B2 and U.S. patent application No. 20220379582A1, each of which is incorporated by reference. A plurality of molecules that is to be coupled to a surface of a solid support may comprise moieties that are configured to form non-covalent bonds with a surface (e.g., electrostatic or magnetic interactions). Useful non-covalent coupling chemistries may include oligonucleotides, peptides, and nanoparticles.

A surface layer may be formed by one or more steps. In some cases, a surface layer may be formed on a surface of a solid support by a single step. In other cases, a surface layer may be formed on a surface of a solid support by two or more steps. In particular cases, a surface layer may be formed by two or more sequential steps. For example, a surface layer may be formed by first coupling a first plurality of molecules to a surface of a solid support, then coupling a second plurality of molecules to the first plurality of molecules. In another example, a surface layer may be formed by first coupling a first plurality of molecules to a surface of a solid support, and then coupling a second plurality of molecules to the surface of the solid support. In other particular cases, a surface layer may be formed by two or more non-sequential steps. For example, a surface layer formation process comprising first coupling a first plurality of molecules to a surface of a solid support, then coupling a second plurality of molecules to the first plurality of molecules, may include one or more intermediate steps (e.g., rinsing, activating functional groups, exchanging buffers, etc.) between the first coupling step and the second coupling step.

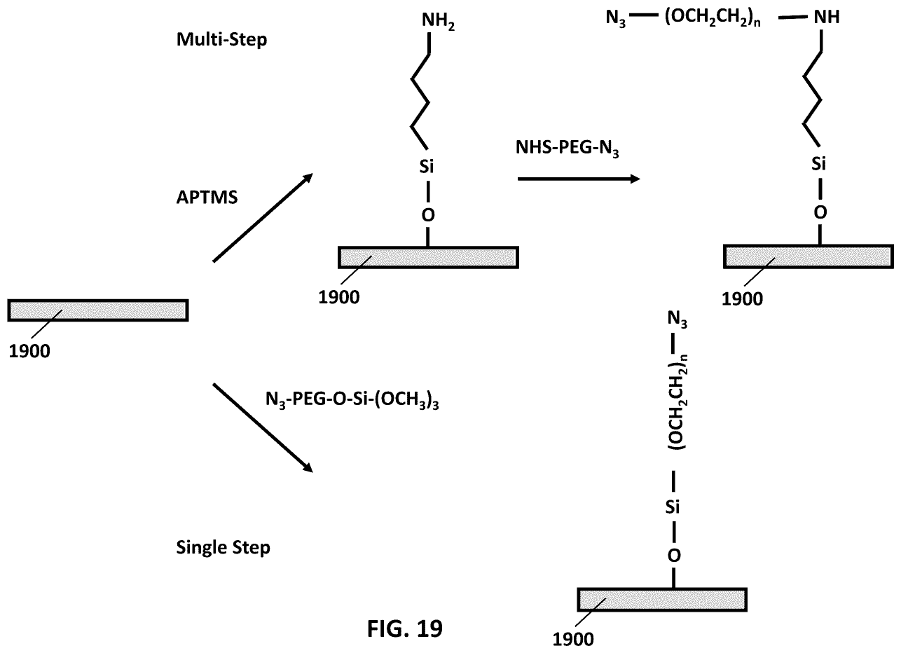

FIG. 19 depicts two pathways for forming a surface layer on a solid support 1900. The methods are exemplified with chemistries that produce a surface layer comprising azide functional groups. Moreover, FIG. 19 depicts a single molecule attached to a surface for clarity, but would be expected to produce pluralities of coupled molecules on the surface. In the upper, multi-step pathway, the solid support 1900 is contacted with aminated silane molecules (e.g., APTMS, APTES, GOPS, etc.) to form an aminated surface layer. In a second step, the aminated surface layer is contacted with amine-reactive molecules (e.g., NHS-PEG-azide) to add azide functional groups to the surface layer. In the lower, single step pathway, the solid support 1900 is contacted with silanized, azide-containing molecules, thereby forming a surface layer containing azide functional groups. In some cases, a single step surface layer formation process may be chosen due to a simpler and faster process workflow. In other cases, a multi-step surface layer formation process may be chosen due to more uniform surface layer density, increased surface layer molecular density, and/or decreased quantity of defects in the surface layer.

A method of forming a surface layer on a surface of a solid support may comprise the steps of: a) contacting the surface of the solid support with a first plurality of molecules, and b) coupling the plurality of molecules to the surface of the solid support. In some cases, a method of forming a surface layer on a surface of a solid support may further comprise repeating contacting the surface of the solid support with the first plurality of molecules. In other cases, a method of forming a surface layer on a surface of a solid support may further comprise contacting the surface of the solid support with a second plurality of molecules, in which the second plurality of molecules differs from the first plurality of molecules (e.g., with respect to chemical composition, with respect to concentration, with respect to a fluidic medium comprising the first and/or second plurality of molecules, etc.). Contacting and/or coupling a plurality of molecules to a surface of a solid support may be repeated to increase the surface density of molecules, increase spatial uniformity of molecules, or produce compositional heterogeneity in a surface layer formed on a surface. Contacting of a plurality of molecules to a surface of a solid support may involve delivering molecules in vapor phase for contact with the surface. For example, silane compounds may be deposited on a silicon-containing solid support via chemical vapor deposition. Contacting of a plurality of molecules to a surface of a solid support may involve delivering molecules in a liquid phase for contact with the surface. For example, silane compounds may be deposited on a silicon-containing solid support via chemical liquid deposition.

Deposition of some surface layers may be facilitated by performing the deposition of molecules that form the surface layer in the presence of a solvent system. In particular, choice of solvent system may facilitate surface layer deposition when surface layers are to be formed on surfaces of a solid support that are exposed within a patternable material (e.g., a photoresist) by a lithographic process (e.g., photolithography, nanoimprint lithography, etc.). Selection of a solvent system may affect the density, uniformity, and/or conversion efficiency of formed surface layers, as well as affecting interactions between the deposited molecules of the surface layer and the patternable material.

Design and optimization of a deposition solvent system for forming a surface layer may be influenced by several aspects of the system. For example, certain deposition processes may include formation of covalent bonds (e.g., formation of coordination covalent bonds with solid support surfaces, formation of covalent bonds during a Click-type reaction, etc.), in which the covalent bond formation most readily occurs in the presence of a particular type of solvent (e.g., an aqueous solvent, an organic solvent, a polar solvent, a non-polar solvent, etc.). Additionally, materials present during a surface layer deposition process may affect formulation of a deposition solvent system. Wettability of materials (e.g., patternable materials, solid support surfaces) may vary according to solvent composition. Wettability may be a particular concern in patterned wells or depressions within a patternable material, where large contact angles may prevent complete wetting of surfaces within the wells or depressions. Accordingly, a method of depositing a surface layer may utilize a multi-solvent system to deposit molecules.

A particularly useful solvent system may comprise water and a miscible solvent. In some cases, a solvent system may comprise water and a miscible organic solvent. In some cases, a solvent system may comprise water and a miscible polar solvent. Exemplary polar solvents can include N-methyl pyrrolidone, tetrahydrofuran, ethyl acetate, acetone, dimethylfuran, acetonitrile, dimethyl sulfoxide, propylene carbonate, N-butanol, isopropyl alcohol, nitromethane, ethanol, methanol, acetic acid, and a combination thereof. In some cases, a solvent system may comprise water and an aprotic solvent. Exemplary aprotic solvents can include N-methyl pyrrolidone, tetrahydrofuran, ethyl acetate, acetone, dimethylfuran, acetonitrile, dimethyl sulfoxide, propylene carbonate, or a combination thereof.

A first solvent and a second solvent of a multi-solvent composition may be combined in a particular ratio, for example based upon weight, molarity, etc. A first solvent relative to a second solvent of a multi-solvent composition may have a ratio (e.g., based upon weight, molarity, etc.) of at least about 1:100, 1:20, 1:10, 1:5, 1:2, 1:1, 2:1, 5:1, 10:1, 20:1, 100:1, or more than 100:1. Alternatively or additionally, a first solvent relative to a second solvent of a multi-solvent composition may have a ratio (e.g., based upon weight, molarity, etc.) of no more than about 100:1, 20:1, 10:1, 5:1, 2:1, 1:1, 1:2, 1:5, 1:10, 1:20, 1:100, or less than 1:100.

A particular solvent of a multi-solvent composition may a percentage of the multi-solvent system (e.g., with respect to weight, with respect to molarity) of at least about 0.1%, 0.5%, 1%, 5%, 10%, 20%, 25%, 30%, 40%, 50%, 60%, 70%, 80%, 90%, 95%, 99%, 99.9%, or more than 99.9%. Alternatively or additionally, a particular solvent of a multi-solvent composition may a percentage of the multi-solvent system (e.g., with respect to weight, with respect to molarity) of no more than about 99.9%, 99%, 95%, 90%, 80%, 70%, 60%, 50%, 40%, 30%, 25%, 20%, 10%, 5%, 1%, 0.5%, 0.1%, or less than 0.1%. The skilled person will readily recognize that certain solvents may have a limited miscibility with water. Accordingly, the quantity of a miscible solvent combined with water may be limited by the miscibility of the miscible solvent in water.

As an example, a useful solvent system for forming a surface layer on a patterned substrate may comprise water and dimethyl sulfoxide. It may be advantageous to utilize this solvent system for surface deposition methods such as certain Click-type reactions (e.g., DBCO-azide) and some of the deposition reactions depicted in FIG. 19 (e.g., the second step of the upper two-step method, or the lower single-step method). In some cases, a miscible solvent may be selected if it observed to facilitate some swelling or reversible deformation of a patternable material (without causing dissociation of the patternable material from the solid support). Without wishing to be bound by theory, swelling or reversible deformation of the patternable material by contact with a solvent composition during a surface layer deposition process may facilitate removal of the patternable material during a subsequent stripping process.

A method of forming a surface layer on a surface of a solid support may comprise a step of coupling a first plurality of molecules to a second plurality of molecules. A molecule of a first plurality of molecules may comprise: i) a moiety that is configured to be coupled to a surface of a solid support, and ii) a moiety that is configured to be coupled to a complementary moiety of a molecule of a second plurality of molecules. A molecule of a second plurality of molecules may comprise a complementary moiety that is configured to be coupled to a moiety of a molecule of the first plurality of molecules. A molecule of a second plurality of molecules may not comprise a moiety that is configured to be coupled to a surface of a solid support. In some cases, a first plurality of molecules may be coupled to a second plurality of molecules after the first plurality of molecules has been coupled to a surface of a solid support. In other cases, a first plurality of molecules may be coupled to a second plurality of molecules before the first plurality of molecules has been coupled to a surface of a solid support.

A molecule of a first plurality of molecules may be coupled to a molecule of a second plurality of molecules in the presence of a fluidic medium. A fluidic medium may be configured to facilitate coupling of a molecule of a first plurality of molecules to a molecule of a second plurality of molecules. A skilled person will readily recognize suitable fluidic media depending upon the coupling mechanism that is to be utilized to couple a molecule of a first plurality of molecules to a molecule of a second plurality of molecules. For example, an aminated molecule may be covalently coupled to an NHS ester by a nucleophilic substitution reaction, preferably in the presence of an organic fluidic medium. In some cases, a preferable fluidic medium for coupling a molecule of a first plurality of molecules to a molecule of a second plurality of molecules may be detrimental to other aspects of an array formation process. For example, when coupling molecules comprising NHS esters to a solid support comprising covalently coupled molecules with amine groups, the presence of an organic solvent may disrupt covalent bonds between the solid support and the aminated molecules. Accordingly, such a method of attaching molecules comprising NHS esters to the solid support by coupling to the aminated molecules may cause defect formation due to loss of aminated molecules from the surface of the solid support.

Surface density of molecules on a surface of a solid support may be controlled by a method set forth herein. For example, it may be advantageous to control a surface density of coupling moieties at array sites; excess coupling moieties at array sites could lead to an increased quantity of array sites with multiple-analyte occupancy (i.e., two or more analytes at array sites after deposition of analytes). Likewise, too few coupling moieties at array sites could lead to an increased quantity of array sites with zero-analyte occupancy (i.e., no analytes present at array sites after deposition of analytes).

Surface density of molecules on a surface of a solid support may be controlled through various methods, including single-step or multi-step deposition processes, as set forth herein. In a single-step process, a plurality of molecules may be attached to a surface of a solid support, in which the plurality of molecules comprises a first type of molecule comprising a first moiety (e.g., a first reactive moiety, a first coupling moiety, a first passivating moiety) and a second type of molecule comprising a second moiety (e.g., a second reactive moiety, a second coupling moiety, a second passivating moiety), in which the first moiety differs from the second moiety. Surface densities of the first moieties and the second moieties may be controlled, in part, by the molar ratio of the first type of molecule and the second type of molecule in the plurality of molecules.

Alternatively, several multi-step processes can be performed to control surface density of molecules. In a first example, a surface layer can be performed by attaching a first plurality of molecules to a surface of a solid support, in which the plurality of molecules comprises a first type of molecule comprising a first reactive moiety, and a second type of molecule comprising a second reactive moiety, in which the first reactive moiety has an orthogonal reaction chemistry to the second reactive moiety. Subsequently, a second plurality of molecules can be attached to the first plurality of molecules, in which the second plurality of molecules comprises a first type of molecule comprising a first complementary reactive moiety that is configured to react with the first reactive moiety, and a second type of molecule comprising a second complementary reactive moiety that is configured to react with the second reactive moiety. Surface densities of the first type of molecule and second type of molecule of the second plurality of molecules may be controlled, in part, by the molar ratio of the first type of molecule and the second type of molecule in the first plurality of molecules.

In a second example, a surface layer can be performed by attaching a first plurality of molecules to a surface of a solid support, in which the plurality of molecules comprises only a first type of molecule comprising a reactive moiety. Subsequently, a second plurality of molecules can be attached to the first plurality of molecules, in which the second plurality of molecules comprises a first type of molecule comprising a first moiety (e.g., a first reactive moiety, a first coupling moiety, a first passivating moiety), and a second type of molecule comprising a second moiety (e.g., a second reactive moiety, a second coupling moiety, a second passivating moiety), in which the first type of molecule and the second type of molecule each comprises a complementary reactive moiety that is configured to react with the reactive moiety of the first type of molecule of the first plurality of molecules. Surface densities of the first type of molecule and second type of molecule of the second plurality of molecules may be controlled, in part, by the molar ratio of the first type of molecule and the second type of molecule in the second plurality of molecules.

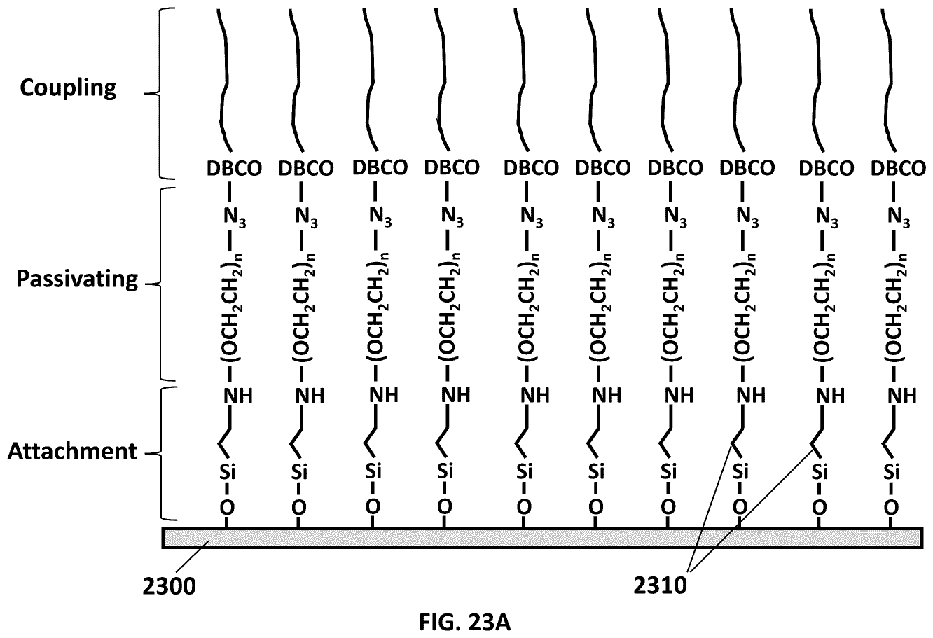

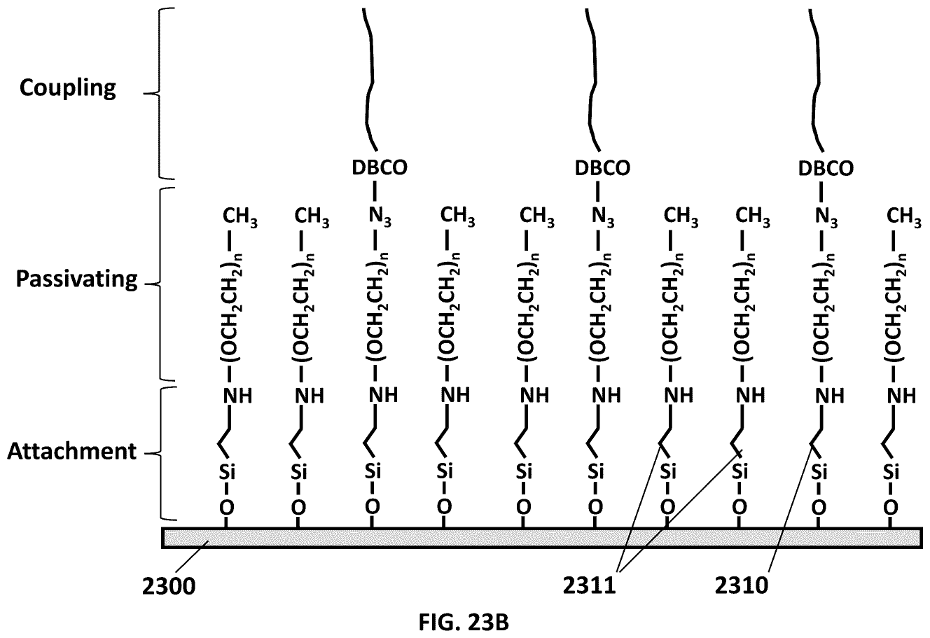

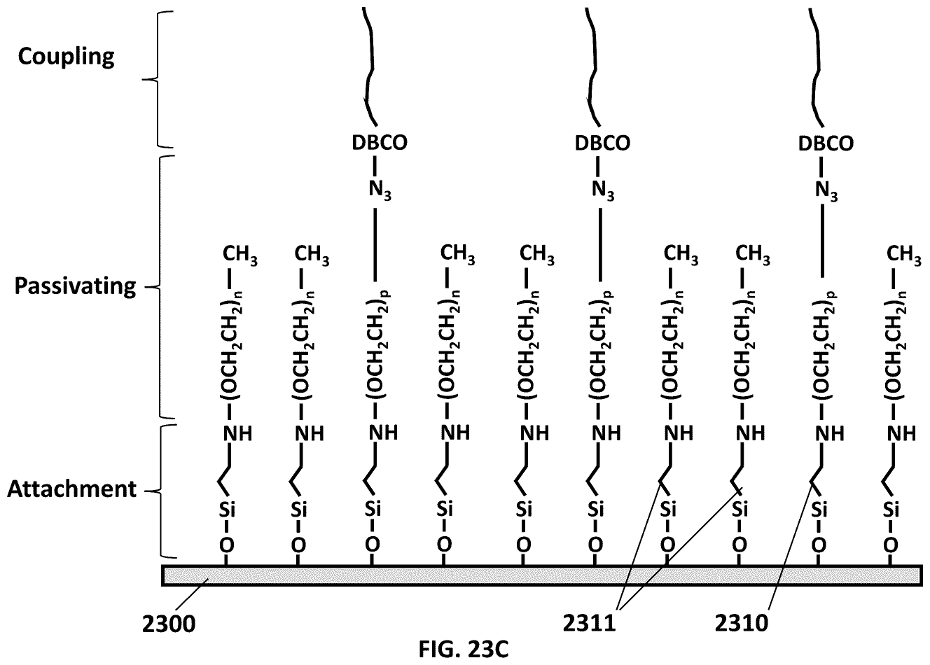

FIGS. 23A-23C illustrate configurations of surface layers that may be formed by a method set forth herein. FIG. 23A depicts a substantially homogeneous surface layer comprising surface-coupled molecules 2310 attached to a surface of solid support 2300. The molecules may comprise multiple moieties with differing functions, including an attachment moiety, an optional passivating moiety, and a coupling moiety. If the molecules are substantially homogeneous in structure and/or molecular chain length, the surface layer may comprise one or more sub-layers, such as an attachment layer, a passivation layer, and a coupling layer. Variations in molecular structure or molecular chain length, as well as inherent molecular motion can produce spatial and/or temporal variations in the morphology and thickness of such sublayers. FIG. 23B depicts a surface layer configuration similar to the configuration of FIG. 23A, but with a reduced surface density of coupling moieties (e.g., oligonucleotides, ligand-receptor binding components, reactive functional groups, etc.). The surface-coupled moieties containing coupling moieties 2310 are distributed on the surface of the solid support 2300 with surface-coupled moieties that do not comprise a coupling moiety 2311. The surface density of the coupling moieties of the coupling sublayer may be controlled by a method set forth herein. FIG. 23C depicts a similar configuration to FIG. 23B, but with decreased molecular chain length (i.e., p<n) for the surface-coupled molecules that do not comprise a coupling moiety 2311. This configuration may be advantageous for minimizing defects in surface layers during surface layer formation. The coupling sub-layer of FIG. 23C may be formed by covalent attachment of coupling moieties to reactive functional groups. If the molecules comprising the reactive functional groups have a substantially longer molecular chain length, the increased molecular chain length should inhibit occlusion of the reactive functional group by neighboring molecules without the coupling moiety 2311. Accordingly, the reactive functional groups may be more accessible during a covalent reaction to attach a coupling moiety.

Provided herein are advantageous methods for forming surface layers by multi-step processes. The methods may provide a surface layer with fewer defects on a solid support due to an increased efficiency of the steps that form the surface layer. In an aspect, provided herein is a method, comprising: a) providing a solid support surface comprising a plurality of surface-coupled moieties, in which the surface-coupled moieties comprise reactive functional groups, b) contacting the solid support with an aqueous medium comprising a plurality of molecules, in which molecules of the plurality of molecules comprise coupling moieties, in which the aqueous medium further comprises a kosmotropic agent or a clouding agent, in which a coupling moiety of the coupling moieties comprises a complementary reactive functional group, and in which reactive functional groups covalently coupled complementary reactive functional groups, and c) covalently coupling molecules of the plurality of molecules to at least 50% of the plurality of surface-coupled moieties in the presence of the kosmotropic agent or clouding agent.

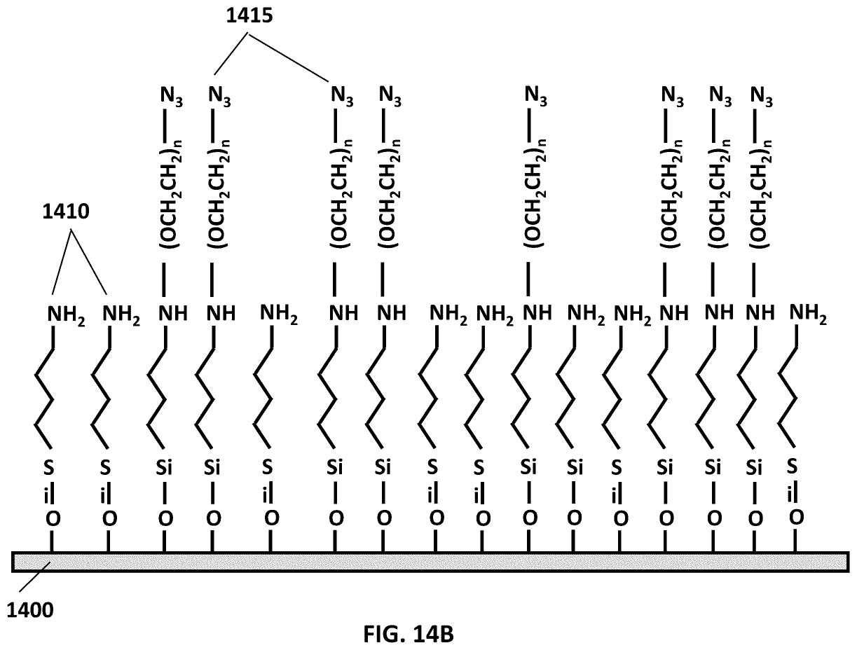

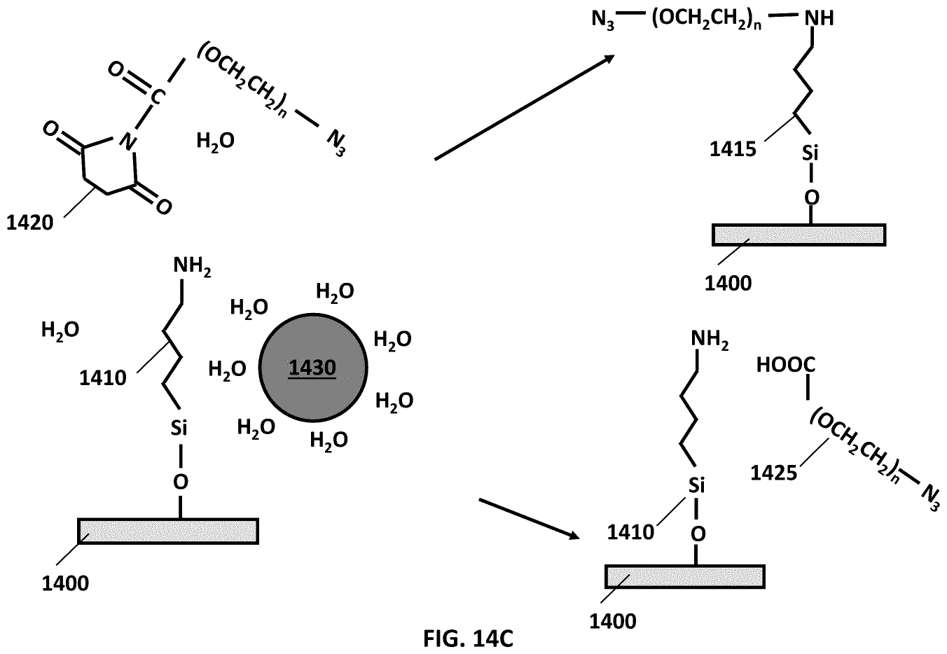

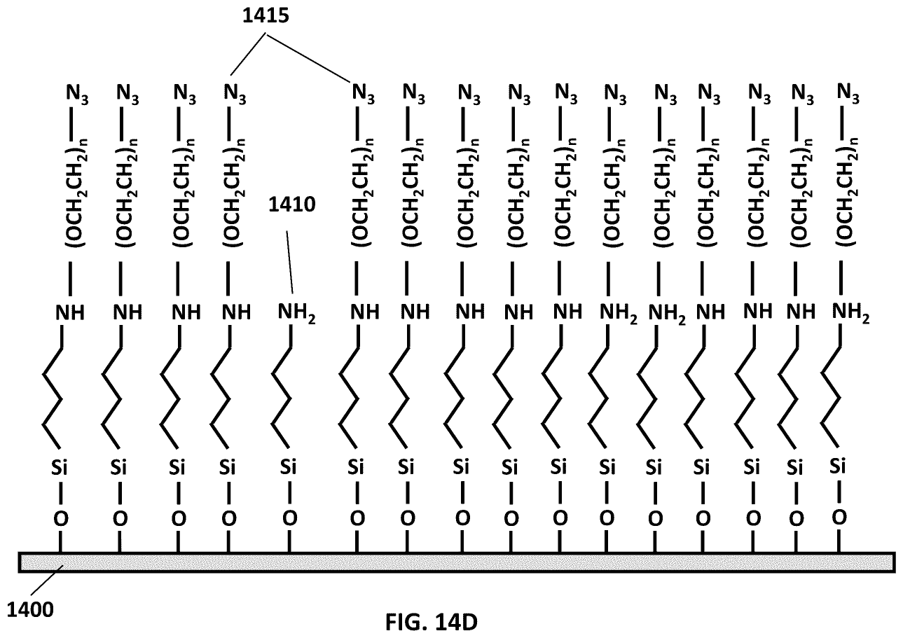

FIGS. 14A-14B depict aspects of forming surface layers in an absence of a kosmotropic or clouding agent. FIG. 14A depicts reactive pathways for attaching NHS esters to surface-coupled amines in the presence of an aqueous medium. FIG. 14A depicts a single molecule attached to a surface for clarity, but the depicted mechanism would be expected to occur for pluralities of coupled molecules on the surface. As shown, a solid support 1400 comprises covalently coupled APTMS molecules 1410 comprising a terminal amine group. The solid support is contacted with an aqueous medium comprising NHS-PEG-azide molecules 1420. The preferred upper mechanism comprises performing nucleophilic substitution reactions to displace N-hydroxysuccinimide leaving groups from NHS esters, thereby forming a surface layer comprising PEG-azide moieties 1415 coupled to the solid support. However, the less-preferred lower mechanism comprises hydrolyzing some NHS esters with available water molecules, thereby forming carboxylated PEG-azide molecules 1425 in solution and leaving some surface-coupled APTMS molecules 1410 unreacted. Depending upon reactive conditions, the lower hydrolysis mechanism may dominate over the preferred surface-coupling mechanism. FIG. 14B depicts a surface layer formed by the reactive system depicted in FIG. 14A. The solid support comprises a surface layer comprising a mixture of unreacted APTMS molecules 1410 and surface-coupled PEG azide molecules 1415. The spatial distribution of defects (i.e., unreacted APTMS molecules 1410) in the surface layer of FIG. 14B may be random.

FIGS. 14C-14D depict aspects of forming surface layers in the presence of a kosmotropic or clouding agent. FIG. 14C depicts an equivalent reactive system to FIG. 14A, however a kosmotropic or clouding agent 1430 is present in a fluidic medium contacted with the solid support 1400. Without wishing to be bound by theory, a kosmotropic or clouding agent may comprise a chemical species that reduces an intrinsic reactivity of water within the reactive system. For example, a kosmotropic agent may comprise a molecule that structures water molecules around itself, thereby reducing a likelihood of an associated water molecule participating in a detrimental hydrolysis reaction. In another example, a clouding agent may comprise an ionic species that forms an effective charge cloud around a polymeric species (e.g., a PEGylated molecule), thereby screening the molecule from interactions with water molecules. The chemical mechanism described for FIG. 14A are still possible in the reactive system of FIG. 14C, however the presence of the kosmotropic or clouding agent increases a likelihood of the preferred surface-coupling reaction occurring. FIG. 14D depicts a surface layer formed by the reactive system depicted in FIG. 14C. The solid support comprises a surface layer comprising a mixture of unreacted APTMS molecules 1410 and surface-coupled PEG azide molecules 1415, but with a lower surface density of defects (i.e., unreacted APTMS molecules 1410) than the surface layer depicted in FIG. 14B. The spatial distribution of defects in the surface layer of FIG. 14D may be random.

A method of forming a surface layer on a surface of a solid support may comprise a step of coupling a first plurality of molecules to a second plurality of molecules. A first plurality of molecules may be contacted or combined with a second plurality of molecules, in which molecules of the first plurality of molecules comprises first reactive moieties, in which molecules of the second plurality of molecules comprises second reactive moieties, and in which the first reactive moieties can react with the second reactive moieties to form covalent bonds between molecules of the first plurality of molecules and molecules of the second plurality of molecules. A first reactive moiety and a second reactive moiety may be configured to form a covalent bond by any conceivable mechanism, such as a substitution reaction, an elimination reaction, an addition reaction, a Click-type reaction, or a combination thereof. A first reactive moiety or a second reactive moiety may comprise a reactive functional group such as a nucleophilic functional group, an electrophilic functional group, or a Click-type reactant.

Molecules of a first plurality of molecules may be coupled to molecules of a second plurality of molecules with a particular efficiency or conversion. An efficiency or conversion of a coupling reaction between molecules of a first plurality of molecules and molecules of a second plurality of molecules may be calculated with respect to a limiting reactant or an excess reactant. An efficiency or conversion of a coupling reaction between molecules of a first plurality of molecules and molecules of a second plurality of molecules may be calculated as a single-pass efficiency or conversion (i.e., an efficiency or conversion for a single reaction step) or an overall efficiency or conversion (i.e., an efficiency or conversion or one or more reaction steps). In some cases, a step of coupling molecules of a first plurality of molecules to molecules of a second plurality of molecules may be repeated. For example, a first plurality of molecules may be coupled to a second plurality of molecules in the presence of a kosmotropic agent or a clouding agent two or more times to achieve a higher overall conversion of coupled molecules. Molecules of a first plurality of molecules may be coupled to molecules of a second plurality of molecules with an efficiency or conversion of at least 1%, 5%, 10%, 20%, 25%, 30%, 35%, 40%, 45%, 50%, 55%, 60%, 65%, 70%, 75%, 80%, 85%, 90%, 95%, 99%, 99.9%, or more than 99.9%. Alternatively or additionally, molecules of a first plurality of molecules may be coupled to molecules of a second plurality of molecules with an efficiency or conversion of no more than about 99.9%, 99%, 95%, 90%, 85%, 80%, 75%, 70%, 65%, 60%, 55%, 50%, 45%, 40%, 35%, 30%, 25%, 20%, 10%, 5%, 1%, or less than 1%.

In some cases, a coupling reaction of a first plurality of molecules with a second plurality of molecules may be repeated at least once. A coupling reaction may be repeated at least once under identical reactive conditions (e.g., with respect to aqueous medium composition, with respect to reaction time, with respect to reaction temperature, etc.). A coupling reaction may be repeated at least once, with a first coupling reaction occurring under differing reactive conditions than a second coupling reaction (e.g., differing aqueous medium composition, differing reaction time, differing reaction temperature, etc.). In particular cases, a first coupling reaction may occur in the presence of a kosmotropic agent or a clouding agent, and a second coupling reaction may occur in the presence of the same kosmotropic agent or clouding agent. In other particular cases, a first coupling reaction may occur in the presence of a first kosmotropic agent or a clouding agent, and a second coupling reaction may occur in the presence of a differing second kosmotropic agent or clouding agent. In particular cases, a first coupling reaction may occur in the presence of a kosmotropic agent, and a second coupling reaction may occur in the presence of a clouding agent. In particular cases, a first coupling reaction may occur in an aqueous medium comprising a solvating composition (e.g., water and an optional co-solvent), and a second coupling reaction may occur in an aqueous medium comprising the same solvating composition. In other particular cases, a first coupling reaction may occur in the presence of a first solvating composition, and a second coupling reaction may occur in the presence of a differing second solvating composition. In particular cases, a first coupling reaction may occur in an aqueous medium comprising a second plurality of molecules (e.g., NHS esters), and a second coupling reaction may occur in an aqueous medium comprising the same second plurality of molecules. In other particular cases, a first coupling reaction may occur in the presence of a second plurality of molecules, and a second coupling reaction may occur in the presence of a differing third plurality of molecules (e.g., differing with respect to reactive functional groups, differs with respect to an additional moiety, etc.).

A coupling reaction that comprises coupling a first plurality of molecules to a second plurality of molecules may be slowed or stopped by the addition of a quenching agent. A quenching agent may comprise any molecule or moiety that is configured to inhibit a coupling reaction between molecules of a first plurality of molecules and molecules of a second plurality of molecules, as set forth herein. A quenching agent may comprise a reactive functional group that is configured to undergo a coupling reaction with a reactive functional group of a molecule that is not coupled to a surface of a solid support. A quenching agent may comprise a reactive functional group that is not configured to undergo a coupling reaction with a reactive functional group of a molecule that is coupled to a surface of a solid support. In some cases, a quenching agent may comprise a non-reactive species that is configured to inhibit a coupling reaction between molecules of a first plurality of molecules and molecules of a second plurality of molecules. For example, a quenching agent may comprise an acid or base, whose addition alter a pH of an aqueous medium to a pH that inhibits a coupling reaction.

A method, as set forth herein, may comprise one or more rinsing steps. A rinsing step may comprise contacting a solid support and/or a surface layer disposed thereupon to a rinsing medium. A rinsing medium may be configured to facilitate removal of unbound moieties from a solid support, a surface thereof, a surface layer disposed upon the solid support, or a surface of the surface layer. A rinsing step may be performed at any conceivable step of an array formation process, including before or after depositing a patternable material, before or after forming wells or well-like structures in a patternable material, before or after forming a surface layer or a component thereof on a surface of a solid support, before or after coupling molecules by a coupling reaction, and before or after any repetitions of aforementioned process steps.

### Surface Layer Cross-Reactivity

Some methods set forth herein comprise forming compositions that are precursors to a fully formed single-analyte array composition. A precursor single-analyte array composition may comprise a solid support with a patternable material disposed on a surface of the solid support, in which the patternable material comprises wells or well-like structures, and in which the wells or well-like structures comprise pluralities of molecules coupled to an exposed surface of the solid support at the bottoms of the wells or well-like structures. In some cases, molecules of a plurality molecules coupled to the surface of the solid support within a well or well-like structure may possess reactivity for a patternable material that at least partially surrounds the well or well-like structure. For example, a well in an organic photoresist material may contain a plurality of molecules (e.g., organosilanes, organophosphates, organophosphonates) coupled to a solid support surface at the bottom of the well, in which molecules of the plurality of molecules comprise a reactive functional group, and in which the reactive functional group can undergo a reaction that covalently bonds the organic photoresist material to molecules of the plurality of molecules.

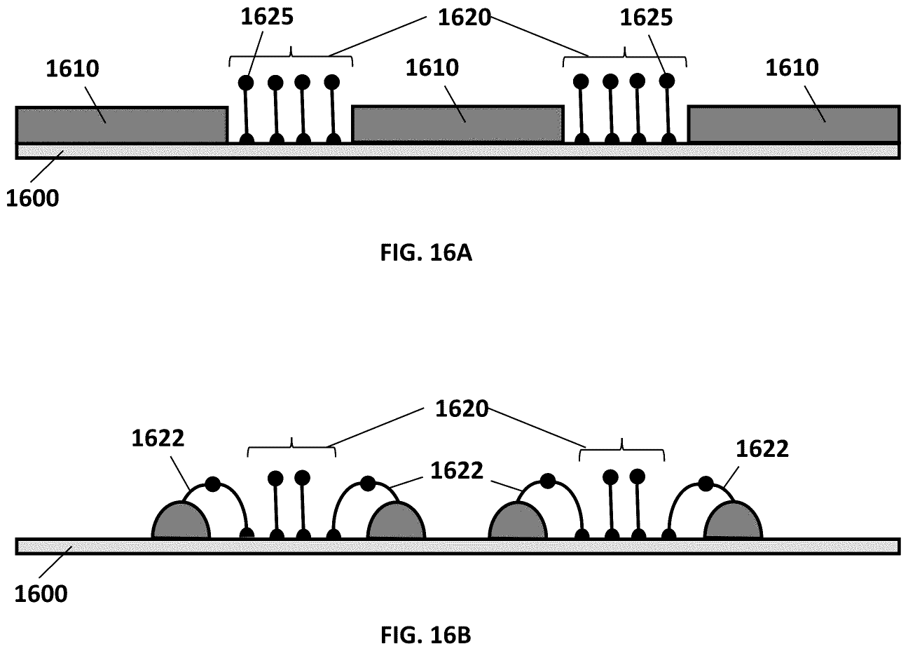

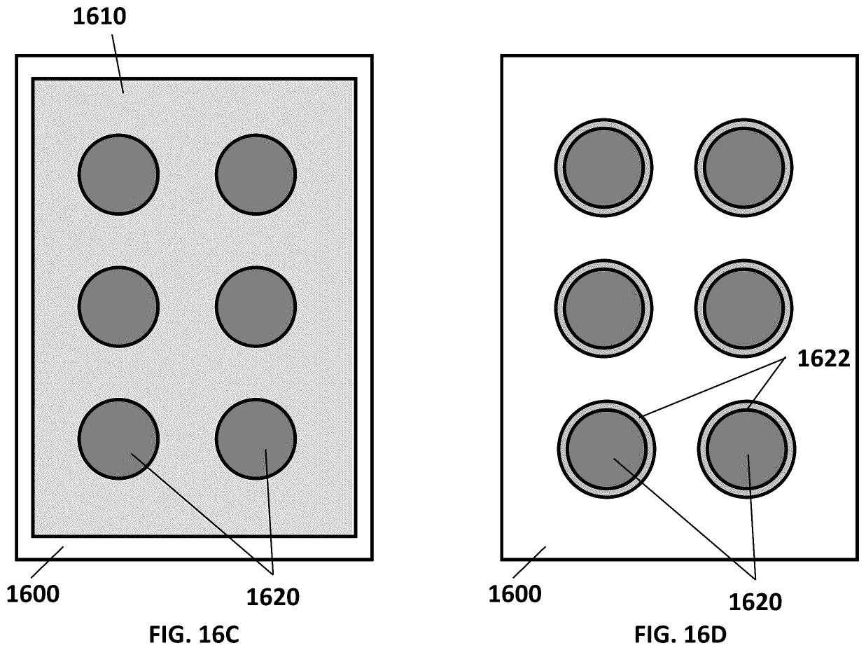

Cross-reactivity between molecules or moieties of a patternable material and molecules of a plurality of surface-coupled molecules may form an adduct surface layer at an interface between the patternable material and the plurality of surface-coupled molecules, in which the adduct surface layer is adhered to a surface of the solid support on which the patternable material is disposed. FIGS. 16A-16D illustrate a process that results in formation of an adduct surface layer. FIG. 16A depicts a cross-sectional view of a precursor array composition comprising a solid support 1600 with a patternable material 1610 disposed on a surface of the solid support 1600. The patternable material 1610 comprises a plurality of wells, in which each well comprises a plurality of surface-coupled molecules 1620. Each molecule of the plurality of surface-coupled molecules comprises a reactive functional group 1625 that is configured to undergo a coupling reaction with a molecule or moiety of the patternable material 1610. FIG. 16B depicts a cross-sectional view of an array composition in which molecules of the plurality of surface-coupled molecules have coupled to molecules or moieties of the patternable material 1610, thereby forming adduct surface layers, in which the adduct surface layers comprise adducts 1622 of the molecules of the plurality of surface-coupled molecules 1620 and the patternable material 1610. Excess patternable material 1610 has been removed from the surface of the solid support, thereby providing a surface of the solid support 1600 comprising the adduct surface layers and the pluralities of surface-coupled molecules. FIGS. 16C-16D depict the same array compositions as FIGS. 16A-16B viewed from a top-down orientation. FIG. 16C depicts a solid support 1600 with a patternable material 1610 disposed on a surface of the solid support 1600. The patternable material 1610 comprises a plurality of substantially circular wells, in which each well comprises a plurality of surface-coupled molecules 1620. FIG. 16D depicts a cross-sectional view of an array composition in which molecules of the plurality of surface-coupled molecules have coupled to molecules or moieties of the patternable material 1610, thereby forming adduct surface layers that surround at least a portion of a perimeter of each region comprising a plurality of surface-coupled molecules, in which the adduct surface layers comprises adducts 1622 of the molecules of the plurality of surface-coupled molecules 1620 and the patternable material 1610.

An adduct surface layer comprising an adduct of a molecule or moiety of a patternable material and a surface-coupled molecule may have an increased likelihood of forming an orthogonal binding interaction. In some cases, an adduct surface layer may have an increased likelihood of binding two or more analytes at an analyte binding site. In some cases, an adduct surface layer may have an increased likelihood of binding an affinity agent or other assay reagent. In some cases, an adduct surface layer may increase an average characteristic dimension (e.g., diameter, length, width, area, etc.) of an analyte binding site. In some cases, an adduct surface layer may decrease a quantity of molecules for coupling an analyte at an analyte binding site due to reaction of the molecules during the adduct surface layer formation reaction.

An adduct surface layer may form in the presence of a medium that is configured to facilitate an adduct surface layer formation reaction. An adduct surface layer may form in the presence of a fluidic medium that is configured to facilitate an adduct surface layer formation reaction. A medium that facilitates formation of an adduct surface layer may be introduced at any conceivable step of an array formation process, including a rinsing step of a solid support and/or a surface layer attached thereto, or a separating step that separates a patternable material from a surface of the solid support. A medium that facilitates formation of an adduct surface layer may comprise a species that catalyzes formation of an adduct surface layer (e.g., a cationic species, an anionic species, an acid, a base, etc.). A medium that facilitates formation of an adduct surface layer may comprise an aqueous medium, non-aqueous medium, organic solvent, polar solvent, or non-polar solvent.

An adduct surface layer may occur where an interface is formed between an exposed surface of a patternable material and reactive molecules such as surface-coupled molecules. In some array formation processes described herein, such an interface can occur in each well or depression formed in a patternable material, such as by a lithographic process. Accordingly, an adduct surface layer may form concentrically or semi-concentrically around a surface layer that is formed in such a well or depression, for example due to covalent interactions between the patternable material and molecules deposited in a surface layer formed in the well or depression. Adduct layers can be characterized by a suitable surface analysis technique provided the analysis technique is capable of providing a resolution that matches the feature size of the surface adduct layer. Techniques such as electron microscopy or atomic force microscopy may be especially useful for characterizing adduct layers. In some cases, such an analytical technique can be utilized to identify optimal processing conditions to minimize or maximize formation of an adduct layer.

An adduct layer may be characterized by an average height or thickness relative to a surface of a solid support on which the adduct layer is disposed. Alternatively or additionally, an adduct layer may be characterized by an average width. An adduct layer may have an average height, thickness, or width of at least about 1 nanometer (nm), 2 nm, 3 nm, 4 nm, 5 nm, 6 nm, 7 nm, 8 nm, 9 nm, 10 nm, 15 nm, 20 nm, 30 nm, 40 nm, 50 nm, or more than 50 nm. Alternatively or additionally, an adduct layer may have an average height, thickness, or width of no more than about 50 nm, 40 nm, 30 nm, 20 nm, 15 nm, 10 nm, 9 nm, 8 nm, 7 nm, 6 nm, 5 nm, 4 nm, 3 nm, 2 nm, 1 nm, or less than 1 nm. In some cases, an adduct layer may have an average height or thickness, in which the adduct layer average height or thickness is greater than an average thickness or height of a surface layer that the adduct surface layer partially or completely surrounds (e.g., a binding site). In some cases, it may be preferable to minimize a difference in average height or thickness between an adduct surface layer and a surface layer that the adduct surface layer partially or completely surrounds. For example, an adduct surface layer may have an average thickness or height that is no more than about 10 nm, 9 nm, 8 nm, 7 nm, 6 nm, 5 nm, 4 nm, 3 nm, 2 nm, 1 nm, or less than 1 nm higher than an average thickness or height of a surface layer that the surface adduct layer partially or completely surrounds.

In cases of single-analyte array systems where an adduct surface layer is demonstrated to cause orthogonal binding phenomena, it may be advantageous to inhibit formation of the adduct surface layer during an array formation process. Provided herein are methods for inhibiting formation of adduct surface layers formed by cross-reactivity between patternable materials and surface-coupled molecules or moieties. In an aspect, provided herein is a method, comprising: a) providing a solid support comprising a surface, in which a surface layer (e.g., a patternable material) is disposed on the surface, in which the surface layer comprises a well, and in which a portion of the surface of the solid support is exposed in the well, b) contacting the surface layer with an organic polar solvent (e.g., an aprotic organic polar solvent, a protic organic polar solvent), in which the organic polar solvent comprises a plurality of competitive reactants (e.g., surfactant molecules), c) after contacting the surface layer with the organic aprotic solvent, forming an admixture of the plurality of competitive reactants and the surface layer, d) coupling a plurality of molecules to the portion of the solid support, in which the plurality of molecules comprises a plurality of reactive functional groups, and e) removing from the solid support at least a fraction of the admixture comprising the surface layer and the plurality of competitive reactants.

Disclosed herein are additional array preparation methods or steps thereof that may inhibit formation of an adduct surface layer. A method may comprise one or more steps that reduce the cross-reactivity of a patternable material or inhibit a cross-reaction between the patternable material and a molecule of a surface layer. Steps of a method that may inhibit formation of an adduct surface layer can include one or more of: 1) performing a hard baking or soft baking process at a reduced temperature; 2) performing a hard baking or soft baking process for a reduced amount of time; 3) equilibrating a solid support in a plasma treatment oven at a reduced oven temperature; 4) equilibrating a solid support in a plasma treatment oven for a reduced amount of time; 5) performing a plasma treatment process on a solid support for a minimal amount of time; 6) contacting the patternable material with a competitive reactant after a plasma treatment process; 7) minimizing storage time between processing steps; 8) storing plasma-treated solid supports under a controlled gas atmosphere or vacuum; 9) reducing the gas pressure or concentration of surface molecules contacted to the patterned solid support; 10) utilizing a solvent composition, as set forth herein, to form a surface layer in a well or depression of the patternable material, and 11) stripping the patternable material utilizing a stripping solution comprising a surfactant species.

In an aspect, provided herein is a method, comprising: a) exposing a substrate to a plasma, in which the substrate comprises a solid support and a layer of a resist material disposed on a surface of the solid support, and in which the layer of the resist material comprises a plurality of depressions, in which each individual depression of the plurality of depression comprises an exposed region of the surface of the solid support, b) binding a plurality of molecules to each individual exposed region of the surface of the solid support in each individual depression of the plurality of depressions, in which molecules of the plurality of molecules comprise reactive functional groups that are not attached to the surface of the solid support, in which the binding occurs in the presence of a fluidic medium comprising water and a miscible solvent, and c) after binding the plurality of molecules to each individual exposed region of the surface of the solid support, removing the layer of the resist material from the surface of the solid support.

A molecule of a plurality of molecules that are attached to a surface of a solid support in a well or depression of a patternable material may comprise a reactive functional group. A molecule of a plurality of molecules that are attached to a surface of a solid support in a well or depression of a patternable material may comprise a molecular chain (e.g., a molecule having a continuous chain of at least about 10, 20, 30, 50, or more than 50 covalently-bonded atoms), in which the molecule comprises a reactive functional group as a terminal moiety. For example, a surface-coupled molecule may comprise a terminal primary amine functional group. Alternatively, a molecule of a plurality of molecules that are attached to a surface of a solid support in a well or depression of a patternable material may comprise a molecular chain, in which the molecule comprises a reactive functional group as a non-terminal moiety. For example, a surface-coupled molecule may comprise a secondary or tertiary amine functional group, or a sidechain comprising a primary amine functional group.

The reactivity of a patternable material toward a reactive functional group of a surface-coupled molecule may depend upon the chemical composition of the patternable material, the processing conditions of the patternable material (e.g., baking, plasma treatment, etc.), the deposition conditions of molecules during attachment to a surface of a solid support adjacent to the patternable material, and the chemical composition of the molecules that are attached to the surface of the solid support. In some cases, a patternable material may be reactive toward a surface-coupled molecule comprising a reactive functional group, in which the reactive functional group is a nucleophilic functional group (e.g., an amine, an azide, a nitrite, a hydroxylamine, an amide, a thiol, an alcohol, a carboxylate, an alkene, an alkyne, etc.). Alternatively, a patternable material may be reactive toward a surface-coupled molecule comprising a reactive functional group, in which the reactive functional group is an electrophilic functional group (e.g., an alkyl halide. an acyl halide, etc.). Cross-reactivity between a patternable material can be readily identified due to the formation of adduct surface layers adjacent to the perimeters of array sites. Such adduct surface layers are observable by methods such as atomic force microscopy or electron microscopy.

In some cases, a method of forming an array may further comprise contacting a patternable material or a solid support comprising the patternable material with a reactive agent, in which the contacting occurs after processing the patternable material (e.g., by baking, plasma treatment, etc.) and before removing the layer of the resist material. Optionally, contacting the patternable material of the solid support comprising the patternable material with a reactive agent may occur before molecules are attached to the surface of the solid support in wells or depressions within the patternable material. A reactive agent contacted with the patternable material may be a gas-phase reactive agent or a liquid-phase reactive agent. A reactive agent may be selected to contain a similar reactive functional group to a surface-coupled species that demonstrates cross-reactivity with a patternable material. For example, if a patternable material is observed to cross-react with surface-coupled molecules containing amine functional groups, the patternable material may be contacted with an amine-containing reactive agent that does not comprise a surface-attaching moiety. Reactive agents may become attached to the patternable material, thereby inhibiting an adduct-forming reaction between the patternable material and a surface-coupled molecule.

A surface layer (e.g., a patternable material) may be contacted with a fluidic medium that causes an increase or a decrease in a volume of the surface layer. In some cases, contacting a surface layer with a volume-altering fluidic medium may alter the volume and/or morphology of a well or well-like structure within the surface layer. A volume-altering fluidic medium may increase or decrease the volume of a well or well-like structure. For example, a volume-altering fluidic medium may facilitate swelling of a patternable material into a void volume of a well, thereby decreasing the void volume of the well. Without wishing to be bound by theory, a volume-altering fluidic medium may reduce intramolecular or intermolecular adhesion within molecules or moieties constituting a surface layer (e.g., a surface layer comprising a patternable material). After contacting a surface layer with a volume-altering fluidic medium, the surface layer may absorb a volume-altering fluidic medium or a constituent thereof. A volume change of a swelling surface layer may be proportional to a volume of a volume-altering fluidic medium that is absorbed by the surface layer. In some cases, a volume-altering fluidic medium may include an organic polar solvent. In particular cases, a volume-altering fluidic medium may further comprise a plurality of competitive reactants (e.g., surfactant molecules). For example, during the formation of an admixture comprising a patternable material and surfactant molecules, contacting the patternable material with a polar organic solvent comprising surfactant molecules may promote a volume change of the patternable material. In other cases, a volume-altering fluidic medium may not comprise a polar organic solvent.

Contact with a volume-altering medium may decrease reactivity of a resist material (e.g., reactivity due to chemical structure, reactivity due to alteration from a substrate processing step such as plasma treatment, etc.). Without wishing to be bound by theory, reduced reactivity of a resist material may arise due to decreased density of resist molecules or reactive sites thereon or introduction of quenching species that inhibit reactivity or provide reactive competitors. A volume-altering medium may be contacted with a substrate comprising a resist material for enough time to reduce resist reactivity, such as at least about 1 minute (min), 2 mins, 5 mins, 10 mins, 15 mins, 20 mins, 30 mins, 1 hour (hr), 3 hrs, 6 hrs, 12 hrs, 24 hrs, or more than 24 hrs. Alternatively or additionally, a volume-altering medium may be contacted with a substrate comprising a resist material for no more than about 24 hrs, 12 hrs, 6 hrs, 3 hrs, 1 hr, 30 mins, 20 mins, 15 mins, 10 mins, 5 mins, 2 mins, 1 min, or less than 1 min.

A method of forming an array on a surface of a solid support may comprise a step of contacting a surface layer, as set forth herein, (e.g., a patternable material) with a medium that inhibits cross-reactivity between the surface layer and molecules coupled to the surface of the solid support. A method of forming an array on a surface of a solid support may comprise a step of forming an admixture of molecules or moieties of a surface layer and a component of a cross-reactivity inhibiting medium (e.g., surfactant molecules). In some cases, a surface layer may be contacted with a cross-reactivity inhibiting medium and/or an admixture may be formed before a plurality of molecules have been coupled to an exposed portion of a surface of a solid support. In other cases, a surface layer may be contacted with a cross-reactivity inhibiting medium and/or an admixture may be formed after a plurality of molecules have been coupled to an exposed portion of a surface of a solid support.

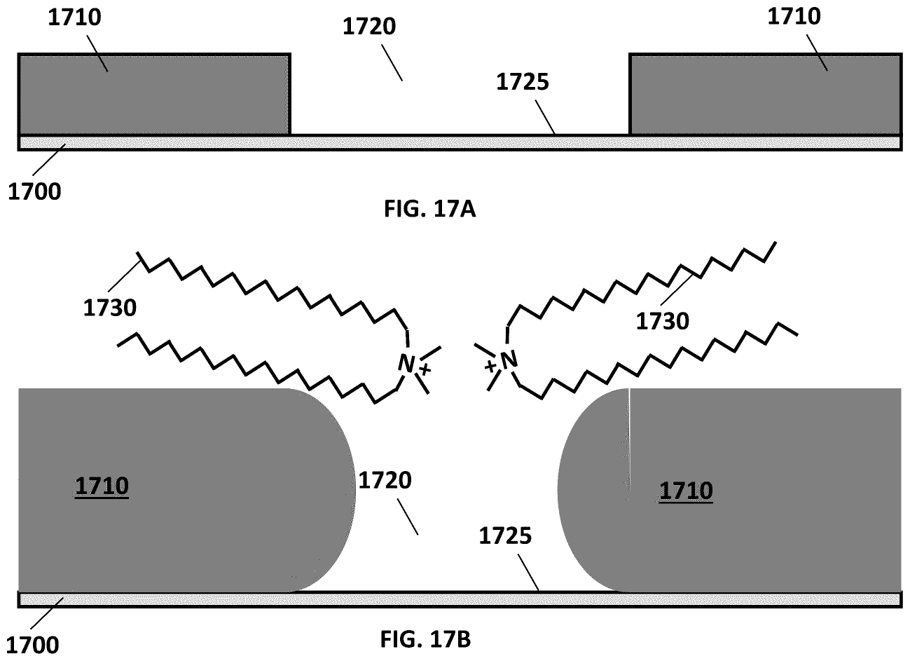

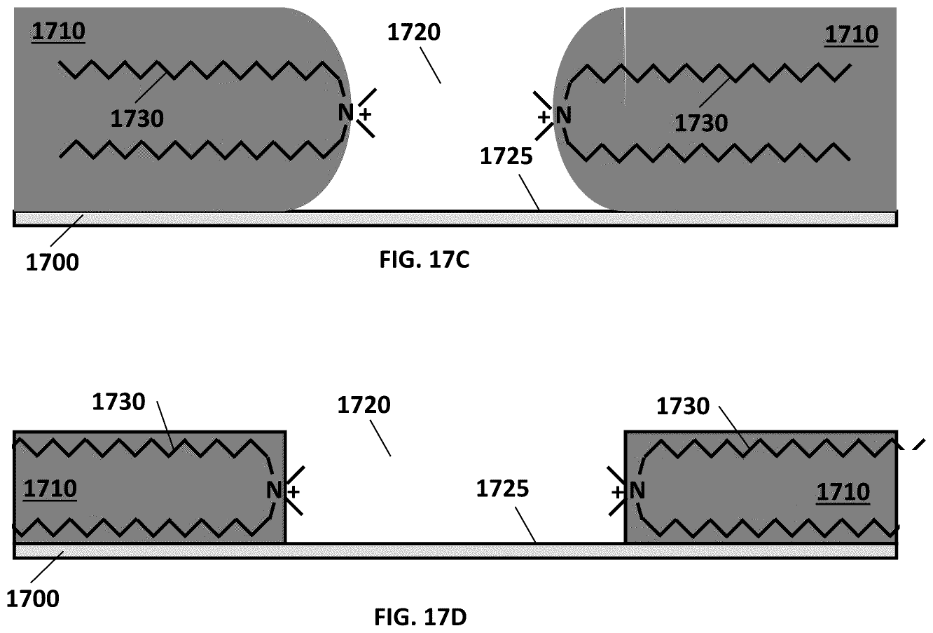

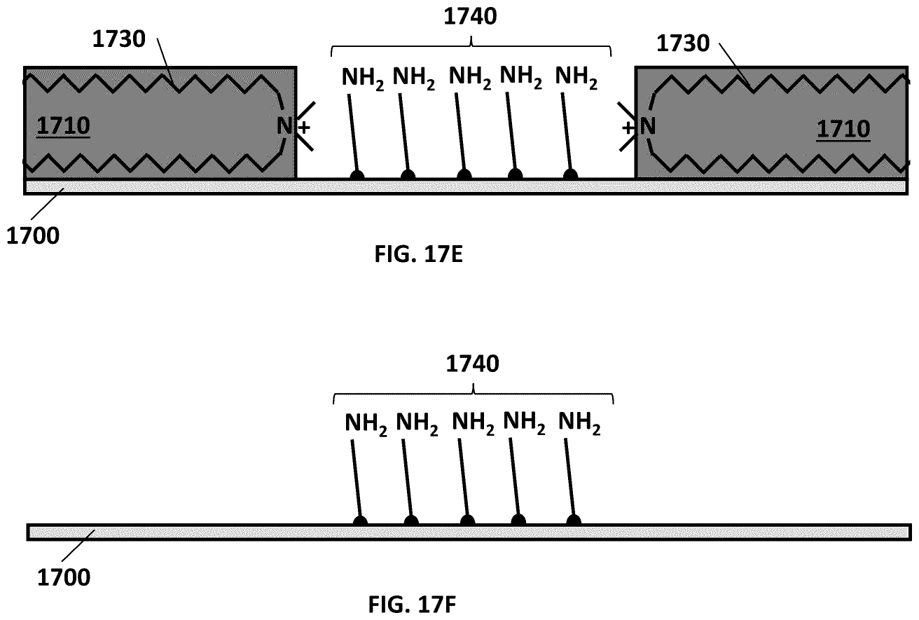

FIGS. 17A-17F illustrate a method of inhibiting cross-reactivity between a surface layer and a plurality of surface-coupled moieties or molecules during an array formation process. FIG. 17A depicts a cross-sectional view of a solid support 1700 comprising a surface layer comprising a patternable material 1710 that is disposed on the upper surface of the solid support 1700. A well 1720 has been formed within the surface layer, with a bottom of the well comprising an exposed portion 1725 of the upper surface of the solid support 1700. Optionally, the composition of FIG. 17A may be contacted with a volume-altering fluidic medium that alters the volume of the surface layer comprising the patternable material 1710. FIG. 17B depicts contacting the solid support and/or surface layer with a cross-reactivity inhibiting medium (e.g., an organic polar solvent) that comprises a plurality of surfactant molecules 1730. As shown in FIG. 17C, surfactant molecules 1730 are absorbed into the surface layer, thereby forming an admixture of the surfactant molecules 1730 and the patternable material 1710. FIG. 17D depicts an optional step in which the cross-reactivity inhibiting medium has been removed from contact with the solid support and/or surface layer, optionally altering a volume occupied by the admixture of surfactant molecules 1730 and patternable material 1710. FIG. 17E depicts an array composition formed after coupling a plurality of molecules 1740 to the exposed portion 1725 of the surface of the solid support 1700. FIG. 17F depicts an array composition after separating the admixture comprising the surfactant molecules 1730 and the patternable material 1710. The solid support 1700 comprises an analyte binding site comprising a plurality of surface-coupled molecules 1740. The presence of the surfactant molecules within the admixture may inhibit the cross-reactivity of molecules or moieties of the surface layer for the surface-coupled molecules or moieties, thereby inhibiting formation of an adduct surface layer adjacent to the analyte binding site.

A fluidic medium comprising surfactant molecules may be contacted with a resist material to reduce reactivity. In some cases, surfactant molecules may comprise secondary, tertiary, or quaternary amine surfactants. A surfactant molecule can comprise a hydrophobic tail that is configured to solubilize within a resist material. A fluidic medium comprising surfactants may be formulated with a sufficient surfactant concentration to increase. wettability of the fluidic medium in wells or well-like structures formed in a patterned resist material. Due to the hydrophobic nature of many resist materials, an aqueous medium may poor wet wells or well-like structures in the resist material. Accordingly, a presence of surfactant molecules may increase a likelihood that photoresist materials that bound a surface of a well or well-like structure become wetted when contacted with a fluidic medium, as set forth herein

After contacting a surface layer (e.g., a patternable material) with a medium comprising a plurality of competitive reactants, an admixture comprising molecules or moieties of the surface layer and the plurality of competitive reactants may be formed. In some cases, an admixture comprising molecules or moieties of the surface layer and the plurality of competitive reactants may be substantially homogeneous, spatially and/or compositionally. In other cases, an admixture comprising molecules or moieties of the surface layer and the plurality of competitive reactants may be heterogeneous, spatially and/or compositionally. For example, an admixture comprising molecules or moieties of the surface layer and the plurality of competitive reactants may form preferentially in or near portions of a surface layer that are directly contacted with a medium comprising the competitive reactants (e.g., exposed surfaces of the surface layer, surfaces of a surface layer adjacent to a well, etc.). In some cases, an admixture comprising molecules or moieties of the surface layer and the plurality of competitive reactants may be formed adjacent to a plurality of surface-coupled molecules or moieties.

A fluidic medium, such as a volume-altering medium or a medium comprising a plurality of competitive reactants, may comprise a polar solvent. A selected solvent may be a protic solvent or an aprotic solvent. In some cases, a fluidic medium may comprise a polar organic solvent. A fluidic medium may comprise an aqueous medium that further comprises an organic polar solvent. An organic solvent may be provided to an aqueous medium at a concentration that is fully or partially miscible with water. Exemplary organic polar solvents may include acetic acid, acetone, acetonitrile, acetyl acetone, 2-aminoethanol, aniline, anisole, benzonitrile, benzyl alcohol, butanol, butanone, chlorobenzene, chloroform, cyclohexanol, cyclohexanone, diethylene glycol, diglyme, dimethoxyethane, N,N-dimethylaniline, dimethylformamide, dimethylphthalate, dimethyl sulfoxide, dioxane, ethanol, ethyl acetate, ethyl benzoate, ethylene glycol, glycerin, heptanol, hexanol, methanol, methyl acetate, methylene chloride, octanol, pentanol, propanol, pyridine, tetrahydrofuran, or combinations thereof.

An admixture comprising molecules or moieties of a surface layer (e.g., a patternable material) and a plurality of competitive reactants may be formed on an array composition comprising a plurality of surface-coupled molecules or moieties, in which the surface-coupled molecules or moieties comprise reactive functional groups. A method of array formation may further comprise one or more steps or processes that can facilitate coupling reactions between molecules or moieties of a surface layer and competitive reactants or reactive functional groups of surface-coupled molecules or moieties. In some cases, coupling reactions between molecules or moieties of a surface layer and competitive reactants or reactive functional groups of surface-coupled molecules or moieties may be facilitated by a fluidic medium (e.g., a rinsing medium, a quenching medium, a surface layer dissolution medium, etc.). A method may further comprise reacting competitive reactants with a set of molecules or moieties of a surface layer (e.g., a patternable material). A method may further comprise reacting a reactive functional group of a competitive reactant with a molecule or moiety of a surface layer (e.g., a patternable material). A method may further comprise reacting a competitive reactant with a molecule or moiety of a surface layer adjacent to a surface-coupled molecule or moiety, as set forth herein. For example, a competitive reactant may react with a molecule of a patternable material at an edge or sidewall of a well in the patternable material, thereby preventing a reactive functional group of a surface-coupled molecule from reacting with the molecule of the patternable material. In some cases, reacting of a competitive reactant can occur adjacent to a portion of a solid support that is exposed in a well. In some cases, reacting of a competitive reactant can occur adjacent to sidewall of a well.

Presence of a competitive reactant in an admixture comprising the competitive reactant and molecules or moieties of a surface layer may inhibit coupling reactions surface-coupled molecules or moieties with molecules or moieties of the surface layer. Coupling reactions of competitive reactants with molecules or moieties of a surface layer may occur in a molar ratio to coupling reactions of surface-coupled molecules or moieties with molecules or moieties of a surface layer, such as a molar ratio of at least about 1, 1.1, 1.5, 2, 3, 4, 5, 10, 15, 20, 25, 30, 40, 50, 100, 500, 1000, 10000, 100000, 1000000, or more than 1000000. Alternatively or additionally, coupling reactions of competitive reactants with molecules or moieties of a surface layer may occur in a molar ratio to coupling reactions of surface-coupled molecules or moieties with molecules or moieties of a surface layer, such as a molar ratio of no more than about 1000000, 100000, 10000, 1000, 500, 100, 50, 40, 30, 25, 20, 15, 10, 5, 4, 3, 2, 1.5, 1.1, 1, or less than 1.

A method of array formation may comprise a step of separating a surface layer (e.g., a patternable material) from a surface of a solid support. In some cases, separation of a surface layer may comprise separating an admixture comprising molecules or moieties of the surface layer from a surface of a solid support. Separation of a surface layer from a surface of a solid support may occur in the presence of a dissolution medium that is configured to separate the surface layer from the surface of the solid support. A method may comprise a step of removing from the solid support at least a fraction of an admixture, in which removing the admixture from the solid support comprises contacting the surface layer (e.g., patternable material) with a dissolution medium, in which the dissolution medium comprises a solubility for molecules or moieties of the surface layer and competitive reactants. In some cases, a coupling reaction of molecules or moieties of a surface layer with competitive reactants or surface-coupling moieties may occur in the presence of a dissolution medium.

In some cases, a method of array formation may comprise rinsing a dissolution medium, as set forth herein, from a solid support. Optionally, rinsing a dissolution medium may be repeated. In some cases, a method of array formation may comprise rinsing a cross-reactivity inhibiting medium, as set forth herein, from a solid support. Optionally, rinsing a cross-reactivity medium may be repeated.

In some cases, it may be preferred to facilitate formation of an adduct surface layer, as set forth herein. For example, incorporation of energy-absorbing materials (e.g., photolabile compounds, photoisomerization compounds, thermal conductors, etc.) into adduct surface layers can provide energy sinks on an array surface. Provided herein are methods of providing adduct surface layers comprising energy-absorbing materials by coupling molecules or moieties of a surface layer (e.g., patternable material) to surface-coupled molecules or moieties. In an aspect, provided herein is a method, comprising: a) providing a solid support comprising a surface, in which a surface layer (e.g., a patternable material) is disposed on the surface, in which the surface layer comprises a well, and in which a portion of the surface of the solid support is exposed in the well, b) forming an admixture of a plurality of protectant moieties (e.g., photoactive molecules, thermally-conductive particles, oxidation inhibitors, radical scavengers, etc.) and the surface layer, c) coupling a plurality of molecules to the portion of the solid support, and d) after coupling the plurality of molecules to the portion of the solid support, forming an adduct surface layer adjacent to the portion of the solid support, in which the adduct surface layer is disposed on the surface, in which the adduct surface layer comprises a molecule of the plurality of molecules coupled to a molecule of the surface layer, and in which the adduct surface layer further comprises protectant moieties of the plurality of protectant moieties.

An admixture comprising molecules or moieties of a surface layer (e.g., a patternable material) and protectant moieties may be formed on a surface of a solid support. Forming an admixture comprising molecules or moieties of a surface layer and protectant moieties may comprise one or more steps of: i) contacting a surface layer comprising molecules or moieties with a protectant medium, in which the protectant medium comprises a plurality of protectant moieties, ii) absorbing protectant moieties of the plurality of protectant moieties into the surface layer, and iii) optionally rinsing the protectant medium from the solid support. In some cases, a protectant medium may comprise a volume-altering fluidic medium, as set forth herein. In some cases, a protectant medium may comprise an organic polar solvent, as set forth herein.

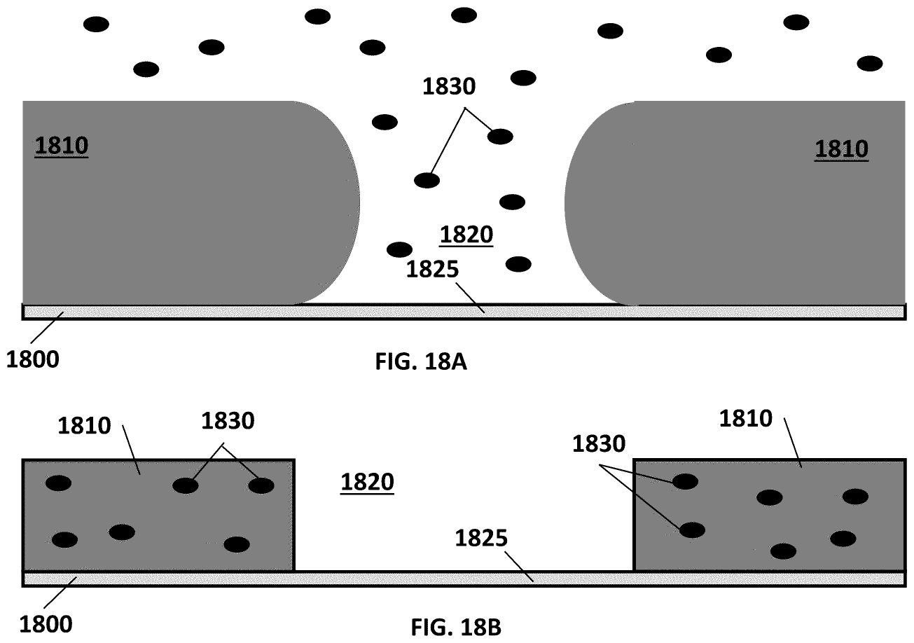

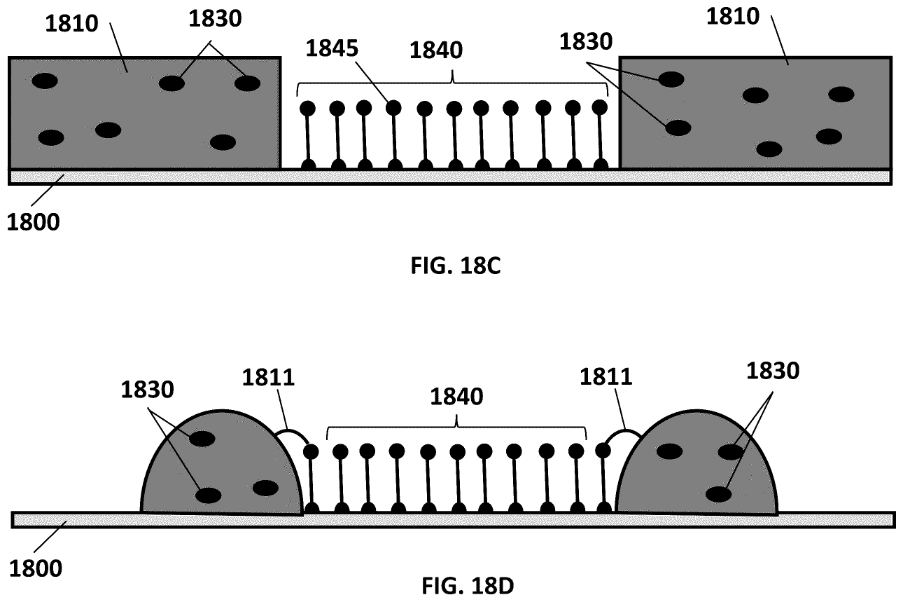

FIGS. 18A-18D depict cross-sectional views of array compositions during a process of forming a single-analyte array comprising adduct surface layers. FIG. 18A depicts a solid support 1800 comprising a patternable material 1810 that is disposed on a top surface of the solid support 1800. The patternable material comprises a well 1820 with a bottom surface formed by an exposed portion 1825 of the surface of the solid support 1800. The composition is contacted by a protectant medium (e.g., a fluidic medium) comprising protectant moieties 1830. FIG. 18B depicts an array composition after the array has been contacted with the protectant medium. Protectant moieties have been absorbed by the patternable material 1810 to form an admixture comprising molecules or moieties of the patternable material 1810 and protectant moieties 1830. FIG. 18C depicts an array composition after a plurality of molecules 1840 have been coupled to the exposed portion 1825 of the surface of the solid support 1800. The plurality of molecules comprises reactive functional groups 1845 that are configured to react with molecules or moieties of the patternable material 1810. Optionally, the plurality of molecules 1840 may be coupled to the surface before an admixture comprising protectant moieties 1830 is formed with the patternable material 1810. FIG. 18D depicts an array composition after at least a portion of the patternable material 1810 has been separated from the surface of the solid support 1800 (e.g., separated by a dissolution medium). An adduct surface layer is formed adjacent to the plurality of molecules 1840, in which the adduct surface layer comprises protectant moieties 1830 and adducts 1811 formed by coupling of surface-coupled molecules to molecules or moieties of the patternable material 1810.

### Passivated Array Compositions

Provided herein are single-analyte array compositions comprising advantageous surface chemistries for inhibiting orthogonal binding phenomena. The arrays may contain discrete sites that are configured to couple single analytes and one or more interstitial regions that separate sites from each other. In some configurations, the sites of a single-analyte array may comprise a surface chemistry that differs from a surface chemistry of an interstitial region. For example, an interstitial region of a single-analyte array may comprise no moieties that are configured to couple a single analyte, and each analyte-binding site may comprise at least one moiety that is configured to couple a single analyte at the analyte-binding site. In some configurations, the sites of a single-analyte array may comprise a similar surface chemistry to the surface chemistry of an interstitial region. For example, an analyte-binding site may comprise a mixture of analyte-coupling moieties and passivating moieties, while an interstitial region may comprise passivating moieties without analyte-coupling moieties.

Of particular interest are array compositions that provide surface chemistries that mediate interactions of unbound moieties with at least one surface of an array. Preferably, a surface of a single-analyte array will selectively bind analytes, and optionally other particular reagents, at analyte-binding sites, and will inhibit binding of unbound moieties (optionally including analytes and other particular reagents) at interstitial regions of the array. An array composition may comprise a solid support comprising one or more surfaces, and a layer disposed upon or adjacent to a surface of the one or more surfaces, in which the layer is configured to inhibit the binding of unbound moieties that are contacted to the surface of the one or more surfaces. In some configurations, a layer disposed upon or adjacent to a surface of a solid support may comprise a plurality of molecules, in which one or more molecules of the plurality of molecules are configured to inhibit binding of an unbound moiety. In particular configurations, a layer disposed upon or adjacent to a surface of a solid support may comprise a plurality of molecules, in which the layer further comprises a plurality of defects, and in which the layer further comprises one or more molecules that are coupled to a defect of the plurality of defects.

In an aspect, provided herein is a composition, comprising: a) a solid support, in which the solid support comprises: i) a plurality of sites, in which each site is couple to one and only one analyte, and ii) one or more interstitial regions, in which each site of the plurality of sites is spatially separated from other sites of the plurality of sites by an interstitial region of the one or more interstitial regions, b) a first plurality of molecules, in which the first plurality of molecules is coupled to the one or more interstitial regions, and in which each molecule of the first plurality of molecules comprises a moiety that is configured to inhibit binding of an assay agent, c) a plurality of defects occurring in a random spatial distribution on the one or more interstitial regions, and in which each defect of the plurality of defects comprises a moiety that is configured to bind the assay agent, d) a second plurality of molecules bound to the plurality of defects, and e) a plurality of assay agents coupled to the solid support, in which less than about 10%, 5%, 1%, 0.5%, 0.1%, 0.05%, 0.01%, 0.005%, or 0.001%, of the plurality of assay agents are coupled to the one or more interstitial regions of the solid support. A method, as set forth herein, may sufficiently passivate defects on an array surface such that only a fraction of assay agents may become bound to an unintended address of the array.

In another aspect, provided herein is a composition, comprising: a) a solid support, in which the solid support comprises: i) a plurality of sites, in which each site is coupled to one and only one analyte, and ii) one or more interstitial regions, in which each site of the plurality of sites is spatially separated from other sites of the plurality of sites by an interstitial region of the one or more interstitial regions, b) a first plurality of molecules, in which the first plurality of molecules is coupled to the one or more interstitial regions, and in which each molecule of the first plurality of molecules comprises a first moiety that is configured to inhibit binding of a detection agent, c) a second plurality of molecules occurring in a random spatial distribution on the one or more interstitial regions, in which each molecule of the second plurality of molecules comprises a dissimilar chemical structure to each molecule of the first plurality of molecules, and in which each molecule of the second plurality of molecules is configured to inhibit binding of the detection agent, d) a plurality of defects, in which each defect is configured to bind the assay agent, in which the plurality of defects comprises a random spatial distribution on the one or more interstitial regions, and in which the plurality of defects comprises a subset of defects comprising no more than about 25%, 20%, 10%, 5%, 1%, 0.5%, 0.1%, 0.05%, or 0.01%, of defects of the plurality of defects, in which each defect of the subset of defects is spatially non-resolvable from at least one site of the plurality of sites, and e) a plurality of detection agents coupled to the solid support, in which the plurality of detection agents is coupled to the subset of defects. A method, as set forth herein, may sufficiently passivate a fraction of available defects on an array such that a limited number of defects affect an assay result at sites of the array. For example, no more than about 0.1%, 1%, 5%, 10%, 20%, or 25% of sites may have an adjacent non-passivated defect, such that binding of an assay agent (e.g., an analyte, a detection agent) to the defect causes a detectable signal from the defect (i.e., a false positive) that is spatially non-resolvable from a detectable signal from the site (i.e., a true positive).

In another aspect provided herein is a composition, comprising: a) a solid support, in which the solid support comprises: i) a plurality of sites, in which each site comprises one and only one analyte, and ii) one or more interstitial regions, in which each site of the plurality of sites is spatially separated from other sites of the plurality of sites by an interstitial region of the one or more interstitial regions, b) a passivating layer, in which the passivating layer is coupled to the one or more interstitial regions, in which the passivating layer is configured to inhibit binding of an assay agent, in which the passivating layer comprises a first plurality of passivating molecules and a second plurality of passivating molecules, in which a first passivating molecule of the first plurality of passivating molecules is chemically dissimilar to a second passivating molecule of the second plurality of passivating molecules, and in which the second plurality of passivating molecules occurs in a first random spatial distribution, c) a plurality of defects, in which each defect is configured to bind an assay agent, and in which the plurality of defects occurs in a second random spatial distribution on the one or more interstitial regions, and d) a plurality of assay agents bound to the plurality of defects.

In another aspect, provided herein is an array, comprising: a) a solid support comprising a surface, b) a plurality of discrete regions on the surface of the solid support, in which each discrete region comprises a plurality of molecules coupled to the surface of the solid support, and c) one or more interstitial regions, in which each individual discrete region of the plurality of discrete regions is separated from each other discrete region by an interstitial region of the one or more interstitial regions, in which the plurality of molecules comprises a plurality of passivating molecules and a plurality of coupling molecules, in which a ratio of a quantity of the plurality of passivating molecules to a quantity of the plurality of coupling molecules is at least 2:1, and in which the one or more interstitial regions comprise a layer disposed on the surface of the solid support, in which the layer comprises a hydrophobic material.

An array may comprise a plurality of discrete regions (e.g., array sites). A discrete region may have a characteristic dimension (e.g., width, length, diameter) of at least about 10 nanometers (nm), 20 nm, 50 nm, 100 nm, 120 nm, 150 nm, 200 nm, 500 nm, 1 micron (μm), or more than 1 μm. Alternatively or additionally, a discrete region may have a characteristic dimension of no more than about 1 μm, 500 nm, 200 nm, 120 nm, 150 nm, 100 nm, 50 nm, 20 nm, 10 nm, or less than 10 nm. A discrete region may have a characteristic surface area of at least about 1×10² square nanometers (nm²), 1×10³ nm², 1×10⁴ nm², 2×10⁴ nm², 5×10⁴ nm², 1×10⁵ nm², 5×10⁵ nm², 1×10⁶ nm², or more than 1×10⁶ nm². Alternatively or additionally, a discrete region may have a characteristic surface area of no more than about 1×10⁶ nm², 5×10⁵ nm², 1×10⁵ nm², 5×10⁴ nm², 2×10⁴ nm², 1×10⁴ nm², 1×10³ nm², 1×10² nm², or less than 1×10² nm². An array may have an average pitch or inter-site spacing of at least about 10 nm, 50 nm, 100 nm, 200 nm, 500 nm, 1 μm, 2 μm, or more than 2 μm. Alternatively or additionally, an array may have an average pitch or inter-site spacing of no more than about 2 μm, 1 μm, 500 nm, 200 nm, 100 nm, 50 nm, 10 nm, or less than 10 nm.

An interstitial region of an array may comprise a surface layer that is configured to inhibit binding of an assay agent to the interstitial region. The surface layer may have a net chemical characteristic, such as hydrophobicity or hydrophilicity. Accordingly, a surface layer may comprise a hydrophobic material (e.g., an adhesion promoter such as a silane or titanate) or a hydrophilic material (e.g., PEG, dextrans). In some cases, an interstitial region may comprise hexamethyldisilazane (HMDS). In some cases, it may be preferable to provide a surface layer with longer alkyl groups (e.g., ethyl, propyl, butyl groups, etc.). A suitable surface layer for an interstitial region may depend upon an assay agent that will be contacted with the interstitial region. An optimal surface layer may be characterized by a contact angle measurement. An array may have a contact angle measurement of at least about 1°, 5°, 10°, 15°, 20°, 25°, 30°, 35°, 40°, 45°, 50°, 55°, 60°, 65°, 70°, 75°, 80°, 85°, or more than 85°. Alternatively or additionally, an array may have a contact angle measurement of no more than about 85°, 80°, 75°, 70°, 65°, 60°, 55°, 50°, 45°, 40°, 35°, 30°, 25°, 20°, 15°, 10°, 5°, 1°, or less than 1°. In some cases, a suitable surface layer may have a contact angle measurement that is not fully hydrophobic or hydrophilic. For example, a suitable surface layer may have a contact angle measurement in a range between about 30° and about 60°, between about 40° and about 60°, between about 50° and about 60°, between about 30° and about 50°, between about 40° and about 60°, between about 35° and about 55°, or between about 45° and about 55°.

An array may further comprise a nanoparticle (e.g., an anchoring moiety, a nucleic acid nanoparticle) that is coupled to a discrete region. An array may further comprise a nanoparticle that comprises a coupling moiety, in which the nanoparticle is coupled to the array by binding of the coupling moiety of the nanoparticle to a coupling moiety of a plurality of coupling moieties of a discrete region of the plurality of discrete regions. Suitable coupling moieties can include oligonucleotides, components of a ligand-receptor binding pair, or covalent coupling moieties (e.g., Click-type reactants). In some cases, a coupling moiety of an individual nanoparticle of a plurality of nanoparticles comprises an oligonucleotide, in which the oligonucleotide of the individual nanoparticle is hybridized to an oligonucleotide of a plurality of oligonucleotides of the discrete region of the plurality of discrete regions. In some cases, an individual nanoparticle is coupled to the array by binding of two or more coupling moieties of the nanoparticle to coupling moieties of the plurality of coupling moieties of the discrete region of the plurality of discrete regions.

In some cases, an array may comprise a plurality of nanoparticles coupled to the discrete regions of the solid support. In some cases, a nanoparticle may comprise an anchoring moiety, an analyte, or an analyte attached to an anchoring moiety. An array may comprise a plurality of discrete regions, in which at least one nanoparticle is coupled to at least about 5%, 10%, 20%, 30%, 40%, 50%, 60%, 70%, 80%, 90%, 95%, or more than 95% of the discrete regions of the plurality of discrete regions. Alternatively or additionally, an array may comprise a plurality of discrete regions, in which at least one nanoparticle is coupled to no more than about 95%, 90%, 80%, 70%, 60%, 50%, 40%, 30%, 20%, 10%, 5%, or less than 5% of the discrete regions of the plurality of discrete regions. An array may comprise a plurality of discrete regions, in which one and only one nanoparticle is coupled to at least about 5%, 10%, 20%, 30%, 40%, 50%, 60%, 70%, 80%, 90%, 95%, or more than 95% of the discrete regions of the plurality of discrete regions. Alternatively or additionally, an array may comprise a plurality of discrete regions, in which one and only one nanoparticle is coupled to no more than about 95%, 90%, 80%, 70%, 60%, 50%, 40%, 30%, 20%, 10%, 5%, or less than 5% of the discrete regions of the plurality of discrete regions.

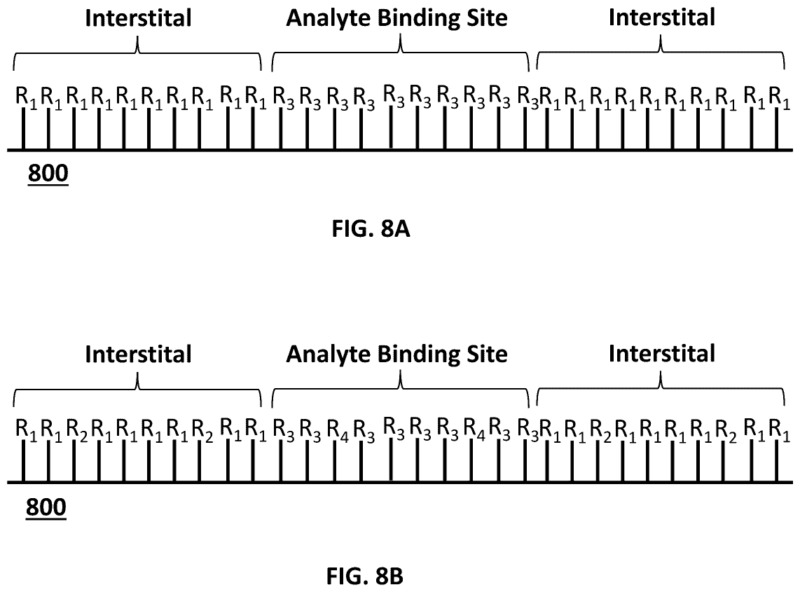

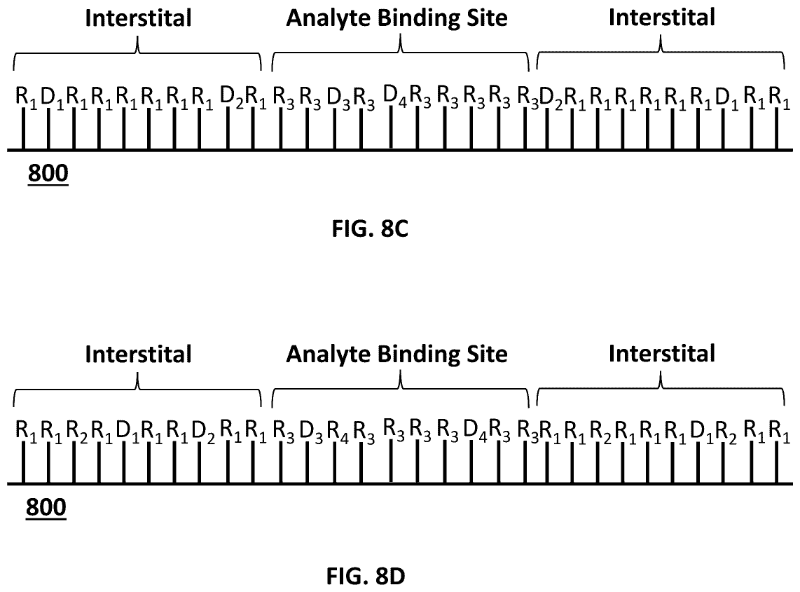

FIGS. 8A-8D illustrate single-analyte array compositions that may occur during an array formation process, as set forth herein. FIGS. 8A-8B depict idealized single-analyte arrays that do not comprise any identifiable defects, as set forth herein. FIG. 8A depicts a solid support 800 comprising interstitial regions and an analyte binding site, with the interstitial regions comprising a differing surface chemistry from that of the analyte binding site. Both interstitial regions contain a substantially uniform surface layer of surface-coupled moieties R1, and the analyte binding site comprises a substantially uniform layer of surface-coupled moieties R3. FIG. 8B depicts a more complex version of the single-analyte array depicted in FIG. 8A. FIG. 8B depicts a solid support 800 comprising interstitial regions and an analyte binding site, with the interstitial regions comprising a differing surface chemistry from that of the analyte binding site. Both interstitial regions contain a chemically-mixed surface layer of surface-coupled moieties R1 and R2, and the analyte binding site comprises a chemically-mixed layer of surface-coupled moieties R3 and R4. FIGS. 8C-8D depict non-idealized single-analyte arrays that comprise defects. FIG. 8C depicts a single-analyte array with a similar surface chemistry to that of the single-analyte array depicted in FIG. 8A. The interstitial regions contain more than one type of defect (D1 and D2) and the analyte binding site contains more than one type of defect (D3 and D4). FIG. 8D depicts a single-analyte array with a similar surface chemistry to that of the single-analyte array depicted in FIG. 8B. The interstitial regions contain more than one type of defect (D1 and D2) and the analyte binding site contains more than one type of defect (D3 and D4). It will be recognized that, in some cases, distribution of defects may be spatially and/or chemically homogeneous or heterogeneous.

A single-analyte array composition, as set forth herein, may comprise a solid support containing a surface, in which the surface may comprise one or more of: i) a site that is configured to couple an analyte, and ii) an interstitial region that is configured to inhibit binding of an analyte or assay agent. A surface of a solid support may comprise a layer that is disposed upon the surface (e.g., an organic layer, a non-organic layer). A layer disposed upon a surface may be attached to a surface by one or more covalent bonds. A layer disposed upon a surface may be adhered to a surface by a non-covalent interaction, such as an electrostatic interaction or a magnetic interaction. A layer disposed upon a surface may comprise a passivating layer, in which the passivating layer is configured to inhibit binding of an assay agent. For example, an interstitial region of a single-analyte array may comprise a passivating layer that prevents binding of an analyte or assay agent to the interstitial region. A layer disposed upon a surface may comprise a coupling layer, in which the coupling layer is configured to couple an analyte to the surface. In some configurations, a coupling layer may comprise a plurality of molecules, in which a first molecule of the plurality of molecules comprises a passivating moiety, and in which a second molecule of the plurality of molecules comprises a coupling moiety that is configured to couple an analyte to the coupling layer. In a particular configuration, a coupling layer may comprise a molecule, in which the molecule comprises a passivating moiety and a coupling moiety.

Accordingly, a single-analyte array, as set forth herein, may comprise a solid support comprising two or more layers, in which a first region of the array (e.g., an interstitial region) comprises a first solvent-exposed layer, and in which a second region (e.g., a site that is configured to bind an analyte) of the array comprises a second solvent-exposed layer, and in which the chemical composition of the first solvent-exposed layer differs from the chemical composition of the second solvent-exposed layer. For example, a single-analyte array may comprise one or more interstitial regions and a plurality of sites, in which the one or more interstitial regions comprise a solvent-exposed passivating layer that comprises substantially only passivating molecules, and in which the plurality of sites comprises a solvent-exposed coupling layer, in which the coupling layer comprises a compositionally-heterogeneous mixture of coupling molecules and passivating molecules.

A composition may comprise an assay agent, as set forth herein. An assay agent may be contacted with a single-analyte array at any point in time during a single-analyte assay or process. In some cases, an assay agent may comprise a fluidic medium that is contacted with a single-analyte array. In some configurations, an assay agent may be solvated, suspended, or otherwise contained within a fluidic medium that is contacted with a single-analyte array. An unbound assay agent, when contacted with a single-analyte array or a surface thereof, may become bound to the single-analyte array or the surface thereof. A single-analyte array, as set forth herein, may be formed with an intention of facilitating a specific binding interaction between an assay agent and a binding partner of the assay agent. For example, an assay agent comprising an antibody may become specifically bound to an antigen of the antibody if the antigen is present on a single-analyte array. In another example, an anion may become bound to an array surface comprising positively-charged functional groups (e.g., amines). A single-analyte array, as set forth herein, may comprise a defect that forms an orthogonal binding interaction with an assay agent.

An assay agent may comprise any suitable molecule, particle, moiety, or material that may be utilized during a single-analyte assay or process. An assay agent may comprise a molecule, particle, moiety, or material that is utilized during a reactive process (e.g., a synthesis, degradation, or conversion process). An assay agent may comprise a molecule, particle, moiety, or material that is utilized during a binding interaction process. For example, a single-analyte array containing a plurality of analytes may be contacted with an affinity agent that is configured to bind to at least one analyte of the plurality of analytes. An assay agent may comprise a molecule, particle, moiety, or material that is utilized during a single-analyte detection process, such as a detectable label (e.g., a fluorophore, luminophore, radiolabel, nucleic acid tag, or peptide tag) or a detection fluid. An assay agent may comprise a molecule, particle, moiety, or material that is utilized during an auxiliary step of a single-analyte process or assay, such as process initiation, process termination, rinsing, storage, and/or stabilization. The skilled person will recognize that there are innumerable possible assay agents given the broad applicability of the single-analyte arrays described here. The disclosure set forth herein should not be seen as limiting the possible composition or use of an assay agent, as set forth herein.

An assay agent may comprise any suitable phase of matter, including solids, liquids, and/or gases. An assay agent may comprise a multi-phase composition, such as an emulsion. An assay agent may comprise an organic species, inorganic species, or semiconductor species. An assay agent may comprise a small molecule species, a macromolecular species, or a nanoparticle species. An assay agent may comprise as ionic species, such as a cation, anion, a monatomic species, a polyatomic species, etc. An assay agent may comprise a chaotrope, a denaturant, or a surfactant. An assay agent may be characterized by one or more physical properties, such as hydrophobicity, hydrophilicity, polarity, non-polarity, nucleophilic reactivity, electrophilic reactivity, inertness, net negative electrical charge, net positive electrical charge, or a combination thereof. In some cases, an assay agent may comprise one or more physical properties that facilitate formation of orthogonal binding interactions with defects on a single-analyte array or a surface thereof.

In some cases, an assay agent may comprise a detection agent. A detection agent may comprise any suitable species or composition that is configured to provide spatial and/or temporal information related to a single-analyte array. For example, a detection agent may comprise one or more fluorophores that are configured to provide spatial information regarding the physical location of analyte-binding addresses on a single-analyte array. An assay agent may comprise a detection agent, in which the detection agent is configured to bind to an analyte of a plurality of analytes on a single-analyte array. A detection agent may comprise a detectable label (e.g., a fluorophore, a luminophore, a radiolabel, a nucleic acid tag, a peptide tag, etc.) or a plurality of detectable labels. Optionally a detectable label may further comprise: i) one or more affinity agents (e.g., an aptamer, antibody, antibody fragment, mini-protein binder, avimer, DARPin, etc.), and/or ii) a coupling partner that is configured to couple a detectable label to one or more affinity agents (e.g., an organic nanoparticle, an inorganic nanoparticle, a nucleic acid nanoparticle, etc.). In a preferable embodiment, a detection agent may comprise i) a nanoparticle coupling partner, ii) a plurality of affinity agents, and iii) a plurality of detectable labels. In some cases, a nanoparticle may comprise a nucleic acid nanoparticle (e.g., a structured nucleic acid nanoparticle, a nucleic acid nanoball, etc.). In some cases, a nanoparticle may comprise a non-nucleic acid nanoparticle (e.g., a quantum dot, a fluorescent polymer particle, etc.). Orthogonal binding of a detection agent to a portion of a single-analyte array other than an analyte (e.g., an interstitial region, a moiety of an analyte binding site other than the analyte) may produce a false detection event when the binding occurs at an optically non-resolvable distance from the analyte.

A composition may comprise a first species of assay agent and a second species of assay agent, in which the first species of assay agent and the second species of assay agent are both configured to form orthogonal binding interactions with a single-analyte array or a surface thereof. In some cases, a composition may comprise a first species of assay agent and a second species of assay agent, in which the first species of assay agent and the second species of assay agent are both configured to cooperatively form an orthogonal binding interaction with a single-analyte array or a surface thereof. For example, a single-analyte array composition may comprise an ionic species and a detection agent, in which the ionic species forms a bridging interaction that orthogonally binds the detection agent to a surface of the single-analyte array. In other cases, a composition may comprise a first species of assay agent and a second species of assay agent, in which the first species of assay agent and the second species of assay agent form independent orthogonal binding interactions with a single-analyte array or a surface thereof. For example, a single-analyte array composition may comprise a detection agent comprising an affinity agent and a detectable label, in which the affinity can become bound to a first type of defect on an array surface, and in which the detectable label can become bound to a second type of defect on the array surface, in which the first type of defect and the second type of defect are different.

A single-analyte array, as set forth herein, may be provided with a passivating layer disposed upon one or more surfaces of the array. A passivating layer may be configured to inhibit binding of an assay agent to a surface upon which the passivating layer is disposed. In some cases, a passivating layer may comprise a coating or continuum material on a surface (e.g. exposed to solvent), in which substituent molecules or moieties of the passivating layer are coupled to a surface of a solid support, other substituent molecules or moieties of the passivating layer, or both. For example, a surface of an array may be provided with a cross-linked polymer coating, in which the physical properties of the cross-linked polymer coating is configured to inhibit binding of an assay agent to the surface of the array. In other cases, a surface of an array may be provided with a passivating layer comprising a plurality of molecules, in which each molecule of the plurality of molecules is directly coupled to a surface of a solid support containing the array. For example, a plurality of polyethylene glycol-containing molecules may be coupled to a surface of a single-analyte array, in which each PEG-containing molecule of the plurality of PEG-containing molecule is individually coupled to the surface of the single-analyte array. A passivating layer may be characterized as being on a surface (e.g. exposed to solvent) and comprising one or more bulk or average physical characteristics (e.g., average surface density, average net electrical charge, average water contact angle, etc.). A passivating layer may be further characterized as containing one or more defects, in which a defect of the one or more defects has a physical property that differs from a bulk or average physical characteristic of the passivating layer.

A passivating layer may comprise a plurality of passivating molecules, in which a molecule of the plurality of passivating molecules comprises a passivating moiety. A passivating moiety may comprise a moiety that is on a surface (e.g. exposed to solvent) and configured to inhibit binding of an assay agent to the passivating molecule. A molecule of a plurality of passivating molecules may comprise a PEG moiety. A molecule of a plurality of passivating molecules may comprise an alkane moiety or a fluorinated alkane moiety. A molecule of a plurality of passivating molecules may comprise an alkane moiety or a nucleic acid moiety or a peptide moiety. A molecule of a plurality of passivating molecules may comprise a polysaccharide moiety (e.g., a dextran molecule). A passivating layer may comprise a substantially homogeneous plurality of molecules (e.g., the layer including no more than one species of molecule on a surface, excluding any defects in the passivating layer). A passivating layer may comprise a heterogeneous plurality of molecules (e.g., the layer including two or more differing species of molecules on a surface, excluding any defects in the passivating layer).

A passivating layer may comprise a passivating layer on a surface (e.g., exposed to solvent) and comprising molecules with a particular structure. In some cases, a molecule of a plurality of molecules of a passivating layer may comprise a linear structure with respect to a molecular backbone of the molecule. In other cases, a molecule of a plurality of molecules of a passivating layer may comprise a branched structure with respect to a molecular backbone of the molecule. In further cases, a plurality of molecules of a passivating layer may comprise a mixture of molecules with either linear or branched structures. A choice of molecules with linear or branched structures (or combinations thereof) may depend upon surface-binding interactions formed by assay agents contacted with a single-analyte array. For example, molecules comprising linear molecular chains may be preferable for achieving a higher average molecular surface density for a passivating layer, while molecules comprising branched molecular chains may be preferable for promoting steric occlusion, especially of macromolecular assay agents. In another example, it may be preferable to utilize a mixture of chain lengths of passivating molecules for a passivating layer to facilitate increased diversity of surface conformations within the passivating layer.

A single-analyte array, as set forth herein, may comprise a surface containing a passivating layer, in which the passivating layer is characterized as: i) comprising a substantially uniform passivating layer on a surface (e.g. exposed to solvent), ii) comprising a first plurality of passivating molecules, and iii) comprising a second plurality of passivating molecules, in which the second plurality of passivating molecules comprises a spatially-random distribution amongst the first plurality of passivating molecules. Optionally, a single-analyte array may further comprise one or more defects, in which each defect of the one or more defects is configured to form an orthogonal binding interaction with an assay agent. Such an array composition may arise by a method as set forth herein, in which the method comprises a step of binding a second plurality of passivating molecules to defects in a passivating layer comprising a substantially uniform first plurality of passivating molecules.

A single-analyte array may comprise a second plurality of passivating molecules, in which the second plurality of passivating molecules comprises a random spatial distribution on a surface amongst a substantially uniform first plurality of passivating molecules on the surface. In some cases, a molecule of a second plurality of passivating molecules may be directly coupled to a solid support of a single-analyte array (e.g., covalently coupled, non-covalently coupled). In other cases, a molecule of a second plurality of passivating molecules may be coupled to a solid support of a single-analyte array by a surface-coupled moiety. A surface-coupled moiety may comprise a molecule that is structurally analogous to a molecule of a substantially uniform first plurality of passivating molecules. For example, a structural analogue of a molecule may include a structural isomer, a degradation product, an adduct, an unreacted molecule, or an impurity of a first plurality of passivating molecules that has been incorporated into a passivating layer. A surface-coupled moiety may comprise an orthogonal binding moiety that is configured to form a binding interaction with an assay agent and/or a molecule of a second plurality of passivating molecules (e.g., a reactive functional group, a polar functional group, a non-polar functional group, an electrically-charged functional group, etc.). A molecule of a second plurality of molecules may comprise a moiety that is complementary to an orthogonal binding moiety of a surface-coupled moiety. In a preferred embodiment, a molecule of a second plurality of passivating molecules comprises: i) a surface-coupled moiety comprising a orthogonal binding moiety, ii) a passivating molecule comprising a moiety that is complementary to a orthogonal binding moiety, and iii) a linkage between the orthogonal binding moiety and the moiety that is complementary to the orthogonal binding moiety (e.g., a covalent bond, a non-covalent interaction).

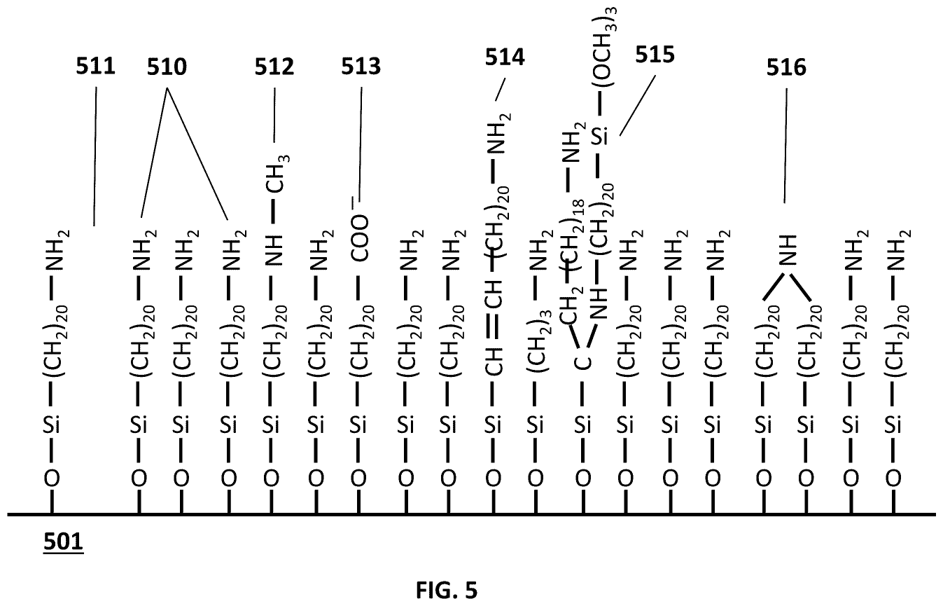

FIG. 5 depicts examples of surface-coupled moieties that are structurally analogous to molecules of a substantially uniform layer of molecules. A solid support 501 comprises a plurality of passivating molecules 510 and structural analogues thereof. Each passivating molecule comprises a terminal silane moiety that is covalently coupled to the surface of the solid support 501, a passivating moiety (e.g., an alkyl group), and a terminal primary or secondary amine group. The surface also comprises a void space 511 at which a molecule-binding site on the surface is unoccupied by a surface-coupled moiety. Structural analogues coupled to the surface include a molecule with an additional functional group added to the terminal amine group 512, a molecule with an oxidized terminal functional group 513 (e.g., amine to carboxylate), a molecule with a partially unsaturated passivating moiety 514, and an adduct 515 comprising two molecules of the plurality of passivating molecules with free terminal amine and silane groups, and an adduct 516 comprising two molecules of the plurality of passivating molecules 510 with no free terminal amine groups.

A molecule of a second plurality of passivating molecules may be provided to a single-analyte array or a surface thereof based upon a known or characterized capacity to inhibit binding of an assay agent to the molecule of the second plurality of passivating molecules. In a preferred embodiment, a molecule of a second plurality of passivating molecules may be provided to a single-analyte array or a surface thereof based upon a known or characterized capacity to inhibit binding of two or more assay agents to the molecule of the second plurality of passivating molecules. In some cases, a molecule of a second plurality of passivating molecules may comprise a chemically or structurally similar passivating moiety to a molecule of a first plurality of passivating molecules. For example, a single-analyte array may be provided with a substantially uniform passivating layer comprising a first plurality of passivating molecules and further comprising a random spatial distribution of a second plurality of passivating molecules, in which the first plurality of passivating molecules comprise a first passivating moiety (e.g., PEG), and in which the second plurality of passivating molecules comprise the first passivating moiety and a second passivating moiety (e.g., PEG), in which the first passivating moiety and the second passivating moiety comprise substantially identical chemical structures (e.g., with respect to chemical formula, with respect to covalent bonding order, with respect to conformation) and are joined by a linkage comprising a covalent reaction product. In some cases, a molecule of a second plurality of passivating molecules may comprise a chemically or structurally dissimilar (e.g., with respect to chemical formula, with respect to covalent bonding order, with respect to conformation) passivating moiety to a molecule of a first plurality of passivating molecules. For example, a molecule of a first plurality of passivating molecules may comprise a passivating moiety comprising PEG, whereas a molecule of a second plurality of passivating molecules may comprise a passivating moiety comprising a polysaccharide moiety (e.g., a dextran, a glycan, etc.), a peptide moiety, or a nucleic acid moiety. In some cases, a second molecule of a second plurality of passivating molecules may further comprise a PEG moiety, an alkane moiety, a fluorinated alkane moiety, or any other conceivable moiety arising from a defect in a passivating layer comprising a first plurality of passivating molecules.

In some cases, a single-analyte array may comprise a passivating layer containing a first plurality of passivating molecules and a second plurality of passivating molecules on a surface (e.g. exposed to solvent), in which the first plurality of passivating molecules is substantially homogeneous with respect to a first chemical structure (e.g., with respect to chemical formula, with respect to covalent bonding order, with respect to conformation), and in which the second plurality of passivating molecules is substantially homogeneous with respect to a second chemical structure (e.g., with respect to chemical formula, with respect to covalent bonding order, with respect to conformation). Such an array composition may arise when an array comprising a passivating layer with a plurality of defects is contacted with a homogeneous mixture of passivating molecules that are configured to couple to defects of the plurality of defects. In some cases, a single-analyte array may comprise a passivating layer containing a first plurality of passivating molecules and a second plurality of passivating molecules, in which the first plurality of passivating molecules is substantially homogeneous with respect to a first chemical structure (e.g., with respect to chemical formula, with respect to covalent bonding order, with respect to conformation), and in which the second plurality of passivating molecules is heterogeneous with respect to a second chemical structure (e.g., with respect to chemical formula, with respect to covalent bonding order, with respect to conformation). Such an array composition may arise when an array comprising a passivating layer with a plurality of defects is contacted with a heterogeneous mixture of passivating molecules that are configured to couple to defects of the plurality of defects. A first molecule and a second molecule of a heterogeneous second plurality of passivating molecules may differ with respect to any conceivable chemical or structural property, including molecular chain length, molecular chain degree of branching, atomic composition, atomic arrangement (e.g., isomerization), or chemical property (e.g., hydrophobicity, electronegativity, net electrical charge, polarity, hydrodynamic radius, or a combination thereof).

Single-analyte array compositions, as set forth herein, can arise from methods of removing defects in passivating layers, thereby forming an array with a second plurality of passivating molecules on a surface of the array, in which molecules of the second plurality of passivating molecules are located at array addresses having a first random spatial distribution on the array surface. However, in some cases, not all defects will be removed by a method set forth herein. Accordingly, a single-analyte array may be further characterized by a second random spatial distribution of addresses, in which each address of the random spatial distribution comprises a defect. A first random spatial distribution of addresses containing passivating molecules of a second plurality of passivating molecules and a second random spatial distribution of addresses comprising a defect may be random with respect to each other.

In some cases, a first random spatial distribution of addresses comprising a passivating molecule of a second plurality of passivating molecules may be described with respect to a statistical distribution of molecules of the second plurality of passivating molecules with respect to sites of the plurality of sites. For example, a statistical distribution may describe a fraction of sites of a plurality of sites, in which each site of the fraction of sites may be characterized as having N molecules of a second plurality of passivating molecules within an optically non-resolvable distance of the site of the fraction of sites. In some cases, a second random spatial distribution of addresses comprising a defect of a plurality of defects may be described with respect to a statistical distribution of defects of the plurality of defects with respect to sites of the plurality of sites. For example, a statistical distribution may describe a fraction of sites of a plurality of sites, in which each site of the fraction of sites may be characterized as having one or more defects of a plurality of defects within a given distance of the site of the fraction of sites. A random spatial distribution, as set forth herein, may be described by a statistical distribution, such as a normal distribution, a bimodal distribution, a Poisson distribution, etc.

In other cases, a first random spatial distribution of addresses comprising a passivating molecule of a second plurality of passivating molecules may be described with respect to a probabilistic distribution of molecules of the second plurality of passivating molecules with respect to sites of the plurality of sites. For example, there may be an M % chance that a randomly chosen site of a plurality of sites of a single-analyte array is within an optically non-resolvable distance of a passivating molecule of a second plurality of passivating molecules. In other cases, a second random spatial distribution of addresses comprising a defect of a plurality of defects may be described with respect to a probabilistic distribution of defects of the plurality of defects with respect to sites of the plurality of sites. For example, there may be an M % chance that a randomly chosen site of a plurality of sites of a single-analyte array is within an optically non-resolvable distance of a defect of a plurality of defects.

A single-analyte array composition, as set forth herein, may have a reduced quantity of defects relative to some or all sites on the array. A single-analyte array may comprise a ratio of a total quantity of a first plurality of sites to a total quantity of defects that is at least about 10, 25, 50, 100, 250, 500, 1000, 2500, 5000, 10000, 25000, 50000, 100000, 500000, 1000000, or more than 10000000. Alternatively or additionally, a single-analyte array may comprise a ratio of a total quantity of a first plurality of sites to a total quantity of defects that is no more than about 1000000, 500000, 250000, 100000, 50000, 25000, 10000, 5000, 2500, 1000, 500, 250, 100, 50, 25, 10, or less than 10. In some cases, no more than about 10%, 5%, 1%, 0.5%, 0.1%, 0.05%, 0.01%, 0.005%, 0.001%, 0.0005%, 0.0001%, 0.00005%, 0.00001%, 0.000005%, 0.000001%, or less than 0.000001% of sites of a plurality of sites on a single-analyte array are within an optically non-resolvable distance of defects of a plurality of defects. Alternatively or additionally, at least about 0.000001%, 0.000005%, 0.00001%, 0.00005%, 0.0001%, 0.0005%, 0.001%, 0.005%, 0.01%, 0.05%, 0.1%, 0.5%, 1%, 5%, 10%, or more than 10% of sites of a plurality of sites of a single-analyte array are within an optically non-resolvable distance of defects of a plurality of defects.

In some cases, a likelihood of a random site of a plurality of sites on a single-analyte array being an optically non-resolvable distance from a nearest defect of a plurality of defects is no more than about 10%, 5%, 1%, 0.5%, 0.1%, 0.05%, 0.01%, 0.005%, 0.001%, 0.0005%, 0.0001%, 0.00005%, 0.00001%, 0.000005%, 0.000001%, or less than 0.000001%. Alternatively or additionally, a likelihood of a random site of a plurality of sites on a single-analyte array being an optically non-resolvable distance from a nearest defect of a plurality of defects is at least about 0.000001%, 0.000005%, 0.00001%, 0.00005%, 0.0001%, 0.0005%, 0.001%, 0.005%, 0.01%, 0.05%, 0.1%, 0.5%, 1%, 5%, 10%, or more than 10%.

A solid support or a surface thereof, as set forth herein, may comprise a material that is configured to couple a molecule of a first plurality of molecules. In some cases, a solid support may comprise a silicon-containing material (e.g., glass, silicon, fused silica, quartz, etc.). A solid support or a surface thereof, may comprise a material comprising a plurality of molecule-binding sites, in which a molecule-binding site is configured to couple a molecule of a first plurality of molecules. For example, a silicon-containing material may comprise a surface containing a plurality of silicon atoms, in which each silicon atom is configured to form a coordination bond with a silicon-containing molecule (e.g., an organosilane). In some cases, a defect may comprise a silicon atom on a surface of a solid support, in which the silicon atom is not covalently-bonded to a molecule of a first plurality of molecules.

A single-analyte array composition, as set forth herein, may comprise a plurality of analytes. In some configurations, a plurality of analytes may be contacted with a single-analyte array (e.g., a plurality of unbound analytes within a fluidic medium that is contacted with the single-analyte array). In other configurations, a plurality of analytes may be coupled to a single-analyte array. In a preferred embodiment, a plurality of analytes may be coupled to a single-analyte array comprising a plurality of sites, in which each site comprises one and only one analyte of the plurality of analytes. In other embodiments, a plurality of analytes may be coupled to a single-analyte array comprising a plurality of sites, in which a first fraction of sites of the plurality of sites comprises one and only one analyte of the plurality of analytes, and in which a second fraction of sites of the plurality of sites comprises two or more analytes of the plurality of analytes. In other embodiments, a plurality of analytes may be coupled to a single-analyte array comprising a plurality of sites, in which a first fraction of sites of the plurality of sites comprises one and only one analyte of the plurality of analytes, and in which a second fraction of sites of the plurality of sites has zero analytes of the plurality of analytes. In a preferred embodiment, an analyte of a plurality of analytes is coupled to a site of a plurality of sites by an anchoring moiety, as set forth herein. In a particularly preferred embodiment, an analyte of a plurality of analytes is coupled to a site of a plurality of sites by a nucleic acid anchoring moiety, such as a nucleic acid origami or a nucleic acid nanoball.

A single-analyte array composition may comprise a plurality of assay agents. In some configurations, a composition may comprise a plurality of unbound assay agents contacted with a single-analyte array (e.g., contacted within a fluidic medium). In other configurations, a composition may comprise a plurality of assay agents that are coupled to a single-analyte array (e.g., coupled to analytes of a single-analyte array, coupled to defects of a single-analyte array). In other configurations, a first plurality of unbound assay agents in contact with a single-analyte array, as set forth herein, and a second plurality of assay agents that are bound to the single-analyte array. In some configurations, a composition may further comprise a fluidic medium, in which the fluidic medium is contacted with a plurality of assay agents, and in which the fluidic medium is contacted with a solid support of a single-analyte array. In some configurations, a first assay agent of a plurality of assay agents may be bound to a defect of the plurality of defects of a single-analyte array, as set forth herein. In some configurations, a second assay agent may be bound to an analyte of a plurality of analytes of a single-analyte array, as set forth herein.

In a preferred embodiment of a single-analyte array, as set forth herein, a plurality of assay agents may be bound to the single-analyte array, in which a first fraction of assay agents may be bound to a plurality of defects of the single-analyte array, and in which a second fraction of assay agents may be bound to a plurality of analytes of the single-analyte array. A single-analyte array comprising a plurality of bound assay agents may be characterized by a ratio of a quantity of a second fraction of assay agents bound to analytes to a quantity of a first fraction of assay agents bound to defects. A ratio of a quantity of a second fraction of assay agents bound to analytes to a quantity of a first fraction of assay agents bound to defects may be at least about 10, 50, 100, 500, 1000, 5000, 10000, 50000, 100000, 500000, 1000000, 10000000, 100000000, 1000000000, or more than 1000000000. Alternatively or additionally, a ratio of a quantity of a second fraction of assay agents bound to analytes to a quantity of a first fraction of assay agents bound to defects may be no more than about 1000000000, 100000000, 10000000, 1000000, 500000, 100000, 50000, 10000, 5000, 1000, 500, 100, 50, 10, or less than 10.

In some configurations, molecules or moieties may be coupled to a surface of a single-analyte array that provide a particular property or utility to the single-analyte array. Such molecules or moieties may include passivating molecules or moieties, coupling molecules or moieties, detectable molecule or moieties, and/or chemically-protective molecules or moieties. A chemically-protective molecule or moiety may include any molecule or moiety that inhibits a mechanism of chemical or physical degradation of a single-analyte array or a component thereof (e.g., a surface molecule, an analyte, an anchoring group, an assay reagent in contact with the single-analyte array, etc.). Chemically-protective molecules or moieties may inhibit a mechanism of chemical or physical degradation, such as photodamage (e.g., photolysis, photon-assisted cross-linking, photon-catalyzed free radical generation, etc.), acid/base reactions, oxidation or reduction reactions, or free radical reactions. In some cases, a chemically-protective molecule or moiety may comprise a chemical sink, in which a single chemical sink is configured to inhibit two or more instances of chemical or physical degradation. For example, a chemical sink may comprise a molecule comprising a plurality of photolabile compounds or photoisomerization compounds, in which each chemical sink can absorb more than one excess photon, thereby inhibiting more than one photodamage reaction.

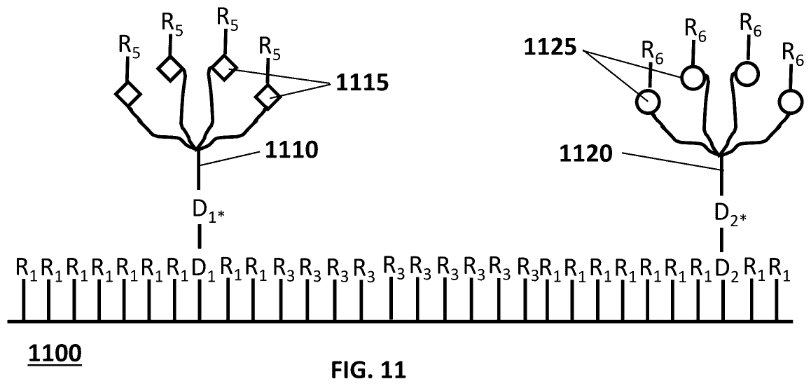

FIG. 11 depicts an array comprising two different types of chemical sink molecules coupled to a surface layer. A solid support 1100 comprises an analyte binding site containing a plurality of molecules R₃ and at least one interstitial region containing a plurality of molecules R₁. The at least one interstitial region comprises chemically-differing defects D₁ and D₂. Defect D₁ is coupled to a first chemical sink moiety by a coupling group D_{1*} that forms a binding interaction with defect D₁. The first chemical sink moiety comprises a first branched linking moiety 1110 and a plurality of photodamage inhibitors 1115 (e.g., photolabile compounds, photoisomerization compounds, etc.). Defect D₂ is coupled to a second chemical sink moiety by a coupling group D_{2*} that forms a binding interaction with defect D₂. The second chemical sink moiety comprises a second branched linking moiety 1120 and a plurality of reactive damage inhibitors (e.g., radical scavengers, electrophilic functional groups, nucleophilic functional groups, etc.).

Exemplary photodamage inhibitors may include photolabile species such as quinoline compounds, coumarin compounds, cyanine compounds, xanthene compounds, ortho-nitrobenzene compounds, benzoin compounds, BODIPY, and carbazole compounds. Additional useful photolabile compounds and linking chemistries can be found in “Photonanotechnology for Therapeutics and Imaging,” Ed. Choi, S. K., (2020); Hansen, M. J., et al., Chem. Soc. Rev., 2015, 44, 3358-3377; Piloto, A. M., et al., Tetrahedron, 2014, 70, 650-657; San Miguel, V., et al. J. Am. Chem. Soc., 2011, 133, 5380-5388; Elamri, I., et al., J. Am. Chem. Soc., 2021, 143, 10596-10603; Lv, W., et al., J. Am. Chem. Soc., 2019, 141, 17482-17486; Lu, P., et al., Matter, 2021, 4, 2172-2229; Lerch, M. M., et al., Nature Comm., 2016, 7, 12054; Hemmer, J. R., et al., J. Am. Chem. Soc., 2016, 138, 13960-13966; Sanchez-Somolinos, C., “Light-Sensitive Azobenzene-Containing Liquid Crystalline Polymers,” In Polymers and Polymeric Composities: A Reference Series, 2020, 1-31; and Fedele, C., et al., “New Tricks and Emerging Applications from Contemporary Azobenzene Research,” Photochem. Photobio Sci, 2022, each of which is incorporated by reference in its entirety. Alternatively or additionally, photodamage inhibitors may include photoisomerization species, such as stilbenes, azobenzenes, indigos, alpha-bismines, hydrazones, diarylethenes, spiropyrans, dihydropyrenes, and Stenhouse adducts. Chemical or physical damage inhibitor compounds may be incorporated into a chemical sink moiety by innumerable attachment chemistries that are known in the art, such as Click-type reactions or NHS-ester chemistry onto a scaffold molecule (e.g., a polymer, a nucleic acid, etc.).

An array composition, as set forth herein, may be disposed within a flow cell or fluidic cartridge. An array composition may be disposed within a chamber, channel, reservoir, or void space of a flow cell or fluidic cartridge. A flow cell or fluidic cartridge may comprise a chamber, channel, reservoir, or void space, in which the chamber, channel, reservoir, or void space comprises a surface, and in which an array composition, as set forth herein, is disposed on or formed on the surface of the chamber, channel, reservoir, or void space. In some cases, a flow cell or fluidic cartridge may comprise a multi-piece assembly, in which a first piece of the multi-piece assembly comprises a solid support, in which the array is disposed on a surface of the solid support, and may further comprise a second piece of the multi-piece assembly (e.g., a backer), in which the second piece is joined to first piece, thereby enclosing a chamber, channel, reservoir, or void space comprising the array. In some cases, a surface layer may be formed on a second piece of a flow cell or fluidic cartridge, in which the surface layer is formed on a surface of the second piece that is disposed within the chamber, channel, reservoir, or void space containing the array. A surface layer formed on a piece of a flow cell or fluidic cartridge may be substantially similar to a surface layer formed on an array. For example, it may be advantageous to provide a surface layer comprising a hydrophobic material (e.g., hexamethyldisilazane) or a passivating layer (e.g., PEG, dextrans, etc.) on a surface of a second piece.

A flow cell or fluidic cartridge may comprise a multi-piece assembly. The multi-piece assembly may be joined by a suitable joining method, such as adhesive joining or laser bonding. In some cases, a first piece and a second piece of a multi-piece fluidic assembly may be joined by an adhesive, such as a pressure-sensitive adhesive, an epoxy adhesive, or a UV-cured adhesive. In other cases, a surface of first piece and a surface of a second piece of a multi-piece assembly may be directly coupled by a bonding method such as laser bonding. In some cases, a second piece may be formed onto a first piece of a multi-piece assembly (e.g., via polymer extrusion). In some cases, a second piece may be configured to mechanically attach to a first piece of a multi-piece assembly (e.g., a snap-on assembly). Additional useful methods of joining flow cells or fluidic assemblies can be found in U.S. Patent Publication No. 20220379582A1, which is herein incorporated by reference in its entirety.

In an aspect, provided herein is a flow cell, comprising: a) a first solid support, in which an array, as set forth herein, is disposed on a surface of the first solid support, and b) a second solid support, in which the first solid support is joined to the second solid support to form an enclosed void, in which the array is disposed within the void, and in which a surface of the second solid support within the void comprises a surface layer, as set forth herein (e.g., a surface layer comprising a hydrophobic material or a hydrophilic material). In some cases, a second solid support may comprise a same surface layer as a surface layer disposed on an interstitial region of an array disposed within the flow cell. Alternatively, a second solid support may comprise a differing surface layer as a surface layer disposed on an interstitial region of an array disposed within the flow cell.

### Methods of Forming Single-Analyte Arrays

In an aspect, provided herein is a method, comprising: a) coupling a first plurality of molecules (e.g., organic molecules) to a solid support to form a surface layer (e.g., an organic layer), in which the layer comprises a plurality of defects, in which each defect of the plurality of defects comprises an absence of a molecule of the first plurality of molecules, in which the layer comprises an average density of surface defects, in which the plurality of defects comprises a spatially-random distribution on the solid support, and in which the solid support comprises: i) a plurality of sites, and ii) one or more interstitial regions, in which each site of the plurality of sites is spatially separated from other sites of the plurality of sites by an interstitial region of the one or more interstitial regions, and b) coupling a second plurality of molecules (e.g., organic molecules) to the solid support, in which each molecule of the second plurality of molecules is coupled to a defect of the plurality of defects, and in which each molecule of the second plurality of molecules comprises a passivating moiety. In some cases, a method may comprise a method of forming a passivating layer on a solid support (e.g., a passivating layer disposed on an interstitial region). In other cases, a method may comprise a method of forming a coupling layer on a solid support (e.g., a coupling layer on a site of a plurality of sites).

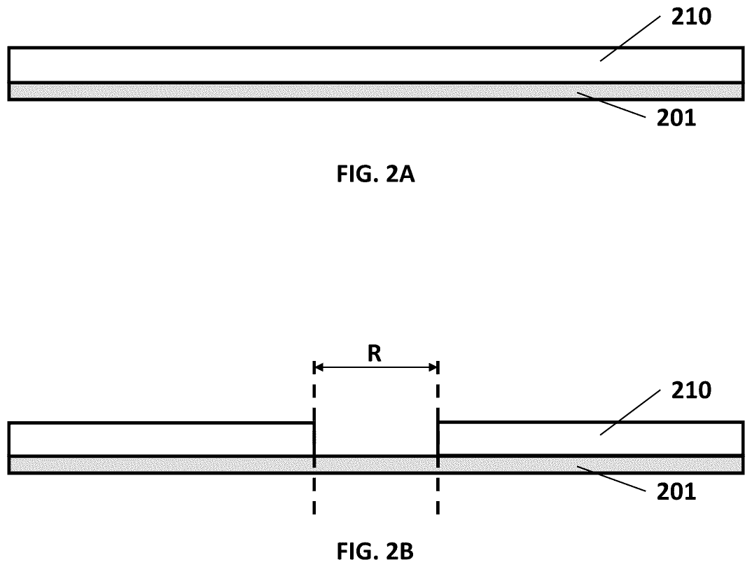

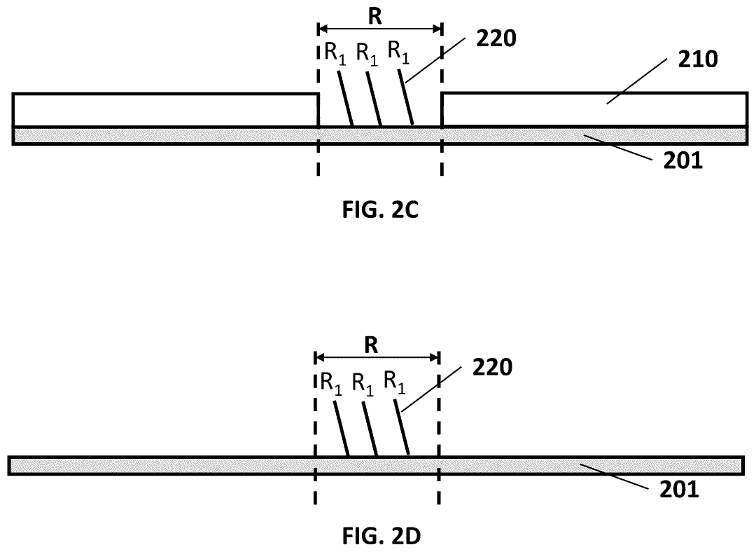

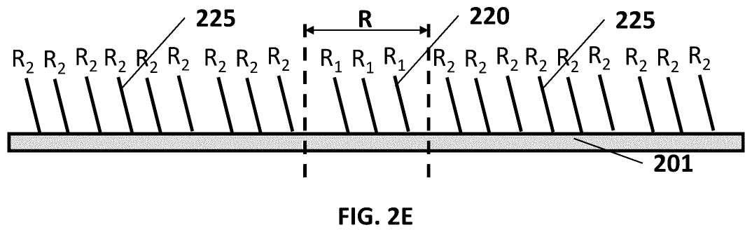

FIGS. 2A-2E depict an idealized lithographic method of forming a single-analyte array. Such a method is considered idealized because it would produce a single-analyte array comprising a plurality of sites and one or more interstitial regions, in which the single-analyte array does not comprise any surface defects that facilitate orthogonal binding interactions. FIG. 2A depicts a solid support 201 comprising a resist material 210 (e.g., photoresist) that is disposed on a surface of the solid support 201. FIG. 2B depicts patterning by selective removal of the resist material 210 (e.g., by photolithography) to expose selected regions of the solid support 201. The selective removal of the resist material 210 produces an exposed region of solid support 201 with a characteristic dimension (e.g., width, length, diameter) of R. FIG. 2C depicts binding of a plurality of coupling molecules 220 containing moieties R1 (e.g., coupling moieties,) to the exposed region of the solid support 201. The entire region with characteristic dimension R is occupied by the plurality of coupling molecules 220. FIG. 2D depicts removal of the remaining resist material 210 from the surface of the solid support 201, thereby exposing the remainder of the surface of the solid support 201. FIG. 2E depicts binding of a plurality of passivating molecules 225 containing moieties R2 (e.g., passivating moieties) to the remaining exposed region of the solid support 201. The formed array comprises a site containing the plurality of coupling molecules that is completely surrounded by an interstitial region comprising the plurality of passivating molecules 225. Although only a single site is depicted as being formed in FIGS. 2A-2E, the method is readily extendible to pluralities of sites. The skilled person will readily recognize numerous methods and variations thereof for producing similar array configurations.

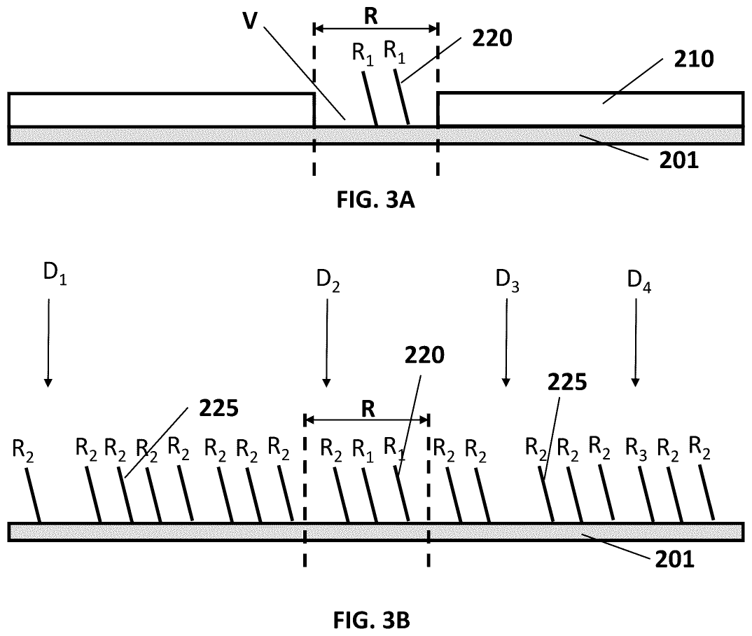

FIG. 3A-3B illustrate analogous array formation methods as shown in FIGS. 2A-2E, but with defects arising during the formation process. FIG. 3A depicts an analogous step to that depicted in FIG. 2C, however with a void space V occurring where a molecule of a plurality of coupling molecules 220 has failed to bind to a molecule-binding site. FIG. 3B depicts an analogous step to that depicted in FIG. 2E, however with defects arising during the binding of the plurality of passivating molecules 225. Defects D1 and D3 comprise void spaces (i.e., an absence of a molecule) at molecule-binding sites on the surface of the solid support 201 where molecules of the plurality of passivating molecules 225 failed to bind. Defect D2 comprise a defect due to the presence of a passivating molecule 225 at a molecule-binding site that is supposed to contain a coupling molecule 220. Defect D4 depicts a molecule-binding site containing a bound structural analogue (e.g., a structural isomer, a degradation product, an adduct, an unreacted molecule, or an impurity) of a passivating molecule 225, in which the structural analogue comprises moiety R3. Notably, the presence of a passivating molecule 225 in the analyte-binding site may not affect the function of the array, and in some cases may be advantageous for preventing orthogonal binding of assay agents at the analyte-binding site. Also notably, the structural analogue of the passivating molecule 225 may not produce orthogonal binding interactions, although in some cases, it will produce such interactions.

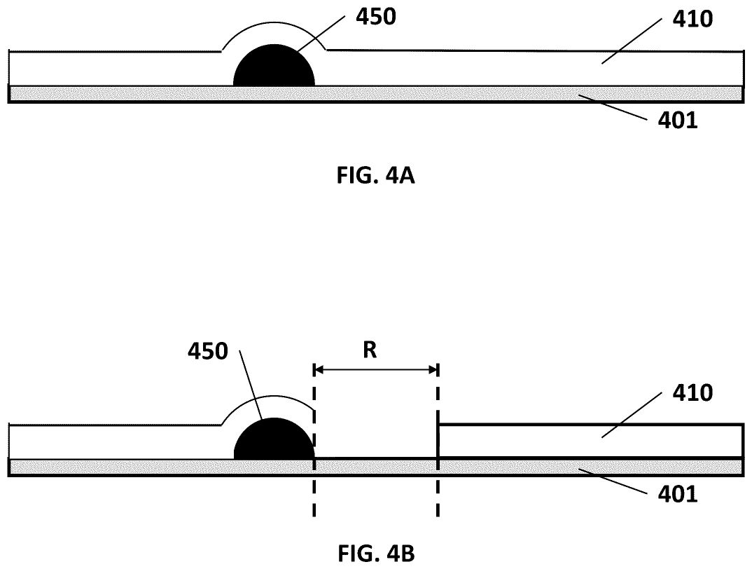

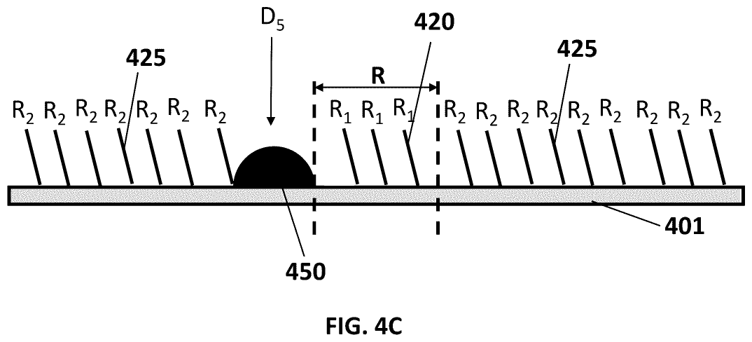

FIGS. 4A-4C also illustrate analogous array formations methods as shown in FIGS. 2A-2E, but with a solid support comprising a manufacturing defect (e.g., an adhered particle). FIG. 4A depicts a solid support 401 comprising a substantially uniform layer of a resist material 410. The solid support 401 further comprises a manufacturing defect 450 that occludes a region of the surface. FIG. 4B depicts an analogous process step to FIG. 2B, in which a portion of the resist material 410 has been removed to expose a region of the surface of the solid support 401 that is adjacent to the manufacturing defect 450. FIG. 4C depicts an analogous process step to FIG. 2E, in which a plurality of coupling molecules 420 and a plurality of passivating molecules 425 have been deposited on the surface. Due to the properties of the manufacturing defect 450, molecules of the plurality of passivating molecules 425 do not bind, leaving the manufacturing defect exposed to possibly form orthogonal binding interactions.

In some cases, a method may comprise coupling a first plurality of molecules to a solid support, in which coupling the first plurality of molecules comprises coupling the first plurality of molecules to one or more interstitial regions. Such a method may further comprise one or more steps of: a) coupling a third plurality of molecules to a plurality of sites to form a second layer on a surface (e.g. exposed to solvent), in which the second layer comprises a second plurality of defects, in which the defects comprise an absence of a molecule of the third plurality of molecules on the surface, and in which the second layer comprises a second average defect density on the solid support, and b) coupling a fourth plurality of molecules to the plurality of sites, in which each molecule of the fourth plurality of molecules is coupled to a defect of the second plurality of defects, and in which each molecule of the second plurality of organic molecules comprises a passivating moiety. Such a method may be utilized to provide analyte-binding sites with decreased likelihood of forming orthogonal binding interactions with assay agents.

In some cases, a method may comprise coupling a first plurality of molecules to a solid support, in which coupling the first plurality of molecules comprises coupling the first plurality of molecules to a plurality of sites. Such a method may further comprise: a) coupling a third plurality of molecules to one or more interstitial regions to form a second layer on a surface (e.g. exposed to solvent), in which the second layer comprises a second plurality of defects, in which each the defects comprise an absence of a molecule of the third plurality of molecules on the surface, and in which the second layer comprises a second average defect density on the solid support, and b) coupling a fourth plurality of molecules to the one or more interstitial regions, in which each molecule of the fourth plurality of molecules is coupled to a defect of the second plurality of defects, and in which each molecule of the second plurality of molecules comprises a passivating moiety. Such a method may be utilized to provide interstitial regions with decreased likelihood of forming orthogonal binding interactions with assay agents on single-analyte arrays with analyte-binding sites that are resistant to orthogonal binding of assay agents.

Before coupling a second plurality of molecules to a single-analyte array, a layer disposed upon the array (e.g., a surface layer of an interstitial region, a surface layer of an analyte binding site) may have an average defect density. An average defect density of a layer before coupling a second plurality of molecules to defects of a single-analyte array may be no more than about 1000, 500, 100, 50, 10, 5, 1, 0.5, 0.1, 0.05, 0.01, 0.005, 0.001, or less than 0.001 defects per site relative to a total quantity of sites. Alternatively or additionally, an average defect density of a layer before coupling a second plurality of molecules to defects of a single-analyte array may be at least 0.001, 0.005, 0.01, 0.05, 0.1, 0.5, 1, 5, 10, 50, 100, 500, 1000 or more than 1000 defects per site relative to a total quantity of sites. An average defect density of a layer before coupling a second plurality of molecules to defects of a single-analyte array may be no more than about 1000, 500, 250, 100, 50, 25, 10, 5, 1, 0.5, 0.1, 0.05, 0.01, 0.005, 0.001 or less than 0.001 defects per square nanometer. Alternatively or additionally, an average defect density of a layer before coupling a second plurality of molecules to defects of a single-analyte array may be at least about 0.001, 0.005, 0.01, 0.05, 0.1, 0.5, 1, 5, 10, 25, 50, 100, 250, 500, 1000 or more than 1000 defects per square nanometer.

In some cases, coupling a first plurality of molecules to a solid support to form a layer may comprise forming a self-assembled monolayer comprising the first plurality of molecules on a surface (e.g., exposed to solvent). In particular cases, each molecule comprising a self-assembled monolayer may be individually coupled to a solid support. In other cases, coupling a first plurality of molecules to a solid support to form a layer may comprise forming a polymeric network comprising the first plurality of molecules on a surface (e.g. exposed to solvent). For example, a polymeric network may comprise a composition in which each molecule of a first plurality of molecules is coupled to at least one other molecule of the first plurality of molecules, and optionally in which a molecule of the first plurality of molecules may be coupled to a solid support.

In some cases, coupling a first plurality of molecules to a solid support to form a layer may comprise covalently coupling the first plurality of molecules to the solid support to form the layer on a surface (e.g., exposed to solvent). In some cases, a solid support may comprise a silicon-containing material (e.g., glass, silicon, fused silica, quartz, etc.). In particular cases, a first plurality of molecules may comprise an organosilane, in which the organosilane is covalently attached to a silicon-containing material of a solid support. In some cases, a solid support may comprise a metal or metal oxide (e.g., gold, titanium dioxide, zirconium oxide, etc.). In particular cases, a first plurality of molecules may comprise an organophosphate or an organophosphonate, in which the organophosphate or organophosphonate is covalently attached to a metal or metal oxide of a solid support.

A method, as set forth herein, may comprise coupling a second plurality of molecules to defects of a layer on a single-analyte array. A molecule of a second plurality of molecules may be provided with functional group that facilitates coupling of the molecule to a defect of a layer on a single-analyte array. For example, a molecule of a second plurality of molecules may be provided with a nucleophilic functional group if a defect is expected to contain an electrophilic moiety. In another example, a molecule of a second plurality of molecules may be provided with a negatively-charged functional group (e.g., a carboxylate) if a defect is expected to contain a positively-charged functional group (e.g., an amine). In some cases, a molecule of a second plurality of molecules may comprises a functional group selected from the group consisting of amine, carboxylate, azide, hydroxyl, alkene, alkyne, epoxide, thiol, ester, and thioester.

In some cases, a layer, as set forth herein, may be formed in a step-wise process. Such a method may be utilized to form a layer comprising molecules, in which a molecule comprises two or more moieties. For example, a layer may be provided comprising molecules containing a passivating moiety (e.g., PEG) and a coupling moiety (e.g., an oligonucleotide), in which the molecules are formed by coupling the passivating moieties to a solid support, then coupling the coupling moieties to the passivating moieties. In some cases, a method may further comprise coupling a fifth plurality of molecules (e.g., organic molecules) to a solid support, in which a molecule of the fifth plurality of molecules is coupled to a molecule of a first plurality of molecules coupled to the solid support. In some cases, a molecule of a fifth plurality of molecules may not be coupled directly to the solid support, for example, being indirectly coupled to the solid support. In particular cases, coupling a fifth plurality of molecules to a solid support may occur before coupling a second plurality of molecules to the solid support. In other particular cases, coupling a fifth plurality of molecules to a solid support may occur after coupling a second plurality of molecules to the solid support.

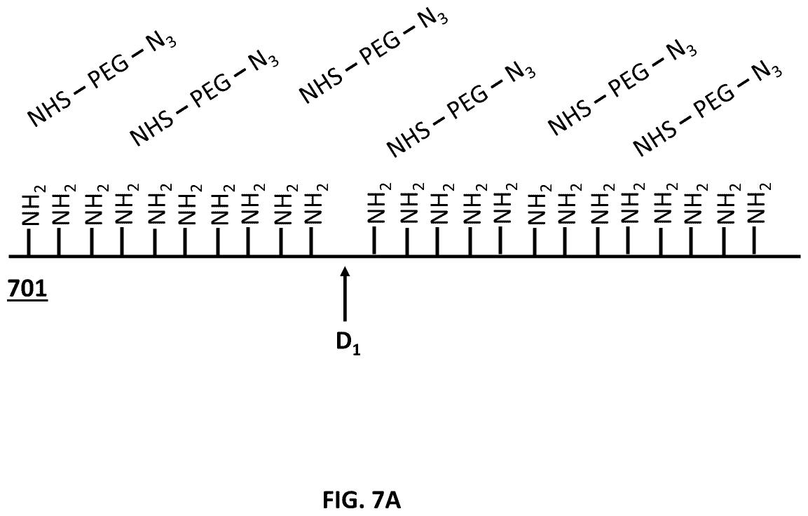

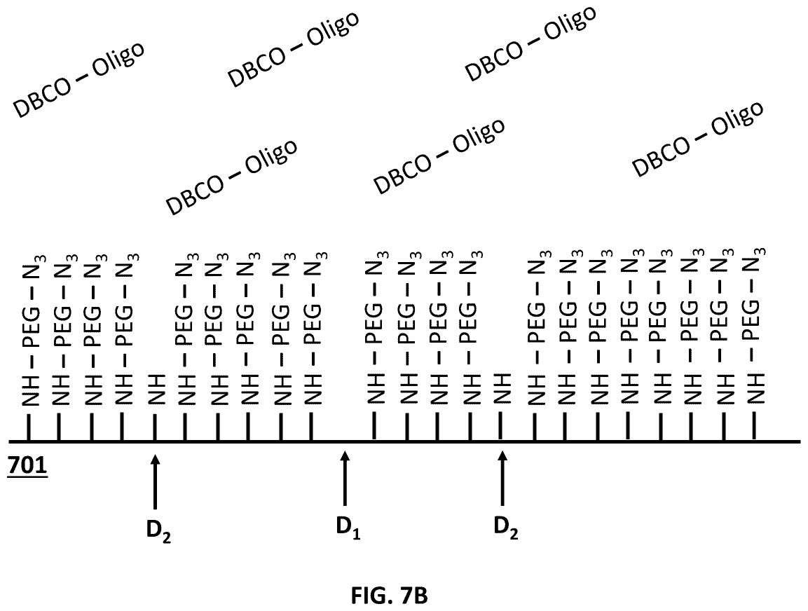

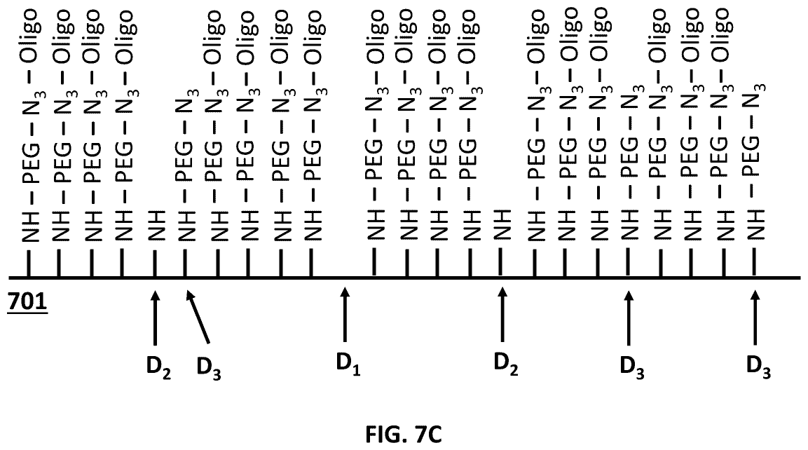

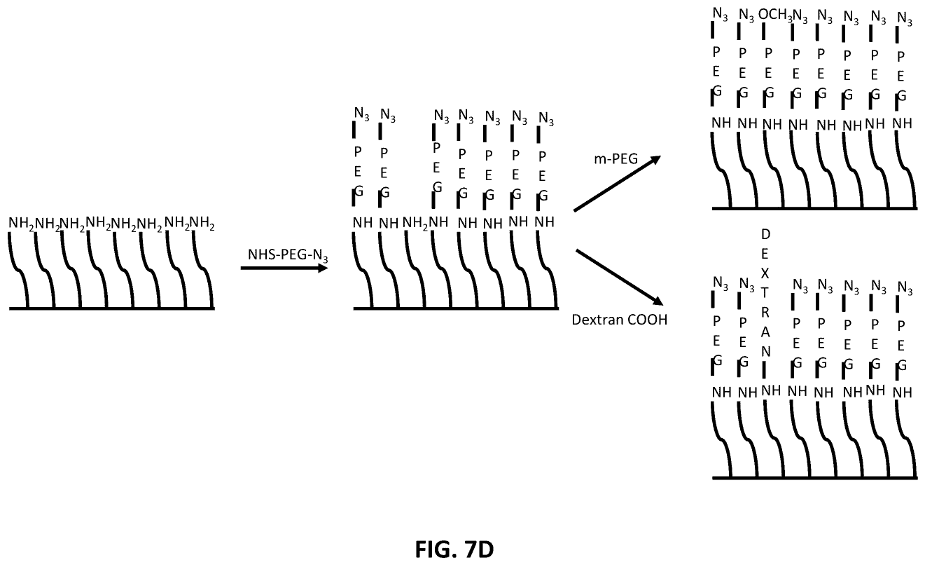

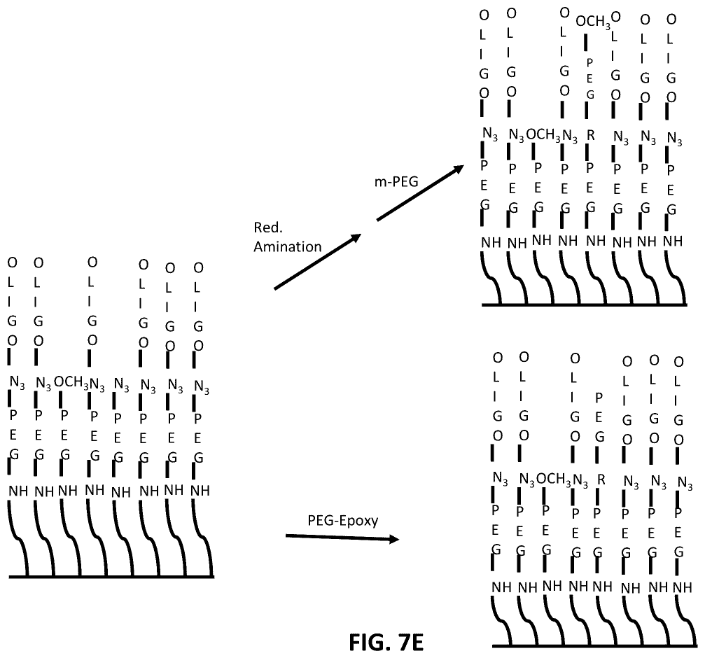

FIGS. 7A-7E depict methods for forming functionalized surfaces for single-analyte arrays by a step-wise method. FIG. 7A depicts a solid support 701 comprising a substantially uniform layer containing a plurality of surface-linked functional groups (e.g., amines). The substantially uniform layer of surface-linked functional groups comprises a defect, D1, in which the defect comprises an absence of a surface-linked functional group. The array is contacted with a plurality of passivating molecules (e.g., NHS-PEG-N3) that are configured to react with the surface-linked functional groups. FIG. 7B illustrates a second step of a step-wise surface formation method. The solid support comprises a passivated surface (e.g., a PEGylated surface) with terminal reactive functional groups (e.g., azide moieties). In addition to the defect D₁ from the original surface, new defects D₂ exist in the passivated surface due to incomplete reaction between the surface-linked functional groups and the plurality of passivating molecules. Defects D₂ comprise unreacted surface-linked functional groups. The passivated surface is contacted with another plurality of coupling molecules (e.g., dibenzocyclooctylene-terminated oligonucleotides) that are configured to react with the terminal reactive functional groups of the passivated surface. FIG. 7C depicts a formed surface with incorporated coupling molecules. Incomplete reaction between the terminal reactive functional groups and the coupling molecules causes defects D₃, in which defects D₃ comprise exposed terminal reactive groups. The finally-formed surface comprises defects D₁, D₂, and D₃, each of which may form orthogonal binding interactions with assay agents that are contacted with the surface during a single-analyte assay or process. FIG. 7D illustrates a method of removing defects D2 from an array such as that shown in FIG. 7B. After binding the plurality of passivating molecules to the surface-linked functional groups, a second plurality of molecules (e.g., passivating molecules) may be contacted with the surface, in which the second plurality of molecules is configured to bind to the unreacted surface-linked functional groups. Exemplary pathways for providing a differing form of PEG (e.g., m-PEG) or a passivating carbohydrate (e.g., carboxylated dextran) are shown. The resulting surface has at least a reduced quantity of remaining defects D₂. FIG. 7E illustrates a method of removing defects D₃ from an array such as that shown in FIG. 7C. The array may have been treated by a method such as that shown in FIG. 7D, although optionally such a treatment may occur after the processes shown in FIG. 7C or 7E. The terminal reactive functional groups may optionally undergo a reaction to convert them into a different reactive functional group (e.g., reductive amination of azide to amine). The terminal reactive functional groups may then undergo a reaction with a plurality of molecules (e.g., passivating molecules) that contain complementary reactive functional groups (e.g., amine-NHS, azide-epoxy, etc.). FIG. 7E depicts two differing pathways, both resulting in the incorporation of a passivating molecules (e.g., PEG), thereby reducing the number of defects D₃ on the surface. Optionally, a method may comprise a step of contacting a solid support with a second plurality of surface-coupling moieties (e.g., silanes) to remove vacancies such as D1 defects depicted in FIGS. 7A-7C. The skilled person will readily recognize numerous variations of reactive schemes that will lead to a desired reduction in the quantity of surface defects on a single-analyte array surface.

In some cases, after coupling a fifth plurality of molecules (e.g., organic molecules) to a solid support, the solid support may comprise a second plurality of defects. A second plurality of defects may arise due to, for example, incomplete reaction or coupling of a fifth plurality of molecules with a first plurality of molecules during the formation of a surface layer comprising two or more moieties (e.g., coupling moieties, passivating moieties). In some cases, a defect of a second plurality of defects may comprise absence of molecules of a fifth plurality of molecules. In other cases, a defect of a second plurality of defects may comprise a molecule that is structurally analogous to a molecule of a fifth plurality of molecules. For example, a structural analogue of a molecule may include a structural isomer, a degradation product, an adduct, an unreacted molecule, or an impurity of a fifth plurality of molecules that has been incorporated into a passivating layer. A method may further comprise coupling a sixth plurality of molecules to a solid support, in which at least a first fraction of the sixth plurality of molecules is coupled to defects of a second plurality of defects. In some cases, a sixth plurality of molecules may comprise a first fraction and a second fraction, in which the first fraction of the sixth plurality of molecules is coupled to defects of a second plurality of defects, and in which the second fraction of the sixth plurality of molecules is coupled to defects of a first plurality of defects.

A method, as set forth herein, may comprise coupling a molecule or moiety to a surface defect of a surface of a single-analyte array, in which the molecule or moiety provides a similar chemical or physical property to the surface of the single-analyte array as already exists. For example, a passivating molecule may be coupled to a defect of a surface layer comprising a plurality of passivating molecules. In another example, a coupling molecule may be coupled to a defect of a surface layer comprising a plurality of coupling molecules. In particular cases, a molecule or moiety may be coupled to a defect of a surface layer, in which the molecule or moiety is chemically similar (structurally or with regard to a physical property) or chemically identical to a molecule or a plurality of molecules that comprises the surface layer. For example, a PEG moiety may be coupled to a defect of a PEGylated surface layer. In other particular cases, a molecule or moiety may be coupled to a defect of a surface layer, in which the molecule or moiety is not chemically similar (structurally or with regard to a physical property) or chemically identical to a molecule or a plurality of molecules that comprises the surface layer. For example, an alkane moiety may be coupled to a defect of a PEGylated surface layer.

A method, as set forth herein, may comprise coupling a molecule or moiety to a surface defect of a surface of a single-analyte array, in which the molecule or moiety provides a differing chemical or physical property to the surface of the single-analyte array as already exists. A differing chemical or physical property may be provided to a surface layer for numerous reasons, including but not limited to: 1) inhibiting certain orthogonal binding interactions between a surface layer and an unbound moiety; 2) providing an additional mechanism of binding inhibition for an orthogonal binding interaction between a surface layer and an unbound moiety; 3) inhibiting a mechanism of chemical or physical degradation of an analyte; 4) inhibiting a mechanism of chemical or physical degradation of a surface layer; 5) providing additional sites for controlled coupling of other molecules or moieties to a surface layer; or 6) combinations thereof.

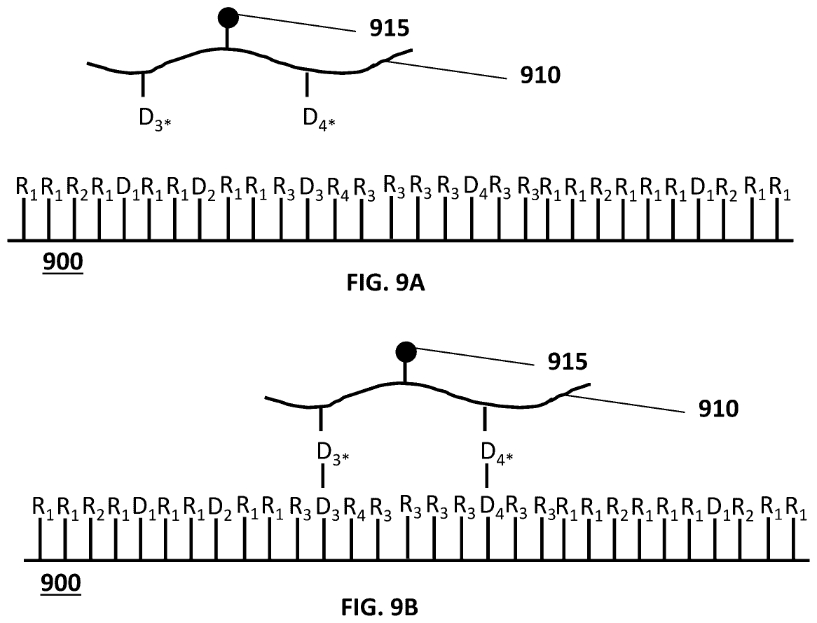

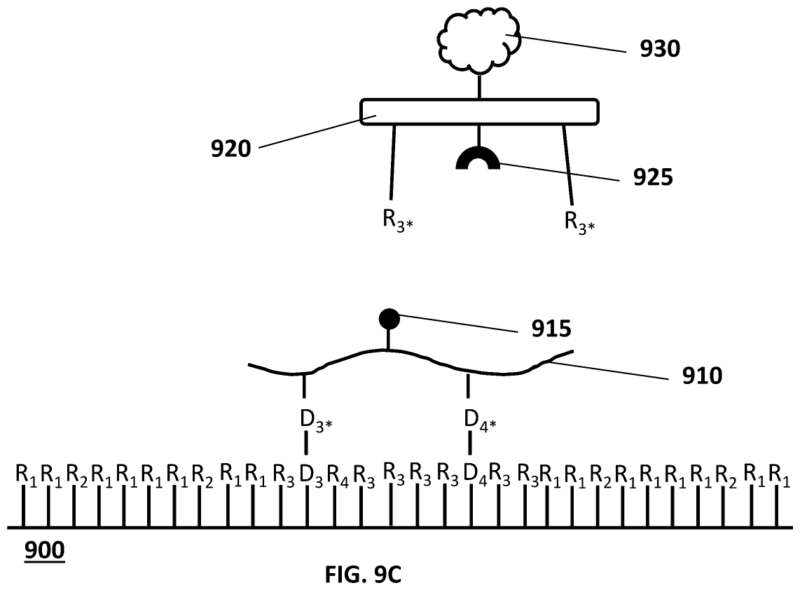

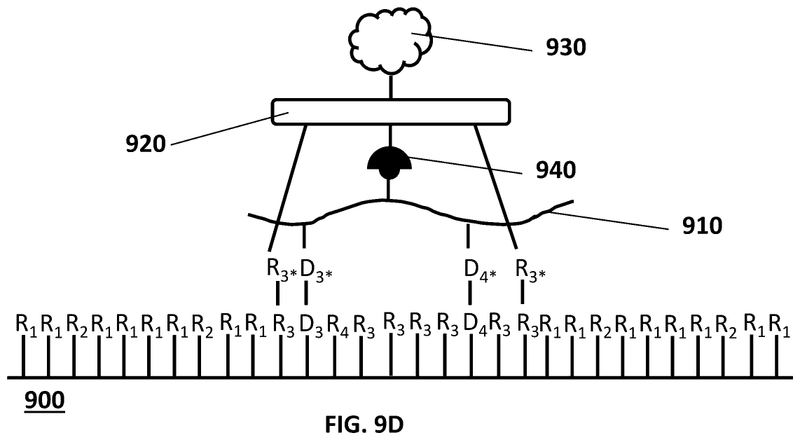

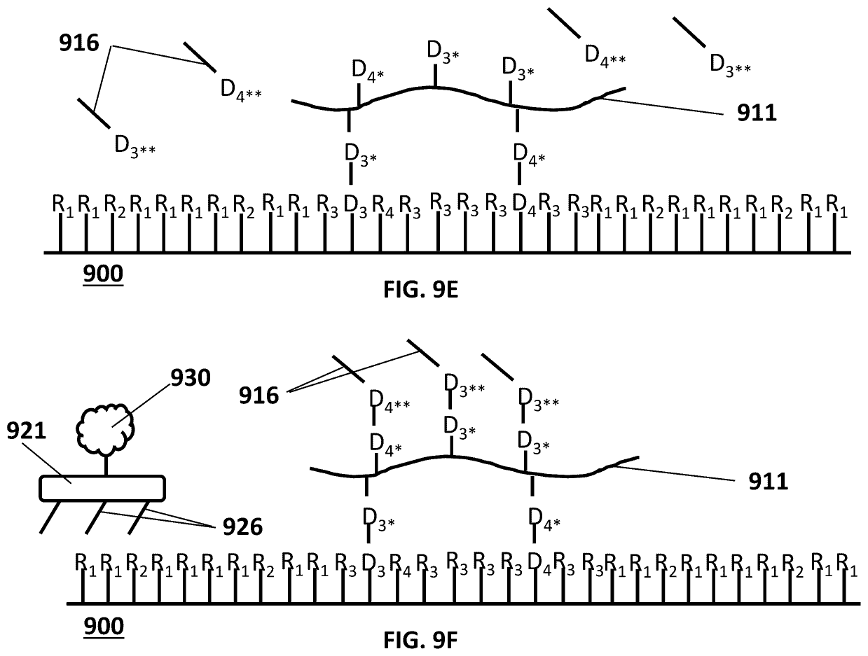

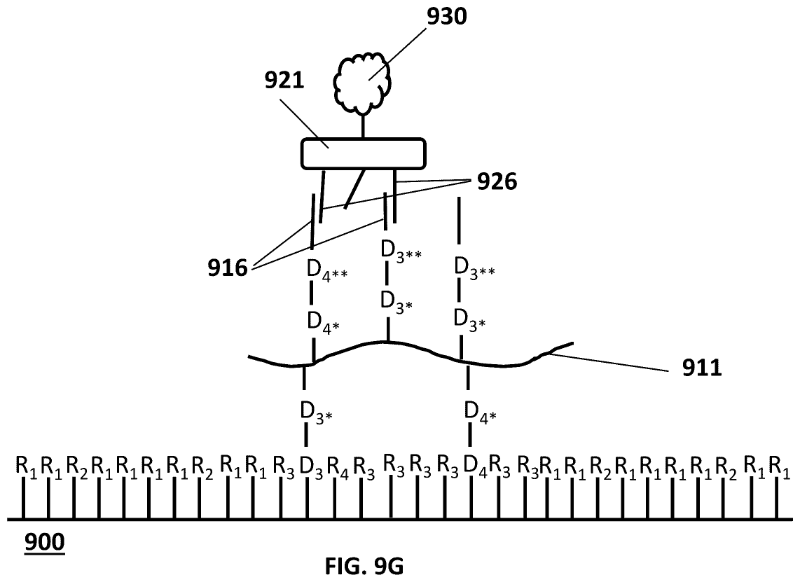

FIGS. 9A-9G illustrate a method of attaching molecules or moieties to a surface utilizing defects in a surface layer. FIG. 9A depicts a step of attaching a moiety (e.g., a polymeric molecule) to an analyte binding site. A solid support 900 comprises an analyte binding site containing a plurality of molecules comprising moieties R₃ or R₄ and at least one interstitial region containing a plurality of molecules comprising moieties R₁ or R₂. The analyte binding site also comprises two or more defects with differing chemical properties (D₃ and D₄, respectively), and the at least one interstitial region comprises two or more defects with differing chemical properties (D₁ and D₂, respectively). The solid support 900 is contacted with a moiety 910, in which the moiety 910 comprises moieties D_{3*} and D_{4*} that are configured to bind the moiety 910 to defects D₃ and D₄, respectively. The moiety 910 further comprises a coupling group 915 that is configured to facilitate binding of an analyte to the analyte binding site. FIG. 9B depicts a configuration in which the moiety 910 has been coupled to the analyte binding site of solid support 900 by binding interactions (e.g., covalent or non-covalent interactions) between defects D₃ and D₄ and moieties D_{3*} and D_{4*}, respectively. FIG. 9C depicts contacting an analyte 930 with the solid support 900. The analyte 930 is coupled to an anchoring moiety 920 (e.g., a nucleic acid particle). The anchoring moiety comprises groups R_{3*} and R_{4*} that are configured to form binding interactions with moieties R₃ and R₄, respectively, and complementary coupling group 925 that is configured to form a coupling interaction with coupling group 915. FIG. 9D depicts a configuration in which the analyte is coupled to the analyte binding site by binding interactions between moieties R_{3*}, R_{4*}, and complementary coupling group 925 with moieties R₃, R₄, and coupling group 915, respectively. Moiety 910 may be configured to inhibit orthogonal binding interactions at the analyte binding site. Moiety 910 may also be configured to provide a second mechanism for coupling an analyte to an analyte binding site. For example, binding interactions between R3 and R3* or R4 and R4* may be kinetically rapid (e.g., nucleic acid hybridization) relative to a binding interaction between coupling group 915 and complementary coupling group 925 (e.g., a Click-type reaction). Such a configuration may be advantageous for rapidly positioning an analyte at a binding site before more permanently binding the analyte to the analyte binding site.

FIGS. 9E-9G depict an alternative method of coupling an analyte to an analyte binding site. FIG. 9E depicts the solid support of FIG. 9A with a coupled moiety 911 containing an excess of moieties D3* and D4*. The solid support 900 is contacted with a plurality of coupling moieties 916 (e.g., oligonucleotides) containing either moieties D3** or D4** that are configured to couple to moieties D3* or D4*, respectively. FIG. 9F depicts the solid support 900, in which the plurality of coupling moieties 916 have become coupled to moiety 911 by interactions between moieties D3* and D4* with moieties D3** and D4**, respectively. The solid support 900 is contacted with an analyte 930. The analyte is coupled to an anchoring moiety 921 (e.g., a nucleic acid particle) containing complementary coupling moieties 926 that are configured to form binding interactions with coupling moieties 916. FIG. 9G depicts a configuration in which the analyte has become bound to the analyte binding site by coupling of the complementary coupling moieties 926 of the anchoring moiety 921 to the coupling moieties 916 that are coupled to the moiety 911.

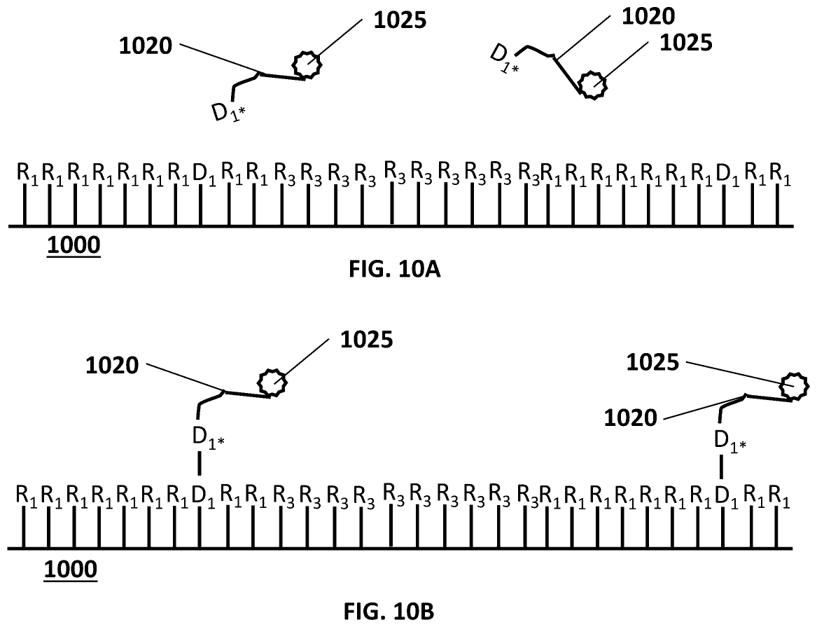

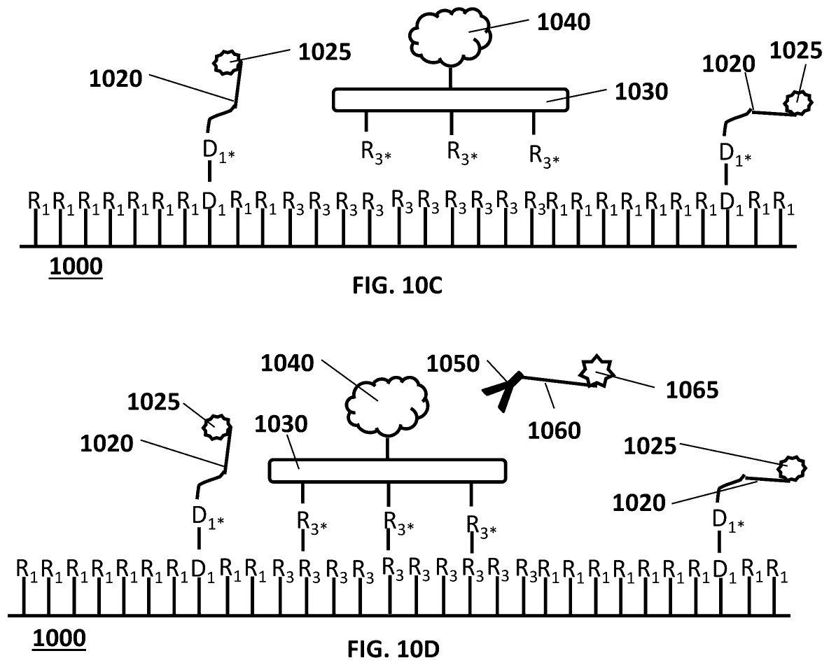

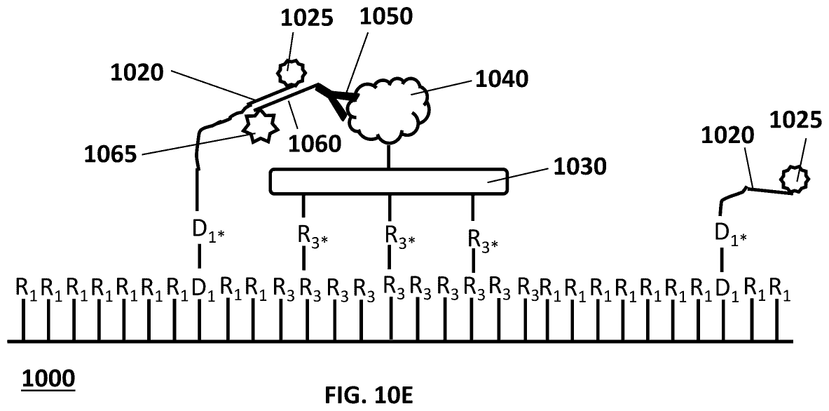

FIGS. 10A-10E depict an alternative scheme for coupling molecules or moieties to a surface layer of a single-analyte array utilizing defects in the surface layer. In the illustrated scheme, molecules or moieties are attached to a surface to facilitate detection of an analyte at an analyte binding site of the single-analyte array. FIG. 10A depicts a solid support 1000 comprising an analyte binding site containing a plurality of molecules R3 and at least one interstitial region containing a plurality of molecules R1. The at least one interstitial region comprises defects D1. The solid support 1000 is contacted with a plurality of detectable molecules or moieties (e.g., oligonucleotides), in which a molecule or moiety 1020 of the plurality of detectable molecules or moieties comprises a first detectable label 1025 and a moiety D1* that is configured to couple the molecule or moiety 1020 to a defect D1. FIG. 10B depicts a configuration of the solid support 1000, in which molecules or moieties 1020 of the plurality of molecules or moieties are coupled to defects D1 by binding interactions between defects D1 and moieties D1*. FIG. 10C illustrates contacting the solid support 1000 with an analyte 1040 that is coupled to an anchoring moiety (e.g., a nucleic acid particle) comprising moieties R3* that are configured to bind to molecules R3 at the analyte binding site. FIG. 10D depicts a configuration of the single-analyte array in which the analyte 1040 is bound at the single-analyte binding site by binding interactions between moieties R3* and molecules R3. The solid support 1000 is contacted with a detectable probe 1060 comprising an affinity agent 1050 (e.g., an antibody, an aptamer, a peptamer, etc.) and a second detectable label 1065. The detectable probe 1060 is configured to form a binding interaction with the molecule or moiety 1020 (e.g., by nucleic acid hybridization). The affinity agent 1050 is configured to have a binding specificity for the analyte 1040. FIG. 10E depicts a configuration in which the detectable probe 1060 is coupled to the analyte 1040 by a binding interaction between the affinity agent 1050 and the analyte 1040. A second binding interaction is formed between the detectable probe 1060 and the molecule or moiety 1020, thereby bringing the first detectable label into close proximity to the second detectable label 1065. Such a system may be useful, for example, with detectable label pairs that form a Forster resonant energy transfer (FRET) pair.

A method, as set forth herein, may comprise a step of providing a single-analyte array comprising a surface layer, in which the surface layer comprises one or more defects. In some cases, a defect of a surface layer may be formed spontaneously. For example, a defect may be formed during formation of a surface layer due to incorporation of impurities, presence of impurities on a surface of a solid support, or cross-reactivity of two molecules of the surface layer. In another example, a defect of a surface layer may form during a single-analyte assay or process. Accordingly, a method, as set forth herein, may further include one or more steps of a single-analyte assay or process before and/or after providing a surface layer comprising a defect.

In other cases, a defect of a surface layer may be formed by a designed or engineered process. A designed or engineered process may include one or more steps that are configured to produce a defect in a surface layer. In particular cases, a designed or engineered process may comprise performing a surface layer formation process at a known suboptimal formation condition. For example, a designed or engineered surface layer formation process may include one or more conditions of: 1) providing a surface of a solid support comprising one or more defect-facilitating regions; 2) providing a plurality of molecules comprising an impurity; 3) providing a deficit or an excess of a plurality of molecules relative to a quantity of molecules needed to form a complete surface layer; 4) providing a deposition condition (e.g., temperature, pressure, concentration, pH, ionic strength, etc.) for a plurality of molecules that inhibits complete formation of a surface layer comprising the plurality of molecules or facilitates formation of defects in the surface layer; 5) providing a processing condition (e.g., temperature, pressure, irradiation, pH change, presence of a reactive chemical species, etc.) after a surface layer formation process that facilitates formation of a defect; or 6) combinations thereof.

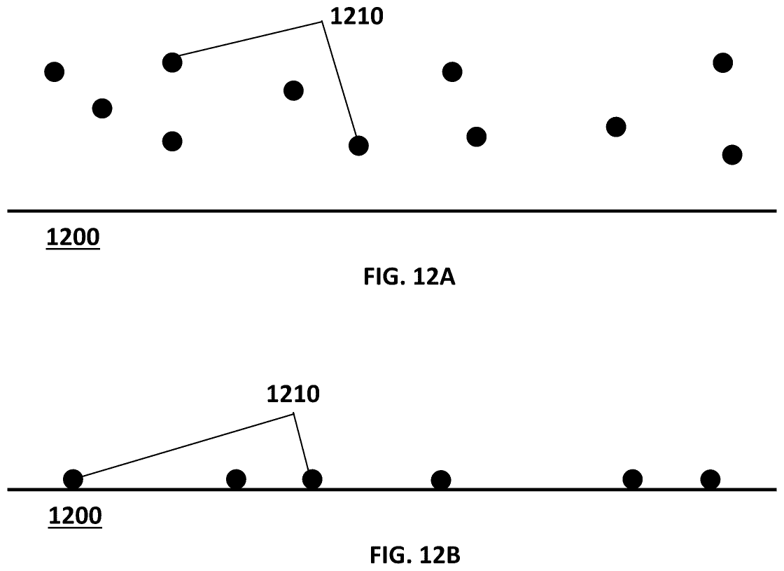

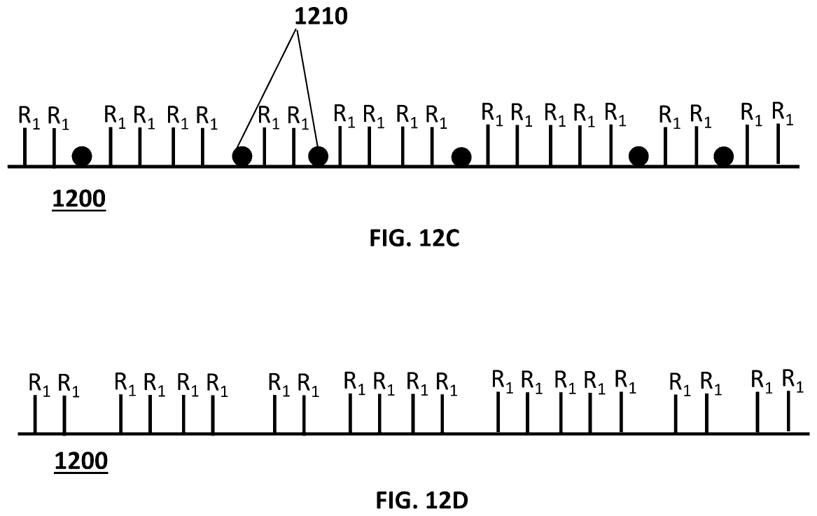

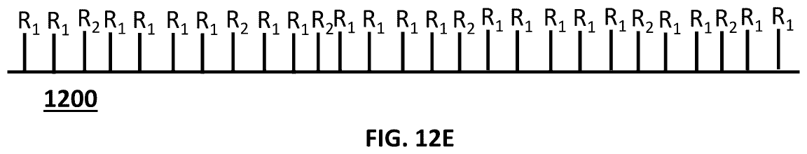

FIGS. 12A-12E illustrate a method of providing a surface layer comprising a plurality of defects by an engineered process. FIG. 12A illustrates a solid support 1200 that is contacted with a plurality of particles 1210 (e.g., organic nanoparticles, inorganic nanoparticles, sputtered metals, etc.). The particles may be deposited by any suitable method, such as settling, precipitation, electrostatic bonding, aggregation, etc. FIG. 12B depicts a subsequent configuration, in which the plurality of particles 1210 is deposited in a spatially-random distribution on a surface of the solid support 1200. FIG. 12C depicts coupling of a plurality of molecules R1 to the surface of the solid support 1200. The molecules R1 are not depicted as depositing on the particles 1210, but in some cases, they may deposit on the particles. FIG. 12D depicts a subsequent step, in which the plurality of particles 1210 have been separated from the surface of the solid support 1200, thereby forming a plurality of defects comprising an absence of a molecule R1. FIG. 12E depicts a final step, in which a second plurality of molecules R2 have been deposited at defects created by the preceding engineered process.

A designed or engineered process may be modified to produce a desired surface defect size or density at a region of a single-analyte array (e.g., an interstitial region, an analyte binding site or a plurality thereof). In some cases, deposition of a particle or similar moiety may be utilized to produce a defect comprising an absence of molecules of a surface layer, for example by a process such as the one depicted in FIGS. 12A-12E. The size (e.g., diameter, shape, circumference, etc.) may be chosen to produce a particular size or shape of defect. In some cases, a particle or similar moiety may have a characteristic dimension (e.g., diameter, length, width, etc.) of at least about 1 nanometer (nm), 5 nm, 10 nm, 20 nm, 25 nm, 50 nm, 100 nm, 250 nm, 500 nm, 1 micron (μm), 10 μm, 50 μm, 100 μm, or more than 100 μm. Alternatively or additionally, a particle or similar moiety may have a characteristic dimension of no more than about 100 μm, 50 μm, 10 μm, 1 μm, 500 nm, 250 nm, 100 nm, 50 nm, 25 nm, 20 nm, 10 nm, 5 nm, 1 nm, or less than 1 nm. In some cases, a designed or engineered process may be utilized to produce regions of differing chemical or physical properties on a single-analyte array. For example, a surface layer comprising passivating molecules (e.g., PEG molecules) may be patterned with defects comprising an absence of molecules, then the defects may be subsequently filled with a different species of passivating molecules, a different surface density of passivating molecules, one or more chemical sink moieties, a moiety with a different function (e.g., coupling moieties, detectable moieties, etc.), or a combination thereof.

A method, as set forth herein, may further comprise coupling a plurality of analytes to a plurality of sites of a single-analyte array, as set forth herein. In some cases, after coupling a plurality of analytes to a plurality of sites of a single-analyte array, a site of the plurality of sites may comprise one and only one analyte of the plurality of analytes. In other cases, after coupling a plurality of analytes to a plurality of sites of a single-analyte array, a site of the plurality of sites may comprise two or more analytes of the plurality of analytes. In yet other cases, after coupling a plurality of analytes to a plurality of sites of a single-analyte array, a site of the plurality of sites may have zero analytes of the plurality of analytes. In some cases, a fraction of sites of a plurality of sites may comprise one and only one analyte. In particular cases, a fraction of sites of a plurality comprising one and only one analyte may exceed a fraction of sites containing one and only one analyte as predicted by a Poisson distribution (e.g., at least about 40%, 50%, 60%, 70%, 80%, 90%, 95%, 99%, 99.9%, or greater than 99.9% of sites of a plurality of sites). In particular cases, an analyte of a plurality of analytes is coupled to an anchoring moiety (e.g., a nucleic acid nanoparticle, a non-nucleic acid nanoparticle), in which the anchoring moiety is configured to couple the analyte to a site of the plurality of sites, and in which the anchoring moiety is configured to occlude contact of the analyte with the site of the plurality of sites.

In some cases, coupling a plurality of analytes to a plurality of sites may occur after coupling the second plurality of organic molecules. For example, a single-analyte array comprising a first plurality of molecules and a second plurality of molecules may be formed, then a plurality of analytes may be coupled to the formed single-analyte array. In other cases, coupling a plurality of analytes to a plurality of sites may occur before coupling the second plurality of organic molecules. For example, a plurality of analytes may be coupled to a plurality of sites of a single-analyte array comprising a plurality of defects, then a second plurality of molecules may be coupled to defects of the plurality of defects. Such a method may be utilized if a plurality of defects comprises a chemical property that is unlikely to facilitate binding of analytes, but may facilitate subsequent binding of an assay agent after coupling analytes.

A method, as set forth herein, may further comprise contacting a solid support with a plurality of assay agents, thereby coupling one or more assay agents of the plurality of assay agents to the solid support. In some cases, coupling an assay agent of the plurality of assay agents to the solid support may comprise coupling the assay agent to a defect of a plurality of defects on the solid support. In other cases, coupling an assay agent to the solid support may comprise coupling the assay agent to a site of a plurality of sites on the solid support (e.g., coupling an assay agent to an analyte that is coupled to the site of the plurality of sites). In some cases, an assay agent may comprise an analyte, an affinity agent, or a reagent other than an analyte or an affinity agent (e.g., an ionic species, a small molecule compound, a macromolecular compound)

In some cases, contacting a solid support with a plurality of assay agents may comprise contacting a solid support with a fluidic medium containing the plurality of assay agents. In particular cases, a method may further comprise, after coupling one or more assay agents to a solid support, altering a condition of a fluidic medium that is contacted with the assay agent(s), thereby decoupling the assay agent(s) from the solid support. Altering a condition of a fluidic medium may comprise altering a pH, an ionic strength, a reagent concentration, or a combination thereof, of the fluidic medium.

A method, as set forth herein, may comprise binding a molecule of a second plurality of molecules to a defect of a plurality of defects, in which the defect of the plurality of defects comprises a molecule-binding site that is configured to bind the molecule of the second plurality of organic molecules or a molecule of a first plurality of organic molecules. For example, after coupling a first plurality of molecules to a surface of a solid support, one or more molecule-binding sites may be unoccupied (e.g., a void space in a substantially uniform layer), thereby permitting a molecule of a second plurality of molecules to be bound to a molecule-binding site of the one or more molecule-binding sites. A method, as set forth herein, may comprise binding one or more molecules to one or more defects, in which the defect(s) comprise(s) a structural analogue of the molecule(s) (e.g., a structural isomer, a degradation product, an adduct, an unreacted molecule, or an impurity of the molecule of the first plurality of molecules).

A method, as set forth herein, may comprise coupling one or more second molecules to one or more defects, in which of the second molecule(s) comprise(s) a passivating moiety and a reactive moiety. In some cases, one or more second molecules may comprise a passivating moiety and a reactive moiety, in which the reactive moiety is configured to covalently bind to a defect. For example, a second molecule may comprise a carboxylated or aminated dextran molecule. In other cases, a second molecule may comprise a passivating moiety and a reactive moiety, in which the reactive moiety is configured to form a specific binding interaction with an assay agent. For example, after coupling a second molecule to a defect, a reactive moiety of the molecule may be coupled to an assay agent comprising a complementary reactive moiety.

In another aspect, provided herein is a method, comprising: a) providing an array comprising a solid support, in which the array comprises: i) a plurality of sites, in which a site of the plurality of sites is configured to couple one and only one analyte, ii) one or more interstitial regions, in which a site of the plurality of sites is separated from other sites of the plurality of sites by the one or more interstitial regions, and iii) a surface-bound layer comprising a plurality of molecules (e.g., organic molecules), in which the surface-bound layer comprises a first plurality of defects and a second plurality of defects, in which the first plurality of defects is chemically distinguishable from the second plurality of defects, b) contacting the array with a second plurality of molecules, and c) coupling a first fraction of the second plurality of molecules to the first plurality of defects, and coupling a second fraction of the second plurality of molecules to the second plurality of defects. In some cases, an array may be contacted with a second plurality of molecules, in which the second plurality of molecules comprises a first species of molecules and a second species of molecules, in which the first species of molecules is configured to bind to the first fraction of defects, and in which the second species of molecules is configured to bind to the second fraction of defects. In other cases, an array may be contacted with a second plurality of molecules, in which the second plurality of molecules comprises only one species of molecules, and in which the only one species of molecules is configured to couple to a first fraction of defects and a second fraction of defects. In some cases, a first fraction of defects may be chemically distinguishable from a second fraction of defects based upon a chemical composition, a physical property, a presence or absence of a molecule, or a combination thereof. In some cases, an array may comprise a surface-bound layer, in which the surface-bound layer is coupled to a site of the array, or a plurality of sites of the array. In some cases, an array may comprise a surface-bound layer, in which the surface-bound layer is coupled to an interstitial region of the array. In some cases, an array may comprise a first surface-bound layer and a second surface-bound layer, in which the first surface-bound layer is coupled to a site of the array, and in which the second surface-bound layer is coupled to an interstitial region of the array.

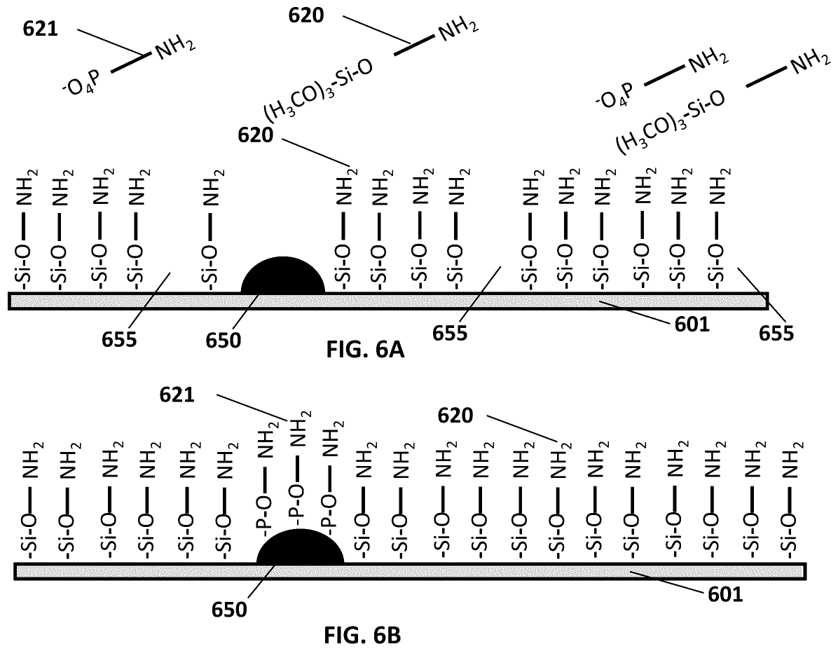

FIGS. 6A-6B depict a method of binding a mixture of a first species of molecules and a second species of molecules to a single-analyte array comprising defects. FIG. 6A depicts a solid support 601 (e.g., a silicon-containing material) comprising a surface containing a bound plurality of molecules 620 (e.g., passivating molecules, coupling molecules). The surface also comprises a manufacturing defect 650 (e.g., a metal or metal oxide particle) that is disposed upon the surface of the solid support 601. The surface further comprises three defects 655 comprising an absence of a molecule bound to the solid support 601. The solid support 601 is contacted with a plurality of molecules under conditions that will promote binding of the molecules to the defects 650 and 655. The plurality of molecules comprises a mixture of a first silane species 620 and a second phosphate species 621. FIG. 6B depicts a final product, in which molecules of the plurality of molecules have bound to the solid support 601. The silane molecules 620 have become bound to vacant defects 655, thereby removing the vacant defects 655. The phosphate molecules 621 have become bound to the manufacturing defect 650, thereby providing a layer or coating that partially or fully conceals the defect 650.

Provided herein are compositions that may be advantageous for coupling molecules to surface-coupled molecules or moieties, as set forth herein. In an aspect, provided herein is a composition, comprising: a) a solid support, b) a first plurality of molecules coupled to the solid support, in which molecules of the first plurality of molecules comprises reactive functional groups (e.g., a nucleophilic functional group, an electrophilic functional group, a Click-type reagent), and c) an aqueous medium contacted to the solid support, in which the aqueous medium comprises: i) a second plurality of molecules, in which molecules of the second plurality of molecules comprise complementary functional groups (e.g., an N-hydroxysuccinimide (NHS) ester), in which molecules of the second plurality of molecules further comprise polymeric moieties, and ii) a kosmotropic agent or a clouding agent.

An array composition may comprise a first plurality of molecules, in which the first plurality of molecules is coupled to a solid support, and a second plurality of molecules, in which the second plurality of molecules is in an aqueous medium that is in contact with the solid support. In some cases, a second plurality of molecules that is contacted to a solid support may not be coupled to the solid support. In some configurations, an array composition may comprise a first plurality of molecules that is coupled to a solid support, in which the first plurality of molecules comprises a reactive functional group, and may further comprise a second plurality of molecules in an aqueous medium that is contacted to the solid support, in which the second plurality of molecules comprises complementary reactive functional groups, in which reactive functional groups are configured to form covalent bonds with complementary reactive functional groups.

A particularly useful composition may comprise a first plurality of molecules containing nucleophilic functional groups and a second plurality of molecules comprising electrophilic functional groups. In some configurations, a first plurality of molecules may comprise an amine functional group (e.g., a primary amine, a secondary amine, a tertiary amine). In other configurations, a first plurality of molecules may comprise a nucleophilic functional group such as an alcohol, a thiol, an azide, or an amide. In some configurations, a second plurality of molecules may comprise electrophilic functional groups comprising leaving groups, such as activated esters. In a particular configuration, a second plurality of molecules may comprise N-hydroxysuccinimide (NHS) esters. Without wishing to be bound by theory, provided array compositions may be particularly useful when a reactivity of reactive functional groups with complementary functional groups is similar to or lower than a reactivity of water with complementary functional groups. For example, provided compositions may increase a reactivity for nucleophilic substitution of amine functional groups with NHS esters in the presence of water, in which the NHS esters are available to undergo hydrolysis by water.

An array composition may be contacted with an aqueous medium that is configured to facilitate coupling of a plurality of molecules to a plurality of surface-coupled molecules. An aqueous medium may comprise water and one or more of: a) an organic co-solvent, b) a buffering species, c) a kosmotropic agent, and d) a clouding agent. In some configurations, an aqueous medium may comprise water and: a) an organic co-solvent, b) a buffering species, and c) a kosmotropic agent. In other configurations, an aqueous medium may comprise water and: a) an organic co-solvent, b) a buffering species, and c) a clouding agent. In some configurations, an aqueous medium may comprise water and: a) an organic co-solvent, b) a buffering species, c) a kosmotropic agent, and d) a clouding agent.

An aqueous medium may comprise an organic co-solvent. In some cases, an organic co-solvent may be miscible with water. In other cases, an organic co-solvent may be immiscible or partially miscible with water. In some cases, an organic co-solvent may comprise a polar aprotic solvent, such as acetone, acetonitrile, dichloromethane, dimethylformamide, dimethylpropyleneurea, dimethyl sulfoxide, ethyl acetate, hexamethylphosphoramide, pyridine, sulfolane, tetrahydrofuran, or combinations thereof. In some cases, an organic co-solvent may comprise a polar protic solvent, such as formic acid, n-butanol, isopropanol, nitromethane, ethanol, methanol, acetic acid, or combinations thereof. In some cases, an organic co-solvent may comprise a nonpolar solvent, such as pentane, hexane, benzene, chloroform, diethyl ether, 1,4-dioxane, or combinations thereof.

An aqueous medium may comprise an organic co-solvent at a weight percentage of no more than about 70 weight percent (wt %), 60 wt %, 50 wt %, 45 wt %, 40 wt %, 35 wt %, 30 wt %, 25 wt %, 20 wt %, 15 wt %, 10 wt %, 5 wt %, 1 wt %, or less than 1 wt %. Alternatively or additionally an aqueous medium may comprise an organic co-solvent at a weight percentage of at least about 1 wt %, 5 wt %, 10 wt %, 15 wt %, 20 wt %, 25 wt %, 30 wt %, 35 wt %, 40 wt %, 45 wt %, 50 wt %, 60 wt %, 70 wt %, or more than 70 wt %.

An aqueous medium may comprise a buffering species. A buffering species, as set forth herein, may be provided to an aqueous medium to maintain a pH of the aqueous medium. A buffering species may be selected to provide a pH of an aqueous medium of at least about 1.0, 1.5, 2.0, 2.5, 3.0, 3.5, 4.0, 4.5, 5.0, 5.5, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.5, 9.0, 9.5, 10.0, 10.5, 11.0, 11.5, 12.0, 12.5, 13.0, 13.5, 14.0, or more than 14.0. Alternatively or additionally, a buffering species may be selected to provide a pH of an aqueous medium of no more than about 14.0, 13.5, 13.0, 12.5, 12.0, 11.5, 11.0, 10.5, 10.0, 9.5, 9.0, 8.5, 8.0, 7.9, 7.8, 7.7, 7.6, 7.5, 7.4, 7.3, 7.2, 7.1, 7.0, 6.9, 6.8, 6.7, 6.6, 6.5, 6.4, 6.3, 6.2, 6.1, 6.0, 5.5, 5.0, 4.5, 4.0, 3.5, 3.0, 2.5, 2.0, 1.5, 1.0, or less than 1.0.

An aqueous medium may comprise a plurality of molecules, in which molecules of the plurality of molecules comprise: i) a complementary functional group, and ii) a polymeric moiety. A molecule of a plurality of molecules may comprise a polymeric moiety comprising a linear polymeric chain. A molecule of a plurality of molecules may comprise a polymeric moiety comprising a branched polymeric chain. A molecule of a plurality of molecules may comprise a polymeric moiety comprising a dendrimeric polymeric chain. In some cases, a polymeric moiety may comprise a polyethylene glycol (PEG) chain, an alkane chain, a polypeptide chain, a polynucleotide chain, a polysaccharide chain, or a combination thereof. A molecule of a plurality of molecules may comprise a polymeric moiety, in which the polymeric moiety has a molecular weight of at least about 100 Daltons (Da), 250 Da, 500 Da, 1000 Da, 1500 Da, 2000 Da, 2500 Da, 3000 Da, 4000 Da, 5000 Da, 7500 Da, 10000 Da, or more than 10000 Da. Alternatively or additionally, a molecule of a plurality of molecules may comprise a polymeric moiety, in which the polymeric moiety has a molecular weight of no more than about 10000 Da, 7500 Da, 5000 Da, 4000 Da, 3000 Da, 2500 Da, 2000 Da, 1500 Da, 1000 Da, 500 Da, 250 Da, 100 Da, or less than 100 Da.

An aqueous medium may comprise a plurality of molecules, in which molecules of the plurality of molecules comprise: i) a first functional group, ii) a polymeric moiety, and iii) a second functional group. In some cases, a molecule of a plurality of molecules may comprise a first functional group that is configured to covalently bind to a surface-coupled molecule or moiety, and may further comprise a second functional group, in which the second functional group comprises a reactive functional group (e.g., a nucleophilic group, an electrophilic group, a Click-type reactant, etc.). In other cases, a molecule of a plurality of molecules may comprise a first functional group that is configured to covalently bind to a surface-coupled molecule or moiety, and may further comprise a second functional group, in which the second functional group comprises a non-reactive functional group (e.g., an alkyl group, a halide group, etc.). A molecule of a plurality of molecules may comprise a first functional group, a second functional group, and a polymeric moiety, in which the first functional group and the second functional group are terminal moieties of the polymeric moiety. For example, a molecule may comprise a linear PEG chain, with an NHS ester functional group at a first terminus and an azide functional group at a second terminus.

An aqueous medium may further comprise a kosmotropic agent and/or a clouding agent, as set forth herein. In some cases, a kosmotropic agent may be selected from a group consisting of carbonate ion, sulfate ion, phosphate ion, magnesium ion, lithium ion, zinc ion, aluminum ion, trehalose, glucose, proline, tert-butanol, and combinations thereof. In some cases, a clouding agent may be selected from a group consisting of sodium chloride, potassium chloride, sodium bromide, potassium bromide, sodium nitrate, sodium sulfate, sodium phosphate, and combinations thereof. In some cases, a kosmotropic agent that is used in a composition or method set forth herein is not one or more of a carbonate ion, sulfate ion, phosphate ion, magnesium ion, lithium ion, zinc ion, aluminum ion, trehalose, glucose, proline, tert-butanol, and combinations thereof. In some cases, a clouding agent may be selected from a group consisting of sodium chloride, potassium chloride, sodium bromide, potassium bromide, sodium nitrate, sodium sulfate, sodium phosphate. A clouding agent may be provided in an aqueous medium at a concentration that does not exceed a cloud point of a molecule comprising a polymeric moiety. A kosmotropic agent or a clouding agent may be provided in an aqueous medium in a concentration of at least about 1 milliMolar (mM), 10 mM, 50 mM, 100 mM, 150 mM, 200 mM, 250 mM, 300 mM, 350 mM, 400 mM, 450 mM, 500 mM, 550 mM, 600 mM, 650 mM, 700 mM, 750 mM, 800 mM, 900 mM, 1M, 1.5M, 2M, 3M, 4M, 5M, or more than 5M. Alternatively or additionally, a kosmotropic agent or a clouding agent may be provided in an aqueous medium in a concentration of no more than about 5M, 4M, 3M, 2M, 1.5M, 1M, 900 mM, 800 mM, 750 mM, 700 mM, 650 mM, 600 mM, 550 mM, 500 mM, 450 mM, 400 mM, 350 mM, 300 mM, 250 mM, 200 mM, 150 mM, 100 mM, 50 mM, 10 mM, 1 mM, or less than 1 mM.

Also provided herein are compositions for inhibiting cross-reactivity between a patternable material and surface-coupled molecules comprising reactive functional groups. In an aspect, provided herein is a composition, comprising: a) a solid support comprising a surface, b) a patternable material disposed on the surface, in which the patternable material comprises a well, in which the well is at least partially bounded by the patternable material, and in which a bottom of the well comprises an exposed portion of the surface, c) a plurality of molecules, in which the molecules are coupled to the exposed portion of the surface, and in which molecules of the plurality of molecules comprise reactive functional groups, and d) a plurality of protectant moieties, in which the plurality of protectant moieties is dispersed within the patternable material.

An array composition may comprise a plurality of surface-coupled molecules or moieties that are coupled to a surface of a solid support adjacent to a patternable material. In some configurations, a plurality of surface-coupled molecules or moieties may comprise reactive moieties or reactive functional groups (e.g., nucleophilic moieties, electrophilic moieties, Click-type reactants, etc.). In some configurations, a surface-coupled moiety or molecule may be configured to couple to an analyte or an anchoring moiety, as set forth herein. In some configurations, a surface-coupled moiety or molecule may be coupled to an analyte or an anchoring moiety, as set forth herein. In some configurations, a surface-coupled moiety or molecule may be configured to couple to another molecule (e.g., a molecule comprising a polymeric moiety, a molecule comprising a moiety that is configured to couple an analyte to a surface, etc.). In some configurations, a surface-coupled moiety or molecule may be coupled to another molecule. In some configurations, a first subset of molecules or moieties of a plurality of surface-coupled molecules or moieties may be coupled to a second plurality of molecule or moieties, and a second subset of molecules or moieties of a plurality of surface-coupled molecules or moieties may not be coupled to a second plurality of molecule or moieties. For example, an array composition may be formed by covalently coupling a plurality of molecules to a plurality of surface-coupled molecules, in which not all surface-coupled molecules form a covalent bond to molecules of the plurality of molecules.

An array composition may comprise a patternable material disposed on a surface of a solid support, in which a plurality of surface-coupled moieties comprising reactive functional groups is disposed adjacent to the patternable material. A patternable material may comprise reactive moieties. For example, an organic photoresist material may comprise a molecular structure that contains nucleophilic and/or electrophilic moieties. Accordingly, such an organic photoresist material can be susceptible to cross-reactivity with reactive functional groups of adjacent surface-coupled molecules or moieties. In some configurations, an array composition may comprise: a) a solid support, b) a patternable material disposed on a surface of the solid support, and c) a plurality of surface-coupled molecules disposed on the surface of the solid support, in which molecules of the plurality of surface-coupled molecules are coupled to the surface of the solid support adjacent to the patternable material, and in which the plurality of surface-coupled molecules comprises reactive functional groups that are configured to undergo a covalent reaction with molecules or moieties of the patternable material. In particular configurations, an array composition may further comprise a fluidic medium that is configured to facilitate a reaction between a reactive functional group of a surface-coupled molecule and a patternable material.

An array composition may comprise a surface layer disposed on a surface of a solid support, in which the surface layer comprises an admixture of a patternable material and protectant moieties or molecules. Protectant moieties or molecules may be configured to inhibit a reaction between a reactive functional group of a surface-coupled molecule and a patternable material. In some configurations, a protectant moiety of a plurality of protectant moieties may comprise a reactive functional groups, in which a reactivity between the reactive functional group and a patternable material is higher than a reactivity between a reactive functional group of a surface-coupled molecule or moiety and the patternable material. For example, a protectant moiety may comprise a stronger nucleophilic functional group than a nucleophilic functional group of a surface-coupled molecule. In other configurations, an admixture of a plurality of protectant moieties comprising reactive functional groups and a patternable material may provide a higher effective concentration of reactive functional groups of the plurality of protectant moieties relative to a concentration of reactive functional groups of a plurality of surface-coupled moieties. Accordingly, reactions between protectant moieties and a patternable material may kinetically predominate even if surface-coupled moieties comprise reactive functional groups with a higher intrinsic reactivity for the patternable material.

A protectant moiety or molecule, as set forth herein, may comprise one or more of: i) a reactive moiety or functional group, and ii) a moiety that is configured to permeate the protectant moiety into a patternable material. In some configurations, a protectant moiety may comprise one or more molecular chains, in which the molecular chains are configured to permeate the protectant moiety into a patternable material. For example, a protectant moiety may comprise a non-polar molecular chain (e.g., an alkyl group) that facilitate permeation into a non-polar patternable material. In an advantageous configuration, a protectant moiety may comprise a surfactant molecule. A surfactant molecule may comprise: i) a tail group that is configured to permeate into a patternable material, and ii) a reactive head group that is configured to remain in contact with a fluidic medium. For example, a surfactant may comprise a non-polar tail group that is configured to permeate a non-polar patternable medium and a reactive, polar head group that is configured to remain in contact with a polar fluidic medium. Such a composition may advantageously concentrate reactive functional groups of protectant moieties near surfaces of a patternable material (e.g., adjacent to sidewalls of wells) where cross-reactions with reactive functional groups of surface-coupled moieties or molecules are most likely to occur. Accordingly, in some configurations, a concentration of protectant moieties in a patternable material may be higher near surfaces of the patternable material that are contactable with a fluidic medium (e.g., external surfaces, surfaces not contacted with a solid support, etc.). In other configurations, a plurality of protectant moieties may have a substantially uniform concentration in a patternable material.

An array composition, as set forth herein, may be contacted with a fluidic medium. In some configurations, a fluidic medium in contact with an array composition may comprise protectant moieties, as set forth herein. For example, a fluidic medium comprising protectant moieties may be contacted with an array composition during a process of forming an admixture comprising a patternable material and a plurality of protectant moieties. In another example, a fluidic medium may be contacted with an array composition during an assay step or an array formation step, in which the fluidic medium comprises protectant moieties. Such a composition may be advantageous for maintaining a concentration or quantity of protectant moieties in an admixture comprising a patternable material and a plurality of protectant moieties.

An array composition, as set forth herein, may be contacted with a dissolution medium. A dissolution medium may be configured to separate patternable material from a surface of a solid support. In some configurations, a dissolution medium may facilitate a reaction between a reactive functional group or moiety and a patternable material. For example, a dissolution medium may facilitate a reaction between a reactive functional group of a protectant moiety and a patternable material. In another example, a dissolution medium may facilitate a reaction between a reactive functional group of a surface-coupled molecule or moiety and a patternable material. In some configurations, a dissolution may facilitate an extent of reaction between reactive functional groups of protectant moieties and a patternable material relative to an extent of reaction between reactive functional groups of surface-coupled molecules and a patternable material. In some configurations, dissolution may enhance a rate of reaction between reactive functional groups of protectant moieties and a patternable material relative to a rate of reaction between reactive functional groups of surface-coupled molecules and a patternable material.

A perimeter material may be formed adjacent to a site of a single-analyte array, for example due to cross-reactivity of a patternable material with a surface-coupled molecule or moiety. A characteristic size of a perimeter material (e.g., a diameter, a length, a width, a circumference, a surface area, a volume) may be measured by any suitable technique, such as scanning electron microscopy, transmission electron microscopy, or atomic force microscopy. A characteristic size of a perimeter material may be increased or decreased by a method set forth herein. For example, relative to a method of array formation that forms a perimeter material, a method of inhibiting perimeter material formation, as set forth herein, may reduce a diameter, surface area, or volume of the formed perimeter material. In another example, relative to a method of array formation that forms a perimeter material, a method of incorporating moieties (e.g., photodamage inhibitors) into a perimeter material, as set forth herein, may increase a diameter, surface area, or volume of the formed perimeter material. A characteristic size of a perimeter material may increase by at least about 1%, 5%, 10%, 20%, 30%, 40%, 50%, 75%, 100%, 200%, 300%, 400%, 500%, 1000%, or more than 1000%. Alternatively, a characteristic size of a perimeter material may increase by no more than about 1000%, 500%, 400%, 300%, 200%, 100%, 75%, 50%, 40%, 30%, 20%, 10%, 5%, 1%, or less than 1%. A characteristic size of a perimeter material may decrease by at least about 1%, 5%, 10%, 20%, 30%, 40%, 50%, 75%, 90%, 95%, 99%, 99.9% or more than 99.9%. Alternatively, a characteristic size of a perimeter material may decrease by no more than about 99.9%, 99%, 95%, 90%, 75%, 50%, 40%, 30%, 20%, 10%, 5%, 1%, or less than 1%.

In another aspect, provided herein is an array composition, comprising: a) a solid support comprising a surface, and b) a solid-phase admixture disposed on the surface, in which the solid-phase admixture comprises a patternable material and a plurality of chemical sink moieties, as set forth herein. In particular configurations, an array composition may further comprise a plurality of surface-coupled molecules or moieties coupled to a surface of a solid support, in which molecules or moieties of the plurality of surface-coupled molecules or moieties are adjacent to an admixture comprising a patternable material and a plurality of chemical sink moieties (e.g., adjacent to a sidewall of a well or well-like structure in the patternable material).

In some configurations, an admixture may comprise a patternable material and a plurality of chemical sink moieties, in which the plurality of chemical sink moieties is dispersed in a spatially homogeneous manner. In other configurations, an admixture may comprise a patternable material and a plurality of chemical sink moieties, in which the plurality of chemical sink moieties is dispersed in a spatially heterogeneous manner. For example, a concentration of chemical sink moieties dispersed in a patternable material may be higher near surfaces of the patternable material that are contactable with a fluidic medium (e.g., external surfaces, surfaces not contacted with a solid support, etc.). In some configurations, an admixture may comprise a patternable material and a plurality of particles, in which particles of the plurality of particles comprise chemical sink moieties. In particular configurations, one or more chemical sink moieties may be covalently coupled to a particle that is dispersed within a patternable material. In other particular configurations, one or more chemical sink moieties may be non-covalently coupled to a particle that is dispersed within a patternable material.

In another aspect, provided herein is an array composition, comprising: a) a solid support comprising a surface, b) a plurality of molecules coupled to a portion of the surface, and c) a perimeter material disposed on the surface adjacent to the portion of the surface, in which the perimeter material comprises a molecule of the plurality of molecules covalently coupled to a molecule of a patternable material, and in which the perimeter material further comprises a chemical sink moiety. An array composition may further comprise an analyte coupled to a plurality of molecules (e.g., an analyte binding site). In some configurations, an array composition may comprise an anchoring moiety (e.g., a nucleic acid nanoparticle) coupled to a plurality of molecules, in which the anchoring moiety is coupled to an analyte.

In another aspect, provided herein is a system, comprising: a) an array composition, as set forth herein, in which the array composition comprises a perimeter material comprising a chemical sink moiety, and b) a light source, in which the light source is configured to produce light with a wavelength that is absorbed by the chemical sink moiety. In some configurations, a system may further comprise an analyte coupled to the array composition. In particular configurations, a system may further comprise an analyte coupled adjacent to a perimeter material.

### Polypeptide Assays

The present disclosure provides compositions, apparatus and methods that can be useful for characterizing sample components, such as proteins, nucleic acids, cells or other species, by obtaining multiple separate and non-identical measurements of the sample components. In particular configurations, the individual measurements may not, by themselves, be sufficiently accurate or specific to make the characterization, but an aggregation of the multiple non-identical measurements can allow the characterization to be made with a high degree of accuracy, specificity and confidence. For example, the multiple separate measurements can include subjecting the sample to reagents that are promiscuous with regard to recognizing multiple components of the sample. Accordingly, a first measurement carried out using a first promiscuous reagent may perceive a first subset of sample components without distinguishing one component from another. A second measurement carried out using a second promiscuous reagent may perceive a second subset of sample components, again, without distinguishing one component from another. However, a comparison of the first and second measurements can distinguish: (i) a sample component that is uniquely present in the first subset but not the second; (ii) a sample component that is uniquely present in the second subset but not the first; (iii) a sample component that is uniquely present in both the first and second subsets; or (iv) a sample component that is uniquely absent in the first and second subsets. The number of promiscuous reagents used, the number of separate measurements acquired, and degree of reagent promiscuity (e.g. the diversity of components recognized by the reagent) can be adjusted to suit the component diversity expected for a particular sample.

The present disclosure provides assays that are useful for detecting one or more analytes. Exemplary assays are set forth herein in the context of detecting proteins. Those skilled in the art will recognize that methods, compositions and apparatus set forth herein can be adapted for use with other analytes such as nucleic acids, polysaccharides, metabolites, vitamins, hormones, enzyme co-factors and others set forth herein or known in the art. Particular configurations of the methods, apparatus and compositions set forth herein can be made and used, for example, as set forth in U.S. Pat. No. 10,473,654 or US Pat. App. Pub. Nos. 2020/0318101 A1 or 2020/0286584 A1, each of which is incorporated herein by reference. Exemplary methods, systems and compositions are set forth in further detail below.

A composition, apparatus or method set forth herein can be used to characterize an analyte, or moiety thereof, with respect to any of a variety of characteristics or features including, for example, presence, absence, quantity (e.g. amount or concentration), chemical reactivity, molecular structure, structural integrity (e.g. full length or fragmented), maturation state (e.g. presence or absence of pre- or pro-sequence in a protein), location (e.g. in an analytical system, subcellular compartment, cell or natural environment), association with another analyte or moiety, binding affinity for another analyte or moiety, biological activity, chemical activity or the like. An analyte can be characterized with regard to a relatively generic characteristic such as the presence or absence of a common structural feature (e.g. amino acid sequence length, overall charge or overall pKa for a protein) or common moiety (e.g. a short primary sequence motif or post-translational modification for a protein). An analyte can be characterized with regard to a relatively specific characteristic such as a unique amino acid sequence (e.g. for the full length of the protein or a motif), an RNA or DNA sequence that encodes a protein (e.g. for the full length of the protein or a motif), or an enzymatic or other activity that identifies a protein. A characterization can be sufficiently specific to identify an analyte, for example, at a level that is considered adequate or unambiguous by those skilled in the art.

In particular configurations, a protein can be detected using one or more affinity agents having known or measurable binding affinity for the protein. For example, an affinity agent can bind a protein to form a complex and a signal produced by the complex can be detected. A protein that is detected by binding to a known affinity agent can be identified based on the known or predicted binding characteristics of the affinity agent. For example, an affinity agent that is known to selectively bind a candidate protein suspected of being in a sample, without substantially binding to other proteins in the sample, can be used to identify the candidate protein in the sample merely by observing the binding event. This one-to-one correlation of affinity agent to candidate protein can be used for identification of one or more proteins. However, as the protein complexity (i.e. the number and variety of different proteins) in a sample increases, or as the number of different candidate proteins to be identified increases, the time and resources to produce a commensurate variety of affinity agents having one-to-one specificity for the proteins approaches limits of practicality.

Methods set forth herein, can be advantageously employed to overcome these constraints. In particular configurations, the methods can be used to identify a number of different candidate proteins that exceeds the number of affinity agents used. For example, the number of candidate proteins identified can be at least 5×, 10×, 25×, 50×, 100× or more than the number of affinity agents used. This can be achieved, for example, by (1) using promiscuous affinity agents that bind to multiple different candidate proteins suspected of being present in a given sample, and (2) subjecting the protein sample to a set of promiscuous affinity agents that, taken as a whole, are expected to bind each candidate protein in a different combination, such that each candidate protein is expected to be encoded by a unique profile of binding and non-binding events. Promiscuity of an affinity agent is a characteristic that can be understood relative to a given population of proteins. Promiscuity can arise due to the affinity agent recognizing an epitope that is known to be present in a plurality of different candidate proteins suspected of being present in the given population of unknown proteins. For example, epitopes having relatively short amino acid lengths such as dimers, trimers, or tetramers can be expected to occur in a substantial number of different proteins in the human proteome. Alternatively or additionally, a promiscuous affinity agent can recognize different epitopes (e.g. epitopes differing from each other with regard to amino acid composition or sequence), the different epitopes being present in a plurality of different candidate proteins. For example, a promiscuous affinity agent that is designed or selected for its affinity toward a first trimer epitope may bind to a second epitope that has a different sequence of amino acids when compared to the first epitope.

Although performing a single binding reaction between a promiscuous affinity agent and a complex protein sample may yield ambiguous results regarding the identity of the different proteins to which it binds, the ambiguity can be resolved when the results are combined with other identifying information about those proteins. The identifying information can include characteristics of the protein such as length (i.e. number of amino acids), hydrophobicity, molecular weight, charge to mass ratio, isoelectric point, chromatographic fractionation behavior, enzymatic activity, presence or absence of post translational modifications or the like. The identifying information can include results of binding with other promiscuous affinity agents. For example, a plurality of different promiscuous affinity agents can be contacted with a complex population of proteins, in which the plurality is configured to produce a different binding profile for each candidate protein suspected of being present in the population. In this example, each of the affinity agents can be distinguishable from the other affinity agents, for example, due to unique labeling (e.g. different affinity agents having different luminophore labels), unique spatial location (e.g. different affinity agents being located at different addresses in an array), and/or unique time of use (e.g. different affinity agents being delivered in series to a population of proteins). Accordingly, the plurality of promiscuous affinity agents produces a binding profile for each individual protein that can be decoded to identify a unique combination of epitopes present in the individual protein, and this can in turn be used to identify the individual protein as a particular candidate protein having the same or similar unique combination of epitopes. The binding profile can include observed binding events as well as observed non-binding events and this information can be evaluated in view of the expectation that particular candidate proteins produce a similar binding profile, for example, based on presence and absence of particular epitopes in the candidate proteins.

In some configurations, distinct and reproducible binding profiles may be observed for one or more unknown proteins in a sample. However, in many cases one or more binding events produces inconclusive or even aberrant results and this, in turn, can yield ambiguous binding profiles. For example, observation of binding outcome for a single-molecule binding event can be particularly prone to ambiguities due to stochasticity in the behavior of single molecules when observed using certain detection hardware. The present disclosure provides methods that provide accurate protein identification despite ambiguities and imperfections that can arise in many contexts. In some configurations, methods for identifying, quantitating or otherwise characterizing one or more proteins in a sample utilize a binding model that evaluates the likelihood or probability that one or more candidate proteins that are suspected of being present in the sample will have produced an empirically observed binding profile. The binding model can include information regarding expected binding outcomes (e.g. binding or non-binding) for binding of one or more affinity reagent with one or more candidate proteins. The information can include an a priori characteristic of a candidate protein, such as presence or absence of a particular epitope in the candidate protein or length of the candidate protein. Alternatively or additionally, the information can include empirically determined characteristics such as propensity or likelihood that the candidate protein will bind to a particular affinity reagent. Accordingly, a binding model can include information regarding the propensity or likelihood of a given candidate protein generating a false positive or false negative binding result in the presence of a particular affinity reagent, and such information can optionally be included for a plurality of affinity reagents.

Methods set forth herein can be used to evaluate the degree of compatibility of one or more empirical binding profiles with results computed for various candidate proteins using a binding model. For example, to identify an unknown protein in a sample of many proteins, an empirical binding profile for the protein can be compared to results computed by the binding model for many or all candidate proteins suspected of being in the sample. In some configurations of the methods set forth herein, identity for the unknown protein is determined based on a likelihood of the unknown protein being a particular candidate protein given the empirical binding pattern or based on the probability of a particular candidate protein generating the empirical binding pattern. Optionally a score can be determined from the measurements that are acquired for the unknown protein with respect to many or all candidate proteins suspected of being in the sample. A digital or binary score that indicates one of two discrete states can be determined. In particular configurations, the score can be non-digital or non-binary. For example, the score can be a value selected from a continuum of values such that an identity is made based on the score being above or below a threshold value. Moreover, a score can be a single value or a collection of values. Particularly useful methods for identifying proteins using promiscuous reagents, serial binding measurements and/or decoding with binding models are set forth, for example, in U.S. Pat. No. 10,473,654 US Pat. App. Pub. No. 2020/0318101 A1 or Egertson et al., BioRxiv (2021), DOI: 10.1101/2021.10.11.463967, each of which is incorporated herein by reference.

The present disclosure provides compositions, apparatus and methods for detecting one or more proteins. A protein can be detected using one or more affinity agents having binding affinity for the protein. The affinity agent and the protein can bind each other to form a complex and, during or after formation, the complex can be detected. The complex can be detected directly, for example, due to a label that is present on the affinity agent or protein. In some configurations, the complex need not be directly detected, for example, in formats where the complex is formed and then the affinity agent, protein, or a label component that was present in the complex is detected.

Many protein detection methods, such as enzyme linked immunosorbent assay (ELISA), achieve high-confidence characterization of one or more protein in a sample by exploiting high specificity binding of antibodies, aptamers or other binding agents to the protein(s) and detecting the binding event while ignoring all other proteins in the sample. ELISA is generally carried out at low plex scale (e.g. from one to a hundred different proteins detected in parallel or in succession) but can be used at higher plexity. ELISA methods can be carried out by detecting immobilized binding agents and/or proteins in multiwell plates, on arrays, or on particles in microfluidic devices. Exemplary plate-based methods include, for example, the MULTI-ARRAY technology commercialized by MesoScale Diagnostics (Rockville, Maryland) or Simple Plex technology commercialized by Protein Simple (San Jose, CA). Exemplary, array-based methods include, but are not limited to those utilizing Simoa® Planar Array Technology or Simoa® Bead Technology, commercialized by Quanterix (Billerica, MA). Further exemplary array-based methods are set forth in U.S. Pat. Nos. 9,678,068; 9,395,359; 8,415,171; 8,236,574; or 8,222,047, each of which is incorporated herein by reference. Exemplary microfluidic detection methods include those commercialized by Luminex (Austin, Texas) under the trade name xMAP® technology or used on platforms identified as MAGPIX®, LUMINEX® 100/200 or FEXMAP 3D®.

Other detection methods that can also be used, for example at low plex scale, include procedures that employ SOMAmer reagents and SOMAscan assays commercialized by Soma Logic (Boulder, CO). In one configuration, a sample is contacted with aptamers that are capable of binding proteins with specificity for the amino acid sequence of the proteins. The resulting aptamer-protein complexes can be separated from other sample components, for example, by attaching the complexes to beads (or other solid support) that are removed from other sample components. The aptamers can then be isolated and, because the aptamers are nucleic acids, the aptamers can be detected using any of a variety of methods known in the art for detecting nucleic acids, including for example, hybridization to nucleic acid arrays, PCR-based detection, or nucleic acid sequencing. Exemplary methods and compositions are set forth in U.S. Pat. Nos. 7,855,054; 7,964,356; 8,404,830; 8,945,830; 8,975,026; 8,975,388; 9,163,056; 9,938,314; 9,404,919; 9,926,566; 10,221,421; 10,239,908; 10,316,321 10,221,207 or 10,392,621, each of which is incorporated herein by reference.

In some detection assays, a protein can be cyclically modified and the modified products from individual cycles can be detected. In some configurations, a protein can be sequenced by a sequential process in which each cycle includes steps of detecting the protein and removing one or more terminal amino acids from the protein. Optionally, one or more of the steps can include adding a label to the protein, for example, at the amino terminal amino acid or at the carboxy terminal amino acid. In particular configurations, a method of detecting a protein can include steps of (i) exposing a terminal amino acid on the protein; (ii) detecting a change in signal from the protein; and (iii) identifying the type of amino acid that was removed based on the change detected in step (ii). The terminal amino acid can be exposed, for example, by removal of one or more amino acids from the amino terminus or carboxyl terminus of the protein. Steps (i) through (iii) can be repeated to produce a series of signal changes that is indicative of the sequence for the protein.

In a first configuration of a cyclical protein detection method, one or more types of amino acids in the protein can be attached to a label that uniquely identifies the type of amino acid. In this configuration, the change in signal that identifies the amino acid can be loss of signal from the respective label. For example, lysines can be attached to a distinguishable label such that loss of the label indicates removal of a lysine. Alternatively or additionally, other amino acid types can be attached to other labels that are mutually distinguishable from lysine and from each other. For example, lysines can be attached to a first label and cysteines can be attached to a second label, the first and second labels being distinguishable from each other. Exemplary compositions and techniques that can be used to remove amino acids from a protein and detect signal changes are those set forth in Swaminathan et al., Nature Biotech. 36:1076-1082 (2018); or U.S. Pat. No. 9,625,469 or 10,545,153, each of which is incorporated herein by reference. Methods and apparatus under development by Erisyon, Inc. (Austin, TX) may also be useful for detecting proteins.

In a second configuration of a cyclical protein detection method, a terminal amino acid of a protein can be recognized by an affinity agent that is specific for the terminal amino acid or specific for a label moiety that is present on the terminal amino acid. The affinity agent can be detected on the array, for example, due to a label on the affinity agent. Optionally, the label is a nucleic acid barcode sequence that is added to a primer nucleic acid upon formation of a complex. For example, a barcode can be added to the primer via ligation of an oligonucleotide having the barcode sequence or polymerase extension directed by a template that encodes the barcode sequence. The formation of the complex and identity of the terminal amino acid can be determined by decoding the barcode sequence. Multiple cycles can produce a series of barcodes that can be detected, for example, using a nucleic acid sequencing technique. Exemplary affinity agents and detection methods are set forth in US Pat. App. Pub. No. 2019/0145982 A1; 2020/0348308 A1; or 2020/0348307 A1, each of which is incorporated herein by reference. Methods and apparatus under development by Encodia, Inc. (San Diego, CA) may also be useful for detecting proteins.

Cyclical removal of terminal amino acids from a protein can be carried out using an Edman-type sequencing reaction in which a phenyl isothiocyanate reacts with a N-terminal amino group under mildly alkaline conditions (e.g. about pH 8) to form a cyclical phenylthiocarbamoyl Edman complex derivative. The phenyl isothiocyanate may be substituted or unsubstituted with one or more functional groups, linker groups, or linker groups containing functional groups. An Edman-type sequencing reaction can include variations to reagents and conditions that yield a detectable removal of amino acids from a protein terminus, thereby facilitating determination of the amino acid sequence for a protein or portion thereof. For example, the phenyl group can be replaced with at least one aromatic, heteroaromatic or aliphatic group which may participate in an Edman-type sequencing reaction, non-limiting examples including: pyridine, pyrimidine, pyrazine, pyridazoline, fused aromatic groups such as naphthalene and quinoline), methyl or other alkyl groups or alkyl group derivatives (e.g., alkenyl, alkynyl, cyclo-alkyl). Under certain conditions, for example, acidic conditions of about pH 2, derivatized terminal amino acids may be cleaved, for example, as a thiazolinone derivative. The thiazolinone amino acid derivative under acidic conditions may form a more stable phenylthiohydantoin (PTH) or similar amino acid derivative which can be detected. This procedure can be repeated iteratively for residual protein to identify the subsequent N-terminal amino acid. Many variations of Edman-type degradation have been described and may be used including, for example, a one-step removal of an N-terminal amino acid using alkaline conditions (Chang, J. Y., FEBS LETTS., 1978, 91 (1), 63-68). In some cases, Edman-type reactions may be thwarted by N-terminal modifications which may be selectively removed, for example, N-terminal acetylation or formylation (e.g., see Gheorghe M. T., Bergman T. (1995) in Methods in Protein Structure Analysis, Chapter 8: Deacetylation and internal cleavage of Proteins for N-terminal Sequence Analysis. Springer, Boston, MA. https://doi.org/10.1007/978-1-4899-1031-8_8).

Non-limiting examples of functional groups for substituted phenyl isothiocyanate may include ligands (e.g. biotin and biotin analogs) for known receptors, labels such as luminophores, or reactive groups such as click functionalities (e.g. compositions having an azide or acetylene moiety). The functional group may be a DNA, RNA, peptide or small molecule barcode or other tag which may be further processed and/or detected.

The removal of an amino terminal amino acid using Edman-type processes can utilize at least two main steps, the first step includes reacting an isothiocyanate or equivalent with protein N-terminal residues to form a relatively stable Edman complex, for example, a phenylthiocarbamoyl complex. The second step can include removing the derivatized N-terminal amino acid, for example, via heating. The protein, now having been shortened by one amino acid, may be detected, for example, by contacting the protein with a labeled affinity agent that is complementary to the amino terminus and examining the protein for binding to the agent, or by detecting loss of a label that was attached to the removed amino acid.

Edman-type processes can be carried out in a multiplex format to detect, characterize or identify a plurality of proteins. A method of detecting a protein can include steps of (i) exposing a terminal amino acid on a protein at an address of an array; (ii) binding an affinity agent to the terminal amino acid, where the affinity agent includes a nucleic acid tag, and where a primer nucleic acid is present at the address; (iii) extending the primer nucleic acid, thereby producing an extended primer having a copy of the tag; and (iv) detecting the tag of the extended primer. The terminal amino acid can be exposed, for example, by removal of one or more amino acids from the amino terminus or carboxyl terminus of the protein. Steps (i) through (iv) can be repeated to produce a series of tags that is indicative of the sequence for the protein. The method can be applied to a plurality of proteins on the array and in parallel. Whatever the plexity, the extending of the primer can be carried out, for example, by polymerase-based extension of the primer, using the nucleic acid tag as a template. Alternatively, the extending of the primer can be carried out, for example, by ligase- or chemical-based ligation of the primer to a nucleic acid that is hybridized to the nucleic acid tag. The nucleic acid tag can be detected via hybridization to nucleic acid probes (e.g. in an array), amplification-based detections (e.g. PCR-based detection, or rolling circle amplification-based detection) or nuclei acid sequencing (e.g. cyclical reversible terminator methods, nanopore methods, or single molecule, real time detection methods). Exemplary methods that can be used for detecting proteins using nucleic acid tags are set forth in US Pat. App. Pub. No. 2019/0145982 A1; 2020/0348308 A1; or 2020/0348307 A1, each of which is incorporated herein by reference.

A protein can optionally be detected based on its enzymatic or biological activity. For example, a protein can be contacted with a reactant that is converted to a detectable product by an enzymatic activity of the protein. In other assay formats, a first protein having a known enzymatic function can be contacted with a second protein to determine if the second protein changes the enzymatic function of the first protein. As such, the first protein serves as a reporter system for detection of the second protein. Exemplary changes that can be observed include, but are not limited to, activation of the enzymatic function, inhibition of the enzymatic function, attenuation of the enzymatic function, degradation of the first protein or competition for a reactant or cofactor used by the first protein. Proteins can also be detected based on their binding interactions with other molecules such as proteins, nucleic acids, nucleotides, metabolites, hormones, vitamins, small molecules that participate in biological signal transduction pathways, biological receptors or the like. For example, a protein that participates in a signal transduction pathway can be identified as a particular candidate protein by detecting binding to a second protein that is known to be a binding partner for the candidate protein in the pathway.

The presence or absence of post-translational modifications (PTM) can be detected using a composition, apparatus or method set forth herein. A PTM can be detected using an affinity agent that recognizes the PTM or based on a chemical property of the PTM. Exemplary PTMs that can be detected, identified or characterized include, but are not limited to, myristoylation, palmitoylation, isoprenylation, prenylation, farnesylation, geranylgeranylation, lipoylation, flavin moiety attachment, Heme C attachment, phosphopantetheinylation, retinylidene Schiff base formation, diphthamide formation, ethanolamine phosphoglycerol attachment, hypusine, beta-Lysine addition, acylation, acetylation, deacetylation, formylation, alkylation, methylation, C-terminal amidation, arginylation, polyglutamylation, polyglyclyation, butyrylation, gamma-carboxylation, glycosylation, glycation, polysialylation, malonylation, hydroxylation, iodination, nucleotide addition, phosphonate ester formation, phosphoramidate formation, phosphorylation, adenylylation, uridylylation, propionylation, pyroglutamate formation, S-glutathionylation, S-nitrosylation, S-sulfenylation, S-sulfinylation, S-sulfonylation, succinylation, sulfation, glycation, carbamylation, carbonylation, isopeptide bond formation, biotinylation, carbamylation, oxidation, reduction, pegylation, ISGylation, SUMOylation, ubiquitination, neddylation, pupylation, citrullination, deamidation, elminylation, disulfide bridge formation, proteolytic cleavage, isoaspartate formation, racemization, and protein splicing.

PTMs may occur at particular amino acid residues of a protein. For example, the phosphate moiety of a particular proteoform can be present on a serine, threonine, tyrosine, histidine, cysteine, lysine, aspartate or glutamate residue of the protein. In other examples, an acetyl moiety can be present on the N-terminus or on a lysine; a serine or threonine residue can have an O-linked glycosyl moiety; an asparagine residue can have an N-linked glycosyl moiety; a proline, lysine, asparagine, aspartate or histidine amino acid can be hydroxylated; an arginine or lysine residue can be methylated; or the N-terminal methionine or at a lysine amino acid can be ubiquitinated.

In some configurations of the apparatus and methods set forth herein, one or more proteins can be detected on a solid support. For example, protein(s) can be attached to a support, the support can be contacted with detection agents (e.g. affinity agents) in solution, the agents can interact with the protein(s), thereby producing a detectable signal, and then the signal can be detected to determine the presence of the protein(s). In multiplexed versions of this approach, different proteins can be attached to different addresses in an array, and the probing and detection steps can occur in parallel. In another example, affinity agents can be attached to a solid support, the support can be contacted with proteins in solution, the proteins can interact with the affinity agents, thereby producing a detectable signal, and then the signal can be detected to determine presence, quantity or characteristics of the proteins. This approach can also be multiplexed by attaching different affinity agents to different addresses of an array.

Proteins, affinity agents or other objects of interest can be attached to a solid support via covalent or non-covalent bonds. For example, a linker can be used to covalently attach a protein or other object of interest to an array. A particularly useful linker is a structured nucleic acid particle such as a nucleic acid nanoball (e.g. a concatemeric amplicon produced by rolling circle replication of a circular nucleic acid template) or a nucleic acid origami. For example, a plurality of proteins can be conjugated to a plurality of structured nucleic acid particles, such that each protein-conjugated particle forms an address in the array. Exemplary linkers for attaching proteins, or other objects of interest, to an array or other solid support are set forth in US Pat. App. Pub. No. 2021/0101930 A1, which is incorporated herein by reference.

A protein can be detected based on proximity of two or more affinity agents. For example, the two affinity agents can include two components each: a receptor component and a nucleic acid component. When the affinity agents bind in proximity to each other, for example, due to ligands for the respective receptors being on a single protein, or due to the ligands being present on two proteins that associate with each other, the nucleic acids can interact to cause a modification that is indicative of the two ligands being in proximity. Optionally, the modification can be polymerase catalyzed extension of one of the nucleic acids using the other nucleic acid as a template. As another option, one of the nucleic acids can form a template that acts as splint to position other nucleic acids for ligation to an oligonucleotide. Exemplary methods are commercialized by Olink Proteomics AB (Uppsala Sweden) or set forth in U.S. Pat. Nos. 7,306,904; 7,351,528; 8,013,134; 8,268,554 or 9,777,315, each of which is incorporated herein by reference.

A method or apparatus of the present disclosure can optionally be configured for optical detection (e.g. luminescence detection). Analytes or other entities can be detected, and optionally distinguished from each other, based on measurable characteristics such as the wavelength of radiation that excites a luminophore, the wavelength of radiation emitted by a luminophore, the intensity of radiation emitted by a luminophore (e.g. at particular detection wavelength(s)), luminescence lifetime (e.g. the time that a luminophore remains in an excited state) or luminescence polarity. Other optical characteristics that can be detected, and optionally used to distinguish analytes, include, for example, absorbance of radiation, resonance Raman, radiation scattering, or the like. A luminophore can be an intrinsic moiety of a protein or other analyte to be detected, or the luminophore can be an exogenous moiety that has been synthetically added to a protein or other analyte.

A method or apparatus of the present disclosure can use a light sensing device that is appropriate for detecting a characteristic set forth herein or known in the art. Particularly useful components of a light sensing device can include, but are not limited to, optical sub-systems or components used in nucleic acid sequencing systems. Examples of useful sub systems and components thereof are set forth in US Pat. App. Pub. No. 2010/0111768 A1 or U.S. Pat. Nos. 7,329,860; 8,951,781 or 9,193,996, each of which is incorporated herein by reference. Other useful light sensing devices and components thereof are described in U.S. Pat. Nos. 5,888,737; 6,175,002; 5,695,934; 6,140,489; or 5,863,722; or US Pat. Pub. Nos. 2007/007991 A1, 2009/0247414 A1, or 2010/0111768; or WO2007/123744, each of which is incorporated herein by reference. Light sensing devices and components that can be used to detect luminophores based on luminescence lifetime are described, for example, in U.S. Pat. Nos. 9,678,012; 9,921,157; 10,605,730; 10,712,274; 10,775,305; or 10,895,534, each of which is incorporated herein by reference.

Luminescence lifetime can be detected using an integrated circuit having a photodetection region configured to receive incident photons and produce a plurality of charge carriers in response to the incident photons. The integrated circuit can include at least one charge carrier storage region and a charge carrier segregation structure configured to selectively direct charge carriers of the plurality of charge carriers directly into the charge carrier storage region based upon times at which the charge carriers are produced. See, for example, U.S. Pat. Nos. 9,606,058, 10,775,305, and 10,845,308, each of which is incorporated herein by reference. Optical sources that produce short optical pulses can be used for luminescence lifetime measurements. For example, a light source, such as a semiconductor laser or LED, can be driven with a bipolar waveform to generate optical pulses with FWHM durations as short as approximately 85 ps having suppressed tail emission. See, for example, in U.S. Pat. No. 10,605,730, which is incorporated herein by reference.

For configurations that use optical detection (e.g. luminescent detection), one or more analytes (e.g. proteins) may be immobilized on a surface, and this surface may be scanned with a microscope to detect any signal from the immobilized analytes. The microscope itself may include a digital camera or other luminescence detector configured to record, store, and analyze the data collected during the scan. A luminescence detector of the present disclosure can be configured for epiluminescent detection, total internal reflection (TIR) detection, waveguide assisted excitation, or the like.

A light sensing device may be based upon any suitable technology, and may be, for example, a charged coupled device (CCD) sensor that generates pixilated image data based upon photons impacting locations in the device. It will be understood that any of a variety of other light sensing devices may also be used including, but not limited to, a detector array configured for time delay integration (TDI) operation, a complementary metal oxide semiconductor (CMOS) detector, an avalanche photodiode (APD) detector, a Geiger-mode photon counter, a photomultiplier tube (PMT), charge injection device (CID) sensors, JOT image sensor (Quanta), or any other suitable detector. Light sensing devices can optionally be coupled with one or more excitation sources, for example, lasers, light emitting diodes (LEDs), arc lamps or other energy sources known in the art.

An optical detection system can be configured for single molecule detection. For example, waveguides or optical confinements can be used to deliver excitation radiation to locations of a solid support where analytes are located. Zero-mode waveguides can be particularly useful, examples of which are set forth in U.S. Pat. Nos. 7,181,122, 7,302,146, or 7,313,308, each of which is incorporated herein by reference. Analytes can be confined to surface features, for example, to facilitate single molecule resolution. For example, analytes can be distributed into wells having nanometer dimensions such as those set forth in U.S. Pat. No. 7,122,482 or 8,765,359, or US Pat. App. Pub. No 2013/0116153 A1, each of which is incorporated herein by reference. The wells can be configured for selective excitation, for example, as set forth in U.S. Pat. No. 8,798,414 or 9,347,829, each of which is incorporated herein by reference. Analytes can be distributed to nanometer-scale posts, such as high aspect ratio posts which can optionally be dielectric pillars that extend through a metallic layer to improve detection of an analyte attached to the pillar. See, for example, U.S. Pat. Nos. 8,148,264, 9,410,887 or 9,987,609, each of which is incorporated herein by reference. Further examples of nanostructures that can be used to detect analytes are those that change state in response to the concentration of analytes such that the analytes can be quantitated as set forth in WO 2020/176793 A1, which is incorporated herein by reference.

An apparatus or method set forth herein need not be configured for optical detection. For example, an electronic detector can be used for detection of protons or charged labels (see, for example, US Pat. App. Pub. Nos. 2009/0026082 A1; 2009/0127589 A1; 2010/0137143 A1; or 2010/0282617 A1, each of which is incorporated herein by reference in its entirety). A field effect transistor (FET) can be used to detect analytes or other entities, for example, based on proximity of a field disrupting moiety to the FET. The field disrupting moiety can be due to an extrinsic label attached to an analyte or affinity agent, or the moiety can be intrinsic to the analyte or affinity agent being used. Surface plasmon resonance can be used to detect binding of analytes or affinity agents at or near a surface. Exemplary sensors and methods for attaching molecules to sensors are set forth in US Pat. App. Pub. Nos. 2017/0240962 A1; 2018/0051316 A1; 2018/0112265 A1; 2018/0155773 A1 or 2018/0305727 A1; or U.S. Pat. Nos. 9,164,053; 9,829,456; 10,036,064, each of which is incorporated herein by reference.

In some configurations of the compositions, apparatus and methods set forth herein, one or more proteins can be present on a solid support, where the proteins can optionally be detected. For example, a protein can be attached to a solid support, the solid support can be contacted with a detection agent (e.g. affinity agent) in solution, the affinity agent can interact with the protein, thereby producing a detectable signal, and then the signal can be detected to determine the presence, absence, quantity, a characteristic or identity of the protein. In multiplexed versions of this approach, different proteins can be attached to different addresses in an array, and the detection steps can occur in parallel, such that proteins at each address are detected, quantified, characterized or identified. In another example, detection agents can be attached to a solid support, the support can be contacted with proteins in solution, the proteins can interact with the detection agents, thereby producing a detectable signal, and then the signal can be detected to determine the presence of the proteins. This approach can also be multiplexed by attaching different probes to different addresses of an array.

In multiplexed configurations, different proteins can be attached to different unique identifiers (e.g. addresses in an array), and the proteins can be manipulated and detected in parallel. For example, a fluid containing one or more different affinity agents can be delivered to an array such that the proteins of the array are in simultaneous contact with the affinity agent(s). Moreover, a plurality of addresses can be observed in parallel allowing for rapid detection of binding events. A plurality of different proteins can have a complexity of at least 5, 10, 100, 1×10³, 1×10⁴, 1×10⁵ or more different native-length protein primary sequences. Alternatively or additionally, a proteome, proteome subfraction or other protein sample that is analyzed in a method set forth herein can have a complexity that is at most 1×10⁵, 1×10⁴, 1×10³, 100, 10, 5 or fewer different native-length protein primary sequences. The total number of proteins of a sample that is detected, characterized or identified can differ from the number of different primary sequences in the sample, for example, due to the presence of multiple copies of at least some protein species. Moreover, the total number of proteins of a sample that is detected, characterized or identified can differ from the number of candidate proteins suspected of being in the sample, for example, due to the presence of multiple copies of at least some protein species, absence of some proteins in a source for the sample, or loss of some proteins prior to analysis.

A protein can be attached to a unique identifier using any of a variety of means. The attachment can be covalent or non-covalent. Exemplary covalent attachments include chemical linkers such as those achieved using click chemistry or other linkages known in the art or described in U.S. patent application Ser. No. 17/062,405, which is incorporated herein by reference. Non-covalent attachment can be mediated by receptor-ligand interactions (e.g. (strept)avidin-biotin, antibody-antigen, or complementary nucleic acid strands), for example, in which the receptor is attached to the unique identifier and the ligand is attached to the protein or vice versa. In particular configurations, a protein is attached to a solid support (e.g. an address in an array) via a structured nucleic acid particle (SNAP). A protein can be attached to a SNAP and the SNAP can interact with a solid support, for example, by non-covalent interactions of the DNA with the support and/or via covalent linkage of the SNAP to the support. Nucleic acid origami or nucleic acid nanoballs are particularly useful. The use of SNAPs and other moieties to attach proteins to unique identifiers such as tags or addresses in an array are set forth in U.S. patents application Ser. Nos. 17/062,405 and 63/159,500, each of which is incorporated herein by reference.

The methods, compositions and apparatus of the present disclosure are particularly well suited for use with proteins. Although proteins are exemplified throughout the present disclosure, it will be understood that other analytes can be similarly used. Exemplary analytes include, but are not limited to, biomolecules, polysaccharides, nucleic acids, lipids, metabolites, hormones, vitamins, enzyme cofactors, therapeutic agents, candidate therapeutic agents or combinations thereof. An analyte can be a non-biological atom or molecule, such as a synthetic polymer, metal, metal oxide, ceramic, semiconductor, mineral, or a combination thereof.

One or more proteins that are used in a method, composition or apparatus herein, can be derived from a natural or synthetic source. Exemplary sources include, but are not limited to biological tissues, fluids, cells or subcellular compartments (e.g. organelles). For example, a sample can be derived from a tissue biopsy, biological fluid (e.g. blood, sweat, tears, plasma, extracellular fluid, urine, mucus, saliva, semen, vaginal fluid, synovial fluid, lymph, cerebrospinal fluid, peritoneal fluid, pleural fluid, amniotic fluid, intracellular fluid, extracellular fluid, etc.), fecal sample, hair sample, cultured cell, culture media, fixed tissue sample (e.g. fresh frozen or formalin-fixed paraffin-embedded) or product of a protein synthesis reaction. A protein source may include any sample where a protein is a native or expected constituent. For example, a primary source for a cancer biomarker protein may be a tumor biopsy sample or bodily fluid. Other sources include environmental samples or forensic samples.

Exemplary organisms from which proteins or other analytes can be derived include, for example, a mammal such as a rodent, mouse, rat, rabbit, guinea pig, ungulate, horse, sheep, pig, goat, cow, cat, dog, primate, non-human primate or human; a plant such as Arabidopsis thaliana, tobacco, corn, sorghum, oat, wheat, rice, canola, or soybean; an algae such as Chlamydomonas reinhardtii; a nematode such as Caenorhabditis elegans; an insect such as Drosophila melanogaster, mosquito, fruit fly, honey bee or spider; a fish such as zebrafish; a reptile; an amphibian such as a frog or Xenopus laevis; a Dictyostelium discoideum; a fungi such as Pneumocystis carinii, Takifugu rubripes, yeast, Saccharomyces cerevisiae or Schizosaccharomyces pombe; or a Plasmodium falciparum. Proteins can also be derived from a prokaryote such as a bacterium, Escherichia coli, staphylococci or Mycoplasma pneumoniae; an archae; a virus such as Hepatitis C virus, influenza virus, coronavirus, or human immunodeficiency virus; or a viroid. Proteins can be derived from a homogeneous culture or population of the above organisms or alternatively from a collection of several different organisms, for example, in a community or ecosystem.

In some cases, a protein or other biomolecule can be derived from an organism that is collected from a host organism. For example, a protein may be derived from a parasitic, pathogenic, symbiotic, or latent organism collected from a host organism. A protein can be derived from an organism, tissue, cell or biological fluid that is known or suspected of being linked with a disease state or disorder (e.g., cancer). Alternatively, a protein can be derived from an organism, tissue, cell or biological fluid that is known or suspected of not being linked to a particular disease state or disorder. For example, the proteins isolated from such a source can be used as a control for comparison to results acquired from a source that is known or suspected of being linked to the particular disease state or disorder. A sample may include a microbiome or substantial portion of a microbiome. In some cases, one or more proteins used in a method, composition or apparatus set forth herein may be obtained from a single source and no more than the single source. The single source can be, for example, a single organism (e.g. an individual human), single tissue, single cell, single organelle (e.g. endoplasmic reticulum, Golgi apparatus or nucleus), or single protein-containing particle (e.g., a viral particle or vesicle).

A method, composition or apparatus of the present disclosure can use or include a plurality of proteins having any of a variety of compositions such as a plurality of proteins composed of a proteome or fraction thereof. For example, a plurality of proteins can include solution-phase proteins, such as proteins in a biological sample or fraction thereof, or a plurality of proteins can include proteins that are immobilized, such as proteins attached to a particle or solid support. By way of further example, a plurality of proteins can include proteins that are detected, analyzed or identified in connection with a method, composition or apparatus of the present disclosure. The content of a plurality of proteins can be understood according to any of a variety of characteristics such as those set forth below or elsewhere herein.

A plurality of proteins can be characterized in terms of total protein mass. The total mass of protein in a liter of plasma has been estimated to be 70 g and the total mass of protein in a human cell has been estimated to be between 100 pg and 500 pg depending upon cells type. See Wisniewski et al. Molecular & Cellular Proteomics 13:10.1074/mcp.M113.037309, 3497-3506 (2014), which is incorporated herein by reference. A plurality of proteins used or included in a method, composition or apparatus set forth herein can include at least 1 pg, 10 pg, 100 pg, 1 ng, 10 ng, 100 ng, 1 μg, 10 μg, 100 μg, 1 mg, 10 mg, 100 mg or more protein by mass. Alternatively or additionally, a plurality of proteins may contain at most 100 mg, 10 mg, 1 mg, 100 μg, 10 μg, 1 μg, 100 ng, 10 ng, 1 ng, 100 pg, 10 pg, 1 pg or less protein by mass.

A plurality of proteins can be characterized in terms of percent mass relative to a given source such as a biological source (e.g. cell, tissue, or biological fluid such as blood). For example, a plurality of proteins may contain at least 60%, 75%, 90%, 95%, 99%, 99.9% or more of the total protein mass present in the source from which the plurality of proteins was derived. Alternatively or additionally, a plurality of proteins may contain at most 99.9%, 99%, 95%, 90%, 75%, 60% or less of the total protein mass present in the source from which the plurality of proteins was derived.

A plurality of proteins can be characterized in terms of total number of protein molecules. The total number of protein molecules in a Saccharomyces cerevisiae cell has been estimated to be about 42 million protein molecules. See Ho et al., Cell Systems (2018), DOI: 10.1016/j.cels.2017.12.004, which is incorporated herein by reference. A plurality of proteins used or included in a method, composition or apparatus set forth herein can include at least 1 protein molecule, 10 protein molecules, 100 protein molecules, 1×10⁴ protein molecules, 1×10⁶ protein molecules, 1×10⁸ protein molecules, 1×10¹⁰ protein molecules, 1 mole (6.02214076×10²³ molecules) of protein, 10 moles of protein molecules, 100 moles of protein molecules or more. Alternatively or additionally, a plurality of proteins may contain at most 100 moles of protein molecules, 10 moles of protein molecules, 1 mole of protein molecules, 1×10¹⁰ protein molecules, 1×10⁸ protein molecules, 1×10⁶ protein molecules, 1×10⁴ protein molecules, 100 protein molecules, 10 protein molecules, 1 protein molecule or less.

A plurality of proteins can be characterized in terms of the variety of full-length primary protein structures in the plurality. For example, the variety of full-length primary protein structures in a plurality of proteins can be equated with the number of different protein-encoding genes in the source for the plurality of proteins. Whether or not the proteins are derived from a known genome or from any genome at all, the variety of full-length primary protein structures can be counted independent of presence or absence of post translational modifications in the proteins. A human proteome is estimated to have about 20,000 different protein-encoding genes such that a plurality of proteins derived from a human can include up to about 20,000 different primary protein structures. See Aebersold et al., Nat. Chem. Biol. 14:206-214 (2018), which is incorporated herein by reference. Other genomes and proteomes in nature are known to be larger or smaller. A plurality of proteins used or included in a method, composition or apparatus set forth herein can have a complexity of at least 2, 5, 10, 100, 1×10³, 1×10⁴, 2×10⁴, 3×10⁴ or more different full-length primary protein structures. Alternatively or additionally, a plurality of proteins can have a complexity that is at most 3×10⁴, 2×10⁴, 1×10⁴, 1×10³, 100, 10, 5, 2 or fewer different full-length primary protein structures.

In relative terms, a plurality of proteins used or included in a method, composition or apparatus set forth herein may contain at least one representative for at least 60%, 75%, 90%, 95%, 99%, 99.9% or more of the proteins encoded by the genome of a source from which the sample was derived. Alternatively or additionally, a plurality of proteins may contain a representative for at most 99.9%, 99%, 95%, 90%, 75%, 60% or less of the proteins encoded by the genome of a source from which the sample was derived.

A plurality of proteins can be characterized in terms of the variety of primary protein structures in the plurality including transcribed splice variants. The human proteome has been estimated to include about 70,000 different primary protein structures when splice variants ae included. See Aebersold et al., Nat. Chem. Biol. 14:206-214 (2018), which is incorporated herein by reference. Moreover, the number of the partial-length primary protein structures can increase due to fragmentation that occurs in a sample. A plurality of proteins used or included in a method, composition or apparatus set forth herein can have a complexity of at least 2, 5, 10, 100, 1×10³, 1×10⁴, 7×10⁴, 1×10⁵, 1×10⁶ or more different primary protein structures. Alternatively or additionally, a plurality of proteins can have a complexity that is at most 1×10⁶, 1×10⁵, 7×10⁴, 1×10⁴, 1×10³, 100, 10, 5, 2 or fewer different primary protein structures.

A plurality of proteins can be characterized in terms of the variety of protein structures in the plurality including different primary structures and different proteoforms among the primary structures. Different molecular forms of proteins expressed from a given gene are considered to be different proteoforms. Proteoforms can differ, for example, due to differences in primary structure (e.g. shorter or longer amino acid sequences), different arrangement of domains (e.g. transcriptional splice variants), or different post translational modifications (e.g. presence or absence of phosphoryl, glycosyl, acetyl, or ubiquitin moieties). The human proteome is estimated to include hundreds of thousands of proteins when counting the different primary structures and proteoforms. See Aebersold et al., Nat. Chem. Biol. 14:206-214 (2018), which is incorporated herein by reference. A plurality of proteins used or included in a method, composition or apparatus set forth herein can have a complexity of at least 2, 5, 10, 100, 1×10³, 1×10⁴, 1×10⁵, 1×10⁶, 5×10⁶, 1×10⁷ or more different protein structures. Alternatively or additionally, a plurality of proteins can have a complexity that is at most 1×10⁷, 5×10⁶, 1×10⁶, 1×10⁵, 1×10⁴, 1×10³, 100, 10, 5, 2 or fewer different protein structures.

A plurality of proteins can be characterized in terms of the dynamic range for the different protein structures in the sample. The dynamic range can be a measure of the range of abundance for all different protein structures in a plurality of proteins, the range of abundance for all different primary protein structures in a plurality of proteins, the range of abundance for all different full-length primary protein structures in a plurality of proteins, the range of abundance for all different full-length gene products in a plurality of proteins, the range of abundance for all different proteoforms expressed from a given gene, or the range of abundance for any other set of different proteins set forth herein. The dynamic range for all proteins in human plasma is estimated to span more than 10 orders of magnitude from albumin, the most abundant protein, to the rarest proteins that have been measured clinically. See Anderson and Anderson Mol Cell Proteomics 1:845-67 (2002), which is incorporated herein by reference. The dynamic range for plurality of proteins set forth herein can be a factor of at least 10, 100, 1×10³, 1×10⁴, 1×10⁶, 1×10⁸, 1×10¹⁰, or more. Alternatively or additionally, the dynamic range for plurality of proteins set forth herein can be a factor of at most 1×10¹⁰, 1×10⁸, 1×10⁶, 1×10⁴, 1×10³, 100, 10 or less.

A method set forth herein can be carried out in a fluid phase or on a solid phase. For fluid phase configurations, a fluid containing one or more proteins can be mixed with another fluid containing one or more affinity agents. For solid phase configurations one or more proteins or affinity agents can be attached to a solid support. One or more components that will participate in a binding event can be contained in a fluid and the fluid can be delivered to a solid support, the solid support being attached to one or more other component that will participate in the binding event.

A method of the present disclosure can be carried out at single analyte resolution. Alternatively to single-analyte resolution, a method can be carried out at ensemble-resolution or bulk-resolution. Bulk-resolution configurations acquire a composite signal from a plurality of different analytes or affinity agents in a vessel or on a surface. For example, a composite signal can be acquired from a population of different protein-affinity agent complexes in a well or cuvette, or on a solid support surface, such that individual complexes are not resolved from each other. Ensemble-resolution configurations acquire a composite signal from a first collection of proteins or affinity agents in a sample, such that the composite signal is distinguishable from signals generated by a second collection of proteins or affinity agents in the sample. For example, the ensembles can be located at different addresses in an array. Accordingly, the composite signal obtained from each address will be an average of signals from the ensemble, yet signals from different addresses can be distinguished from each other.

A composition, apparatus or method set forth herein can be configured to contact one or more proteins (e.g. an array of different proteins) with a plurality of different affinity agents. For example, a plurality of affinity agents (whether configured separately or as a pool) may include at least 2, 5, 10, 25, 50, 100, 250, 500 or more types of affinity agents, each type of affinity agent differing from the other types with respect to the epitope(s) recognized. Alternatively or additionally, a plurality of affinity agents may include at most 500, 250, 100, 50, 25, 10, 5, or 2 types of affinity agents, each type of affinity agent differing from the other types with respect to the epitope(s) recognized. Different types of affinity agents in a pool can be uniquely labeled such that the different types can be distinguished from each other. In some configurations, at least two, and up to all, of the different types of affinity agents in a pool may be indistinguishably labeled with respect to each other. Alternatively or additionally to the use of unique labels, different types of affinity agents can be delivered and detected serially when evaluating one or more proteins (e.g. in an array).

A method of the present disclosure can be performed in a multiplex format. In multiplexed configurations, different proteins can be attached to different unique identifiers (e.g. the proteins can be attached to different addresses in an array). Multiplexed proteins can be manipulated and detected in parallel. For example, a fluid containing one or more different affinity agents can be delivered to a protein array such that the proteins of the array are in simultaneous contact with the affinity agent(s). Moreover, a plurality of addresses can be observed in parallel allowing for rapid detection of binding events. A plurality of different proteins can have a complexity of at least 5, 10, 100, 1×10³, 1×10⁴, 2×10⁴, 3×10⁴ or more different native-length protein primary sequences. Alternatively or additionally, a proteome or proteome subfraction that is analyzed in a method set forth herein can have a complexity that is at most 3×10⁴, 2×10⁴, 1×10⁴, 1×10³, 100, 10, 5 or fewer different native-length protein primary sequences. The plurality of proteins can constitute a proteome or subfraction of a proteome. The total number of proteins that is detected, characterized or identified can differ from the number of different primary sequences in the sample from which the proteins are derived, for example, due to the presence of multiple copies of at least some protein species. Moreover, the total number of proteins that are detected, characterized or identified can differ from the number of candidate proteins suspected of being present, for example, due to the presence of multiple copies of at least some protein species, absence of some proteins in a source for the proteins, or loss of some proteins prior to analysis.

A particularly useful multiplex format uses an array of proteins and/or affinity agents. A polypeptide, anchoring group, polypeptide composite or other analyte can be attached to a unique identifier, such as an address in an array, using any of a variety of means. The attachment can be covalent or non-covalent. Exemplary covalent attachments include chemical linkers such as those achieved using click chemistry or other linkages known in the art or described in US Pat. App. Pub. No. 2021/0101930 A1, which is incorporated herein by reference. Non-covalent attachment can be mediated by receptor-ligand interactions (e.g. (strept)avidin-biotin, antibody-antigen, or complementary nucleic acid strands), for example, in which the receptor is attached to the unique identifier and the ligand is attached to the protein or vice versa. In particular configurations, a protein is attached to a solid support (e.g. an address in an array) via a structured nucleic acid particle (SNAP). A protein can be attached to a SNAP and the SNAP can interact with a solid support, for example, by non-covalent interactions of the DNA with the support and/or via covalent linkage of the SNAP to the support. Nucleic acid origami or nucleic acid nanoballs are particularly useful. The use of SNAPs and other moieties to attach proteins to unique identifiers such as tags or addresses in an array are set forth in US Pat. App. Pub. No. 2021/0101930 A1, which is incorporated herein by reference.

A solid support or a surface thereof may be configured to display an analyte or a plurality of analytes. A solid support may contain one or more patterned, formed, or prepared surfaces that contain at least one address for displaying an analyte. In some cases, a solid support may contain one or more patterned, formed, or prepared surfaces that contain a plurality of addresses, with each address configured to display one or more analytes. Accordingly, an array as set forth herein may comprise a plurality of analytes coupled to a solid support or a surface thereof. In some configurations, a solid support or a surface thereof may be patterned or formed to produce an ordered or patterned array of addresses. The deposition of analytes on the ordered or patterned array of addresses may be controlled by interactions between the solid support and the analytes such as, for example, electrostatic interactions, magnetic interactions, hydrophobic interactions, hydrophilic interactions, covalent interactions, or non-covalent interactions. Accordingly, the coupling of an analyte at each address of an array may produce an ordered or patterned array of analytes whose average spacing between analytes is determined based upon the tolerance of the ordering or patterning of the solid support and the size of an analyte-binding region for each address. An ordered or patterned array of analytes may be characterized as having a regular geometry, such as a rectangular, triangular, polygonal, or annular grid. In other configurations, a solid support or a surface thereof may be non-patterned or non-ordered. The deposition of analytes on the non-ordered or non-patterned array of addresses may be controlled by interactions between the solid support and the analytes, or inter-analyte interactions such as, for example, steric repulsion, electrostatic repulsion, electrostatic attraction, magnetic repulsion, magnetic attraction, covalent interactions, or non-covalent interactions.

A solid support or a surface thereof may contain one or more structures or features. A structure or feature may comprise an elevation, profile, shape, geometry, or configuration that deviates from an average elevation, profile, shape, geometry, or configuration of a solid support or surface thereof. A structure or feature may be a raised structure or feature, such as a ridge, post, pillar, or pad, if the structure or feature extends above the average elevation of a surface of a solid support. A structure or feature may be a depressed structure, such as a channel, well, pore, or hole, if the structure or feature extends below the average elevation of a surface of a solid support. A structure or feature may be an intrinsic structure or feature of a substrate (i.e., arising due to the physical or chemical properties of the substrate, or a physical or chemical mechanism of formation), such as surface roughness structures, crystal structures, or porosity. A structure or feature may be formed by a method of processing a solid support. In some configurations, a solid support or a surface may be processed by a lithographic method to form one or more structures or features. A solid support or a surface thereof may be formed by a suitable lithographic method, including, but not limited to photolithography, Dip-Pen nanolithography, nanoimprint lithography, nanosphere lithography, nanoball lithography, nanopillar arrays, nanowire lithography, immersion lithography, neutral particle lithography, plasmonic lithography, scanning probe lithography, thermochemical lithography, thermal scanning probe lithography, local oxidation nanolithography, molecular self-assembly, stencil lithography, laser interference lithography, soft lithography, magnetolithography, stereolithography, deep ultraviolet lithography, x-ray lithography, ion projection lithography, proton-beam lithography, or electron-beam lithography.

A solid support or surface may comprise a plurality of structures or features. A plurality of structures or features may comprise an ordered or patterned array of structures or features. A plurality of structures or features may comprise a non-ordered, non-patterned, or random array of structures or features. A structure or feature may have an average characteristic dimension (e.g., length, width, height, diameter, circumference, etc.) of at least about 1 nanometer (nm), 5 nm, 10 nm, 20 nm, 30 nm, 40 nm, 50 nm, 75 nm, 100 nm, 150 nm, 200 nm, 250 nm, 300 nm, 400 nm, 500 nm, 750 nm, 1000 nm, or more than 1000 nm. Alternatively or additionally, a structure or feature may have an average characteristic dimension of no more than about 1000 nm, 750 nm, 500 nm, 400 nm, 300 nm, 250 nm, 200 nm, 150 nm, 100 nm, 75 nm, 50 nm, 40 nm, 30 nm, 20 nm, 10 nm, 5 nm, 1 nm, or less than 1 nm. An array of structures or features may have an average pitch, in which the pitch is measured as the average separation between respective centerpoints of neighboring structures or features. An array may have an average pitch of at least about 1 nm, 5 nm, 10 nm, 20 nm, 30 nm, 40 nm, 50 nm, 75 nm, 100 nm, 150 nm, 200 nm, 250 nm, 300 nm, 400 nm, 500 nm, 750 nm, 1 micron (μm), 2 μm, 5 μm, 10 μm, 50 μm, 100 μm, or more than 100 μm. Alternatively or additionally, an array may have an average pitch of no more than about 100 μm, 50 μm, 10 μm, 5 μm, 1 μm, 750 nm, 500 nm, 400 nm, 300 nm, 250 nm, 200 nm, 150 nm, 100 nm, 75 nm, 50 nm, 40 nm, 30 nm, 20 nm, 10 nm, 5 nm, 1 nm, or less than 1 nm.

A solid support or a surface thereof may include a base substrate material and, optionally, one or more additional materials that are contacted or adhered with the substrate material. A solid support may comprise one or more additional materials that are deposited, coated, or inlayed onto the substrate material. Additional materials may be added to the substrate material to alter the properties of the substrate material. For example, materials may be added to alter the surface chemistry (e.g., hydrophobicity, hydrophilicity, orthogonal binding, electrostatic properties), alter the optical properties (e.g., reflective properties, refractive properties), alter the electrical or magnetic properties (e.g., dielectric materials, conducting materials, electrically-insulating materials), or alter the heat transfer characteristics of the substrate material. Additional materials contacted or adhered with a substrate material may be ordered or patterned onto the substrate material to, for example, locate the additional material at addresses or locate the additional material at interstitial regions between addresses. Exemplary additional materials may include metals (e.g., gold, silver, copper, etc.), metal oxides (e.g., titanium oxide, silicon dioxide, alumina, iron oxides, etc.), metal nitrides (e.g., silicon nitride, aluminum nitride, boron nitride, gallium nitride, etc.), metal carbides (e.g., tungsten carbide, titanium carbide, iron carbide, etc.), metal sulfides (e.g., iron sulfide, silver sulfide, etc.), and organic moieties (e.g., polyethylene glycol (PEG), dextrans, chemically-reactive functional groups, etc.).

A method of the present disclosure can include the step of coupling one or more analytes to a solid support or a surface thereof prior to performing a detection step set forth herein. The coupling of one or more analytes to a solid support surface may include covalent or non-covalent coupling of the one or more analytes to the solid support. Covalent coupling of an analyte to a solid support can include direct covalent coupling of an analyte to a solid support (e.g., formation of coordination bonds) or indirect covalent coupling between a reactive functional group of the analyte and a reactive functional group that is coupled to the solid support (e.g., a CLICK-type reaction). Non-covalent coupling can include the formation of any non-covalent interaction between an analyte and a solid support, including electrostatic or magnetic interactions, or non-covalent bonding interactions (e.g., ionic bonds, van der Waals interactions, hydrogen bonding, etc.). The skilled person will readily recognize that the particular analyte and the choice of solid support can affect the selection of a coupling chemistry for the compositions and methods set forth herein.

Accordingly, a coupling chemistry may be selected based upon the criterium that it provides a sufficiently stable coupling of an analyte to a solid support for a time scale that meets or exceeds the time scale of a method as set forth herein. For example, a polypeptide identification method can require a coupling of the analyte to the solid support for a sufficient amount of time to permit a series of empirical measurements of the analyte to occur. An analyte may be continuously coupled to a solid support for an observable length of time such as, for example, at least about 1 minute, 1 hour (hr), 3 hrs, 6 hrs, 12 hrs, 1 day, 1.5 days, 2 days, 3 days, 1 week (wk), 2 wks, 3 wks, 1 month, or more. The coupling of an analyte to a solid support can occur with a solution-phase chemistry that promotes the deposition of the analyte on the solid support. Coupling of an analyte to a solid support may occur under solution conditions that are optimized for any conceivable solution property, including solution composition, species concentrations, pH, ionic strength, solution temperature, etc. Solution composition can be varied by chemical species, such as buffer type, salts, acids, bases, and surfactants. In some configurations, species such as salts and surfactants may be selected to facilitate the formation of interactions between an analyte and a solid support. Covalent coupling methods for coupling an analyte to a solid support may include species such as catalyst, initiators, and promoters to facilitate particular reactive chemistries.

Coupling of an analyte to a solid support may be facilitated by a mediating group. A mediating group may modify the properties of the analyte to facilitate the coupling. Useful mediating groups have been set forth herein (e.g., structured nucleic acid particles). In some configurations, a mediating group can be coupled to an analyte prior to coupling the analyte to a solid support. Accordingly, the mediating group may be chosen to increase the strength, control, or specificity of the coupling of the analyte to the solid support. In other configurations, a mediating group can be coupled to a solid support prior to coupling an analyte to the solid support. Accordingly, the mediating group may be chosen to provide a more favorable coupling chemistry than can be provided by the solid support alone.

### EXAMPLES

### Example 1. Inhibition of Orthogonal Binding

Orthogonal binding of multivalent binding reagents comprising nucleic acid nanoparticles was observed on differing surfaces to determine an effective surface for minimizing orthogonal binding. The multivalent binding reagents comprised a plurality of affinity agents coupled to a tile-shaped nucleic acid nanoparticle. Each multivalent binding reagent further comprised a plurality of fluorophores coupled to the nucleic acid nanoparticle. Additional aspects of multivalent binding reagents are described in U.S. Pat. No. 11,692,217B2, which is herein incorporated by reference in its entirety. Three different multivalent binding reagents were tested: 1) anti-WNK antibody binding reagents, 2) anti-DTR antibody binding reagents, and 3) anti-HHH aptamer binding reagents.

Two surfaces were prepared for testing of the orthogonal binding properties of the three multivalent binding reagents. The first surface comprised a substantially uniform layer of PEG moieties deposited on a glass surface. The second surface comprised a substantially uniform layer of hexamethyldisilazane (HMDS) on a glass surface. Each surface was contacted with a buffered solution containing one of the three multivalent binding reagents at a 500 picomolar concentration. After contacting the surfaces with the multivalent binding reagent media, the surfaces were imaged with confocal laser scanning microscopy to observe the presence of orthogonally bound on each surface.

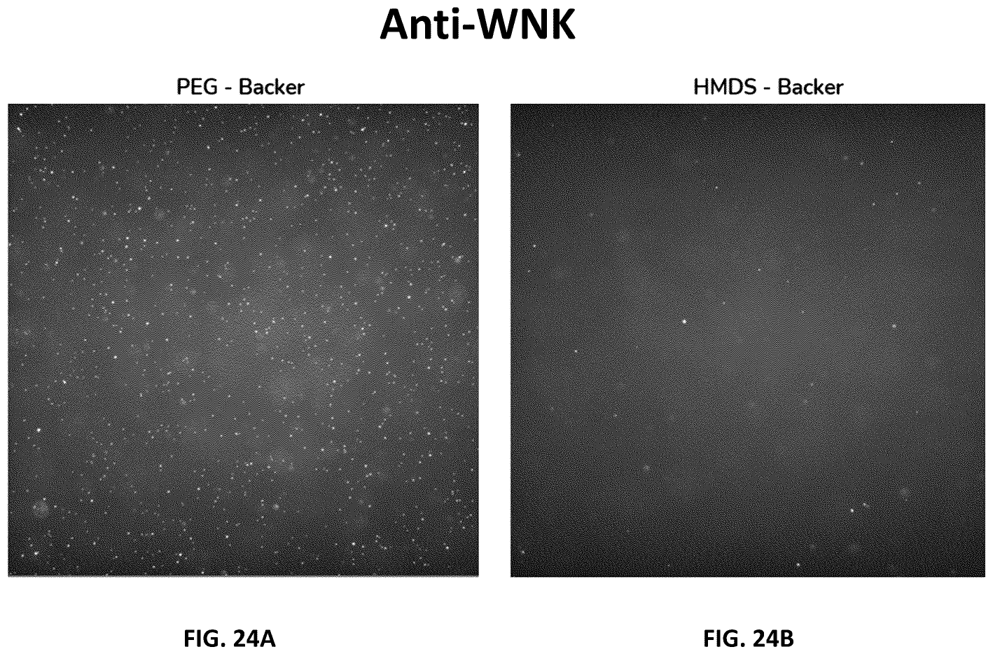

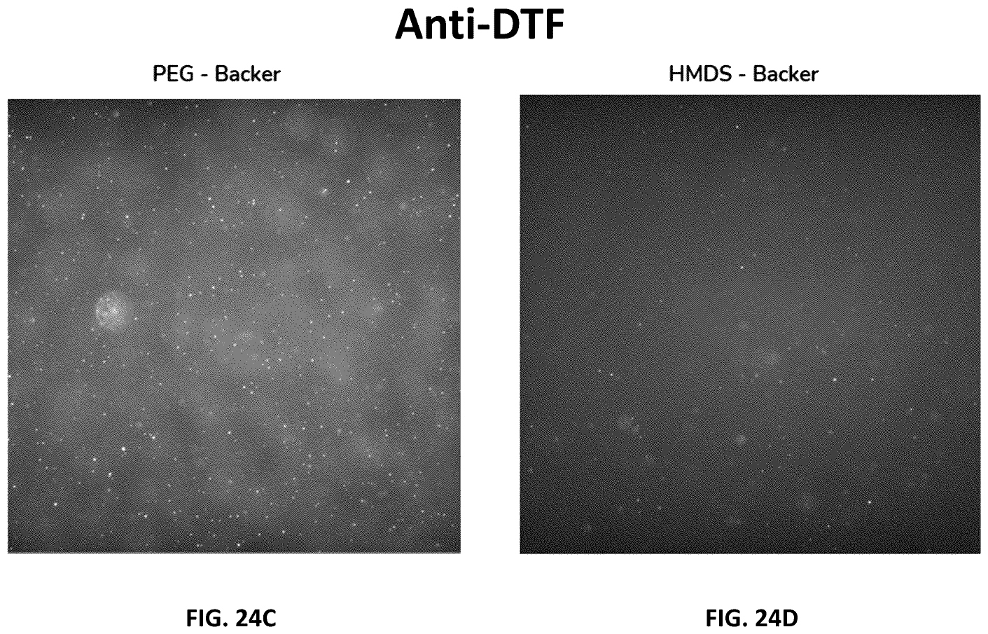

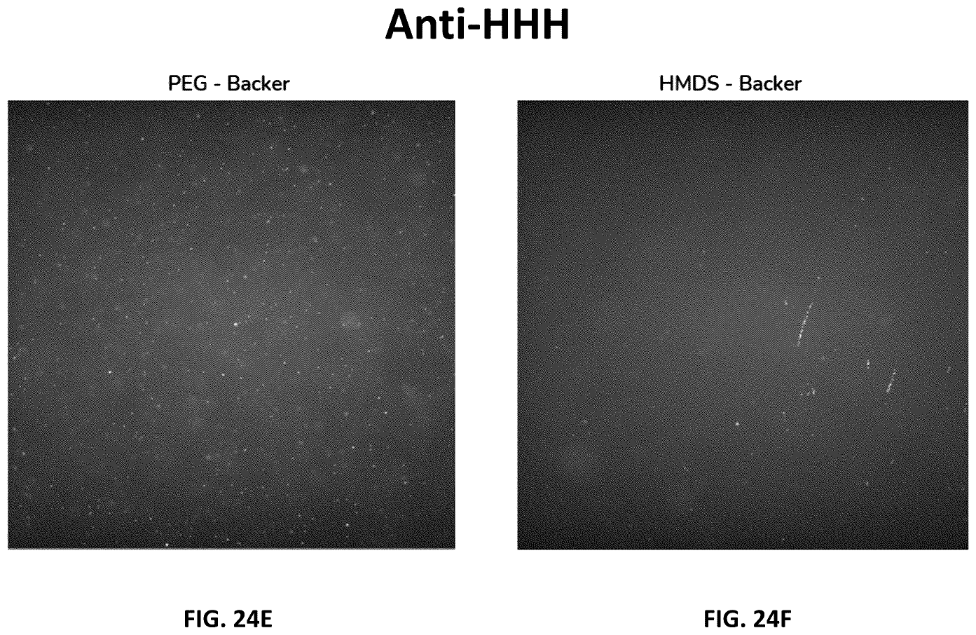

FIGS. 24A, 24C, and 24E show microscopy images for PEGylated surfaces contacted with anti-WNK, anti-DTF, and anti-HHH multivalent binding reagents, respectively. FIGS. 24B, 24D, and 24F show microscopy images for HMDS-coated surfaces contacted with anti-WNK, anti-DTF, and anti-HHH multivalent binding reagents, respectively. Each observed white signal against the uniform dark background represented a single bound multivalent binding reagent. A greater portion of each surface was found to contain orthogonally-bound binding reagents for the PEGylated surfaces.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

Notwithstanding the appended claims, the disclosure set forth herein is also defined by the following clauses:

1) A composition, comprising:
a. a solid support, wherein the solid support comprises:
i. a plurality of sites, wherein each site is couple to one and only one analyte; and
ii. one or more interstitial regions, wherein each site of the plurality of sites is spatially separated from other sites of the plurality of sites by an interstitial region of the one or more interstitial regions;
b. a first plurality of molecules, wherein the first plurality of molecules is coupled to the one or more interstitial regions, and wherein each molecule of the first plurality of molecules comprises a moiety that is configured to inhibit binding of an assay agent;
c. a plurality of defects occurring in a random spatial distribution on the one or more interstitial regions, and wherein each defect of the plurality of defects comprises a moiety that is configured to bind the assay agent;
d. a second plurality of molecules bound to the plurality of defects; and
e. a plurality of assay agents coupled to the solid support, wherein less than 10% of the plurality of assay agents are coupled to the one or more interstitial regions of the solid support.

2) A composition, comprising:
a. a solid support, wherein the solid support comprises:
   i. a plurality of sites, wherein each site is coupled to one and only one analyte; and
   ii. one or more interstitial regions, wherein each site of the plurality of sites is spatially separated from other sites of the plurality of sites by an interstitial region of the one or more interstitial regions;
b. a first plurality of molecules, wherein the first plurality of molecules is coupled to the one or more interstitial regions, and wherein each molecule of the first plurality of molecules comprises a first moiety that is configured to inhibit binding of a detection agent;
c. a second plurality of molecules occurring in a random spatial distribution on the one or more interstitial regions, wherein each molecule of the second plurality of molecules comprises a dissimilar chemical structure to each molecule of the first plurality of molecules, and wherein each molecule of the second plurality of molecules is configured to inhibit binding of the detection agent;
d. a plurality of defects, wherein each defect is configured to bind the assay agent, wherein the plurality of defects comprises a random spatial distribution on the one or more interstitial regions, and wherein the plurality of defects comprises a subset of defects comprising no more than 1% of defects of the plurality of defects, in which each defect of the subset of defects is spatially non-resolvable from at least one site of the plurality of sites; and
e. a plurality of detection agents coupled to the solid support, wherein the plurality of detection agents is coupled to the subset of defects.

3) A composition, comprising:
a. a solid support, wherein the solid support comprises:
   i. a plurality of sites, wherein each site comprises one and only one analyte; and
   ii. one or more interstitial regions, wherein each site of the plurality of sites is spatially separated from other sites of the plurality of sites by an interstitial region of the one or more interstitial regions;
b. a passivating layer, wherein the passivating layer is coupled to the one or more interstitial regions, wherein the passivating layer is configured to inhibit binding of an assay agent, wherein the passivating layer comprises a first plurality of passivating molecules and a second plurality of passivating molecules, wherein a first passivating molecule of the first plurality of passivating molecules is chemically dissimilar to a second passivating molecule of the second plurality of passivating molecules, and wherein the second plurality of passivating molecules occurs in a first random spatial distribution;
c. a plurality of defects, wherein each defect is configured to bind an assay agent, and wherein the plurality of defects occurs in a second random spatial distribution on the one or more interstitial regions; and
d. a plurality of assay agents bound to the plurality of defects.

4) The composition of clause 3, wherein the assay agent comprises a detection agent configured to bind to an analyte of the plurality of analytes.

5) The composition of clause 4, wherein the detection agent comprises a detectable label.

6) The composition of clause 5, wherein the detectable label comprises a fluorophore, a luminophore, a radiolabel, a nucleic acid tag, a protein tag, or a combination thereof.

7) The composition of any one of clauses 3-6, wherein the detection agent comprises an affinity agent.

8) The composition of clause 7, wherein the affinity agent comprises an aptamer.

9) The composition of clause 7, wherein the affinity agent comprises an antibody or functional fragment thereof.

10) The composition of any one of clause 4-9, wherein the detection agent further comprises a nanoparticle.

11) The composition of clause 10, wherein the nanoparticle comprises a structured nucleic acid nanoparticle.

12) The composition of clause 10, wherein the nanoparticle comprises a non-nucleic acid nanoparticle.

13) The composition of clause 3, wherein the assay agent comprises an ionic species.

14) The composition of clause 3, wherein the assay agent comprises a chaotrope, a denaturant, or a surfactant.

15) The composition of any one of clauses 3-14, wherein the first molecule of the first plurality of passivating molecules comprises a polyethylene glycol (PEG) moiety.

16) The composition of any one of clauses 3-14, wherein the first molecule of the first plurality of passivating molecules comprises an alkane or fluorinated alkane moiety.

17) The composition of any one of clauses 3-14, wherein the first molecule of the first plurality of passivating molecules comprises a nucleic acid moiety.

18) The composition of any one of clauses 15-17, wherein the first molecule of the first plurality of passivating molecules comprises a linear molecular structure.

19) The composition of any one of clauses 15-17, wherein the first molecule of the first plurality of passivating molecules comprises a branched molecular structure.

20) The composition of any one of clauses 15-19, wherein the molecules of the first plurality of passivating molecules comprise identical molecular structure.

21) The composition of any one of clause 3-20, wherein the second molecule of the second plurality of passivating molecules comprises a polysaccharide moiety.

22) The composition of any one of clauses 3-20, wherein the second molecule of the second plurality of passivating molecules comprises a polypeptide moiety.

23) The composition of any one of clauses 3-20, wherein the second molecule of the second plurality of passivating molecules further comprises a PEG moiety, an alkane moiety, or a fluorinated alkane moiety.

24) The composition of any one of clauses 21-23, wherein the molecules of the second plurality of passivating molecules comprise identical molecular structure.

25) The composition of any one of clauses 21-23, wherein a first molecule of the second plurality of passivating molecules and the second molecule of the second plurality of passivating molecules comprise differing molecular structures.

26) The composition of clause 25, wherein the differing molecular structures comprise a differing molecular chain length from the second molecule of the second plurality of passivating molecules.

27) The composition of clause 25, wherein the differing molecular structures comprise a differing atomic composition from the second molecule of the second plurality of passivating molecules.

28) The composition of clause 25, wherein first molecule of the second plurality of passivating molecules comprises a differing chemical property from the second molecule of the second plurality of passivating molecules.

29) The composition of clause 28, wherein the differing chemical property comprises hydrophobicity, electronegativity, net electrical charge, polarity, hydrodynamic radius, or a combination thereof.

30) The composition of any one of clauses 3-29, wherein the second molecule of the second plurality of passivating molecules comprises a first passivating moiety and a second passivating moiety, wherein the first passivating moiety is covalently coupled to the second passivating moiety.

31) The composition of any one of clauses 3-29, wherein the second molecule of the second plurality of passivating molecules comprises a first passivating moiety and a second passivating moiety, wherein the first passivating moiety is non-covalently coupled to the second passivating moiety.

32) The composition of any one of clauses 3-31, wherein the first random spatial distribution occurs as a statistical distribution of molecules of the second plurality of passivating molecules with respect to sites of the plurality of sites.

33) The composition of any one of clauses 3-31, wherein the first random spatial distribution occurs as a probabilistic distribution of molecules of the second plurality of passivating molecules with respect to sites of the plurality of sites.

34) The composition of any one of clauses 3-31, wherein the second random spatial distribution occurs as a statistical distribution of molecules of the second plurality of passivating molecules with respect to sites of the plurality of sites.

35) The composition of any one of clauses 3-31, wherein the second random spatial distribution occurs as a probabilistic distribution of molecules of the second plurality of passivating molecules with respect to sites of the plurality of sites.

36) The composition of any one of clauses 32-35, wherein the first random spatial distribution and the second random spatial distribution are random with respect to each other.

37) The composition of any one of clauses 3-36, wherein the total quantity of the first plurality of sites to the total quantity of the plurality of defects is at a ratio of least 100.

38) The composition of clause 37, wherein the total quantity of the first plurality of sites to the total quantity of the plurality of defects is at a ratio of least 1000.

39) The composition of any one of clauses 3-38, wherein no more than 1% of sites of the plurality of sites are within an optically non-resolvable distance of defects of the plurality of defects.

40) The composition of clause 39, wherein no more than 0.1% of sites of the plurality of sites are within an optically non-resolvable distance of defects of the plurality of defects.

41) The composition of any one of clauses 3-40, wherein the likelihood of a random site of the plurality of sites being an optically non-resolvable distance from a nearest defect of the plurality of defects is no more than 1%.

42) The composition of any one of clauses 3-40, wherein the likelihood of a random site of the plurality of sites being an optically non-resolvable distance from a nearest defect of the plurality of defects is no more than 0.1%.

43) The composition of any one of clauses 39-42, wherein the optically non-resolvable distance is at least 1 nanometer (nm).

44) The composition of any one of clauses 39-43, wherein the optically non-resolvable distance is no more than 100 nanometers.

45) The composition of any one of clauses 3-44, wherein an analyte of the plurality of analytes comprises a polypeptide.

46) The composition of any one of clauses 3-44, wherein an analyte of the plurality of analytes comprises a nucleic acid, a polysaccharide, a metabolite, or a pharmaceutical compound.

47) The composition of clause 45 or 46, wherein the analyte is coupled to an anchoring moiety, wherein the anchoring moiety is configured to couple the analyte to one and only one site of the plurality of sites.

48) The composition of clause 47, wherein the anchoring moiety is further configured to inhibit contact of the analyte with the one and only one site of the plurality of sites.

49) The composition of clause 47 or 48, wherein the anchoring moiety comprises a nanoparticle.

50) The composition of clause 49, wherein the nanoparticle comprises a structured nucleic acid nanoparticle.

51) The composition of clause 49, wherein the nanoparticle comprises a non-nucleic acid nanoparticle.

52) The composition of any one of clauses 3-51, further comprising a plurality of assay agents.

53) The composition of clause 52, further comprising a fluidic medium, wherein the fluidic medium is contacted with the plurality of assay agents and the solid support.

54) The composition of clause 53, wherein the fluidic medium comprises one or more unbound assay agents.

55) The composition of any one of clauses 52-54, wherein a first assay agent of the plurality of assay agents is bound to a defect of the plurality of defects.

56) The composition of any one of clauses 52-55, wherein a second assay agent is bound to an analyte of the plurality of analytes.

57) The composition of clause 56, wherein a first fraction of assay agents is bound to the plurality of defects, and wherein a second fraction of assay agents is bound to the plurality of analytes.

58) The composition of clause 57, wherein the ratio of the second fraction of assay agents to the first fraction of assay agents is at least 100.

59) The composition of clause 58, wherein the ratio of the second fraction of assay agents to the first fraction of assay agents is at least 1000.

60) A method, comprising:
a. providing a solid support comprising an organic layer, wherein the organic layer comprises a plurality of defects, wherein each defect of the plurality of defects comprises an absence of the organic molecules, wherein the organic layer comprises an average defect density, wherein the plurality of defects comprises a spatially-random distribution on the solid support, wherein a first plurality of organic molecules is coupled to defects of the plurality of defects, and wherein the solid support comprises:
   i. a plurality of sites; and
   ii. one or more interstitial regions, wherein each site of the plurality of sites is spatially separated from other sites of the plurality of sites by an interstitial region of the one or more interstitial regions; and
b. coupling a second plurality of organic molecules to the solid support, wherein molecules of the second plurality of organic molecules are coupled to defects of the plurality of defects, and wherein each molecule of the second plurality of organic molecules comprises a passivating moiety.

61) The method of clause 60, wherein coupling the first plurality of organic molecules to the solid support comprises coupling the first plurality of organic molecules to the one or more interstitial regions.

62) The method of clause 61, further comprising:
a. coupling a third plurality of organic molecules to the plurality of sites to form a second organic layer, wherein the second organic layer comprises a second plurality of defects, wherein each defect of the second plurality of defects comprises an absence of the organic molecules, and wherein the second organic layer comprises a second average defect density on the solid support; and
b. coupling a fourth plurality of organic molecules to the plurality of sites, wherein molecules of the fourth plurality of organic molecules are coupled to a defect of the second plurality of defects, and wherein molecules of the second plurality of organic molecules comprise passivating moieties.

63) The method of clause 60, wherein coupling the first plurality of organic molecules to the solid support comprises coupling the first plurality of organic molecules to the plurality of sites.

64) The method of clause 63, further comprising:
a. coupling a third plurality of organic molecules to the one or more interstitial regions to form a second organic layer, wherein the second organic layer comprises a second plurality of defects, wherein each defect of the second plurality of defects comprises an absence of the organic molecules, and wherein the second organic layer comprises a second average defect density on the solid support; and
b. coupling a fourth plurality of organic molecules to the one or more interstitial regions, wherein molecules of the fourth plurality of organic molecules are coupled to a defect of the second plurality of defects, and wherein molecules of the second plurality of organic molecules comprise passivating moieties.

65) The method of any one of clauses 60-64, wherein the plurality of sites has an average site dimension of no more than 300 nanometers (nm).

66) The method of any one of clauses 60-65, wherein the plurality of sites has an average pitch of no more than 1.5 microns (μm).

67) The method of any one of clauses 60-66, wherein the average defect density is no more than about 100 defects per site relative to a total quantity of sites.

68) The method of any one of clauses 60-67, wherein the average defect density is at least about 0.01 defects per site, relative to a total quantity of sites.

69) The method of any one of clauses 60-68, wherein coupling the first plurality of organic molecules to a solid support to form an organic layer comprises forming a self-assembled monolayer comprising the first plurality of organic molecules.

70) The method of any one of clauses 60-69, wherein coupling the first plurality of organic molecules to the solid support to form an organic layer comprises covalently coupling the first plurality of organic molecules to a solid support to form an organic layer.

71) The method of any one of clauses 60-70, wherein each molecule of the first plurality of organic molecules comprises an organosilane.

72) The method of clause 71, wherein the solid support comprises silicon.

73) The method of any one of clauses 60-70, wherein each molecule of the first plurality of organic molecules comprises an organophosphate or an organophosphonate.

74) The method of clause 73, wherein the solid support comprises a metal or metal oxide.

75) The method of any one of clauses 60-74, wherein each molecule of the plurality of molecules comprises a functional group selected from the group consisting of amine, carboxylate, azide, hydroxyl, alkene, alkyne, epoxide, thiol, ester, and thioester.

76) The method of any one of clauses 60-75, further comprising coupling a fifth plurality of organic molecules to the solid support, wherein a molecule of the fifth plurality of organic molecules is coupled to a molecule of the first plurality of organic molecules.

77) The method of clause 76, wherein the molecule of the fifth plurality of molecules is indirectly coupled to the solid support.

78) The method of clause 76 or 77, wherein coupling the fifth plurality of organic molecules to the solid support occurs before coupling the second plurality of organic molecules to the solid support.

79) The method of clause 76 or 77, wherein coupling the fifth plurality of organic molecules to the solid support occurs after coupling the second plurality of organic molecules to the solid support.

80) The method of any one of clauses 76-79, wherein, after coupling the fifth plurality of organic molecules to the solid support, the solid support comprises a second plurality of defects.

81) The method of clause 80, further comprising coupling a sixth plurality of organic molecules to the solid support, wherein at least a first fraction of the sixth plurality of organic molecules is coupled to the second plurality of defects.

82) The method of clause 81, wherein at least a second fraction of the sixth plurality of organic molecules is coupled to the first plurality of defects.

83) The method of any one of clauses 60-82, further comprising coupling a plurality of analytes to the plurality of sites.

84) The method of clause 83, wherein a site of the plurality of sites comprises one and only one analyte of the plurality of analytes.

85) The method of clause 83 or 84, wherein an analyte of the plurality of analytes is coupled to an anchoring moiety, wherein the anchoring moiety is configured to couple the analyte to a site of the plurality of sites, and wherein the anchoring moiety is configured to occlude contact of the analyte with the site of the plurality of sites.

86) The method of any one of clauses 83-85, wherein coupling the plurality of analytes occurs after coupling the second plurality of organic molecules.

87) The method of any one of clauses 60-86, further comprising contacting the solid support with a plurality of assay agents, thereby coupling an assay agent of the plurality of assay agents to the solid support.

88) The method of clause 87, wherein an assay agent of the plurality of assay agents comprises an analyte, an affinity agent, or a reagent other than an analyte or an affinity agent.

89) The method of clause 87 or 88, wherein contacting the solid support with the plurality of assay agents occurs in a fluidic medium.

90) The method of clause 89, further comprising, after coupling the assay agent of the plurality of assay agents to the solid support, altering a condition of the fluidic medium, thereby decoupling the assay agent from the solid support.

91) The method of clause 90, wherein altering the condition of the fluidic medium comprises altering pH, ionic strength, reagent concentration, or a combination thereof, of the fluidic medium.

92) The method of clause 60, wherein a defect of the plurality of defects comprises a binding site that is configured to bind an organic molecule of the first plurality of organic molecules.

93) The method of any one of clauses 60-92, wherein an organic molecule of the second plurality of organic molecules comprises a passivating moiety and a reactive moiety, wherein the reactive moiety is configured to covalently bind to a defect of the plurality of defects.

94) A method, comprising:
a. providing an array comprising a solid support, wherein the array comprises:
   i. a plurality of sites, wherein a site of the plurality of sites is configured to couple one and only one analyte;
   ii. one or more interstitial regions, wherein each site of the plurality of sites is separated from other sites of the plurality of sites by the one or more interstitial regions; and
   iii. a surface-bound layer comprising a plurality of organic molecules, wherein the surface-bound layer comprises a first plurality of defects and a second plurality of defects, wherein the first plurality of defects is chemically distinguishable from the second plurality of defects;
b. contacting the array with a second plurality of organic molecules; and
c. coupling a first fraction of the second plurality of organic molecules to the first plurality of defects, and coupling a second fraction of the second plurality of organic molecules to the second plurality of defects.

95) A method, comprising:
a. providing a solid support surface comprising a plurality of surface-coupled moieties, wherein the surface-coupled moieties comprise reactive functional groups;
b. contacting the solid support with an aqueous medium comprising a plurality of molecules, wherein molecules of the plurality of molecules comprise coupling moieties, wherein the aqueous medium further comprises a kosmotropic agent or a clouding agent, wherein a coupling moiety of the coupling moieties comprises a complementary reactive functional group, and wherein reactive functional groups covalently coupled complementary reactive functional groups; and
c. covalently coupling molecules of the plurality of molecules to at least 50% of the plurality of surface-coupled moieties in the presence of the kosmotropic agent or clouding agent.

96) The method of clause 95, wherein providing the solid support surface comprising the plurality of surface-coupled molecules comprises:
i) forming a layer of a patternable material adjacent to the surface of the solid support;
ii) forming a well in the layer of the patternable material, wherein a portion of the surface of the solid support is exposed in the well; and
iii) after forming the well in the layer of the patternable material, coupling the plurality of surface-coupled moieties to the portion of the surface of the solid support.

97) The method of clause 96, wherein forming the well in the layer of the patternable material comprises lithographically forming the well in the layer of the patternable material.

98) The method of clause 96, wherein forming the well in the layer of the patternable material comprises removing patternable material utilizing electromagnetic radiation.

99) The method of any one of clauses 96-98, further comprising, after coupling the plurality of surface-coupled moieties to the portion of the surface of the solid support, separating the patternable material from the solid support.

100) The method of clause 99, wherein separating the patternable material occurs before contacting the solid support with the aqueous medium.

101) The method of clause 99, wherein separating the patternable material occurs after contacting the solid support with the aqueous medium.

102) The method of any one of clauses 95-101, wherein a reactive functional group of the reactive functional groups comprises a nucleophilic functional group, an electrophilic functional group, or a Click-type functional group.

103) The method of any one of clauses 95-101, further comprising repeating step b).

104) The method of clause 103, wherein step c) comprises covalently coupling NHS esters of the aqueous medium to at least 80% of nucleophilic functional groups of the plurality of surface-coupled moieties in the presence of the kosmotropic agent or clouding agent.

105) The method of clause 103 or 104, wherein repeating step b) comprises performing step b) with a first aqueous medium, and subsequently repeating step b) with a second aqueous medium.

106) The method of clause 105, wherein the first aqueous medium and the second aqueous medium have the same composition.

107) The method of clause 105, wherein the first aqueous medium and the second aqueous medium have differing compositions.

108) The method of clause 107, wherein the first aqueous medium differs from the second aqueous medium with respect to the kosmotropic agent or the clouding agent.

109) The method of clause 107 or 108, wherein the first aqueous medium differs from the second aqueous medium with respect to a solvating composition.

110) The method of any one of clauses 107-109, wherein the first aqueous medium differs from the second aqueous medium with respect to the NHS esters.

111) The method of any one of clauses 103-110, further comprising rinsing the solid support with a rinsing medium.

112) The method of clause 111, wherein the rinsing occurs after performing step b) and before repeating step b).

113) The method of clause 111 or 112, wherein the rinsing occurs after repeating step b).

114) A composition, comprising:
a. a solid support;
b. a moiety coupled to the solid support, wherein the moiety comprises a nucleophilic functional group; and
c. an aqueous medium contacted to the solid support, wherein the aqueous medium comprises:
   i. a compound comprising a moiety comprising an N-hydroxysuccinimide (NHS) ester, wherein the compound further comprises a polymeric moiety; and
   ii. a kosmotropic agent or a clouding agent.

115) The composition of clause 114, wherein the solid support comprises a semiconductor or glass.

116) The composition of clause 114 or 115, wherein the solid support comprises a metal oxide.

117) The composition of any one of clauses 114-116, wherein the moiety is covalently coupled to the solid support.

118) The composition of clause 117, wherein the moiety comprises a silane that is covalently coupled to the solid support.

119) The composition of clause 117, wherein the moiety comprises a phosphate or a phosphonate that is covalently coupled to the solid support.

120) The composition of any one of clauses 114-116, wherein the moiety is non-covalently coupled to the solid support.

121) The composition of clause 120, wherein the moiety is coupled to the solid support electrostatically or magnetically.

122) The composition of clause 120 or 121, wherein the moiety comprises a nanoparticle or a nucleic acid particle.

123) The composition of any one of clauses 114-122, wherein the nucleophilic functional group comprises an amine functional group.

124) The composition of clause 123, wherein the amine functional group comprises a primary amine functional group.

125) The composition of clause 123, wherein the amine functional group comprises a secondary amine functional group.

126) The composition of any one of clauses 114-122, wherein the nucleophilic functional group comprises an alcohol, a thiol, an azide, or an amide.

127) The composition of any one of clauses 114-126, wherein the aqueous medium further comprises a buffering species.

128) The composition of clause 127, wherein the buffering species is selected from group consisting of [add buffers list].

129) The composition of any one of clauses 114-128, wherein the aqueous medium further comprises an organic co-solvent.

130) The composition of clause 129, wherein the organic co-solvent is selected from the group consisting of [add organic solvents list].

131) The composition of clause 129 or 130, wherein the organic solvent comprises no more than 50% of the aqueous medium by weight.

132) The composition of any one of clauses 114-131, wherein the aqueous medium comprises a pH of at least about 7.0.

133) The composition of any one of clauses 114-132, wherein the moiety comprising the NHS ester further comprises a molecular chain.

134) The composition of clause 133, wherein the molecular chain comprises a polyethylene glycol (PEG) chain, an alkane chain, a polypeptide chain, a polynucleotide chain, or a polysaccharide chain.

135) The composition of any one of clauses 114-132, wherein the moiety comprising the NHS ester further comprises a dendritic polymer.

136) The composition of any one of clauses 133-135, wherein the molecular chain or the dendritic polymer has a molecular weight of at least 500 Daltons (Da).

137) The composition of any one of clauses 114-136, wherein the moiety comprising the NHS ester further comprises a functional group.

138) The composition of clause 137, wherein the functional group comprises a reactive functional group.

139) The composition of clause 138, wherein the reactive functional group comprises a Click-type reactant.

140) The composition of clause 137, wherein the functional group comprises a non-reactive functional group.

141) The composition of any one of clauses 114-140, wherein the kosmotropic agent is selected from the group consisting of carbonate ion, sulfate ion, phosphate ion, magnesium ion, lithium ion, zinc ion, aluminum ion, trehalose, glucose, proline, tert-butanol, and combinations thereof.

142) The composition of any one of clauses 114-140, wherein the clouding agent comprises a salt selected from group consisting of sodium chloride, potassium chloride, sodium bromide, potassium bromide, sodium nitrate, sodium sulfate, sodium phosphate, and combinations thereof.

143) A method, comprising:
a. providing a solid support comprising a surface, wherein a patternable material is disposed on the surface, wherein the patternable material comprises a well, and wherein a portion of the surface of the solid support is exposed in the well;
b. contacting the patternable material with an organic polar solvent, wherein the organic polar solvent comprises a plurality of surfactant molecules;
c. after contacting the patternable material with the organic polar solvent, forming an admixture of the plurality of surfactant molecules and the patternable material;
d. coupling a plurality of molecules to the portion of the solid support, wherein the plurality of molecules comprises a plurality of reactive functional groups; and
e. removing from the solid support at least a fraction of the admixture comprising the patternable material and the plurality of surfactant molecules.

144) The method of clause 143, wherein providing the solid support comprising the surface further comprises altering a conformation of the well.

145) The method of clause 144, wherein altering the conformation of the well comprises a member selected from the group consisting of: i) removing patternable material adjacent to a side of the well, ii) removing patternable material adjacent to the portion of the solid support that is exposed, iii) altering a morphology of the side of the well, iv) removing material from the portion of solid support that is exposed in the well; v) increasing a volume occupied by patternable material adjacent to the side of the well, vi) decreasing the volume occupied by patternable material adjacent to the side of the well, and vii) combinations thereof.

146) The method of clause 144 or 145, wherein altering the conformation of the well comprises etching patternable material or material from the portion of the solid support that is exposed in the well.

147) The method of clause 146, wherein etching patternable material or material from the portion of the solid support that is exposed in the well comprises dry etching, wet etching, or combinations thereof.

148) The method of clause 144 or 145, wherein increasing or decreasing a volume occupied by patternable material adjacent to the side of the well comprises contacting the patternable material with a volume-altering fluidic medium.

149) The method of clause 148, wherein the volume-altering fluidic medium comprises the organic polar solvent.

150) The method of clause 149, wherein the volume-altering fluidic medium further comprises the plurality of surfactant molecules.

151) The method of clause 148, wherein the volume-altering fluidic medium does not comprise the organic polar solvent.

152) The method of any one of clauses 143-151, wherein steps b) and c) occur before step d).

153) The method of any one of clauses 143-151, wherein step d) occurs before step b).

154) The method of any one of clauses 143-153, further comprising reacting competitive reactive functional groups of surfactant molecules of the plurality of surfactant molecules with a first set of molecules of the patternable material.

155) The method of clause 154, wherein the reacting of the competitive reactive functional groups occurs adjacent to the portion of the solid support that is exposed.

156) The method of clause 154 or 155, wherein the reacting of the competitive reactive functional groups occurs in the presence of a fluidic medium, wherein the fluidic medium is configured to facilitate the reacting of the competitive reactive functional groups to the first set of molecules of the patternable material.

157) The method of any one of clauses 154-156, further comprising reacting reactive functional groups of molecules of the plurality of molecules to a second set of molecules of the patternable material.

158) The method of clause 157, wherein the reacting occurs in the presence of the fluidic medium.

159) The method of clause 157 or 158, wherein a ratio of the first set of molecules to the second set of molecules is at least 2.

160) The method of any one of clauses 143-159, wherein removing from the solid support at least the fraction of the admixture comprises contacting the patternable material with a dissolution medium, wherein the dissolution medium comprises a solubility for the patternable material and the plurality of surfactant molecules.

161) The method of clause 160, further comprising rinsing the dissolution medium from the solid support.

162) The method of any one of clauses 143-161, further comprising rinsing the organic polar solvent from the solid support.

163) The method of any one of clauses 160-162, further comprising sonicating, mechanically agitating, or altering a temperature of the solid support or dissolution medium.

164) A composition, comprising:
a. a solid support comprising a surface;
b. a patternable material disposed on the surface, wherein the patternable material comprises a well, wherein the well is at least partially bounded by the patternable material, and wherein a bottom of the well comprises an exposed portion of the surface;
c. a plurality of molecules, wherein the molecules are coupled to the exposed portion of the surface, and wherein molecules of the plurality of molecules comprise reactive functional groups; and
d. a plurality of protectant moieties, wherein the plurality of protectant moieties is dispersed within the patternable material.

165) The composition of clause 164, wherein the solid support comprises a silicon-containing material.

166) The composition of clause 165, wherein the silicon-containing material comprises silicon, quartz, fused silica, or glass.

167) The composition of any one of clauses 164-166, wherein the solid support comprises a metal oxide.

168) The composition of clause 167, wherein the metal oxide comprises silicon dioxide, zirconium oxide, or titanium oxide.

169) The method of clause 168, wherein the solid support comprises a metal oxide layer disposed upon a silicon-containing material.

170) The composition of any one of clauses 164-169, wherein the patternable material comprises a polymer or resin.

171) The composition of any one of clauses 164-169, wherein the patternable material comprises a photoresist material.

172) The composition of clause 171, wherein the photoresist material comprises a negative photoresist material.

173) The composition of clause 171, wherein the photoresist material comprises a positive photoresist material.

174) The composition of clause 171, wherein the photoresist material comprises a chemically-amplified photoresist material.

175) The composition of any one of clauses 171-174, wherein the photoresist material is selected from a group consisting of polydimethylsiloxane (PDMS), SU-8, polymethyl glutarimide (PMGI), and polymethyl methacrylate (PMMA).

176) The composition of any one of clauses 164-175, wherein the well comprises a sidewall that at least partially bounds the well.

177) The composition of clause 176, wherein a fraction of the plurality of molecules is adjacent to the sidewall.

178) The composition of any one of clauses 164-177, wherein the patternable material comprises reactive moieties.

179) The composition of clause 178, wherein the reactive moieties comprise electrophilic moieties.

180) The composition of clause 178, wherein the reactive functional groups comprise nucleophilic moieties.

181) The composition of any one of clauses 178-180, wherein protectant moieties of the plurality of protectant moieties comprise second reactive functional groups, wherein a reactivity between a second reactive functional group and a reactive moiety is greater than a reactivity between a reactive functional group and the reactive moiety.

182) The composition of any one of clauses 164-181, wherein a protectant moiety of the plurality of protectant moieties comprises a molecular chain, wherein the molecular chain is configured to be soluble in the patternable material.

183) The composition of clause 181 or 182, wherein a protectant moiety of the plurality of protectant moieties comprises a surfactant.

184) The composition of any one of clauses 164-183, further comprising a fluidic medium, wherein the fluidic medium is contacted with the patternable material.

185) The composition of clause 184 wherein the fluidic medium comprises protectant moieties.

186) The composition of clause 184, wherein the fluidic medium comprises a stripping medium, wherein the stripping medium is configured to separate patternable material from the solid support.

187) The composition of any one of clauses 184-186, wherein the fluidic medium is configured to facilitate a reaction between a reactive functional group of the plurality of reactive functional groups and the patternable material.

188) The composition of any one of clauses 164-187, wherein the plurality of protectant moieties comprises a substantially uniform concentration in the patternable material.

189) The composition of any one of clauses 164-187, wherein the plurality of protectant moieties comprises a heterogeneous concentration in the patternable material.

190) The composition of clause 189, wherein a concentration of protectant moieties in the patternable material is higher near surfaces of the patternable material that are contactable with a fluidic medium.

191) A method, comprising:
a. providing a solid support comprising a surface, wherein a patternable material is disposed on the surface, wherein the patternable material comprises a well, and wherein a portion of the surface of the solid support is exposed in the well;
b. forming an admixture of a plurality of chemical sink moieties and the patternable material;
c. coupling a plurality of molecules to the portion of the solid support; and
d. after coupling the plurality of molecules to the portion of the solid support, forming a perimeter material adjacent to the portion of the solid support, wherein the perimeter material is disposed on the surface, wherein the perimeter material comprises a molecule of the plurality of molecules coupled to a molecule of the patternable material, and wherein the perimeter material further comprises chemical sink moieties of the plurality of chemical sink moieties.

192) A composition, comprising:
a. a solid support comprising a surface; and
b. a solid-phase admixture disposed on the surface, wherein the solid-phase admixture comprises a patternable material and a plurality of chemical sink moieties.

193) The composition of clause 192, wherein a molecule of the chemical sink moieties comprises a photolabile moiety or a photoisomerization moiety.

194) A composition, comprising:
a. a solid support comprising a surface;
b. a plurality of molecules coupled to a portion of the surface; and
c. a perimeter material disposed on the surface adjacent to the portion of the surface, wherein the perimeter material comprises a molecule of the plurality of molecules covalently coupled to a molecule of a patternable material, and wherein the perimeter material further comprises a chemical sink moiety.

195) A method, comprising:
a) providing a substrate, wherein the substrate comprises a solid support and a layer of a resist material disposed on a surface of the solid support, and wherein the layer of the resist material comprises a plurality of depressions, wherein each individual depression of the plurality of depression comprises an exposed region of the surface of the solid support;
b) binding a plurality of molecules to each individual exposed region of the surface of the solid support in each individual depression of the plurality of depressions, wherein molecules of the plurality of molecules comprise reactive functional groups that are not attached to the surface of the solid support, wherein the binding occurs in the presence of a fluidic medium comprising water and a miscible solvent; and
c) after binding the plurality of molecules to each individual exposed region of the surface of the solid support, removing the layer of the resist material from the surface of the solid support.

196) The method of clause 195, wherein a reactive functional group of the reactive functional groups comprises a nucleophilic functional group.

197) The method of clause 196, wherein the nucleophilic functional group comprises an amine functional group.

198) The method of clause 196 or 197, wherein a reactive functional group of the reactive functional groups is a terminal moiety of a molecule of the plurality of molecules.

199) The method of any one of clauses 195-198, further comprising exposing the substrate to a plasma.

200) The method of clause 199, wherein exposing the substrate to the plasma occurs for no more than 10 minutes.

201) The method of clause 200, wherein exposing the substrate to the plasma occurs for no more than 5 minutes.

202) The method of any one of clauses 199-201, further comprising contacting the substrate with a reactive agent, wherein the contacting occurs after exposing the substrate to the plasma and before removing the layer of the resist material.

203) The method of clause 202, wherein the contacting comprises contacting the substrate with a gas-phase reactive agent.

204) The method of clause 202 or 203, wherein the contacting comprises contacting the substrate with a liquid-phase reactive agent.

205) The method of any one of clauses 195-204, wherein the miscible solvent comprises an aprotic solvent.

206) The method of clause 205, wherein the aprotic solvent is selected from the group consisting of N-methyl pyrrolidone, tetrahydrofuran, ethyl acetate, acetone, dimethylfuran, acetonitrile, dimethyl sulfoxide, propylene carbonate, and a combination thereof.

207) The method of any one of clauses 195-206, wherein the miscible solvent comprises a polar solvent.

208) The method of clause 207, wherein the polar solvent is selected from the group consisting of N-methyl pyrrolidine, tetrahydrofuran, ethyl acetate, acetone, dimethylfuran, acetonitrile, dimethyl sulfoxide, propylene carbonate, N-butanol, isopropyl alcohol, nitromethane, ethanol, methanol, acetic acid, and a combination thereof.

209) The method of any one of clauses 204-207, wherein a weight ratio of the water to the miscible solvent in the fluidic medium is no more than 10:1.

210) The method of clause 209, wherein the weight ratio of the water to the miscible solvent in the fluidic medium is no more than 2:1.

211) The method of any one of clauses 195-210, wherein removing the layer of the resist material from the surface of the solid support comprises contacting the resist material with a fluidic medium comprising a surfactant.

212) The method of clause 211, wherein the surfactant comprises a non-ionic surfactant, a cationic surfactant, an anionic surfactant, a zwitterionic surfactant, an amphoteric surfactant, or a combination thereof.

213) The method of clause 211 or 212, wherein the contacting of the resist material with a fluidic medium occurs in the presence of sonication.

214) The method of clause 213, wherein the sonication occurs for at least 10 minutes.

215) An array, comprising:
a) a solid support comprising a surface;
b) a plurality of discrete regions on the surface of the solid support, wherein each discrete region comprises a plurality of molecules coupled to the surface of the solid support; and
c) one or more interstitial regions, wherein each individual discrete region of the plurality of discrete regions is separated from each other discrete region by an interstitial region of the one or more interstitial regions;
   wherein the plurality of molecules comprises a plurality of passivating molecules and a plurality of coupling molecules, wherein a ratio of a quantity of the plurality of passivating molecules to a quantity of the plurality of coupling molecules is at least 2:1; and
   wherein the one or more interstitial regions comprise a layer disposed on the surface of the solid support, wherein the layer comprises a hydrophobic material.

216) The array of clause 215, wherein the solid support comprises silicon, silica, fused silica, or quartz.

217) The array of clause 216, wherein the solid support further comprises a layer of silicon dioxide, wherein the surface of the solid support is a surface of the layer of silicon dioxide.

218) The array of any one of clauses 215-217, wherein the plurality of discrete regions has an average dimension of no more than 200 nanometers (nm).

219) The array of clause 218, wherein the plurality of discrete regions has an average dimension of no more than 120 nm.

220) The array of clause 218 or 219, wherein the plurality of discrete regions has an average feature area of no more than 1×10⁵ square nanometers (nm²).

221) The array of clause 220, wherein the plurality of discrete regions has an average feature area of no more than 2×10⁴ nm².

222) The array of any one of clauses 215-221, wherein each individual molecule of the plurality of molecules is covalently coupled to the surface of the solid support.

223) The array of clause 222, wherein a molecule of the plurality of molecules comprises a silane moiety, wherein the silane moiety is covalently coupled to the surface of the solid support.

224) The array of clause 223, wherein each individual molecule of the plurality of molecules comprises a silane moiety, wherein each individual silane moiety is covalently coupled to the surface of the solid support.

225) The array of any one of clauses 215-224, wherein a passivating molecule of the plurality of passivating molecules comprises a polyethylene glycol moiety or a dextran moiety.

226) The array of any one of clauses 215-225, wherein a coupling molecule of the plurality of coupling molecules comprises an oligonucleotide.

227) The array of any one of clauses 215-226, wherein a coupling molecule of the plurality of coupling molecules further comprises a passivating moiety.

228) The array of any one of clauses 215-227, wherein the hydrophobic material comprises an adhesion promoter.

229) The array of clause 228, wherein the adhesion promoter comprises a silane or titanate.

230) The array of clause 229, wherein the silane comprises hexamethyldisilazane.

231) The array of any one of clauses 215-230, wherein the hydrophobic material comprises alkyl groups.

232) The array of clause 231, wherein an alkyl group of the alkyl groups comprises 2 or more carbon atoms.

233) The array of any one of clauses 215-232, further comprising a nanoparticle that comprises a coupling moiety, and wherein the nanoparticle is coupled to the array by binding of the coupling moiety of the nanoparticle to a coupling moiety of the plurality of coupling moieties of a discrete region of the plurality of discrete regions.

234) The array of clause 233, wherein the coupling moiety of the nanoparticle of the plurality of nanoparticles comprises an oligonucleotide, wherein the oligonucleotide of the individual nanoparticle is hybridized to an oligonucleotide coupling moiety of the plurality of oligonucleotide coupling moieties of the discrete region of the plurality of discrete regions. 235) The array of clause 233 or 234, wherein the nanoparticle is coupled to the array by binding of two or more coupling moieties of the nanoparticle to coupling moieties of the plurality of coupling moieties of the discrete region of the plurality of discrete regions.

236) The array of any one of clauses 233-235, wherein the array comprises a plurality of nanoparticles coupled to the discrete regions of the solid support.

237) A flow cell, comprising:
a) a first solid support, wherein an array of any one of clauses 215-236 is disposed on a surface of the first solid support; and
b) a second solid support;
   wherein the first solid support is joined to the second solid support to form an enclosed void, wherein the array is disposed within the void, and wherein a surface of the second solid support within the void comprises a layer of a hydrophobic material.

238) The flow cell of clause 237, wherein the hydrophobic material is the same hydrophobic material as a hydrophobic material disposed on an interstitial region of the array.

239) The flow cell of clause 237 or 238, wherein the hydrophobic material comprises a silane or titanate.

240) The flow cell of clause 239, wherein the silane comprises hexamethyldisilazane.

What is claimed is:

1) A method, comprising:
a) providing a substrate, wherein the substrate comprises a solid support and a layer of a resist material disposed on a surface of the solid support, and wherein the layer of the resist material comprises a plurality of depressions, wherein each individual depression of the plurality of depression comprises an exposed region of the surface of the solid support;
b) binding a plurality of molecules to each individual exposed region of the surface of the solid support in each individual depression of the plurality of depressions, wherein molecules of the plurality of molecules comprise reactive functional groups that are not attached to the surface of the solid support, wherein the binding occurs in the presence of a fluidic medium comprising water and a miscible solvent; and
c) after binding the plurality of molecules to each individual exposed region of the surface of the solid support, removing the layer of the resist material from the surface of the solid support.

2) The method of claim 1, wherein a reactive functional group of the reactive functional groups comprises a nucleophilic functional group.

3) The method of claim 2, wherein the nucleophilic functional group comprises an amine functional group.

4) The method of claim 2, wherein a reactive functional group of the reactive functional groups is a terminal moiety of a molecule of the plurality of molecules.

5) The method of claim 1, further comprising exposing the substrate to a plasma.

6) The method of claim 5, wherein exposing the substrate to the plasma occurs for no more than 10 minutes.

7) The method of claim 5, further comprising contacting the substrate with a reactive agent, wherein the contacting occurs after exposing the substrate to the plasma and before removing the layer of the resist material.

8) The method of claim 7, wherein the contacting comprises contacting the substrate with a gas-phase reactive agent.

9) The method of claim 7, wherein the contacting comprises contacting the substrate with a liquid-phase reactive agent.

10) The method of claim 1, wherein the miscible solvent comprises an aprotic solvent.

11) The method of claim 10, wherein the aprotic solvent is selected from the group consisting of N-methyl pyrrolidone, tetrahydrofuran, ethyl acetate, acetone, dimethylfuran, acetonitrile, dimethyl sulfoxide, propylene carbonate, and a combination thereof.

12) The method of claim 1, wherein the miscible solvent comprises a polar solvent.

13) The method of claim 12, wherein the polar solvent is selected from the group consisting of N-methyl pyrrolidine, tetrahydrofuran, ethyl acetate, acetone, dimethylfuran, acetonitrile, dimethyl sulfoxide, propylene carbonate, N-butanol, isopropyl alcohol, nitromethane, ethanol, methanol, acetic acid, and a combination thereof.

14) The method of claim 9, wherein a weight ratio of the water to the miscible solvent in the fluidic medium is no more than 10:1.

15) The method of claim 1, wherein removing the layer of the resist material from the surface of the solid support comprises contacting the resist material with a fluidic medium comprising a surfactant.

16) The method of claim 15, wherein the surfactant comprises a non-ionic surfactant, a cationic surfactant, an anionic surfactant, a zwitterionic surfactant, an amphoteric surfactant, or a combination thereof.

17) The method of claim 15, wherein the contacting of the resist material with a fluidic medium occurs in the presence of sonication.

18) The method of claim 17, wherein the sonication occurs for at least 10 minutes.

19) An array, comprising:
a) a solid support comprising a surface;
b) a plurality of discrete regions on the surface of the solid support, wherein each discrete region comprises a plurality of molecules coupled to the surface of the solid support; and
c) one or more interstitial regions, wherein each individual discrete region of the plurality of discrete regions is separated from each other discrete region by an interstitial region of the one or more interstitial regions;
wherein the plurality of molecules comprises a plurality of passivating molecules and a plurality of coupling molecules, wherein a ratio of a quantity of the plurality of passivating molecules to a quantity of the plurality of coupling molecules is at least 2:1; and
wherein the one or more interstitial regions comprise a layer disposed on the surface of the solid support, wherein the layer comprises a hydrophobic material.

20) A flow cell, comprising:
a) a first solid support, wherein an array comprising a plurality of discrete regions is disposed on a surface of the first solid support, wherein each discrete region comprises a plurality of molecules coupled to the surface of the solid support; and
b) a second solid support;
wherein the first solid support is joined to the second solid support to form an enclosed void, wherein the array is disposed within the void, and wherein a surface of the second solid support within the void comprises a layer of a hydrophobic material.
